(19) United States
(12) Patent Application Publication
(10) Pub. No.: US 2014/0081667 A1
(43) Pub. Date: Mar. 20, 2014

(54) APPARATUS AND METHOD FOR PROCESSING AND/OR PROVIDING HEALTHCARE INFORMATION AND/OR HEALTHCARE-RELATED INFORMATION WITH OR USING AN ELECTRONIC HEALTHCARE RECORD OR ELECTRONIC HEALTHCARE RECORDS

(71) Applicant: RAYMOND ANTHONY JOAO, YONKERS, NY (US)

(72) Inventor: RAYMOND ANTHONY JOAO, YONKERS, NY (US)

(21) Appl. No.: 14/082,151

(22) Filed: Nov. 17, 2013

Related U.S. Application Data
(63) Continuation-in-part of application No. 14/011,399, filed on Aug. 27, 2013.
(60) Provisional application No. 61/797,537, filed on Dec. 8, 2012.
(60) Provisional application No. 61/797,147, filed on Nov. 30, 2012.
(60) Provisional application No. 61/743,522, filed on Sep. 6, 2012.

(51) Int. Cl. G06F 19/00

(52) U.S. Cl. CPC G06F 19/322
USPC 705/3

(57) ABSTRACT

A computer-implemented method, including storing, in an electronic healthcare record of an individual or patient, a note, comment, or message, provided by the individual, patient, or a caregiver, transmitting the note, comment, or message, to a device used by a provider, receiving information regarding the individual or patient from the provider, processing the information from the provider, generating a report containing information regarding provider information, an examination or procedure finding, a diagnosis, treatment, or treatment plan, or wellness, exercise, fitness, nutritional, diet, rehabilitation, or therapy, information, wherein the report contains information regarding, or a link or hyperlink to, the electronic healthcare record or data or information contained therein, or the note, comment, or message, and transmitting the report to a communication device used by the individual, the patient, the caregiver, the provider or a second provider, or an insurer or payer of the individual, the patient, or the caregiver.

### RELATED APPLICATIONS

This application claims the benefit of the priority of U.S. Provisional Patent Application Ser. No. 61/797,537, filed Dec. 8, 2012, and entitled “APPARATUS AND METHOD FOR PROCESSING AND/OR PROVIDING HEALTHCARE INFORMATION AND/OR HEALTHCARE-RELATED INFORMATION WITH OR USING AN ELECTRONIC HEALTHCARE RECORD OR ELECTRONIC HEALTHCARE RECORDS”, the subject matter and teachings of which are hereby incorporated by reference herein in their entirety. This application also claims the benefit of the priority of U.S. Provisional Patent Application Ser. No. 61/797,147, filed Nov. 30, 2012, and entitled “APPARATUS AND METHOD FOR PROCESSING AND/OR PROVIDING HEALTHCARE INFORMATION AND/OR HEALTHCARE-RELATED INFORMATION WITH OR USING AN ELECTRONIC HEALTHCARE RECORD OR ELECTRONIC HEALTHCARE RECORDS”, the subject matter and teachings of which are hereby incorporated by reference herein in their entirety. This application is also a continuation-in-part application of U.S. patent application Ser. No. 14/011,399, filed Aug. 27, 2013, and entitled “APPARATUS AND METHOD FOR PROCESSING AND/OR PROVIDING HEALTHCARE INFORMATION AND/OR HEALTHCARE-RELATED INFORMATION WITH OR USING AN ELECTRONIC HEALTHCARE RECORD OR ELECTRONIC HEALTHCARE RECORDS”, the subject matter and teachings of which are hereby incorporated by reference herein in their entirety. U.S. patent application Ser. No. 14/011,399, filed Aug. 27, 2013, claims the benefit of the priority of U.S. Provisional Patent Application Ser. No. 61/743,522, filed Sep. 6, 2012, and entitled “APPARATUS AND METHOD FOR PROCESSING AND/OR PROVIDING HEALTHCARE INFORMATION AND/OR HEALTHCARE-RELATED INFORMATION WITH OR USING AN ELECTRONIC HEALTHCARE RECORD OR ELECTRONIC HEALTHCARE RECORDS”, the subject matter and teachings of which are hereby incorporated by reference herein in their entirety.

### FIELD OF THE INVENTION

The present invention pertains to an apparatus and a method for processing and/or for providing healthcare information and/or healthcare-related information with or using an electronic healthcare record or electronic healthcare records, in particular, to an apparatus and a method for processing and/or for providing healthcare information and/or healthcare-related information with or utilizing an electronic healthcare record or electronic healthcare records and data and/or information contained therein for a number and variety of applications.

### BACKGROUND OF THE INVENTION

Healthcare is an area of major concern in the United States. Each year, tens of millions of individuals seek or need the assistance of healthcare professionals. In order to perform proper diagnoses and to prescribe appropriate treatments, healthcare professional or providers typically rely on information which is obtained from patients, relatives of patients, previous providers, and/or healthcare facility and/or hospital staff members. The need to have accurate and/or up-to-date data and/or information, in providing healthcare services and/or healthcare-related services, cannot be emphasized enough.

Stories constantly emerge about patients receiving the wrong treatments, having the wrong surgical procedures performed on themselves, receiving a drug or drugs which fatally and/or otherwise adversely interact with another drug or drugs, etc., with stories going on and on. A 1999 study estimated that between 44,000 and 98,000 individuals die annually in hospitals, in the United States alone, as the result of errors or mistakes made by doctors, healthcare providers, and/or healthcare facility workers. Various other reports also estimate 225,000 deaths annually from medical errors and 180,000 deaths annually from medication errors and adverse reactions. There is no doubt that many of these deaths result from inaccurate and/or erroneous information and/or the lack of the availability of correct and/or up-to-date information.

Another problem lies with the fact that the main source of patient information, medical histories, family histories, etc., upon which doctors or providers may base their diagnoses and/or treatments, are patients who usually supply this information on questionnaires or forms just prior to seeing the healthcare provider and/or during a preliminary interview with the provider. In this regard, information obtained from these questionnaires or forms, as well as from these preliminary interviews with the providers, may not necessarily result in sufficient, comprehensive, and/or accurate, information being obtained regarding the patient. Further, there is no guarantee that the same information will be provided, in a uniform manner, to a next or different provider. As a result, patient information may not be uniformly distributed and/or be available to providers at the point of treatment and/or otherwise.

Another problem which exists in the current healthcare system is that doctors or other providers do not always have the latest information and/or research material available to them prior to, and/or during, the diagnosis and/or treatment process.

It is also no secret that healthcare costs are rising at ever-increasing rates and that insurance companies and other healthcare payers expend great resources in processing and reconciling treatment claims and/or claims for healthcare services and/or benefits. Typically, these insurance and/or benefits claims take place in a paper-based environment and, as a result are slow and inefficient. Fraudulent claims and/or claims which cannot be verified pose another major problem for healthcare payers and insurance companies. These problems only serve to add to the growing costs of healthcare, delayed treatments, and a general dissatisfaction with the current healthcare system.

The tab for healthcare in the U.S. is also expected to hit $4.6 trillion dollars in 2020 which will account for approximately $1 out of every $5, or 20%, of spending in the U.S. economy.

Another problem lies in making up-to-date training materials conveniently available to providers in order to allow providers to remain current with state-of-the-art information and training techniques.

Other problems lie in maintaining patient healthcare records or files private, in safeguarding patient healthcare records or files, in providing notification to patients and other individuals when others have accessed, obtained, and/or made changes to their respective healthcare records or files, and in enabling patients and individuals to restrict and/or limit access to their healthcare records or files.

Although electronic healthcare records (EHRs), electronic medical records (EMRs), electronic dental records (EDRs), electronic pharmacy records (EPRs) and other electronic or digital records systems have emerged in the marketplace, they have not yet proved to be the solution to the U.S. healthcare problems. Further, the fact that there are many different EHRs, EMRs, EDRs, EPRs and other electronic or digital records being offered by different vendors further complicates matters and does not facilitate a comprehensive and centralized healthcare records system.

The list of problems with the current healthcare system goes on and on. In view of the above, there is a great need for an apparatus and a method for providing healthcare information and/or healthcare-related information to the various providers, payers, patients, third party individuals, and/or insurance brokers, agents and/or other intermediaries, which overcomes the shortcomings of prior art.

### SUMMARY OF THE INVENTION

The present invention provides an apparatus and methods for providing healthcare information and/or healthcare-related information with or using an electronic healthcare record or records which overcomes the shortcomings of the prior art.

The present invention is directed to an apparatus and a method for processing and/or for providing healthcare information and/or healthcare-related information with or using an electronic healthcare record or records and, in particular, to an apparatus and a method for processing and/or for providing healthcare information and/or healthcare-related information with or using an electronic healthcare record or records for a variety of healthcare and healthcare related applications.

The apparatus and method of the present invention facilitates the creation and management of a comprehensive healthcare processing system which can manage patient and client records, healthcare provider records, healthcare insurance and/or payer records, and thereby provides an apparatus, system and methods for providing a variety and a multitude of healthcare information processing applications, processes and services.

The present invention facilitates improved healthcare quality, efficient information collection, processing and dissemination, efficient diagnosis and treatment, cost efficiency, cost containment, as well as many other benefits and advantages as will be described herein. The apparatus and method of the present invention can also facilitate the distribution and management of healthcare insurance, life insurance, disability insurance, as well as claims processing related thereto.

The present invention also provides an apparatus and a method for providing a comprehensive processing system which incorporates data and/or information from any combination and/or all of the participants in the healthcare field, including patients, providers, payers or insurance companies, and/or brokers, agents and/or other intermediaries who act on behalf of any of the above-identified persons or entities.

The apparatus of the present invention includes a central processing computer or central processing computer system which can be a network or server computer. The apparatus also includes a healthcare provider communication device or computer which is associated with a healthcare provider such as a healthcare professional, a hospital, a clinic, and/or any other provider of services described herein. The healthcare provider computer(s) can communicate with, and operate in conjunction with, the central processing computer and/or any of the other computers and/or computer systems or communication devices described herein.

The apparatus can also include a healthcare payer communication device or computer which is associated with a healthcare payer such as a healthcare insurer, insurance company, health maintenance organization, a clinic, and/or any other payer of healthcare services and products described herein. The healthcare payer computer(s) can communicate with, and operate in conjunction with, central processing computer and/or any of the other computers and/or computer systems or communication devices described herein.

The apparatus can also include a user or patient communication device or computer which is associated with an individual, or patient, or a caregiver of the individual or patient, who seeks or who is provided with healthcare and/or related services, products and/or related information. The user or patient communication device(s) can communicate with, and operate in conjunction with, central processing computer and/or any of the other computers and/or computer systems described herein.

The apparatus can also include an intermediary communication device or computer which is associated with an intermediary, a broker, an agent, and/or any other individual and/or entity, or any third party, that can utilize the present invention in order to act for and/or on behalf of any other individual, party, or entity, described herein. The intermediary computer(s) can communicate with, and operate in conjunction with, central processing computer and any of the other computers and/or computer systems described herein.

The apparatus can also include a healthcare records computer which can be or can include a computer or computer system, or any number of computers or computer systems, or a cloud computer system or cloud system. The healthcare records computer can serve to store and house an electronic healthcare record or electronic healthcare files or any number of electronic healthcare records or electronic healthcare files. The healthcare records computer can be associated with any provider, insurer, payer, intermediary, insurance exchange, or any user, individual, patient, organization, or entity, who or which utilizes the present invention.

Each healthcare records computer can be utilized to store an electronic healthcare record or electronic healthcare file or any number of electronic healthcare records or electronic healthcare files which can be accessed by the central processing computer, by any provider communication device, by any insurer or payer communication device, by any user or patient communication device, by any intermediary communication device, or by any other computer, communication device or other device described herein as being utilized in connection with the present invention. The healthcare records computer can also be utilized to facilitate cloud storage of any electronic healthcare record(s) or electronic healthcare file(s).

The apparatus can also include an insurance exchange computer, or any number of insurance exchange computers which can be utilized to process and store information regarding the selling of healthcare insurance, disability insurance, and life insurance, policies, products, and/or services, to any of the herein-described users, individuals, patients, or entities, who or which utilize the apparatus 100 and method of the present invention. The insurance exchange computer can be utilized to advertise, provide information regarding, sell, and/or maintain records regarding, and process any other information regarding, group insurance as well as individual or family insurance policies, products, or services. The insurance exchange computer can also be utilized to sell automobile, homeowners, business, and/or liability insurance policies, products, or services.

The apparatus can also include a social networking computer. The social networking computer can be linked with, and utilized in connection with, the apparatus so as to allow and/or facilitate integrating the apparatus of the present invention with social networks, social networking, and social media. The social networking computer can be associated with a social networking company, a social networking website, or social networking entity, website, group, organization, or association. The social networking computer can also be associated with any one or any number of social networking companies, social networking websites, or social networking entities, websites, groups, organizations, or associations. The social networking computer can also provide links to any computers associated with any one or any number of social networking companies, social networking websites, or social networking entities, websites, groups, organizations, or associations. The social networking computer can perform any and all of the functions performed by any social networking company, a social networking website, or social networking entity, website, group, organization, or association. Any number of social networking computers can be utilized in connection with the present invention.

The apparatus can also include a media computer. The media computer can provide, and be a source of, news information, current events information, healthcare information, healthcare or healthcare-related news, current events, advertisements, and/or marketing information or materials, which can be disseminated via the present invention. Any number of media computers, with each being dedicated to providing any number, types, or kinds of, news information, current events information, healthcare information, healthcare or healthcare-related news, current events, advertisements, and/or marketing information or materials, can be utilized in connection with the present invention.

Each of the central processing computer(s), the provider communications devices, the payer communication devices, the user or patient communication devices, the intermediary communication devices, the healthcare records computers, the insurance exchange computers, the social networking computers, and the media computers can communication in a bi-directional manner with, and/or can send and/or receive signals, messages, reports, notification messages, alerts, or any other communications or electronic communication transmissions, to, from and/or between, any other, or any number of, other central processing computer(s), if utilized, provider communications devices, payer communication devices, user or patient communication devices, intermediary communication devices, healthcare records computers, insurance exchange computers, social networking computers, and/or the media computers.

Each of the central processing computer(s), the provider communications devices, the payer communication devices, the user or patient communication devices, the intermediary communication devices, the healthcare records computers, the insurance exchange computers, the social networking computers, and the media computers can be linked to or with any other central processing computer(s), if utilized, provider communications devices, payer communication devices, user or patient communication devices, intermediary communication devices, healthcare records computers, insurance exchange computers, social networking computers, and/or the media computers via a wired link or line or a wireless link.

Each of the provider communications devices, payer communication devices, user or patient communication devices, intermediary communication devices, healthcare records computers, insurance exchange computers, social networking computers, and/or the media computers can be connected with or linked with the central processing computer.

Any and/or all of the signals, messages, reports, notification messages, or any other communications, described herein as being transmitted from one device, computer, or communication device, to another, can be, or can be included in, or be attached to, an e-mail message, an instant messaging message, an electronic transmission, or an electronic data transmission or electronic data interchange, or can be transmitted via any other data or information transmission, and can be transmitted via or using any appropriate or necessary computer(s) or device(s).

The present invention can be utilized on, and/or over, the Internet and/or the World Wide Web and/or any other communication network, telecommunication network, telephone network, a line-connected network, or a wireless communication network, or any combination of same. The present invention can also utilize wireless Internet and/or World Wide Web services, equipment and/or devices. The central processing computer(s) an/or any of the herein-described computers or communication devices can have a web site or web sites associated with same.

The present invention can be utilized on, or over, the Internet and/or the World Wide Web and/or on, or over, any other communication network or system, including, but not limited to, a communication network or system, a telecommunication network or system, a telephone communication network or system, a cellular communication network or system, a wireless communication network or system, a wireless Internet network or system, a wireless World Wide Web network or system, a line or wired communication network or system, a digital communication network or system, a personal communication network or system, a personal communication services (PCS) network or system, a satellite communication network or system, a broad band communication network or system, a low earth orbiting (LEO) satellite network or system, a public switched telephone network or system, a telephone communication network or system, a radio communication network or system, and/or any other communication network or system, and/or any combination of the above communication networks or systems.

The apparatus and method of the present invention can utilize electronic commerce technologies and security methods, techniques and technologies, in any and/or all of the instances of data and/or information processing, and/or data and/or information transmission described herein.

Each of the central processing computer(s), as well as each of the herein-described computers or communication devices can include a central processing unit or CPU, a random access memory device(s) (RAM), a read only memory device(s), and a user input device. Each of the central processing computer(s), as well as each of the herein-described computers or communication devices can also include a display device, a transmitter(s), a receiver, a database(s), and an output device. The database(s) can contain any and/or all of the data and or information which is needed to perform the various processing methods, services, functions and/or operations, described herein.

The present invention can be utilized in numerous preferred embodiments in order to provide a vast array of healthcare and healthcare-related services for any one or more of the various parties described herein.

The present invention can be utilized to create and maintain a comprehensive and/or a centralized electronic healthcare record system. The present invention can also be utilized to provide for a comprehensive electronic healthcare record, file, or history, for each individual, patient, or caregiver, as well as facilitates access to comprehensive healthcare or healthcare-related data and/or information for or regarding an individual, patient, or caregiver via the central processing computer. An individual's, patient's, or caregiver's, electronic healthcare record, electronic healthcare file or electronic healthcare history, can be contained in any number of electronic healthcare records, electronic medical records, electronic dental records, electronic pharmacy records, and/or electronic behavioral healthcare records, regardless of where each respective record is or may be stored.

A user can access any one or more, or any and/or all of, the electronic healthcare records, electronic medical records, electronic dental records, electronic pharmacy records, and/or electronic behavioral healthcare records, or portion(s) of same which contain data or information for or regarding individual, patient, or caregiver. The present invention can be utilized to provide a comprehensive healthcare record, file, or history, for an individual, patient, or caregiver, by providing any and/or all healthcare or healthcare-related data and/or information, for or regarding an individual, patient, pr caregiver, and/or any and/or all link(s) or hyperlink(s) to any and/or all of the electronic healthcare records, electronic medical records, electronic dental records, electronic pharmacy records, and/or electronic behavioral healthcare records, which contain any and/or all healthcare or healthcare-related data or information for or regarding individual, patient, or caregiver.

The present invention can also be utilized by any individual, patient, caregiver, user, provider, insurer or payer, or third party or intermediary, to create a link or hyperlink to any electronic healthcare record(s), electronic medical record(s), electronic dental record(s), electronic pharmacy record(s), and/or electronic behavioral healthcare record(s), which contain or which are to contain healthcare or healthcare-related data or information for or regarding any individual, patient, or caregiver.

The present invention can also be utilized in order to allow an individual or a patient, or a caregiver, or one responsible for the care of an individual or patient, to enter notes, comments, or messages regarding or relating to the individual or patient into one or more of any of the individual's, patient's, or caregiver's, electronic healthcare record(s), electronic healthcare file(s), electronic medical record(s), electronic dental record(s), electronic pharmacy record(s), and/or electronic behavioral healthcare record(s). Any respective note, comment, or message can be in text form, audio form, or video form, and can contain information regarding a symptom, an illness, an experience, a treatment, a diagnosis, a treatment plan, an activity, a problem, a concern, a thought or an idea, a question, a question for a healthcare provider, or any other information which the individual or patient, or one caring for the individual or patient, may deem important to be recorded or noted in the respective electronic healthcare record(s), electronic medical record(s), electronic dental record(s), electronic pharmacy record(s), and/or electronic behavioral healthcare record(s), or which can be communicated to, or otherwise made available to, a provider or an insurer or payer.

A healthcare provider can access, obtain, and/or use the information provided or contained in the note, comment, or message, or provided or contained in multiple notes, comments, or messages, for any suitable purpose, such as, but not limited to, for preparing for or for use during an examination or an office visit, for use during an examination with the individual or patient or for use during a procedure and an administration of a treatment, for use during a conversation or telephone discussion with the individual, patient, or caregiver, for use during a consultation or discussion with the individual, patient, a family member or caregiver of the individual or patient, or another provider, or a payer or insurer or any third party or intermediary, for use during reviewing, updating, modifying, or performing any other activity in connection with, an individual's or patient's healthcare records, files, or histories, for use while making a diagnosis, for use while formulating a treatment or a treatment plan, for use in reviewing or evaluating an individual's or patient's diagnosis or treatment, for use in treatment planning and/or the evaluating of same, for use in care management, for use in monitoring or evaluating a recovery, for use in providing continuing or on-going care or treatment, for use in connection with the providing of a remote healthcare services or tele-health services, and/or for any other suitable use or purpose.

Any notes, comments or messages, can be provided by the individual, patient, or caregiver, or by any person caring for the individual or patient, while making an appointment, in advance of an office visit or an examination or procedure, in connection with any tele-health related activity, or for the purpose of making and entering a note, comment, or message, into the individual's or patient's respective electronic healthcare record(s), electronic medical record(s), electronic dental record(s), electronic pharmacy record(s), and/or electronic behavioral healthcare record(s). In this regard, the present invention can allow an individual or patient, or a caregiver, or one responsible for caring for the individual or patient, to make and enter any notes, comments, or messages, into the individual's or patient's respective electronic healthcare record(s), electronic medical record(s), electronic dental record(s), electronic pharmacy record(s), and/or electronic behavioral healthcare record(s) so as to facilitate accurate and complete healthcare information record keeping.

Any provider of an individual or patient, any insurer or payer of an individual or patient, any caregiver of an individual or patient, or any other authorized third party, intermediary, person, or entity, can also enter and store any note(s), comment(s), or message(s) in the individual's or patient's electronic healthcare record

Any insurance claim form or the payment request form can be date stamped and/or time stamped. In this manner, claim or payment request processing can be tracked or monitored so as to facilitate audits of the insurer or payer in order to ascertain if the insurer or payer is properly and/or efficiently handling a claim or payment request for the individual or patient, and/or if the insurer or payer is in compliance with any laws, rules, or regulations, governing claims or payment processing and/or handling. Information regarding the date stamped and/or time stamped claims, including the insurer's or the payer's processing or handling of same, and the response or reply to same, can also be stored by the present invention and can be accessed and/or obtained by any authorized user or entity.

The present invention can also generate a co-payment message or a deductible message containing information regarding a co-payment due by the individual or patient to the provider under the individual's or patient's insurance policy or payment program or a deductible which has to be met by the individual or patient under the individual's or patient's insurance policy or payment program.

The present invention can also be utilized in connection with or in conjunction with a personal healthcare record which an individual or patient can maintain for himself, herself, and/or for any children, parents, relatives, friends, or any other individuals whom the individual or patient may be providing care for as a caregiver or a person assisting a caregiver for another. In a preferred embodiment, the personal healthcare record can be stored on one or more user or patient communication devices which can include, but which are not limited to a personal computer, a laptop computer, a tablet, a cellular telephone, a wireless telephone, a television, a digital television, a personal digital assistant (PDA), a smart phone, or any other of the herein-described devices, or other devices, which can be used as a user or patient communication device. The personal healthcare record can be stored in any number of user communication devices.

An individual or patient can utilize the present invention to enter notes, comments, messages, information regarding how they are feeling, information regarding a sickness, an illness, a symptom, information regarding types of medications they must take and time intervals for taking same, information regarding their diet, foods eaten, drinks ingested, exercise activity, provider information, allergies, and/or any other healthcare information, healthcare-related information, wellness information, fitness information, diet information, exercise of fitness information, nutritional information, and/or any other information which can find application in a healthcare or healthcare-related setting or scenario or any other information pertinent to the individual or patient as well as any individual(s) for whom the individual or patient is serving as a caregiver.

An individual or patient can utilize the present invention, at any time and with any suitable user or patient communication device, enter or input, and store in a personal healthcare record, any relevant healthcare information, healthcare-related information, wellness information, fitness information, diet information, exercise of fitness information, nutritional information, and/or any other information which can find application in a healthcare or healthcare-related setting or scenario. The patient communication device can also be programmed to provide timed alerts or messages to remind the individual or patient to take medication, eat certain foods, intake certain liquids, schedule an appointment with a provider, check the status of an insurance claim or a payment claim, to exercise, provide diet or exercise reminders, or to perform any other action or activity for himself or herself or to perform any of the above for a person whom he or she is a caregiver.

The individual or patient can, at any time and from any location, access the present invention and upload or transmit to the central processing computer any and/or all information in his or her personal healthcare record into relevant portions of his or her electronic healthcare record and/or into a portion of same dedicated to receiving and storing the personal healthcare record information. The individual or patient can also download or receive from the central processing computer, any data and/or information that is stored in the individual's or patient's electronic healthcare record(s).

The user or patient communication device can also automatically receive, store or record in the personal healthcare record, and transmit to the central processing computer, and data and/or information which can be obtain with or from a wearable sensor or implantable sensor or device such as a wearable or implantable heart rate monitor, blood pressure monitor, blood sugar monitor, or any other device or monitor which can monitor a physiological parameter(s) or a biometric parameter(s). The user or patient communication device can be linked via a wireless or Bluetooth or other suitable communication link with one or more of these wearable or implantable sensors. Data and/or information obtained from the wearable or implantable sensors can be transmitted to the central processing computer and stored in the individual's or patient's electronic healthcare record(s).

The user or patient communication device and/or the personal health record utilized in connection with same, can be equipped with hardware and/or software for translating any data and/or information from one language into any other language, for translating audio information into text information for storing in the user or patient communication device, for storing audio information, for translating text information into audio information, for providing reminders to schedule appointments with providers, for providing reminders for scheduled appointments with providers, and/or for providing any other functions which are described herein as being performed in connection with the user or patient communication device. The present invention can also be utilized to receive information from an individual or patient regarding a personal healthcare record, store and update an electronic healthcare record with the personal healthcare record information, and thereafter, generate a new personal healthcare record using any new or updated information from the electronic healthcare record(s). The present invention can provide and maintain up-to-date electronic healthcare records and personal healthcare records for individuals or patients.

The user or patient communication device of the present invention can also be utilized to be a personal healthcare monitoring and/or planning tool or device for monitoring and/or planning healthcare and/or healthcare-related activities, events, occurrences, and/or happenings, for the individual or patient, the individual's or patient's children, parents, relatives, or those for whom the individual or patient serves or acts as a caregiver. The user or patient communication device can also be utilized to be a personal wellness, fitness, and/or nutritional monitoring and/or planning tool or device for monitoring and/or planning wellness or wellness-related, fitness or fitness-related, and/or nutritional or nutritional-related, activities, events, occurrences, and/or happenings, for the individual or patient, the individual's or patient's children, parents, relatives, or those for whom the individual or patient serves or acts as a caregiver. The user or patient communication device can also be equipped with any needed or desired software or software application or any number of software applications needed, required, or desired for enabling the user or patient communication device to provide the herein-described features, functions, and/or functionality. The present invention can also be utilized to provide information regarding individual and/or family healthcare planning, and/or monitoring, individual and/or family wellness planning and/or monitoring, individual and/or family fitness planning and/or monitoring, and/or individual and/or family nutritional planning and/or monitoring.

The present invention can also be utilized to schedule appointments with providers and to provider automatically generated appointment reminders.

The present invention can also be utilized to provide social networking functionality and capability via an electronic healthcare record(s) or any. Any of the herein-described individuals, patients, caregivers, providers, insurers, payers, third parties, or other entities, can access a social network via any of the electronic healthcare records described herein. Each and every type or kind of electronic healthcare record utilized in or in connection with the present invention can have information, link(s), or hyperlink(s), to any social networking web sites, web pages, support groups, on-line forums, on-link information services, as well as social networking web sites or social networking web pages to or for social networking members, support groups, information providers, healthcare providers, as well as any of the providers, insurers, payers, individuals, patient, third parties, intermediaries, or any other persons or entities described herein who are or who may be members of any social network.

The present invention can also be utilized to provide an individual or patient with information, or a link(s) or a hyperlink(s) to information, regarding a social networking website or a social networking company, any information provided thereby or thereat, or information regarding any social networking support groups or social networking support group members, on-line seminars, forums, chat room discussions, or others, with which or whom the individual or patient may engage upon the individual or patient being diagnosed with an illness, a sickness, or a condition, or upon the individual or patient about to undergo or undergoing a treatment, a procedure, or an operation, or about to embark upon or already involved in a treatment plan.

The providing of the social networking information to the individual or patient can also serve to allow the individual or patient to learn more about a diagnosis, a treatment, or a treatment plan, to interact with others who have been diagnosed with the same or a similar illness, a sickness, or a condition, or others who may be undergoing the same or a similar treatment or who may be following a same or a similar treatment plan. The present invention can also be utilized so as to identify and provide the individual or patient with information or link(s) or hyperlink(s) to a social networking website, a social networking company, a support group or support groups, a member of the social network members of the social network, social networking lectures, classes, or seminars, social networking sponsored lectures, classes, or seminars, social networking discussions, question and answer sessions, or informational or other forums, or any other social networking or social networking sponsored activities or events, for any number of social networks. The present invention can also be utilized in a same, similar, or analogous manner, in order to process and/or to provide veterinary healthcare information and/or veterinary healthcare-related information for and regarding any kind or type of animal or animals or any type or kind of pet or pets. The present invention can also be utilized as a clearinghouse for facilitating the offering, selling, buying, trading, and/or other commerce and/or transactions, involving healthcare and/or healthcare-related services, products and/or goods.

The apparatus and method of the present invention can be utilized in order to perform a diagnosis of, and/or to prescribe a treatment or a treatment plan for, a sickness, illness and/or other condition. The apparatus and method of the present invention can also be utilized to ensure that a proper treatment and/or procedure is performed on the individual or the patient.

The apparatus and method of the present invention can also be utilized to perform treatment evaluations and/or treatment monitoring. In this manner, the present invention can be utilized by any of the providers, insurers, payers, users, individuals, patients, caregivers, and/or intermediaries, described herein to evaluate and/or to monitor treatments, provide training and/or oversight for healthcare providers and/or professionals, and/or to allow insurers or payers and/or insurance companies to evaluate treatments, treatment plans, treatment progress, and/or any other evaluations and/or verifications for healthcare claims processing. In this regard, the present invention can be utilized so as to safeguard against the use of incorrect and/or unconventional and/or fraudulent treatment and/or care.

The apparatus and method of the present invention can also be utilized to create and maintain a comprehensive electronic healthcare record(s) or database for an individual or patient or for a caregiver of the individual or patient. The present invention can be utilized so as to create and maintain a comprehensive electronic healthcare record or database and/or individual or patient database which can be accessed by any provider, insurer, payer, user, individual, patient, or caregiver of the individual or patient, or any intermediary, and/or other party or user, in order to access the individual's or patient's electronic healthcare record(s). The comprehensive electronic healthcare record or database provides a data and/or information source which can be accessed by any user, individual, patient, caregiver, provider, insurer, payer, or any other authorized person, entity, or intermediary, from anywhere in the world, and at any time, in order to obtain information about an individual or patient for any appropriate reason or purpose.

The present invention can also be utilized in order to find, identify, and/or to locate, providers and/or insurers or payers of, and for, respectively, various healthcare treatments, healthcare services and/or healthcare goods or products and/or healthcare-related goods, products, or services.

The apparatus and method of the present invention can also be utilized to schedule appointments for, with, or by any of the users, individuals, patients, caregivers, providers, insurers or payers, and/or intermediaries, described herein. In this manner, an individual or patient, or a caregiver, can make an appointment with a provider using the apparatus of the present invention and/or over the communication network which services the apparatus 100 of the present invention.

The apparatus of the present invention can also be programmed to automatically identify and locate a provider for the individual or patient upon the generation of a diagnostic report or upon the generation of a treatment report or a treatment plan, and can automatically make an appointment for the individual or patient with the identified or located provider, and can automatically include the appointment information in the respective diagnostic report, treatment report or treatment plan.

The apparatus of the present invention can also be utilized by intermediaries, such as, but not limited to brokers, insurance brokers, agents, and others, in order to service their respective clients. The present invention can provide a platform for allowing a broker, agent, or intermediary, to provide improved services to and for his or her insured clients while also providing for a more paperless working environment or relationship.

The present invention can also be utilized in order to provide notification to any of the individuals, patients, caregivers, providers, insurers or payers, users, and/or intermediaries of and/or upon the occurrence or happening of a pre-specified event. The present invention can also be utilized in order to provide notification, electronically and/or otherwise, to any respective party, regarding any event, happening, and/or occurrence, which is described herein and/or which may be reasonably foreseen from the comprehensive nature of the present invention in providing comprehensive healthcare information processing and/or in facilitating the providing of comprehensive healthcare services. The present invention can also be utilized in order to provide notification to any of the users, individuals, patients, caregivers, providers, insurers or payers, and/or intermediaries.

The apparatus and method of the present invention can also be utilized to facilitate healthcare claims processing. Any of the individuals, patients, caregivers, providers, insurers or payers, and/or intermediaries or third parties, or any other users, can file claims with the respective insurer, payer, or party, electronically via the apparatus of the present invention. The apparatus of the present invention can facilitate an expedited and/or a paperless claim process or request for payment process. The apparatus of the present invention can also provide for, or facilitate, automatic claim submission or request for payment submission to an insurer or payer.

The apparatus of the present invention can also be utilized in order to claim or request healthcare insurance benefits, disability insurance benefits, and/or life insurance benefits. The apparatus can also administer and/or maintain financial accounts for, and/or on behalf of, any of the individuals, patients, caregivers, users, providers, insures or payers, and/or intermediaries or third parties, described herein.

The apparatus of the present invention can also be utilized as a healthcare training simulator for any of the providers, healthcare providers, healthcare professionals, and/or other providers described herein. The present invention can also be utilized by any other user and/or individual, patient, or caregiver, or any other person, wishing to learn about a certain healthcare field or topic. The present invention can be utilized to provide formal training, supplemental training, informal training, continuing education training, and/or any other training

The present invention can, in addition, be utilized in order to maintain individual, patient, or caregiver, electronic healthcare records or electronic healthcare files private and/or to safeguard individual, patient, or caregiver, electronic healthcare records or electronic healthcare files, by restricting and/or by limiting access to the respective electronic healthcare records or electronic healthcare files.

The present invention can also provide notification or a notification message or an alert message to an individual, patient, or caregiver, when any individual, patient, caregiver, provider, insurer or payer, and/or intermediary, or any other individual, user, or entity, is attempting to access, has accessed, has obtained access to individual's, patient's, or caregiver's, electronic healthcare record(s) or electronic healthcare file(s) or any data and/or information contained therein, and/or has made, has attempted to make, or is in the process of making, a modification, a change, an alteration, and/or an update or an updating, to their respective electronic healthcare records or electronic healthcare files. The present invention can also provide notification to providers or to healthcare providers, including but not limited to, the individual's, the patient's, or the caregiver's, provider or providers, insurer, insurers, payer, payers, or healthcare payers or insurance providers, including, but not limited to, the individual's, the patient's, or the caregiver's, insurer or payer, or healthcare payer(s) or insurance provider(s), when another individual, patient, caregiver, provider, insurer or payer, and/or intermediary, or any other individual, user, or entity, has attempted to access or obtain, or has accessed or obtained, and/or has attempted to, is attempting to, or is in the process of making, a modification, a change, an alteration, and/or an update or an updating, to their respective electronic healthcare records or electronic healthcare files.

The present invention can also provide notification to an individual, patient, or caregiver, when his or her electronic healthcare record(s) or electronic healthcare file(s), or any portion thereof, has been accessed, obtained, modified, changed, altered, and/or updated, and/or when a request has been made to access, obtain, modify, change, alter, and/or update, his or her electronic healthcare record(s) or electronic healthcare file(s), or any portion thereof.

The present invention can also be utilized in order to allow individual, patients, or their caregivers, to restrict and/or limit access to their electronic healthcare records or electronic healthcare files. The individual, patient, or caregiver, can also limit or restrict an individual's, a user's, a provider's, an insurer's or payer's, an intermediary's or third party's, the ability to access, ability to obtain, ability to change, ability to alter, ability or modify, and/or ability to update, any data and/or information contained in his or her electronic healthcare record(s) or electronic healthcare file(s).

The present invention can also be utilized to issue prescriptions or scripts for medicines, medications, or drugs, to pharmacies on an individual's or a patient's behalf, or to issue prescriptions or scripts for procedures, tests, analyses, analysis work-ups, blood work, treatments, therapy, therapy sessions, physical therapy, physical therapy sessions, or any other prescribed goods, services, or activities, or to issue referrals to other healthcare providers or providers of any other goods or services. The apparatus of the present invention can also be utilized to perform drug-drug and drug-allergy interaction checks.

The apparatus and method of the present invention can also be used to provide for the remote control and/or monitoring of any of the herein-described healthcare devices, healthcare equipment, healthcare testing devices or equipment, healthcare information gathering devices or equipment, or healthcare monitoring devices or equipment. The apparatus and method of the present invention can also be utilized in order to perform a remote procedure on an individual or patient, a remote surgery or surgical procedure on an individual or patient, or to remotely administer a treatment to an individual or patient.

The present invention can also be used to provide information regarding audits or other information regarding any of the providers and/or insurers or payers described herein. The present invention can also be utilized to monitor and/or provider any information regarding any of the providers, or insurers or payers described herein.

The present invention can also be utilized to identify or select individuals or patients for clinical trials, experimental procedures, experimental treatments, healthcare focus groups, discussion groups, support groups, healthcare surveys, or for any other activities or events which involve one or more individuals or patients. Any results of, for, or regarding, the individual's or patient's participation in the respective clinical trial, experimental procedure, experimental treatment, healthcare focus group, discussion group, support group, healthcare survey, or other activity or event, can be stored in the individual's or patient's electronic healthcare record, electronic healthcare file, or electronic healthcare history, as well as in any record or file, electronic or otherwise, regarding the respective clinical trial, experimental procedure, experimental treatment, healthcare focus group, discussion group, support group, healthcare survey, or other activity or event.

The present invention can also be used to test new medications, medicines, drugs, pharmaceutical products, pharmaceutical services, healthcare devices, goods, products, or services, new or experimental treatments or procedures, treatment plans, or care management plans, and/or can be used to obtain survey information or focus group information from the identified or selected individuals and/or patients.

The present invention can also be used to identify or select, and/or to generate a list of individuals or patients with or having a specific condition(s), which list of individuals or patients can be used for research, quality improvement, outreach, reduction of disparities, care management, treatment planning, infection disease control, or any other healthcare-related activity.

The apparatus of the present invention can also be used to determine or to measure, and/or to provide information regarding, the effectiveness of, or side effects experienced or associated with, any medications, medicines, drugs, dietary supplements, supplements, vitamins, over-the-counter products or substances, or to measure the effectiveness of, or the side effects experienced or associated with, any procedures, treatments, treatment plans, care management plans, or any other goods, products, or services which can be offered in the marketplace. The present invention can also be used to provide information regarding health conditions, healthcare conditions, illnesses, diagnoses, symptoms, treatments, treatment plans, care management practices, care management plans, insurance information, information regarding type of insurance, wellness information, healthcare practices, healthcare history patterns, healthcare history patterns, healthcare trends, treatment trends, statistics, statistical analyses, studies, study trends, or any other pertinent healthcare or healthcare-related information, regarding any number or type of groups of individuals or patients.

The apparatus of the present invention can also be programmed to automatically provide or transmit any of the information described herein as being provided by the present invention to any of the herein-described individuals, patients, caregivers, healthcare providers, providers, insurers or payers, third parties, or intermediaries, or any other persons or entities.

The present invention can also be used in order to determine whether or not any respective medication, medicine, or drug, or treatment, being considered could result in any adverse drug interaction(s), adverse reaction(s), or have any other adverse effect, with any other medication, medicine, or drug, or treatment, the individual or patient may currently be taking, may be undergoing, or may have undergone. The present invention can also be used to perform drug formulary checks for or regarding any medication, medicine, or drug, being considered for an individual or patient so as to ensure that same is appropriate for the individual or patient, so as to ensure safety in treatment, or so as to ensure effectiveness in treatment, or for any other appropriate reason. The present invention can also be used to

perform processing routines to effectuate medication, medicine, or drug, reconciliation at any time in or during a treatment, care, or care management, of or for an individual or patient. These medication, medicine, or drug, reconciliation processing routines can be performed continuously during a treatment, a treatment course, a treatment regimen, a treatment duration, or in or during a care setting for an individual or patient, as well as in between treatment or care settings for the individual or patient.

The present invention can also be utilized to submit or transmit electronic immunization data or information to an immunization center or immunization registry, a healthcare provider, a healthcare facility, a hospital, a research center facility, a payer or an insurer, an intermediary, a person, an individual, or an entity, or any immunization information system.

The present invention can also be used to receive and/or process a request, by any healthcare provider, any other provider, an individual, patient, or caregiver, an insurer or a payer, a secondary insurer or a secondary payer, a tertiary or other insurer or payer, or any authorized third party or intermediary, to provide co-payment information and/or deductible information regarding an insurance policy, a healthcare insurance policy, a disability insurance policy, or a life insurance policy, of or for any individual, patient, or caregiver, described herein, or to provide co-payment information and/or deductible information regarding any healthcare insurer or payer or any healthcare insurance policy, payment policy, or plan.

The apparatus of the present invention can also be utilized to provide employee benefits information, to allow an individual, a patient, a caregiver, a beneficiary, or any other person or third party, to enroll in an employee benefit or in employee benefits, to submit a claim or claims or to make a request for, or pursuant to, an employee benefit or an insurance policy or payment policy or plan, to take or retain an employee benefit from one employment relationship, job, or position, to another employment relationship, job, or position, or to maintain an employee benefit after leaving an employment relationship, job, or position, or retiring from an employment relationship, job, or position, thereby providing benefits portability, or to post information regarding a need, a requirement, or a desire, for or to obtain, or enroll in, an employee benefit or policy. The present invention can also be utilized to allow a benefit provider, a benefits provider, or an insurance provider, to provide information to individuals, patients, caregivers, beneficiaries, or any other persons or third parties, of an availability or an offering of a benefit, a policy, an insurance policy, or other policy, plan, or program, being offered by the benefit provider.

The apparatus of the present invention can also be utilized in order to provide a user, individual, patient, or caregiver, or any other authorized person, with information regarding any employee benefit(s) or employee benefit(s) insurance policies or plans which the user, individual, patient, or caregiver, or other authorized person, may have or be covered under as a beneficiary. The present invention can also provide information, links, or hyperlinks, regarding, or providing a link to, any employee benefit(s), healthcare insurance policy or policies, disability insurance policy or policies, life insurance policy or policies, healthcare payment plan or plans, individual retirement account(s) (IRA(s)), self-employed pension (SEP) account(s), bank account(s), savings account(s), financial account(s), or a vacation time benefit, a personal time benefit, a sick time benefit, a healthcare insurance benefit, a disability insurance benefit, a life insurance benefit, an employee discount benefit, a buying service benefit, a tuition reimbursement benefit, an educational assistance benefit, an in-house training benefit, a child care benefit, a day care program benefit, a stock option benefit, a pension benefit, a retirement benefit, a credit union benefit, an employee stock ownership benefit, a profit sharing benefit, an educational assistance program benefit, a child care program benefit, or any other employee benefit which can be offered to an employee by a respective employer, or any other employee benefit or employee benefits described herein.

Information, links, or hyperlinks, regarding, or providing a link or hyperlink to, any employee benefit or employee benefits, healthcare insurance policy or policies, disability insurance policy or policies, life insurance policy or policies, healthcare payment plan or plans, individual retirement account(s) ((IRA(s)), self-employed pension (SEP) account(s), bank account(s), savings account(s), financial account(s), or any other employee benefit or employee benefits described herein, or any employer(s) or benefits provider(s), can also be provided by the present invention and/or can be included in the electronic healthcare record or electronic healthcare file of each individual, patient, or caregiver.

The present invention can also provide any and/or all the herein-described functionality to employees, independent contractors, temporary workers, freelancers, or any other individuals or users who are provided with, or who maintain for themselves, any employee benefits or any benefits that can or may be offered as an employee benefit.

The present invention can be utilized by an individual, a patient, or a caregiver, having a electronic healthcare record or a electronic healthcare file, to access or obtain information regarding an employee benefit via the apparatus of the present invention, via an insurance exchange computer, and/or via, or using, information, a link, or a hyperlink, contained in or stored in the individual's or the patient's electronic healthcare record or electronic healthcare file.

The apparatus of the present invention can also be utilized by an individual, a patient, or a caregiver, having an electronic healthcare record or an electronic healthcare file, to submit or to file a claim for, or a request for, or pursuant to, an employee benefit.

The apparatus can also record and/or store, in the individual's, the patient's, or the caregiver's, electronic healthcare record or electronic healthcare file, or in the database apparatus, any information regarding the individual's or the patient's claim or request, and/or the submission, transmission, or filing, of same, for, or pursuant to, the employee benefit, the completed form(s), claims form(s), request form(s), or any other needed or required information, or any information, which was submitted pertaining to the claim or the request, a response to the claim or the request, the message, or any information contained in the message. The information regarding the individual's, the patient's, or the caregiver's, claim or request, and/or the submission, transmission, or filing, of same, for, or pursuant to, the employee benefit, the completed form(s), claims form(s), request form(s), or any other needed or required information, or any information, which was submitted pertaining to the claim or the request, a response to the claim or the request, the message, or any information contained in the message, can be transmitted to a computer or communication device associated with or used by any respective individual, patient, caregiver, provider, insurer or payer, or intermediary or third party described herein.

The present invention can also be utilized as, and/or as a platform for, an insurance exchange in order to provide a venue by which to allow insurers or payers to sell healthcare insurance, disability insurance, life insurance, automobile insurance, homeowner's insurance, property or casualty insurance, or any other insurance policy, payer policy, payer program, or payer plan.

The apparatus can be used in order to allow insurers or payers to sell healthcare insurance, disability insurance, life insurance, automobile insurance, homeowner's insurance, property or casualty insurance, or any other insurance policy, payer policy, payer program, or payer plan, or can be used by any provider of any type or kind of good, product, or service, to sell its respective goods, products, or services, via the apparatus of the present invention. The present invention can allow any number of insurers or payers, or benefits providers, to offer their healthcare insurance policies, plans, products, services, or programs, for sale via the apparatus of the present invention in order to create a healthcare insurance exchange or an insurance exchange for selling insurance policies, plans, products, services, or programs of any kind or type.

The present invention an also be utilized in order to allow an individual, a patient, or a caregiver, to purchase and/or enroll in a supplemental healthcare insurance policy, plan, product, service, or program, or to purchase an upgrade to or for a current healthcare insurance policy, plan, product, service, or program. The present invention can also be utilized in a same, a similar, or an analogous, manner in order to allow an individual, a patient, or a caregiver, to purchase and/or enroll in a supplemental healthcare insurance policy, plan, product, service, or program, or to purchase an upgrade to or for a current disability insurance policy, plan, product, service, or program, a life insurance policy, plan, product, service, or program, an automobile insurance policy, plan, product, service, or program, a homeowner's insurance policy, plan, product, service, or program, a property or casualty insurance policy, plan, product, service, or program, or any other insurance policy, plan, product, service, or program, payer policy, plan, product, service, or program, any payer program, or any payer plan. Any and/or all information regarding any such insurance purchases and/or enrollments made or effectuated can be stored in the individual's, the patient's, or the caregiver's, electronic healthcare record.

The present invention can also be utilized in order to allow an individual or a patient, or a caregiver for the individual or the patient, to post a request for an insurance policy, his or her requirement(s) for an insurance policy, or his or her need for an insurance policy. The insurance policy can be a policy for healthcare insurance, disability insurance, life insurance, automobile insurance, homeowner's insurance, property or casualty insurance, or any other insurance policy, payer policy, payer program, or payer plan. The present invention can provide information regarding the individual's or the patient's posting of the request for an insurance policy, information contained in the request, or the requirement for an insurance policy, or the need for an insurance policy, to any number of insurers or payers, or to any number of brokers of insurance. Thereafter, any insurer or payer, or any broker, can offer the individual, the patient, or the caregiver, an insurance policy fitting or matching the individual's, the patient's, or the caregiver's, request, request criteria, requirements, or needs, via the apparatus of the present invention.

The present invention can also be utilized in order to allow an insurer, a payer, a healthcare provider, or a provider of any goods, products, or services, to offer, and/or to transmit messages offering, their respective insurance policies, payment policies, payment plans, payment programs, benefits, benefits packages, or any other goods, products, or services, to any number of the herein-described individuals, patients, or caregivers for any individuals or patients, who utilize the present invention. Any of the insurance policies offered via this embodiment can be a policy for healthcare insurance, disability insurance, life insurance, automobile insurance, homeowner's insurance, property or casualty insurance, or any other insurance policy, payer policy, payer program, or payer plan. The present invention can also be utilized in a same, a similar, or an analogous, manner in order to allow an insurer, payer, or any provider of any goods, products, services, or subscriptions, to sell, or to offer to sell, disability insurance, life insurance, automobile insurance, homeowner's insurance, property or casualty insurance, or any other insurance policy, payer policy, payer program, or payer plan, or can be utilized in connection with selling any good, product, or service, or any subscription, which can be the subject of commerce.

The present invention can also be utilized in order to provide for, or facilitate, the selling or the purchasing of any type or kind of healthcare insurance policy, disability insurance policy, life insurance policy, automobile insurance policy, homeowner's insurance policy, property or casualty insurance policy, or any other insurance or insurance policies described or noted herein, payer policy, payer program, or payer plan, and can provide for allowing any individual, patient, caregiver, employer, third party, or intermediary, to pay for same, with any and/or all information regarding the respective healthcare insurance policy, disability insurance policy, life insurance policy, automobile insurance policy, homeowner's insurance policy, property or casualty insurance policy, or any other insurance or insurance policies, or any other insurance policy, payer policy, payer program, or payer plan, being stored in or by the apparatus of the present invention or any computer or communication device described herein.

The apparatus of the present invention can provide for the portability of benefits, such as the portability of healthcare insurance, disability insurance, life insurance, or their respective policies, plans, or programs, or any other related or unrelated insurance policy, payer policy, payer program, or payer plan, from one job to another job, from one employment relationship to another employment relationship, from a period of employment to or during a period of unemployment, from or during a period of unemployment to a period of employment, from a period of employment to or during a period of self-employment, or from a period of employment to, through, or during, a period of retirement, or from or between, or during, any employment or unemployment period or status of an individual, a patient, or a caregiver.

The apparatus of the present invention can also be utilized in order to provide healthcare information, healthcare-related information, wellness information, wellness-related information, and/or any of the herein-described information or functionality, for or regarding animals of any type or kind, pets, dogs, cats, domestic animals, zoo animals, theme park animals, circus animals, animals used in entertainment shows or water shows, or any other animals for which an owner, keeper, or caretaker, desires to store or maintain an electronic healthcare record, an electronic healthcare file, or a healthcare history, or for which an owner, keeper, or caretaker, desires to utilize any of the functionality described herein as being provided by the apparatus of the present invention.

The present invention can also process any of the data or information described herein as being recorded or stored, processed by, or generated by, the apparatus of the present invention, so as to obtain information for or regarding the meaningful use of electronic healthcare records, electronic medical records, electronic dental records, or electronic behavioral healthcare records.

Intelligent agents, software agents, mobile agents, and/or related technologies, can be utilized in conjunction with the present invention. The respective intelligent agent(s), software agent(s), mobile agent(s), (hereinafter referred to collectively as “intelligent agent” or “intelligent agents”) can be programmed and/or designed to act on behalf of the respective users, individuals, patients, caregivers, providers, insurers or payers, and/or intermediaries, so as to act on behalf of the respective party as well as to perform any of processing functions and/or other functions described herein.

In another preferred embodiment, the intelligent agent can act on behalf of the respective person or party in various related interactions and/or other activities which are described as being performed herein and/or which may be incidental and/or related thereto. Therefore, the present invention also provides an agent-based apparatus and method for providing healthcare information and/or healthcare-related information.

The apparatus of the present invention, in any and/or all of the embodiments described herein, can also be programmed to be self-activating and/or activated automatically.

The present invention provides an apparatus and a method for providing comprehensive information in the healthcare fields and/or healthcare-related fields. The present invention also provides valuable services to the various parties who seek, provide, pay for, administer, and/or monitor healthcare services, goods and/or products as well as a healthcare-related services, goods, and/or products.

The present invention can also provide comprehensive and accurate information to any of the users, individuals, patients, caregivers, providers, insurers or payers, and/or intermediaries, or other parties described herein so as to facilitate an improved healthcare system which can provide up-to-date individual, patient, caregiver, provider, insurer or payer, and/or intermediary, information. The apparatus of the present invention, by facilitating the creation and maintenance of a comprehensive database of information, which can be accessed on a global basis, at any time of day or night, and from any location, can provide users, individuals, patients, caregivers, providers, insurers or payers, and/or intermediaries, with information which can improve healthcare treatments, reduce the likelihood of errors in diagnoses and/or prescribed treatments, reduce healthcare costs, reduce the likelihood of incorrect and/or fraudulent care, and can provide for a healthcare system which is characterized by an improved quality of care, care management, and cost efficiency.

The present invention can also process transactions regarding or involving the purchase and/or sale of goods, products, services, healthcare insurance policies, life insurance policies, disability insurance policies, group healthcare insurance policies, group life insurance policies, group disability insurance policies, healthcare, life, or disability, insurance products and/or services, healthcare goods, products, or services, provider offered goods, products, or services, health and/or wellness goods, products, or services, exercise goods, products, or services, drugs, medications, or any other good(s), product(s), or service(s), which may be of interest to any of the of the herein-described users, individuals, patients, caregivers, providers, insurers or payers, insurance companies, healthcare insurance companies, healthcare maintenance organizations, or any other healthcare-related entities, employer employers, third parties, or third party intermediaries, who or which utilize the present invention. In this regard, the apparatus of the present invention can also be utilized as a venue, site, or portal, for conducting electronic commerce, or web-based or Internet-based commerce, or cable television-based, or telecommunication networked-based commerce, with or in any of the various goods, products, or services, which can or may be offered for sale via the apparatus 100 of the present invention.

Any of the diagnostic reports, treatment reports, treatment plans, evaluations reports, provider reports, insurer reports or payer reports, messages, alert messages, notification messages, etc., described herein as being generated by the apparatus of the present invention can contain and/or include a link(s) or a hyperlink(s) to, or a link(s) or a hyperlink(s) to data and/or information stored in, the individual's, the patient's, or the caregiver's, electronic healthcare record or electronic healthcare file.

Further, any of the diagnostic reports, treatment reports, treatment plans, evaluations reports, provider reports, insurer reports or payer reports, messages, alert messages, notification messages, etc., described herein as being generated by the apparatus of the present invention can contain and/or include information regarding any notes, comments, or messages, entered into the electronic healthcare record by the individual, the patient, or a caregiver, or can contain a link(s) or a hyperlink(s) to any notes, comments, or messages entered into the electronic healthcare record by the individual, the patient, or a caregiver.

Any and/or all of the any electronic healthcare records, electronic medical records, electronic dental records, electronic pharmacy records, electronic behavioral health records, utilized in connection with the present invention can contain a link(s) or a hyperlink(s) to any of the herein-described computers or communication devices, including, but not limited to, the healthcare records computers, insurance exchange computers, social networking computers, and/or the media computers. Further, any user, individual, patient, or caregiver, can use his or her user or patient communication device to access any healthcare records computers, insurance exchange computers, social networking computers, and/or media computers, via his or her electronic healthcare record(s), electronic medical record(s), electronic dental record(s), electronic pharmacy record(s), or electronic behavioral health record(s) for any reason and/or purpose.

In any and/or all of the embodiments described herein, the apparatus of the present invention can also be utilized in a same, similar, or analogous manner, in order to process and/or to provide veterinary healthcare information and/or veterinary healthcare-related information for and regarding any kind or type of animal or animals or any type or kind of pet or pets. In this regard, it is to be understood that the present invention can be utilized by any user, individual, caregiver, provider, insurer or payer, or intermediary, in order to process healthcare or healthcare-related information for any animals and/or pets.

The present invention can also provide for cloud-based healthcare or healthcare-related data and/or information processing and/or storage, cloud-based electronic healthcare records, cloud-based electronic healthcare records storage and/or retrieval, a cloud-based electronic healthcare records system or platform, and/or cloud based processing and/or storage of any and/or all of the data and/or information described herein as being processed by the apparatus 100 and methods of the present invention.

### BRIEF DESCRIPTION OF THE DRAWINGS

In the Drawings:

FIG. 1 illustrates a preferred embodiment of the apparatus of the present invention, in block diagram form;

FIG. 2 illustrates the central processing computer of FIG. 1, in block diagram form;

FIG. 3 illustrates the provider communication device of FIG. 1, in block diagram form;

FIG. 4 illustrates the insurer or payer communication device of FIG. 1, in block diagram form;

FIG. 5 illustrates the user or patient communication device of FIG. 1, in block diagram form;

FIG. 6 illustrates the intermediary communication device of FIG. 1, in block diagram form;

FIG. 7 illustrates an exemplary healthcare records cloud system computer of FIG. 1, in block diagram form;

FIG. 8 illustrates the an exemplary insurance exchange computer of FIG. 1, in block diagram form;

FIG. 9 illustrates an exemplary social networking computer of FIG. 1, in block diagram form;

FIG. 10 illustrates an exemplary media computer of FIG. 1, in block diagram form;

FIG. 11 illustrates a preferred embodiment method of utilizing the apparatus of the present invention, in flow diagram form;

FIGS. 12A and 12B illustrate another preferred embodiment method of utilizing the apparatus of the present invention, in flow diagram form;

FIG. 13 illustrates yet another preferred embodiment method of utilizing the apparatus of the present invention, in flow diagram form;

FIG. 14 illustrates still another preferred embodiment method of utilizing the apparatus of the present invention, in flow diagram form;

FIG. 15 illustrates another preferred embodiment method of using the apparatus of the present invention, in flow diagram form.

FIGS. 16A and 16B illustrate another preferred embodiment method for utilizing the apparatus of the present invention, in flow diagram form.

FIGS. 17A and 17B illustrate yet another preferred embodiment method for utilizing the apparatus of the present invention, in flow diagram form.

FIGS. 18A and 18B illustrate another preferred embodiment method for utilizing the apparatus of the present invention, in flow diagram form;

FIG. 19 illustrates another preferred embodiment method of utilizing the apparatus of the present invention, in flow diagram form,

FIGS. 20A and 20B illustrate another preferred embodiment method for utilizing the apparatus of the present invention, in flow diagram form;

FIGS. 21A and 21B illustrate still another preferred embodiment method of utilizing the apparatus of the present invention, in flow diagram form;

FIGS. 22A, 22B and 22C illustrate another preferred embodiment method of utilizing the apparatus 100 of the present invention, in flow diagram form;

FIGS. 23A and 23B illustrate still another preferred embodiment method of utilizing the apparatus 100 of the present invention, in flow diagram form;

FIGS. 24A and 24B illustrate another preferred embodiment method for utilizing the apparatus 100 of the present invention, in flow diagram form;

FIGS. 25A and 25B illustrate another preferred embodiment method for utilizing the apparatus 100 of the present invention, in flow diagram form;

FIGS. 26A and 26B illustrate another preferred embodiment method of utilizing the apparatus 100 of the present invention, in flow diagram form;

FIG. 27 illustrates still another preferred embodiment method of utilizing the apparatus of the present invention, in flow diagram form;

FIG. 28 illustrates another preferred embodiment method of using the apparatus of the present invention, in flow diagram form;

FIG. 29 illustrates still another preferred embodiment method of utilizing the apparatus of the present invention, in flow diagram form;

FIG. 30 illustrates yet another preferred embodiment method of using the apparatus of the present invention, in flow diagram form;

FIG. 31 illustrates another preferred embodiment method of utilizing the apparatus of the present invention, in flow diagram form;

FIG. 32 illustrates another preferred embodiment method of using the apparatus of the present invention, in flow diagram form;

FIG. 33 illustrates still another preferred embodiment method of utilizing the apparatus of the present invention, in flow diagram form;

FIG. 34 illustrates yet another preferred embodiment method of using the apparatus of the present invention, in flow diagram form;

FIG. 35 illustrates still another preferred embodiment method of utilizing the apparatus of the present invention, in flow diagram form;

FIG. 36 illustrates another preferred embodiment method of using the apparatus of the present invention, in flow diagram form;

FIG. 37 illustrates still another preferred embodiment method of utilizing the apparatus of the present invention, in flow diagram form; and

FIG. 38 illustrates another preferred embodiment method of using the apparatus of the present invention, in flow diagram form.

### DESCRIPTION OF THE PREFERRED EMBODIMENTS

The present invention is directed to an apparatus and a method for processing and/or for providing healthcare information and/or healthcare-related information with or using an electronic healthcare record or electronic healthcare records, and, in particular, to an apparatus and a method for processing and/or for providing healthcare information and/or healthcare-related information with or utilizing an electronic healthcare record or electronic healthcare records and data and/or information contained therein for any number or variety of applications and/or in order to provide an improved and comprehensive electronic healthcare record and healthcare records keeping apparatus and method which can provide enhanced functionality and a variety of functions, features and applications all of which can provide for enhancements and improvements in healthcare.

Applicant hereby incorporates by reference herein the subject matter and teachings of U.S. Provisional Patent Application Ser. No. 61/797,537, filed Dec. 8, 2012, and entitled “APPARATUS AND METHOD FOR PROCESSING AND/OR PROVIDING HEALTHCARE INFORMATION AND/OR HEALTHCARE-RELATED INFORMATION WITH OR USING AN ELECTRONIC HEALTHCARE RECORD OR ELECTRONIC HEALTHCARE RECORDS”, the subject matter and teachings of which are hereby incorporated by reference herein in their entirety. Applicant also incorporates by reference herein the subject matter and teachings of U.S. Provisional Patent Application Ser. No. 61/797,147, filed Nov. 30, 2012, and entitled “APPARATUS AND METHOD FOR PROCESSING AND/OR PROVIDING HEALTHCARE INFORMATION AND/OR HEALTHCARE-RELATED INFORMATION WITH OR USING AN ELECTRONIC HEALTHCARE RECORD OR ELECTRONIC HEALTHCARE RECORDS”, the subject matter and teachings of which are hereby incorporated by reference herein in their entirety. Applicant also incorporates by reference herein the subject matter and teachings of U.S. patent application Ser. No. 14/011,399, filed Aug. 27, 2013, and entitled “APPARATUS AND METHOD FOR PROCESSING AND/OR PROVIDING HEALTHCARE INFORMATION AND/OR HEALTHCARE-RELATED INFORMATION WITH OR USING AN ELECTRONIC HEALTHCARE RECORD OR ELECTRONIC HEALTHCARE RECORDS”, the subject matter and teachings of which are hereby incorporated by reference herein in their entirety. Applicant also incorporates by reference herein the subject matter and teachings of U.S. Provisional Patent Application Ser. No. 61/743,522, filed Sep. 6, 2012, and entitled “APPARATUS AND METHOD FOR PROCESSING AND/OR PROVIDING HEALTHCARE INFORMATION AND/OR HEALTHCARE-RELATED INFORMATION WITH OR USING AN ELECTRONIC HEALTHCARE RECORD OR ELECTRONIC HEALTHCARE RECORDS”, the subject matter and teachings of which are hereby incorporated by reference herein in their entirety.

Applicant hereby incorporates by reference herein the subject matter and teachings of U.S. Provisional Patent Application Ser. No. 61/743,522, filed Sep. 6, 2012, and entitled “APPARATUS AND METHOD FOR PROCESSING AND/OR PROVIDING HEALTHCARE INFORMATION AND/OR HEALTHCARE-RELATED INFORMATION WITH OR USING AN ELECTRONIC HEALTHCARE RECORD OR ELECTRONIC HEALTHCARE RECORDS”. The subject matter and teachings of U.S. Provisional Patent Application Ser. No. 61/743,522, filed Sep. 6, 2012, and entitled “APPARATUS AND METHOD FOR PROCESSING AND/OR PROVIDING HEALTHCARE INFORMATION AND/OR HEALTHCARE-RELATED INFORMATION WITH OR USING AN ELECTRONIC HEALTHCARE RECORD OR ELECTRONIC HEALTHCARE RECORDS” are also incorporated by reference herein as if to be fully restated and included herein.

As used herein, the term “electronic healthcare record” or “EHR” means any electronic healthcare record, electronic healthcare file, electronic medical record, electronic dental record, electronic pharmacy record, electronic behavioral health record, and/or any other record or record keeping system, software, hardware, or device, or any combination of same or group of same, which can contain healthcare information or healthcare-related information.

The apparatus and method of the present invention facilitates the creation and management of a comprehensive electronic healthcare record system and a healthcare processing system which can manage patient and client records, doctor and other provider records, healthcare insurance and/or payer records, and thereby provide an apparatus, system, and methods for providing a variety and a multitude of healthcare information processing applications, processes and services.

The apparatus and method of the present invention also provides for the integration of healthcare information and healthcare-related information which can be stored in or obtained from and among any number of different and separate electronic healthcare records and electronic healthcare records systems, which can be provided by any number of vendors or suppliers, and can facilitate a comprehensive electronic healthcare record or electronic healthcare record system.

The apparatus and method of the present invention can also provide for the integration of insurance exchanges and/or employee benefits exchanges and/or the respective computers or computer systems associated therewith with a healthcare information system, a healthcare-related information system, and/or an electronic healthcare record or electronic healthcare records.

The apparatus and method of the present invention can also provide for the integration of social networking computers and social networking web sites and their information and functionality with a healthcare information system, a healthcare-related information system, and/or an electronic healthcare record or electronic healthcare records.

The apparatus and method of the present invention can also provide for the integration of news, information, advertisements, and marketing information and/or materials, with or in connection with a healthcare information system, a healthcare-related information system, and/or an electronic medical record or electronic medical records.

The present invention facilitates improved healthcare quality, efficient information collection, processing and dissemination, efficient diagnosis and treatment, cost efficiency, cost containment, automated billing, notification and alert messaging, as well as many other benefits and advantages as will be described herein.

The apparatus and method of the present invention also facilitates the distribution and management of healthcare insurance, life insurance, disability insurance, as well as claims processing related thereto.

The present invention also provides an apparatus and a method for providing a comprehensive processing system which incorporates data and/or information from any combination and/or all of the participants in the healthcare field including, but not limited to, patients and those seeking healthcare, healthcare providers, doctors, including medical doctors, surgeons, physicians, dentists, orthodontists, periodontists, endodontists, oral surgeons, osteopaths, psychologists, optometrists, podiatrists, osteopaths, chiropractors, pharmacists, therapists, physical therapists, respiratory therapists, nurses, healthcare aids, nurse practitioner, physician's assistant, nutritionists, and/or any other person, individual, and/or professional who can provide healthcare, healthcare-related, wellness and/or wellness-related services and/or products, insurance companies, healthcare insurance companies, disability insurance companies, property or casualty insurance companies, health maintenance organizations, healthcare providers, and any other payer and/or provider of healthcare services and/or products, healthcare claims processing centers, healthcare insurance brokers and/or agents, and/or any other third party and/or intermediary who or which acts on behalf of another and/or assists in to providing of healthcare and/or related services.

The apparatus and method of the present invention can also be utilized in order to maintain patient healthcare records or files private, to safeguard patient healthcare records or files, to provide notification to patients and other individuals when others have accessed, obtained, and/or made changes to their respective healthcare records or files, and/or to enable patients and individuals to restrict and/or limit access to their healthcare records or files.

As used herein, the terms “individual”, “patient”, “client”, “user” or the like, or their plural forms, refers to any person, individual, patient, entity, and/or client, who or which uses the present invention, and/or who seeks and/or who receives healthcare services, healthcare-related services, healthcare-related information, and/or any of the other services and/or products provided by the present invention. The terms “individual”, “patient”, “client”, “user” or the like, or their plural forms, also refer to any athlete or participant of or in any sport or sports or any activity or activities, an athlete or a sports participant of any age, a professional athlete, a minor league athlete, an Olympic athlete, a competitive athlete, a government team athlete, a world class competition athlete, an amateur athlete, a college athlete, a high school age athlete, a child athlete, a secondary school athlete, a recreational organization athlete or member, a child recreational organization athlete or member, an adult recreational organization athlete or member, a little league athlete or member, a boys club athlete or member, a girls club athlete or member, a hobbyist athlete, or any other individual, male or female, who participate in athletic endeavors, sporting events, exercise activities, martial arts, mixed martial arts, boxing, wrestling, or physical activities, or any team sport or activity or individual sport or activity.

As used herein, the term “caregiver” or the plural of same, refers to any parent, child, agent, attorney, representative, guardian, legal guardian, or any other person or entity who or which is responsible for caring for, looking after, or otherwise taking care of any healthcare needs of any individual or patient. The term “caregiver” also refers to any organization, governmental entity, business, team, league, club, network, or any other entity, or any employee or agent of same, which or who oversees, manages, uses, employs, provides oversight over, owns or otherwise has playing or managing rights over, provides control over, or provides or is responsible for the healthcare of, any of the herein-described or other athletes or sports participants.

As used herein, the terms “doctor”, “healthcare provider”, “provider”, “therapist”, “healthcare information specialist”, etc., or their plural forms, refers to any medical doctor, including any and all of the various medical specialists and/or specialties, including, but not limited to internists, orthopedists, opthamalogists, cardiologists, hematologists, endocrinologists, oncologists, ears, nose and throat specialists, neurologists, urologists, gastrointerologists, dermatologists, pediatricians), medical specialist, surgeon, surgical specialists, including any and/or forms and/or types of surgeons), physician, dentist, psychiatrist, psychologist, optometrist, podiatrist, osteopath, chiropractor, pharmacist, therapist, physical therapist, respiratory therapist, nurse, healthcare aid, nutritionist, and/or any other person, individual and/or professional who can provide healthcare, healthcare-relate, wellness and/or wellness-related services and/or products.

As used herein, the terms “insurer”, “payer”, “insurance provider”, “heath insurance provider”, “life insurance provider”, “disability insurance provider”, etc., or their plural forms, refers to any insurance companies, healthcare insurance companies, disability insurance companies, property or casualty insurance companies, health maintenance organizations, healthcare providers, and any other payer and/or provider of healthcare services and/or products, who which provide and/or pay for healthcare and/or healthcare-related benefits, services, and/or products, and/or who or which provide respective health insurance, life insurance and/or disability insurance benefits, services and/or products. The terms “insurer” or “payer” can also refer to any government or governmental agency, department, of entity, which provides healthcare services or which provides payment(s) for healthcare and/or healthcare services.

As used herein, the terms “broker”, “agent”, “billing service”, “collection agent”, “manager”, intermediary”, “assistant”, etc., or their plural forms, refer to any broker, insurance broker, agent, insurance agent, intermediary, third party, billing service provider, collection agent, claim processing agent, and/or any other person, individual, and/or entity, which acts on behalf of, or for, any of the individuals, patients, doctors, healthcare providers, insurers, payers, etc., described herein.

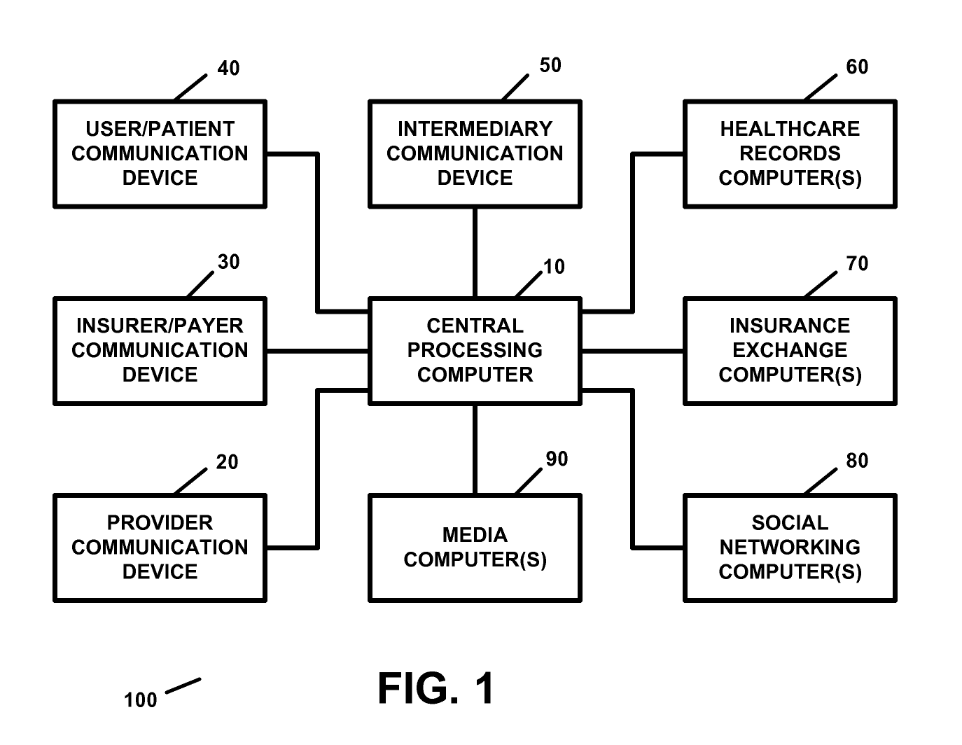

FIG. 1 illustrates the apparatus of the present invention, in block diagram form. The apparatus of the present invention is denoted generally by the reference numeral 100. In the preferred embodiment, the apparatus 100 of the present invention includes a central processing computer or central processing computer system 10 (hereinafter referred to as the “central processing computer 10”). In the preferred embodiment the central processing computer 10 can be a network or server computer.

In the preferred embodiment, the central processing computer 10 can provide control over the apparatus 100 and can perform any of the various processing services and/or functions described herein. The central processing computer 10 may be a single computer or system of computers and/or may be include a plurality of computers or computer systems which are utilized in conjunction with one another. The central processing computer 10, in the preferred embodiment can provides services for any of the other computers and/or computer systems described herein as being associated with any of the individuals, patients, healthcare providers, insurers, payers, brokers, agents, and/or intermediaries, described herein.

The apparatus 100 also includes a healthcare provider communication device or computer 20 (hereinafter referred to as “provider communication device 20” or “provider computer 20”) which is associated with a healthcare provider such as a healthcare professional, a hospital, a clinic, and/or any other provider of services described herein. A provider computer 20 can also be associated with, or can be used by, any research institution, research facility, teaching institution, teaching hospital, college, university, school, or other institution or entity which may perform research, or provide research information or any related information regarding studies, findings, or developments, in the healthcare field or in healthcare-related fields. A provider computer 20 can also be associated with, or can be used by, any public health department, public health agency, public health facility, or other public health entity, on any one or more of a national level, a country level, a state level, a provincial level, a county level, a city level, a municipal level, or any other level, which is entrusted to provide for the public health and/or to perform services or oversight regarding public health. A provider computer 20 can also be associated with, or can be used by, any immunization registry or immunization registries. A provider computer 20 can also be associated with, or can be used by, any source or provider of educational or instructional information, or information regarding instructions or procedures, or links or hyperlinks to same.

Any number or amount of healthcare provider computers 20 can be utilized in conjunction with a healthcare provider and/or group of providers. The healthcare provider communication device(s) 20 can communicate with, and operate in conjunction with, the central processing computer 10 and/or any of the other computers and/or computer systems associated with any of the other individuals and/or entities which utilize and/or operate in conjunction with the present invention.

The apparatus 100 can also include a healthcare insurer or payer communication device or computer 30 (hereinafter referred to as “payer communication device 30” or “payer computer 30”) which is associated with a healthcare payer such as a healthcare insurer, insurance company, health maintenance organization, a clinic, and/or any other payer of healthcare services and products described herein. Any number or amount of healthcare payer computers 30 can be utilized in conjunction with a healthcare payer and/or group of payers. The healthcare payer communication device(s) 30 can communicate with, and operate in conjunction with, central processing computer 10 and/or any of the other computers and/or computer systems associated with any of the other individuals and/or entities which utilize and/or operate in conjunction with the present invention.

The apparatus 100 can also include a user, patient, or individual, communication device or computer 40 (which may hereinafter be referred to either as “user communication device 40”, “user or patient communication device 40”, “user computer 40”, “patient computer 40”, or “user or patient computer or communication device 40”) which is associated with any user of the apparatus 100 or any individual or healthcare patient or client who seeks or who is provided with healthcare and/or related services, products and/or related information. The user or user or patient communication device 40 can also be utilized by any individual, party, or entity, who or which may merely utilize the present invention in order to care or another individual or to obtain information of interest.

A user or user or patient communication device 40 may also be located at public places or locations, such as at kiosks or other publicly available computer or communication devices. Any number or amount of user or patient computers 40 can be utilized in conjunction with a user, patient, group of users, and/or group of patients. The user or patient communication device 40 can communicate with, and operate in conjunction with, the central processing computer 10 and/or any of the other computers and/or computer systems associated with any of the other individuals and/or entities which utilize and/or operate in conjunction with the present invention. The user or patient communication device 40 can also be utilized by any other individual or entity desiring to utilize and/or to obtain information from the apparatus 100.

The apparatus 100 can also include an intermediary communication device or computer 50 (hereinafter referred to as “intermediary communication device 50” or “intermediary computer 50”) which is associated with an intermediary, a broker, an agent, and/or any other individual and/or entity, that can utilize the present invention in order to act for and/or on behalf of any other individual, party, or entity, described herein. Any number or amount of intermediary computers 50 can be utilized in conjunction with an intermediary and/or group of intermediaries. The intermediary computer(s) 50 can communicate with, and operate in conjunction with, the central processing computer 10 and any of the other computers and/or computer systems associated with any of the other individuals and/or entities which utilize and/or operate in conjunction with the present invention.

In the preferred embodiment, any of the provider communication device(s) 20, the payer computer(s) 30, the patient computer(s) 40, and/or the intermediary computer(s) 50, can be any computer or communication device, including, but not limited to, a personal computer, a home computer, a server computer, a network computer, a hand-held computer, a palmtop computer, a laptop computer, a personal communication device, a cellular telephone, a wireless telephone, a mobile telephone, a digital television, an interactive television, a digital television, a personal digital assistant, a telephone, a digital telephone, a television, an interactive television, a beeper, a pager, and/or a watch.

Each of the central processing computer(s) 10, the provider communication device(s) 20, the payer communication device(s) 30, the patient computer(s) 40, and/or the intermediary computer(s) 50, can transmit information to, as well as receive information from, any of the computers 10, 20, 30, 40, and 50, described herein. In this regard, each of the computers 10, 20, 30, 40, and 50, can communicate with, process information from, and/or share data and/or information with, each other and/or any other computer or computers 10, 20, 30, 40, and 50, described herein and/or utilized in conjunction with the present invention. In this manner, data and/or information transfer between any of the computers 10, 20, 30, 40, and 50, can communicate with any other computer or computers 10, 20, 30, 40, and 50, in a bi-directional manner.

The central processing computer(s) 10, the provider communication device(s) 20, the payer computers(s) 30, the patient computer(s) 40, and the intermediary computer(s) 50, can communicate with one another, and/or be linked to one another, over a communication network, a telecommunication network, a telephone network, a line-connected network, and/or a wireless communication network. Each of the computers 10, 20, 30, 40, and 50, can be linked with any other computer or computers directly or indirectly directly or indirectly with one another so as to facilitate a direct or indirect bi-directional communication said respective computers. Communications between each of the computers 10, 20, 30, 40, or 50 can also involve an e-mail server or e-mail servers in those instances when e-mails are described as being used to transmit or send any of the information, signals, messages, reports, notification messages, or any other communications, described herein, by or between any of the computers 10, 20, 30, 40, or 50, or when any of the information, signals, messages, reports, notification messages, or any other communications, described herein, are transmitted by and/or between any of the parties described herein and/or by or between any of the computers 10, 20, 30, 40, or 50, or any other computers or communication devices, computer systems, communication network equipment, server computers, etc., or any other devices used or needed in order to facilitate communications or the transmission of any of the herein-described information, signals, messages, reports, notification messages, or any other communications.

The apparatus 100 can also include a healthcare records computer 60 or computers (hereinafter referred to as “healthcare records computer 60” or “healthcare records computer(s) 60) which can be or can include a computer or computer system, or any number of computers or computer systems, or a cloud computer system or cloud system. The healthcare records computer can serve to store and house an electronic healthcare record or electronic healthcare files or any number of electronic healthcare records or electronic healthcare files. In the preferred embodiment, the healthcare records computer 60 can be associated with any provider, insurer, payer, intermediary, insurance exchange, or any user, individual, patient, organization, or entity, who or which utilizes the apparatus 100 and method of the present invention.

Each healthcare records computer 60 can be utilized to store an electronic healthcare record or electronic healthcare file or any number of electronic healthcare records or electronic healthcare files which can be accessed by the central processing computer 10, by any provider communication device 20, by any insurer or payer communication device 30, by any user or patient communication device 40, by any intermediary communication device 50, or by any other computer, communication device or other device described herein as being utilized in connection with the apparatus 100 and method of the present invention. The healthcare records computer 60 can also be utilized to facilitate cloud storage of any electronic healthcare record(s) or electronic healthcare file(s).

The apparatus 100 can also include an insurance exchange computer 70, or any number of insurance exchange computers 70 which can be utilized to process and store information regarding the selling of healthcare insurance, disability insurance, and life insurance, policies, products, and/or services, to any of the herein-described users, individuals, patients, or entities, who or which utilize the apparatus 100 and method of the present invention. The insurance exchange computer 70 can be utilized to advertise, provide information regarding, sell, and/or maintain records regarding, and process any other information regarding, group insurance as well as individual or family insurance policies, products, or services. The insurance exchange computer 70 can also be utilized to sell automobile, homeowners, business, and/or liability insurance policies, products, or services.

The apparatus 100 can also include a social networking computer 80. The social networking computer 80 can be linked with, and utilized in connection with, the apparatus 100 so as to allow and/or facilitate integrating the apparatus 100 of the present invention with social networks, social networking, and social media. In a preferred embodiment, for example, the social networking computer 80 can be associated with a social networking company, a social networking website, or social networking entity, website, group, organization, or association. The social networking computer 80 can be associated with any one or any number of social networking companies, social networking websites, or social networking entities, websites, groups, organizations, or associations. The social networking computer 80 can also provide links to any computers associated with any one or any number of social networking companies, social networking websites, or social networking entities, websites, groups, organizations, or associations. In the preferred embodiment, the social networking computer 80 can perform any and all of the functions performed by any social networking company, a social networking website, or social networking entity, website, group, organization, or association. In a preferred embodiment, any number of social networking computers 80 can be utilized in connection with the apparatus 100 of the present invention.

The apparatus 100 can also include a media computer 90. In the preferred embodiment, the media computer 90 can provide, and be a source of, news information, current events information, healthcare information, healthcare or healthcare-related news, current events, advertisements, and/or marketing information or materials, which can be disseminated via the apparatus 100 of the present invention, In a preferred embodiment, any number of media computers 90, with each being dedicated to providing any number, types, or kinds of, news information, current events information, healthcare information, healthcare or healthcare-related news, current events, advertisements, and/or marketing information or materials, can be utilized in connection with the apparatus 100.

In a preferred embodiment, each of the central processing computer(s) 10, the provider communications devices 20, the payer communication devices 30, the user or patient communication devices 40, the intermediary communication devices 50, the healthcare records computers 60, the insurance exchange computers 70, the social networking computers 80, and the media computers 90 can communication in a bi-directional manner with, and/or can send and/or receive signals, messages, reports, notification messages, alerts, or any other communications or electronic communication transmissions, to, from and/or between, any other, or any number of, other central processing computer(s) 10, if utilized, provider communications devices 20, payer communication devices 30, user or patient communication devices 40, intermediary communication devices 50, healthcare records computers 60, insurance exchange computers 70, social networking computers 80, and/or the media computers 90.

In a preferred, each of the central processing computer(s) 10, the provider communications devices 20, the payer communication devices 30, the user or patient communication devices 40, the intermediary communication devices 50, the healthcare records computers 60, the insurance exchange computers 70, the social networking computers 80, and the media computers 90 can be linked to or with any other central processing computer(s) 10, if utilized, provider communications devices 20, payer communication devices 30, user or patient communication devices 40, intermediary communication devices 50, healthcare records computers 60, insurance exchange computers 70, social networking computers 80, and/or the media computers 90 via a wired link or line or a wireless link.

In a preferred embodiment, each of the provider communications devices 20, payer communication devices 30, user or patient communication devices 40, intermediary communication devices 50, healthcare records computers 60, insurance exchange computers 70, social networking computers 80, and/or the media computers 90 can be connected with or linked with the central processing computer 10 as shown in FIG. 1.

In a preferred embodiment, any and/or all of the signals, messages, reports, notification messages, or any other communications, described herein as being transmitted from one device, computer, or communication device, to another, can be, or can be included in, or be attached to, an e-mail message, an instant messaging message, an electronic transmission, or an electronic data transmission or electronic data interchange, or can be transmitted via any other data or information transmission, and can be transmitted via or using any appropriate or necessary computer(s) or device(s).

In the preferred embodiment, the present invention is utilized on, and/or over, the Internet and/or the World Wide Web. The present invention, in the preferred embodiment, can also utilize wireless Internet and/or World Wide Web services, equipment and/or devices. The central processing computer(s) 10, in the preferred embodiment, has a web site or web sites associated therewith. Each of the other computers or communication devices described herein can also have a web site or web sites associated with same.

Although the Internet and/or the World Wide Web is a preferred communication system and/or medium utilized, the present invention, in all of the embodiments described herein, can also be utilized with any appropriate communication network or system including, but not limited to, a communication network or system, a telecommunication network or system, a telephone communication network or system, a cellular communication network or system, a wireless communication network or system, a line or wired communication network or system, a wireless Internet network or system, a wireless World Wide Web network or system, a digital communication network or system, a personal communication network or system, a personal communication services (PCS) network or system, a satellite communication network or system, a broad band communication network or system, a low earth orbiting (LEO) satellite network or system, a public switched telephone network or system, a telephone communication network or system, a radio communication network or system, a cable television network or system, and/or any other communication network or system, and/or any combination of the above communication networks or systems.

In the preferred embodiment, each of the central processing computer(s) 10, the provider communication device(s) 20, the payer communication device(s) 30, the patient computer(s) 40, the intermediary computer(s) 50, the healthcare records computer(s) 60, the insurance exchange computer(s) 70, the social networking computer(s) 80, and the media computer(s) 90, can transmit data and/or information using TCP/IP, as well as any other Internet and/or World Wide Web, and/or communication, protocols.

The apparatus 100 of the present invention can utilize electronic commerce technologies and security methods, techniques and technologies, in any and/or all of the instances of data and/or information processing, and/or data and/or information transmission described herein.

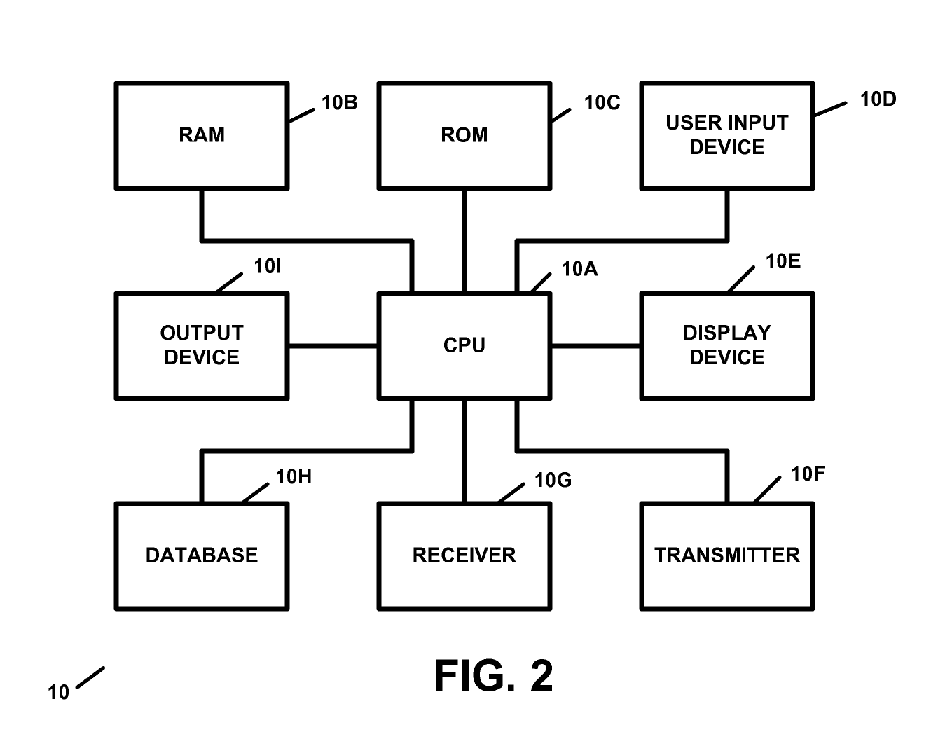

FIG. 2 illustrates the central processing computer 10, in block diagram form. The central processing computer 10, in the preferred embodiment, is a network computer or computer system, or any other communication device which can provide the functionality of, and which can be utilized as a central processing computer such as an Internet server computer and/or a web site server computer. In the preferred embodiment, the central processing computer 10 includes a central processing unit or CPU 10A, which in the preferred embodiment, is a microprocessor. The CPU 10A may also be a microcomputer, a minicomputer, a macro-computer, and/or a mainframe computer, depending upon the application.

The central processing computer 10 also includes a random access memory device(s) 10B (RAM) and a read only memory device(s) 10C (ROM), each of which is connected to the CPU 10A, a user input device 10D, for entering data and/or commands into the central processing computer 10, which includes any one or more of a keyboard, a scanner, a user pointing device, such as, for example, a mouse, a touch pad, and/or an audio input device and/or a video input device, a microphone or audio recording device, a camera or a video recording device, and/or any device, electronic and/or otherwise which can be utilized for inputting and/or entering healthcare data and/or information, for example pulse rate monitors, blood pressure monitors, electrocardiograms, blood-sugars monitors, etc., if desired, which input device(s) are also connected to the CPU 10A. The central processing computer 10 also includes a display device 10E for displaying data and/or information to a user or operator.

The central processing computer 10 also includes a transmitter(s) 10F, for transmitting signals and/or data and/or information to any one or more of the central processing computer(s) 10, the provider communication device(s) 20, the payer computers(s) 30, the patient computer(s) 40, and the intermediary computer(s) 50, the healthcare records computer(s) 60, the insurance exchange computer(s) 70, the social networking computer(s) 80, and the media computer(s) 90, or any other individual computer(s), which may be utilized in conjunction with the present invention. The central processing computer 10 also includes a receiver 10G, for receiving signals and/or data and/or information from any one or more of the central processing computer(s) 10, the provider communication device(s) 20, the payer computers(s) 30, the patient computer(s) 40, and the intermediary computer(s) 50, the healthcare records computer(s) 60, the insurance exchange computer(s) 70, the social networking computer(s) 80, and the media computer(s) 90, which may be utilized in conjunction with the present invention.

The central processing computer 10 also includes a database(s) 10H which contains data and/or information pertaining to the patients, providers, payers, and intermediaries who or which are serviced by the present invention and/or who or which utilize the present invention.

The database 10H can contain any one or any number of electronic healthcare records (EHRs), which electronic healthcare records definition includes electronic healthcare records or electronic healthcare files, electronic medical records or electronic healthcare files (EMRs), electronic dental records or files (EDRs), electronic pharmacy records or files (EPRs), electronic behavioral health records or files (EBHRs), as well as any personal health records or files (PHRs). The database 10H can also contain any links or hyperlinks to any of the above electronic healthcare records or electronic healthcare files, electronic medical records or files, electronic dental records or files, electronic pharmacy records or files, electronic behavioral health records or files, and/or personal health records or files, which may be located or stored on any computer or computers external from the central processing computer 10, for any number of users, individuals, or patients.

Each of the herein-described electronic healthcare records, electronic medical records, electronic dental records, electronic pharmacy records, and/or electronic behavioral health records can also contain a personal health record portion. The apparatus 100 and method of the present invention can store a personal health record for each individual or patient. The personal health record can be stored in each individual's or patient's respective electronic healthcare record(s), electronic medical record(s), electronic dental record(s), electronic pharmacy record(s), and/or electronic behavioral health record(s), as well as in any user or patient communication device 40. The personal healthcare record can be updated as described herein or in any other appropriate manner.

The database 10H can also contain a look-up table or look-up tables and/or data and/or information relating thereto, for identifying and locating a respective electronic healthcare record(s), an electronic medical record, an electronic dental records, an electronic pharmacy record, an electronic behavioral health record, or a personal health records, for or associated with any user, individual, patient, or person who may utilize the apparatus 100 of the present invention. In this regard, the database 10H can store any healthcare data and/or information or healthcare-related data and/or information for any user, individual, patient, or person who may utilize the apparatus 100 of the present invention, whether that information is stored in the central processing computer 10, the database 10H, or any provider communication device(s) 20, payer communication device(s) 30, user or patient communication device(s) 40, intermediary communication device(s) 50, healthcare records computer(s) 60, insurance exchange computer(s) 70, social networking computer(s) 80, and/or media computer(s) 90, regardless of where these computers or communications devices are located and regardless of what data and/or information is stored on same.

In the preferred embodiment, the database 10H contain data and/or information for locating, retrieving, storing, or providing a comprehensive healthcare record of healthcare file for any individual, user, patient, or person. The database 10H can also contain any necessary data or information for locating, identifying, retrieving, storing, any information from any of the various types of kinds of electronic healthcare records or electronic healthcare files regarding of the type, kind, and/or vendor or supplier of same, regardless of where these electronic healthcare records or electronic healthcare files are located or stored. In a preferred embodiment, the database 10H can also contain an index or other information for identifying data fields in the respective databases of the various respective electronic healthcare records for enabling the central processing computer 10 to identify data and/or information in each of the respective electronic healthcare records or electronic healthcare files.

The database 10H can also contain any data and/or information for allowing any herein-described user, individual, patient, person, provider, payer, intermediary, or entity, to access or obtain any of the herein-described data and/or information, wherever such data and/or information is located or stored, as well as to perform any function described herein as being capable of being performed by the apparatus 100 of the present invention.

The database 10H can also contain any data and/or information for integrating, linking to or with, and/or accessing data and/or information stored or located in, any number, type, or kind, of any of the herein-described electronic healthcare records or electronic healthcare files, electronic medical records or files, electronic dental records or files, electronic pharmacy records or files, electronic behavioral health records or files, as well as any personal health records or files.

The database 10H can contain any of the herein-described data and/or information for any number of individuals, users, patients, or persons. The database 10H can also contain data and/or information regarding a name, relationship, and authorization for any parent, relative, legal guardian, caregiver, healthcare proxy holder, or any person, individual, or entity, who or which may be responsible for caring for, accessing, updating, or maintaining healthcare records or files for, making decisions for, or making healthcare-related decisions for, taking actions for, providing care for, or performing any task or activity for, any other individual(s), user(s), patient(s), or person(s). For example, the database 10H can, for a child, contain information regarding the child's parent or legal guardian, and for the database 10H, for an elderly person of any other person, contain information regarding the person's child, caregiver, healthcare proxy holder, or any other authorized person or entity, or for individuals who belong to a school or club's athletic program, or a sports team, a club, a social or other organization, the database 10H can contain information regarding a coach, team doctor, trainer or other authorized individual.

The database 10H can contain any and/or all of the information needed and/or required in order to perform any and/or all of the functions, services and/or operations described herein as being performed by the central processing computer 10 or the apparatus 100 of the present invention. In this regard the database 10H can contain data and/or information regarding patient name, patient identification information, patient social security number or other identification information, date of birth, sex, gender, race, nationality, ethnicity, spoken language, preferred language, other languages, religion or religious affiliation, next-of-kin, relatives, emergency contact person, doctors or providers, therapists, nutritionists, insurance or payer information, group insurance information, group health insurance information, life insurance information, disability insurance information, patient address, phone number, e-mail and/or other contact information, medical history, psychological history, dental history, family history, family medical, psychological, and/or dental history, past and/or current or active symptoms, past and/or current or active diagnoses, past and/or current or active treatments or treatment plans, care management plan or plans, allergies, active or current medications or prescription drugs, active or current medication allergies, past, active, or current allergies, smoking status, insurance coverage, insurance co-payment and/or deductible information, co-payment information regarding any payer or insurer insurance policy or payment plan, deductible information regarding any payer or insurer insurance policy or payment plan, benefit eligibility information, insurance information, insurance claim procedures, insurance claim forms, doctor or provider appointment schedules, past treatments, past diagnosis, symptoms, insurance claim forms, employer information, lifestyle information, treatment plans, treatment progress, broker/agent/intermediary information, education information, age, sex, marital status, employee benefits information, types or services and/or treatments needed, and any other data and/or information regarding the patient which would be needed and/or desired in order to perform any and/or all of the functions, services and/or operations described herein.

The database 10H can also contain provider office visit summaries, hospital discharge summaries, hospital discharge instructions, and/or any examination, treatment, testing, or procedure, summary, and any instructions, treatment plan or instructions, care management plan or instructions, or any other information which can be provided to any individual, patient, provider, payer, insurer, third party or intermediary, or caregiver, described herein as using the apparatus 100 and method of the present invention, or described herein as being able to receive services, provide services, or otherwise use or be serviced by, the apparatus 100 and method of the present invention.

In the case of deceased patients or individuals, the database 10H can contain information regarding date of death, place of death, preliminary cause of death, and/or final determination of cause of death. The database 10H can also contain information regarding any other information regarding a deceased patient or individual and can also contain information regarding final resting place.

The database 10H can also contain, for each patient or individual, information regarding dates of appointments or services with or from healthcare providers or other providers, dates of laboratory tests, dates of treatments, operations, or procedures, dates of doctor visits, therapy sessions, vital signs, healthcare chart changes, or information regarding height, weight, blood pressure, heart rate, pulse rate, body-mass index, growth charts, and/or any other related or pertinent data or information.

The database(s) 10H can also contain healthcare and/or medical video, image, and/or audio, and/or text, data and/or information, and/or surgical video, image, and/or audio, and/or text, data and/or information, and/or dental video, image, and/or audio, and/or text, data and/or information, such as, for example, x-rays, Magnetic Resonant Images (MRI), CAT scans, digital x-ray files, digital Magnetic Resonant Imaging (MRI) files, digital CAT scan files, and/or any other video, imaging, and/or audio, healthcare data and/or information which can be utilized by healthcare providers, payers, intermediaries, patients, and/or other users of the present invention. In this manner, the present invention can facilitate the availability of any of the above-described video, image, and/or audio, data and/or information in a network environment. For example, a medical specialist can have access to, and/or review, an MRI or a CAT scan for a patient, from any location and at any time.

The database 10H can also contain data and/or information regarding providers including provider name, provider social security number or identification number, type of professional or service provider, address, phone number, fax number, e-mail and/or other contact information, experience, specialties, insurances accepted, schedule of charges, financial account identification information, resume information, education, work experience, claim forms, appointment schedules, procedures performed, and/or any other data and/or information concerning the providers for providing any and/or all of the functions, services, and/or operations described herein as being performed by the present invention.

The database 10H can also contain data and/or information regarding all possible fields of medicine, surgery, psychiatry, psychology, dentistry, oral surgery, optometry, podiatry, physical therapy, respiratory therapy, hypnosis, osteopathy, nutrition, wellness, and/or any other possible healthcare fields and/or subject matter which can possibly by utilized in the processing and/or operation of the present invention.

The database 10H can also contain information on illnesses, symptoms, diseases and/or sicknesses, theories, scientific theories, research data and/or information, diagnosis information, treatment information, treatment plans, treatment processes, treatment progresses, treatment interactions, side effects, expected treatment results, treatment providers, treatment durations, treatment costs, pre-treatment information, post-treatment information, treatment monitoring information, statistical information regarding diagnoses, treatments, treatment success rates, treatment failure rates, treatment centers, therapy plans, therapy success rates, therapy failure rates, treatment procedures, medications treatments, non-medication treatments, healthcare institutions, treatment evaluating criteria, treatment mistakes and/or mishaps, indicators of mistakes and/or mishaps, corrective actions, links to providers, links to treatment centers or institutions, reimbursement rates, nutrition information, diet information, exercise information, exercise routines, treatment options, healthcare advise, wellness advice, preventive care, preventive procedure, health maintenance, drug and medication information, drug interaction information, video information, including video files or clips and other information, regarding illnesses, diseases, treatments and follow-up care, audio information, including audio files or clips and other information, regarding illnesses, diseases, treatments and follow-up care, treatment and/or procedure information and/or narratives, treatment analysis, diagnosis analysis, diagnosis monitoring, diagnosis confirmation and/or checking, and/or other information for providing the herein-described functions, services, and/or operations.

The database 10H can also contain information regarding the insurance companies and payers described herein, including, but not limited to, payer name, address, phone number, fax number, e-mail address, identification number(s), coverage types, policies and/or coverages provided, reimbursement rates, patients and/or providers serviced and/or covered by the payer, policy information, claim forms, claim procedures, claim status, claim processing information, claim submission procedures and policies, reasonable and customary charges, co-payment information, pre-approval information and/or procedures, claim form information, electronic form claim forms, insurance and/or coverage requirements, guidelines, and/or triggering events, covered procedures and/or treatments, uncovered procedures and/or treatments, claim approval information, claim approval history, claim approval statistics, claim rejection or denial information, claim rejection or denial history, claim rejection or denial statistics, financial account information, network provider information, network patient information, claim statistics, preventative care and/or benefits information, benefits information, benefits request information and/or claim forms, claim submission information, claim processing information, claim status information, payment information and statistics, and/or any other data and/or information regarding and/or related to payers which are needed and/or desired for providing any and/or all of the functions, services, and/or operations described herein.

The database 10H can also contain data and/or information regarding the brokers, agents and/or intermediaries described herein, including, but not limited to, intermediary name, address, phone number, fax number, e-mail address, clients, patients services, insurance policies, policy information, policy quote information, policy proposal information, any and/or all of the above information described herein regarding patients, providers, payers, etc. which may be of interest to the intermediaries described herein which may be useful and/or beneficial to the intermediaries in providing any of the functions, services, and/or operation described herein.

The database 10H can also contain contact information such as phone numbers, fax numbers, pager numbers, beeper numbers, e-mail addresses, hyperlinks to, and/or any other information which can facilitate contact between any of the parties described herein. The database 10H also includes electronic signature data and/or information for any of the parties, patients, providers, payers, and/or intermediaries, described herein for facilitating transactions, claim submissions, financial transactions, etc., by and/or between any of the above patients, providers, payers, and/or intermediaries.

The database 10H can also contain and notes, comments, or messages, which can be provided by any user, individual, patient, caregiver, provider, insurer, payer, third party, intermediary, or any other person or entity who or which utilizes the apparatus 100 and method of the present invention.

The database 10H can also contain any number of electronic healthcare records, electronic medical records, electronic dental records, electronic pharmacy records, electronic behavioral health records, and/or links to other electronic healthcare records, electronic medical records, electronic dental records, electronic pharmacy records, electronic behavioral health records which might be located in healthcare records computers 60 or other computers or computer systems located remote from the central processing computer 10. Any and/or all of these electronic healthcare records, electronic medical records, electronic dental records, electronic pharmacy records, electronic behavioral health records can contain data and/or information and/or link or hyperlinks to data and/or information regarding any individuals, patients, his or her caregivers, children, parent, relatives, friends, social networking friends, connections, of followers, providers, insurers or payers. The databases 10H can also contain any and/or all information regarding the data and/or information fields in each electronic healthcare record, electronic medical record, electronic dental record, electronic pharmacy record, and/or electronic behavioral health record, information for mapping common or like data fields for each and information or links or hyperlinks for accessing like data or like information fields in each of the different electronic healthcare records, electronic medical records, electronic dental records, electronic pharmacy records, electronic behavioral health records.

The data and/or information in the database 10H can also include links to any other information, information sources, news sources, and/or other information and/or data which can or may be utilized by the present invention and/or by any of the patients, providers, payers, intermediaries and/or any other users of the present invention.

The database 10H can also contain data and/or information regarding healthcare news, healthcare developments, healthcare discoveries, etc., for and including the medical field, surgical field, psychological field, dental field, nutrition field, fitness field, etc., and/or any other healthcare field or fields.

The database 10H, in the preferred embodiment, can also contain video and/or audio files which can be utilized for training of healthcare professionals as well as for providing general information to any user of the present invention. In this manner, and as will be described hereinbelow, the apparatus 100 can be utilized as a simulator for providing training in medical diagnosing, medical training, surgical training, psychiatric training, psychological training, dental training, oral surgery training, therapist training, and/or for training any of the healthcare providers described herein and/or envisioned.

For example, the present invention can be utilized to provide a medical doctor with a set of symptoms, evaluate the diagnosis and treatment prescribed and provide follow-up patient conditions which may or may not call for the medical doctor to re-evaluate his or her diagnosis and/or treatment. In a similar fashion, the present invention can be used for training and continuing education and training for any of the healthcare providers described herein and/or otherwise envisioned utilizing the present invention.

The database 10H can also contain data and/or information restricting access by any of the providers, payers, patients, intermediaries, and/or other users, to any of the data and/or information stored in the database 10H.

The database 10H can also contain information correlating symptoms and/or conditions with diagnoses, prognoses, and/or treatments, treatment methods, procedures, etc. The database 10H also contains any and/or all information needed and/or desired for facilitating the processing of symptoms, conditions, medical histories, family histories, and other information, in order to arrive at diagnoses and/or prognoses, treatments, prescriptions, procedures and/or any other healthcare and/or healthcare-related information.

The database 10H can also contain information regarding medical records, medical charts, x-rays, MRIs, and/or any other information, described herein and/or otherwise, which can be associated with an individual's or patient's medical history, medical record, or medical file, for any individual or patient who utilizes the apparatus 100 and method of the present invention.

The database 10H can also contain information regarding surgical records, surgical charts, x-rays, MRIs, and/or any other information, described herein and/or otherwise, which can be associated with an individual's or patient's surgical history, surgical record, or surgical file, for any individual or patient who utilizes the apparatus 100 and method of the present invention.

The database 10H can also contain information regarding dental records, dental charts, x-rays, and/or any other information, described herein and/or otherwise, which can be associated with an individual's or patient's dental history, dental record, or dental file, for any individual or patient who utilizes the apparatus 100 and method of the present invention.

The database 10H can also contain information regarding a prescription drug record, file, or account, for an individual or patient for any individual or patient who utilizes the apparatus 100 and method of the present invention.

The database 10H can also contain information regarding a healthcare spending account or healthcare spending accounts for any individual or patient, or for any of the individuals or patients, described herein or otherwise, who utilize the apparatus 100 and method of the present invention. For example, the healthcare spending account is or can be an account which can be a deposit account, a credit account, a debit account, an electronic money or an electronic cash account, or any combination of same, which can be held by any individual, patient, employer, bank, credit union, financial institution, investment institution, healthcare insurer, healthcare payer, or any other third party, and which can be used as a source of funds for payment for any type of healthcare service or healthcare product which is provided to, or administered to, or sought by, any individual or patient who utilizes the apparatus 100 and method of the present invention. In a preferred embodiment, the healthcare spending account can be used by the individual or patient to pay for any healthcare service, treatment, procedure, or product, at any time a payment is desired to be made for same.

The database 10H can also contain, for each individual or patient who utilizes the apparatus 100 and method of the present invention, information regarding, or a record of, each and every instance of a provider office visit involving the individual or patient, a communication(s) with a provider or providers involving or regarding the individual or patient, a payment(s) made by or on behalf of the individual or patient, an insurance claim(s) made by a provider or providers on a healthcare insurance policy or account for or regarding the individual or patient, including information regarding date of claim, time of claim, or the provider making the claim, a co-payment(s) made by or on behalf of the individual or patient, a payment(s) made on an insurance claim, a denial(s) of an insurance claim or insurance claims, or a resolution(s) of an insurance claim or insurance claims. The database 10H can also contain information regarding a history or record of insurance claims made by a provider or providers, or made by an individual or patient, for each individual or patient who utilizes the apparatus 100 and method of the present invention.

The database 10H can also contain credit report data or information, a credit report, credit reports, or a credit history, for any individual or patient, or for any of the individuals or patients, described herein or otherwise, who utilize the apparatus 100 and method of the present invention. The credit report or credit reports, or credit history, can contain any of the information which is typically provided by, or which may be provided by, any commercial or other credit reporting company or agency, such as, for example, but not limited to, credit reporting companies such as TransUnion LLC, Experian Information Solutions, Inc., Equifax, Inc., or any other credit reporting company, agency, or bureau, or any credit card company or financial institution. The database 10H can also contain any data or information which is typically found in a credit report database or credit history database, and/or any data and/or information which is, or which can be, utilized in generating, and/or analyzing, a credit report or credit reports, or a credit history, for, or on behalf of, any individual or patient, or for any of the individuals or patients, described herein or otherwise, who utilize the apparatus 100 and method of the present invention. The database 10H can also contain e-mail contact information, telephone contact information, cellular telephone contact information, and/or any other suitable contact information, for an individual or patient which can be utilized to notify the individual or patient when information regarding his or her credit report or credit reports, or credit history, is accessed, obtained, changed, or when a new entry of information is made in same.

The database 10H can also include advertisements, advertisement materials and information, marketing materials or information, commercials, video clips, infomercials, and any other information, which can include text information. video information, audio information, or any combination of same, which can be used to provide an advertisement, or advertisement material or information, to or for any individual, patient, provider, healthcare provider, payer, healthcare payer, insurer, healthcare insurer, product provider, service provider, third party provider, or any other person or entity, who or which utilizes the apparatus 100 and method of the present invention. A respective advertisement, advertisement material and information, marketing material or information, commercial, video clips, infomercials, and/or any other information, can be used to advertise or market any product(s) or service(s) which can be used by, provided to, provided by, advertised to, advertised by, marketed to, or marketed by, any individual, patient, provider, healthcare provider, payer, healthcare payer, insurer, healthcare insurer, product provider, service provider, third party provider, or any other person or entity, who or which utilizes the apparatus 100 and method of the present invention.

The database 10H can also contain news information, news reports, published reports, theses, study reports, or any other data or information regarding health issues, healthcare issues, health conditions, diseases, treatments, drugs, medications, healthcare procedures, medical procedures, surgical procedures, dental procedures, prescription products or services, non-prescription products or services, over-the-counter products or services, health or wellness issues or recommendations, exercise issues or recommendations, alternate therapy or treatment types or recommendations, herbal therapies or recommendations, or any other data or information which can be used by or provided to any individual, patient, provider, healthcare provider, payer, healthcare payer, insurer, healthcare insurer, product provider, service provider, third party provider, or any other person or entity, who or which utilizes the apparatus 100 and method of the present invention. The news information, news reports, published reports, theses, study reports, or any other data or information can include text information, video information, audio information, or any combination of same.

The news information, news reports, published reports, theses, study reports, or any other data or information, stored in the database 10H, can be transmitted to, or fed to, the central processing computer 10, for storage in the database 10H, by or from any appropriate computer or communication device, which is associated with or used by any news source, news organization, research institution, research professional, healthcare facility, an author, researcher, academician, or any other individual, person, or entity. An intermediary communication device 50 can also be utilized to transmit the news information, news reports, published reports, theses, study reports, or any other data or information to the central processing computer 10.

The database 10H can also contain prescription drugs information, prescription medication information, over-the-counter drug or medication information, wellness information, exercise and fitness information, and/or any other information pertinent to an individual's or a patient's heath, well-being, or treatment.

The database 10H can also include language translation information or software so that any of the data or information described herein as being stored in the database 10H, or as being provided in any of the messages, reports, or other communications, described herein can be translated into any language.

The database 10H can also contain, for each individual, patient, provider, and/or insurer or payer who or which utilize the apparatus 100, data and/or information regarding charges made to an individual or patient, charges made by a provider, charges made by an insurer or payer, amounts paid to an individual or patient, amounts paid by an individual or patient to a provider, amounts paid by an insurer or payer to a provider, amounts paid by an insurer or patient to an individual or patient, amounts paid by an individual or patient to an insurer or payer, a charges-back(s) made regarding a payment to, for, or by, a provider, a charge-back(s) made regarding a payment to, for, or by, an individual or patient, and/or a charge-back(s) made regarding a payment to, for, or by, an insurer.

The database 10H can also contain any notes, comments, or messages, which can be provided in text, in audio recordings or audio clips, and/or in video recordings or video clips. The database 10H can also contain any data, information, and/or software programs for translating audio information to text information and for translating test information to audio information. The database 10H can also contain any data, information, and/or software programs for translating text information or audio information from one language to another so as to provide a multi-lingual healthcare information and records keeping system. The database 10H can also contain any notes, comments, or messages, which can be provided by any of the herein-described users, individuals, patients, providers, insurers, payers, third parties, intermediaries, and/or any other person or entity who or which utilizes the apparatus 100 and method of the present invention.

The database 10H can also contain any notes, comments, or messages, which can be stored in any and/or all of the electronic healthcare records or electronic healthcare files, electronic medical records or files, electronic dental records or files, electronic pharmacy records or files, electronic behavioral health records or files, and/or personal health records or files, described herein as being utilized in connection with the apparatus 100 and method of the present invention. In this regard, it is important to note that, in a preferred embodiment of the present invention, any and/or all of the electronic healthcare records or electronic healthcare files, electronic medical records or files, electronic dental records or files, electronic pharmacy records or files, electronic behavioral health records or files, and/or personal health records or files, described herein as being utilized in connection with the apparatus 100 are or can be designed to receive, store, and/or provide, any notes, comments, and/or messages, provided by any of the herein-described users, individuals, patients, providers, insurers, payers, third parties, intermediaries, and/or any other person or entity, as text information or in text form, as audio information or in audio form, or as video information or in video form. Any text or audio information can be translated to from text to audio or from audio to text, and any text or audio information can be translated from one language to any one of more of any other language.

The database 10H can also contain sports medicine-related data and/of information for and including healthcare records, histories, or files, of and for athletes or sports participants of any age and in or for any sport or athletic activity. The database 10H can also contain data and/or information regarding healthcare records, histories, and/or files, for any athletes or sport participants and their respective organizations, teams, clubs, leagues, or other entities. The database 10H can also contain data and/or information for creating and for maintaining a comprehensive and/or centralized sports medicine healthcare record, history, and/or file, system for athletes or participants of any sport or sports or any activity or activities, athletes or sports participants of any age, professional athletes, minor league athletes, Olympic athletes, competitive athletes, government team athletes, world class competition athletes, amateur athletes, college athletes, high school age athletes, children athletes, secondary school athletes, recreational organization athletes or members, child recreational organization athletes or members, adult recreational organization athletes or members, little league athletes or members, boys club athletes or members, girls club athletes or members, hobbyist athletes, or any other individuals, male or female, who participate in athletic endeavors, sporting events, exercise activities or programs, the martial arts, mixed martial arts, boxing and other fighting or combat sports, any and/or all team sports, including but not limited to baseball, football, basketball, hockey, soccer, lacrosse, track and field, gymnastics, car racing, skiing and winter sports, swimming and aquatic sports, weightlifting, dancing, and/or any other sports or sporting activities, and/or other physical activities, or any team sporting activities or individual sporting activities.

The database 10H can also contain data and/or information regarding any organization, governmental entity, business, team, league, club, network, or any other entity, which oversees, manages, uses, employs, provides oversight over, owns or otherwise has playing or managing rights over, provides control over, or provides or is responsible for the healthcare of, any of the herein-described or other athletes or sports participants.

The database 10H can also contain data and/or information for or regarding sports-related injuries or athletic related injuries, or conditions, or other healthcare information relating to sports-related injuries, athletic injuries, sport-related conditions, and/or athletics-related conditions.

The database 10H can also contain data and/or information for diagnosing, treating, treatment planning, curing, rehabilitating, and/or for performing therapy or therapies for, sports-related injuries or conditions or athletic-related injuries or conditions. The database 10H can also contain information regarding diagnoses, treatments, treatment plans, procedures, corrective procedures or surgical procedures, cures, rehabilitation, therapies, physical therapies, exercise therapies, drug or medicinal therapies, diets, nutritional therapies, alternate medicine therapies, herbal therapies, and/or any other information which can or which may be utilized or needed for monitoring and/or managing the health and well-being of athletes or sports participants.

The database 10H can also contain data, information, or algorithms, for devising and planning treatments, treatment plans, procedures, operations, rehabilitation programs, plans, or regimens, physical therapy programs, plans, or regimens, occupational therapy programs, plans, or regimens, exercise programs, plans, or regimens, massage therapy programs, plans, or regimes, and/or any other programs, plans, or regimens for treating, curing, or otherwise dealing with, a sports-related injury or diagnosis.

The database 10H can also contain data and/or information regarding, for identifying or locating, healthcare providers, doctors, specialists, dentists, dental specialists, psychiatrists, psychologists, chiropractors, podiatrists, optometrists, or any other providers, hospitals, treatments facilities, therapists, nurses, physical therapists, massage therapists, occupational therapists, trainers, and/or any other providers or care givers, and/or testing laboratories, who or which can provide services for any other athletes and/or sports participants who may or which my utilize or be serviced by the apparatus 100 and method of the present invention, or any of their respective organizations, teams, clubs, or other entities.

The database 10H can also contain information, text information, audio, audio information or audio clips, video, video information, video clips, audio and video information, audio and video clips, news story, television programs, and/or information in any other form or type regarding fitness, fitness exercises, exercises, fitness routines, fitness regimens, wellness, wellness exercises, wellness routines, wellness regimens, diets, diet exercises, diet or dieting routines, diet ort dieting regimens, training, training principals, training exercises, training routines, training regimens, nutrition, health and well being, meditation and any other information.

The database 10H can also contain statistical and/or other probabilistic and/or mathematical information for assigning and/or correlating certain levels and/or estimates for any and/or all of the information, diagnoses, prognoses, treatments, procedures, and/or any other information processed and/or generated by the central processing computer 10 and/or the apparatus 100.

The database 10H, in the preferred embodiment, can be a database which may include individual databases or collections of databases, with each database being designated to store any and all of the data and/or information described herein. The database 10H, or collection of databases, may be updated by each of the respective patients, providers, payers, users, and/or intermediaries, and/or by any other third party, in real-time, and/or via dynamically linked database management techniques.

The data and/or information stored in the database 10H can also be updated by and/or dynamically linked to, various external sources, including but not limited to news services, research publications, research facilities, healthcare laboratories, providers of healthcare goods and/or services, pharmaceutical companies, research institutions, schools. The database 10H will contain any and all information deemed necessary and/or desirable for providing all of the processing and/or services and/or functions described herein.

The database 10H can also contain data and/or information regarding any and/or all International Classification of Diseases (ICD) codes, ICD-10 codes, ICD-9, or any other ICD codes, or other codes, billing codes, diagnostic codes, treatment codes, or symptom codes, as well as any other codes or coding information which pertains to healthcare, the administration of healthcare services, healthcare record keeping, healthcare billing, healthcare diagnostics, healthcare treatments, or any other healthcare or healthcare-related functions or services, or any information or function, described-herein as capable of being provided by the apparatus 100 and method of the present invention. The database 10H can also contain data and/or information regarding the foreign language translations or conversions of or for, or for the foreign language translation or converting, of any of the herein-described International Classification of Diseases (ICD) codes, ICD-10 codes, ICD-9, any other ICD codes, or other codes, billing codes, diagnostic codes, treatment codes, symptom codes, as well as any other codes or coding information which pertains to healthcare, the administration of healthcare services, healthcare record keeping, healthcare billing, healthcare diagnostics, healthcare treatments, or any of the healthcare or healthcare-related functions or services, or any information or function described-herein as capable of being provided by the apparatus 100 and method of the present invention, into any one or any number of foreign languages.

The database 10H can contain any look-up tables, or information for use in a look table, for translating or converting any of the data, information, or codes, described herein, into any one or any number of foreign languages. The database 10H can also contain any language translation software or language conversion software which can be used to perform any of the foreign language translation or foreign language conversion processing or functionality described as being performed by the apparatus 100 and method of the present invention.

The database 10H can also contain any information or software, or rules algorithms, which can be used in generating insurance claim forms which can be submitted error-free to any of the insurers or payers described herein.

The database 10H can also contain digital pictures, photographs, images, video, or video clips, of individuals or patients, as well as digital pictures, photographs, images, video, or video clips, of physical conditions of or regarding an individual or patient, which can be accessed or retrieved by any of the individuals, patients, providers, payers, or intermediaries, described herein as utilizing the apparatus 100 and method of the present invention. For example, in instances where photographs or images can be useful to see a state of a physical condition of a patient or individual, or to compare a state of a physical condition from one point in time to another, or to track the state of a physical condition, a photograph(s), picture(s), or image(s), or video clip, can be digitally recorded, with a camera or video recording device, and stored in the database 10H and/or in the patient's or individual's healthcare record or healthcare file for later retrieval, use, and/or review.

For example, a dermatologist seeking to determine if a skin condition has or is changing in size, shape, or color, can take and store, in the database 10H and/or in the patient's or individual's healthcare record or healthcare file, one or more photographs, pictures, or images, or a video clips, of the skin condition. In an analogous manner, a plastic surgeon can obtain and store, in the database 10H and/or in the patient's or individual's healthcare record or healthcare file, photographs, pictures, or images, or video clips, showing physical conditions of an individual or patient before, after, or during a procedure or procedures. A dentist or an oral health professional can obtain and store, in the database 10H and/or in the patient's or individual's healthcare record or healthcare file, in addition to x-rays, a photograph(s), picture(s), or image(s), or a video clip(s), showing physical conditions of an individual's or patient's mouth, teeth, gums, or other physical oral state, for later retrieval, use, or review. In an analogous manner, any healthcare provider can obtain and store, in the database 10H and/or in a patient's or individual's healthcare record or healthcare file, a photograph(s), picture(s), or image(s), or a video clip(s), obtained in or during an office visit, an examination, a procedure, an operation, a treatment, or during any other occasion, event, occurrence, or happening, for later retrieval and use as needed or desired by any provider, payer, patient, individual, or intermediary, described herein as being able to utilize the apparatus 100 and method of the present invention.

The database 10H can also contain video and/or audio clips or recordings of office visits, examinations, procedures, operations, or any other healthcare, healthcare-related, or any other event(s), occurrence(s), or happening(s), which may or which can be of interest to any provider, insurer, payer, patient, individual, or intermediary, described herein as being able to utilize the apparatus 100 and method of the present invention.

The database 10H can also contain transcripts of office visits, examinations, procedures, operations, or any other healthcare, healthcare-related, or any other event(s), occurrence(s), or happening(s), which may or which can be of interest to any provider, insurer, payer, patient, individual, or intermediary, described herein as being able to utilize the apparatus 100 and method of the present invention.

The database 10H can also contain data, information, links, or hyperlinks, which can allow a healthcare provider to create or generate and/or transmit prescriptions or electronic prescriptions, or prescription forms, to pharmacies or other providers, for a patient or individual, or prescriptions or electronic prescriptions for tests, analyses, analysis work-ups, procedures, therapy, physical therapy, or other healthcare or healthcare-related services, for a patient or individual, or which can allow a healthcare provider to transmit a referral or an electronic referral or referral form to other healthcare providers or other providers of goods or services for a patient or individual.

The database 10H can also contain data, information, links, or hyperlinks, which can allow a healthcare provider to perform remote control or monitoring of healthcare devices or equipment used in the treatment of, a care of, or a monitoring of, a patient or individual, while the patient or individual is at home, in a hospital, in a nursing home, in a care facility, or traveling in or on, respectively, a car, automobile, train, subway train, boat, helicopter, airplane, aircraft, or any other vehicle. The database 10H can also contain data, information, a link(s), or a hyperlink(s) which can allow a healthcare provided to remotely control healthcare devices or equipment, instruments, surgical instruments, and/or any other devices which can be used in performing a procedure, a surgery, or a surgical procedure, on an individual or patient, and/or to administer a treatment to the individual or patient, via data, information, link(s), or a hyperlink(s), contained in the individual's or patient's electronic healthcare record.

The database 10H can also contain data and/or information regarding artificial limbs, artificial organs, implanted or implantable devices, and/or prosthetic devices, and/or dental implants, dental braces, and/or any other devices associated with an individual or patient. The data and/or information regarding artificial limbs, artificial organs, implanted or implantable devices, and/or prosthetic devices, and/or dental implants, dental braces, and/or any other devices associated with an individual or patient can include manufacturer information, model information, date put into use or installed, if applicable, maintenance instructions, provider who or which prescribed, installed, implanted, or fitted same, dates examined or checked, and/or any other data or information regarding same.

The database 10H can also contain data, information, or software, for performing healthcare audits, for performing meaningful use information processing routines, for identifying or selecting individuals for clinical trials, experimental procedures, experimental treatments, healthcare focus groups, healthcare surveys, or other activities or events, or for performing any other processing routines which can advantageously use any of the information stored in the database 10H, any information stored in any of the herein-described healthcare records, files, or histories, described herein, or any other information, stored by the apparatus 100 of the present invention or any of its computers, communication devices, component parts, or devices, or any other information stored in, provided by, generated by, or used by, the apparatus 100 of the present invention. For example, with regards to clinical trials, experimental procedures, experimental treatments, healthcare focus groups, healthcare surveys, or other activities or events, the database 10H can contain information regarding whether or not an individual or patient can or may be a candidate for, be eligible to participate in, has agreed to be candidate for, or has agreed to participate in, clinical trials, experimental procedures, experimental treatments, healthcare focus groups, healthcare surveys, or other activities or events, or has agreed to be candidate for, or has agreed to participate in, a particular clinical trial(s), experimental procedure(s), experimental treatment(s), healthcare focus group(s), healthcare survey(s), or other activities or events.

The database 10H can also contain any data and/or information needed or used to determine or measure the effectiveness of, or side effects experienced or associated with, any medication(s), medicine(s), drug(s), dietary supplement(s), supplement(s), vitamin(s), nutrient(s), over-the-counter product(s) or substance(s), or the effectiveness of a procedure(s), treatment(s), treatment plan(s), care management plan(s), or any other good(s) or service(s) which can be offered in the marketplace.

The database 10H can also contain data and/or information relating to information regarding health conditions, healthcare conditions, illnesses, diagnoses, symptoms, treatments, treatment plans, care management plans, care management practices, insurance information, information regarding type of insurance, wellness information, healthcare practices, healthcare history patterns, healthcare trends, treatment trends, care management trends, statistics, statistical analyses, studies, study trends, or any other healthcare or healthcare-related information, for or regarding any number or type of groups of individuals or patients, and any data or information for determining same. The database 10H can also contain data or information regarding, or for determining, any of the above-described information for any number of groups of individuals or patients based on sex, gender, age, occupation, education, ethnicity, nationality, country of origin, religion, or any demographic or demographics, or any other criteria. The database 10H can also contain data or information regarding, or for determining statistical information or probability information regarding, any of the herein-described information.

The database 10H can also contain data or information for implementing and for performing drug formulary checks or analyses, as well as data or information for performing medication, medicine, or drug, reconciliation.

The database 10H can also contain immunization data or information.

The database 10H can also contain educational or instructional information, links or hyperlinks to same, information regarding instructions or procedures, or links or hyperlinks to same, in order to allow for the providing of patient-specific educational or instructional information or resources to patients or individuals, as well as to any of the herein-described healthcare providers, other providers, payers or insurers, or intermediaries or caregivers.

The database 10H can also contain data or information necessary or desired for administering employee benefits for any of the individuals or patients who utilize the apparatus 100 and method of the present invention.

The database 10H can also contain data or information necessary or desired for purchasing or enrolling in employee benefits for any of the individuals or patients who utilize the apparatus 100 and method of the present invention.

The database 10H can also contain data or information necessary or desired for allowing any individual or patient to make a request or a claim for, or pursuant to, or to file a request or a claim for, an employee benefit or employee benefits, for any of the individuals or patients who utilize the apparatus 100 and method of the present invention.

The database 10H can also contain data or information for facilitating, or for providing for, the portability of healthcare insurance or health insurance benefits, life insurance or life insurance benefits, or disability insurance or disability insurance benefits, or for providing for the portability of any other employee benefit or employee benefits.

The database 10H can also contain any of the messages or reports described herein as being generated by or provided by the apparatus 100 and method of the present invention, for later use by any provider, insurer, payer, patient, individual, or intermediary, or any other person or entity, described herein as being able to utilize the apparatus 100 and method of the present invention.

The database 10H can also contain any data, information, or software, for performing any of the processing routines or functionality described herein as being capable of being performed by, or provided by, the apparatus 100 of the present invention.

The data and/or information which is contained and/or stored in the database 10H as well as any of the other databases 20H, 30H, 40, and 50H, described herein can be obtained from the various patients, individuals, providers, payers, and/or intermediaries, who or which utilize and/or who or which are serviced by the present invention. For example, the respective patients, providers, payers, intermediaries, and/or other users, could fill out questionnaires, forms, narratives, claim forms, and/or any other information medium, in written form, electronically, and/or otherwise.

Data and/or information stored in the database 10H as well as any of the other databases described herein can be updated by multiple parties. For example, a patient may provide a medical history for his or her individual file, his or her medical doctor can update the medical history information for the patient upon examining and/or treating him or her. The payer may also update the file with any associated payment or payment-related information. Should the patient go to another doctor or different type of doctor, all previous information would be available for, and can be updateable by, the next doctor.

The database 10H can also contain information regarding alternate medicine techniques, herbal techniques, meditation techniques, exercise techniques, self healing, faith healing, and/or other non-medicine treatments and/or techniques.

The database 10H can also include statistical data and/or information regarding diagnoses, and/or alternate diagnoses, treatment success, treatment failure, as well as statistical data and/or information regarding misdiagnoses. The database 10H also contains data and/or information regarding experimental treatments as well as statistical information regarding same, successes of same and failures of same.

The database 10H can also contain any other data and/or information, including software for performing any and all of the operations, routines, processing routines, and other functions and/or functionality described herein as being capable of being performed by the apparatus 100, the central processing computer(s) 10 and any of the herein-described provider communication device(s) 20, payer communication device(s) 30, user or patient communication device(s) 40, intermediary communication device(s) 50, healthcare records computer(s) 60, insurance exchange computer(s) 70, social networking computer(s) 80, and/or media computer(s) 90.

The database 10H can also contain any and/or all of the herein-described information for providing electronic veterinary healthcare records or filed (EVHRs) which can be used for maintaining healthcare records or file for any types or kinds of animals, high value animals, exotic animals, pet of any kind or type, or any other types or kinds of animals. For example, electronic veterinary healthcare records or files can be maintained and used for race horses, circus animals, animals used in shows, service animals, animals used for breeding, household pets, dogs, cats, fish, birds, mammals of any kind or types, birds of any kinds or types, and/or any other animal for which an owner, caregiver, or other responsible person or entity, may find it desirable or necessary to keep a healthcare record or file. In a preferred embodiment, the database 10H can also contain, any of the data and/or information, or any analogous data and/or information, described herein as being stored or contained in the database 10H, for any animal for which an electronic veterinary healthcare record or file is maintained.

It is important to note that the apparatus 100 and method of the present invention can be utilized, in any and or all of the embodiments described herein, in order to process and/or to provide veterinary healthcare information and/or veterinary healthcare-related information for and regarding any kind or type of animal or animals. In this regard, when used in veterinary applications, the terms “individual”, “patient”, “client”, “user” or the like, or their plural forms, also refer to any of the herein-described animals or pets or any other animals or pets.

The database 10H can also contain any data and/or information, as well as any links or hyperlinks to any of the herein-described provider communication device(s) 20, payer communication device(s) 30, user or patient communication device(s) 40, intermediary communication device(s) 50, healthcare records computer(s) 60, insurance exchange computer(s) 70, social networking computer(s) 80, and/or media computer(s) 90 described herein as being used in connection with the present invention, and/or can contain data and/or information and/or links or hyperlinks to any data and/or information located or stored on, at, or in any of the provider communication device(s) 20, payer communication device(s) 30, user or patient communication device(s) 40, intermediary communication device(s) 50, healthcare records computer(s) 60, insurance exchange computer(s) 70, social networking computer(s) 80, and/or media computer(s) 90 described herein.

The database 10H can also contain information, links and/or hyperlinks, to any social networking web sites, web pages, support groups, on-line forums, on-link information services, as well as social networking web sites or social networking web pages to or for social networking members, support groups, information providers, healthcare providers, as well as any of the providers, insurers, payers, individuals, patient, third parties, intermediaries, or any other persons or entities described herein who are or who may be members of any social network.

The database 10H can also contain data and/or information regarding any animals or pets associated with any individual, patient, or caregiver as well as any data and/or information regarding any electronic healthcare record for respective animal or pet.

The database 10H can also contain, for each or any of the herein-described individuals, patients, or caregiver, or for each provider or payer or insurer of a respective individual, patient, or caregiver, financial information regarding insurance premiums or payments, or premiums or payments for an insurer or payer policy, plan or program, which are or were made by or on behalf of the individual, patient, or caregiver, any and/or any insurance claim(s) or request(s) for payment(s) made by or on behalf of the individual, patient, or caregiver, provider bills or provider charges submitted in an insurance claim or a request for payment, provider amounts or provider charges billed for goods, products, or services, amounts paid by an insurer or payer for the amounts billed or charged by a provider, amounts paid or amounts of co-payments paid by or on behalf of the individual, patient, or caregiver, for the amounts billed, deductibles paid by or on behalf of the individual, patient or caregiver, and/or any other data and/or information regarding charges, bills, insurance claims, requests for payments, amounts paid by insurers or payers, and/or any amounts paid by or on behalf of the respective individual, patient, or caregiver.

The database 10H can also contain, for each individual, patient, or caregiver, any data and/or information regarding any vehicle(s) owned or operated by the individual, patient, or caregiver, along with data and/or information, and/or a link(s) or hyperlink(s) to any manufacturer of the vehicle or to any telematics, on-line service provider, or other services provider for the vehicle, such as for example, a telematics, on-line services provider, or other services provider who or which provides products and services such as those offered and provided in connection with automobiles and other motor vehicles as of the filing data of this application.

In any and/or all of the embodiments described herein, any of the data and/or information which is or which may be stored in the database 10H, and/or any of the other databases described herein, can be utilized and/or can appear in any of the reports, diagnostic reports, treatment reports, evaluation reports, provider reports, payer reports, patient reports, training reports, and/or any other reports, described herein.

The central processing computer 10 also includes an output device 10I for output any data, information, report, etc., described herein. In the preferred embodiment, the output device 10I can be a printer, a display, a transmitter, a modem, and/or any other device which can be used to output data.

Any of the data and/or information for any of the patients, individuals, providers, payers, and/or intermediaries, can be updated by different parities and which such updated data and/or information being made available to other respective parties so as to provide and ensure comprehensive and up-to-date healthcare and healthcare-related information.

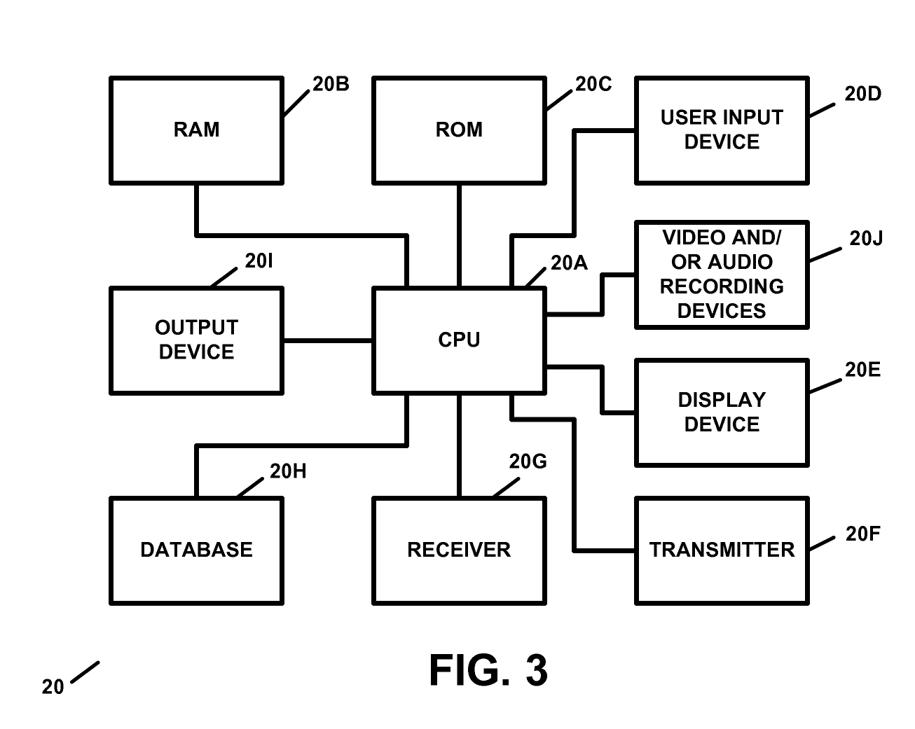

FIG. 3 illustrates the provider communication device 20, in block diagram form. The provider communication device 20, in the preferred embodiment, can be personal computer, a network computer or computer system, or any other computer or communication device, which is utilized as a provider computer 20. In the preferred embodiment, the provider communication device 20 includes a central processing unit or CPU 20A, which in the preferred embodiment, is a microprocessor. The CPU 20A may also be a microcomputer, a minicomputer, a macro-computer, and/or a mainframe computer, depending upon the application.

The provider communication device 20 also includes a random access memory device(s) 20B (RAM) and a read only memory device(s) 20C (ROM), each of which is connected to the CPU 20A, a user input device 20D, for entering data and/or commands into the provider communication device 20, which includes any one or more of a keyboard, a scanner, a user pointing device, such as, for example, a mouse, a touch pad, and/or an audio input device and/or a video input device, and/or any device, electronic and/or otherwise which can be utilized for inputting and/or entering healthcare data and/or information, for example pulse rate monitors, blood pressure monitors, electrocardiograms, blood-sugars monitors, etc., if desired, which input device(s) are also connected to the CPU 20A.

The user input device 20D can also acquire, receive, generate and/or provide, data which can be entered by a user or individual and/or can be a device which can acquire, receive, generate and/or provide, digital data such as medical, healthcare, bio-metric, physiological, and/or any other kind of healthcare data and/or healthcare-related data. For example, a user input device 20D can be a keyboard for allowing a user to input information into the provider communication device and/or a user input device can, for example, by a heart rate monitor or EKG machine which can receive information from a patient or individual and generate a digital signal, digital data, analog data, and/or any other signal, data, and/or information, which is representative of the patient's or individual's heart rate, pulse rate, and/or cardiac activity.

The user input device 20D can also be, or can include, any one or more of, and/or any combination of, a thermometer, a digital thermometer, a stethoscope, a heart rate monitor or measurement device, a pulse rate monitor or measurement device, a blood pressure monitor or measurement device, a blood pressure measurement device, blood analysis device or machine, a respirator, a respiration monitoring or measurement device, a dialysis machine, a dialysis device, electrocardiograph (EKG) machine or device, electrocephalograph (EEG) machine or device, electromyograph (EMG) machine or device, a magnetic resonance imaging (MRI) machine or device, X-ray machine or device, medical imaging machine or device, thermal imaging machine or device, a heart sound monitor or measurement device, a lung sound monitoring or measurement device, respiration rate monitoring or measurement device, a laprascopic device, an arthroscopic device, a vascular testing device, a catheter device, a cardiac performance testing, monitoring, or measurement device, a pulmonary performance testing, monitoring, or measurement device, a vascular system performance monitoring or measurement device, a vascular system testing, monitoring, or measurement device, a metabolism monitoring or measurement device, a sonogram imaging device, a sonogram measurement device, a sonograph device, an optical response device, an optical response measurement device, an intravenous device, an arterial blood pressure measurement or monitoring device, a respiration rate measurement or monitoring device, an ultrasound imaging device, an ultrasound measurement device, a CAT SCAN device, a PET scan device, an optical metabolism measurement or monitoring device, a radiotelemetric device, a doppler medical device, a mammogram device, a carbon dioxide detection or measurement device, a carbon monoxide detection or measurement device, a transvascular impedance measurement or monitoring device, an ultrasonic imaging device, a bone conduction device, a brain function scan analyzer device, external pulse cardiac monitoring or measurement device, a fetal heart rate measurement, monitoring, or probing, device, an endotrachial cardiac monitoring device, a finger tip blood pressure monitoring device, a psychological monitoring device, a surgical instrument, a vital signs measurement device, ear pressure regulating device, phonocardiograph device, acoustic aneurysm detector device, blood oxygen detection device, esophageal probing device, ultrasonic probing device, ausculoscope, vital signs monitoring system, heart activity monitoring device, pulmonary activity monitoring device, sphygmomanometer, esophageal stethoscope, venous pressure measuring device, differential doppler device, physiological data measuring device, body tissue movement device, breathalyzer device, camera probing device, microscopic camera probing device, any scope having a camera and/or a light, a laparoscopic device, a laparoscopic camera device, a camera used in or associated with equipment for performing visual probing of the body or any portions, parts, or organs, thereof, such as, but not limited to, a colonoscopy, an endoscopy, an esophagoscopy, a gastroscopy, or any devices used in laparoscopic surgery or other surgeries, an ingestible or implantable pill, capsule, or device, containing a camera and/or a light and equipment or circuitry for transmitting information as well as images to equipment inside or outside the body, and/or any other bio-metric or physiological data measuring device(s) and/or data acquisition device (hereinafter referred to generally or collectively as “healthcare equipment input device”, “healthcare measurement input device”, or “healthcare monitoring input device”).

The user input device 20D can also be, or can include, a pacemaker, a device for monitoring blood pressure or blood flow, or an ingestible or implantable pill, capsule, or device, containing a camera and/or a light and equipment or circuitry for transmitting information as well as images to equipment inside or outside the body.

The provider communication device 20 also includes a display device 20E for displaying data and/or information to a user or operator.

The provider communication device 20 also includes a transmitter(s) 20F, for transmitting signals and/or data and/or information to any one or more of the central processing computer(s) 10, any other provider communication device(s) 20, the communication device(s) 30, the user or patient communication device(s) 40, the intermediary computer(s) 50, the healthcare records computer(s) 60, the insurance exchange computer(s) 70, the social networking computer(s) 80, and/or the media computer(s) 90 described herein, which may be utilized in conjunction with the present invention. The provider communication device 20 also includes a receiver 20G, for receiving signals and/or data and/or information from any one or more of the central processing computer(s) 10, any other provider communication device(s) 20, the payer communication device(s) 30, the user or patient communication device(s) 40, the intermediary computer(s) 50, the healthcare records computer(s) 60, the insurance exchange computer(s) 70, the social networking computer(s) 80, and/or the media computer(s) 90 described herein, which may be utilized in conjunction with the present invention.

The provider communication device 20 also includes a database(s) 20H. The database 20H can contain and/or be linked to any of the data and/or information described herein as being stored in the database 10H.

The provider communication device 20 also includes an output device 20I for output any data, information, report, etc., described herein. In the preferred embodiment, the output device 20I can be a printer, a display, a transmitter, a modem, and/or any other device which can be used to output data.

The provider communication device 20 also includes a video and/or audio recording device(s) 20J which can include a camera and/or a video recording device for recording pictures or video and/or video clips and/or a microphone or an audio recording device for recording audio or audio clips which can be stored in any of the electronic healthcare, electronic medical, electronic dental, electronic pharmacy, and/or electronic behavioral healthcare, records or files described herein, and/or which can be otherwise used for communicating with other users, individuals, patients, providers, payers, or persons or entities who or which utilize the apparatus 100 and method of the present invention.

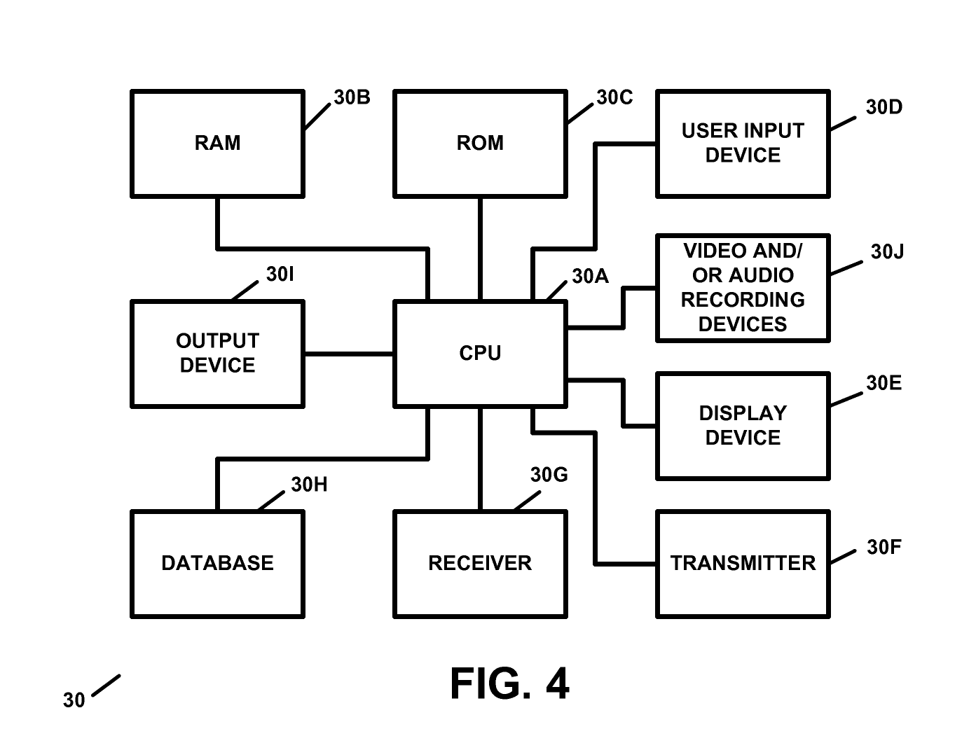

FIG. 4 illustrates the payer communication device 30, in block diagram form. The payer communication device 30, in the preferred embodiment, can be personal computer, a network computer or computer system, or any other computer or communication device, which is utilized as a payer computer 30. In the preferred embodiment, the payer communication device 30 includes a central processing unit or CPU 30A, which in the preferred embodiment, is a microprocessor. The CPU 30A may also be a microcomputer, a minicomputer, a macro-computer, and/or a mainframe computer, depending upon the application.

The payer communication device 30 also includes a random access memory device(s) 30B (RAM) and a read only memory device(s) 30C (ROM), each of which is connected to the CPU 30A, a user input device 30D, for entering data and/or commands into the payer communication device 30, which includes any one or more of a keyboard, a scanner, a user pointing device, such as, for example, a mouse, a touch pad, and/or an audio input device and/or a video input device, and/or any device, electronic and/or otherwise which can be utilized for inputting and/or entering healthcare data and/or information, for example pulse rate monitors, blood pressure monitors, electro-cardiograms, blood-sugars monitors, etc., if desired, which input device(s) are also connected to the CPU 30A. The payer communication device 30 also includes a display device 30E for displaying data and/or information to a user or operator.

The payer communication device 30 also includes a transmitter(s) 30F, for transmitting signals and/or data and/or information to any one or more of the central processing computer(s) 10, the provider communication device(s) 20, any other payer communication device(s) 30, the user or patient communication device(s) 40, and the intermediary computer(s) 50, the healthcare records computer(s) 60, the insurance exchange computer(s) 70, the social networking computer(s) 80, and/or the media computer(s) 90 described herein, which may be utilized in conjunction with the present invention. The payer communication device 30 also includes a receiver 30G, for receiving signals and/or data and/or information from any one or more of the central processing computer(s) 10, the provider communication device(s) 20, any other payer communication device(s) 30, the user or patient communication device(s) 40, the intermediary computer(s) 50, the healthcare records computer(s) 60, the insurance exchange computer(s) 70, the social networking computer(s) 80, and/or the media computer(s) 90 described herein, which may be utilized in conjunction with the present invention.

The payer communication device 30 also includes a database(s) 30H. The database 30H can contain and/or be linked to any of the data and/or information described herein as being stored in the database 10H.

The payer communication device 30 also includes an output device 30I for output any data, information, report, etc., described herein. In the preferred embodiment, the output device 30I can be a printer, a display, a transmitter, a modem, and/or any other device which can be used to output data.

The payer communication device 30 also includes a video and/or audio recording device(s) 30J which can include a camera and/or a video recording device for recording pictures or video and/or video clips and/or a microphone or an audio recording device for recording audio or audio clips which can be stored in any of the electronic healthcare, electronic medical, electronic dental, electronic pharmacy, and/or electronic behavioral healthcare, records or files described herein, and/or which can be otherwise used for communicating with other users, individuals, patients, providers, payers, or persons or entities who or which utilize the apparatus 100 and method of the present invention.

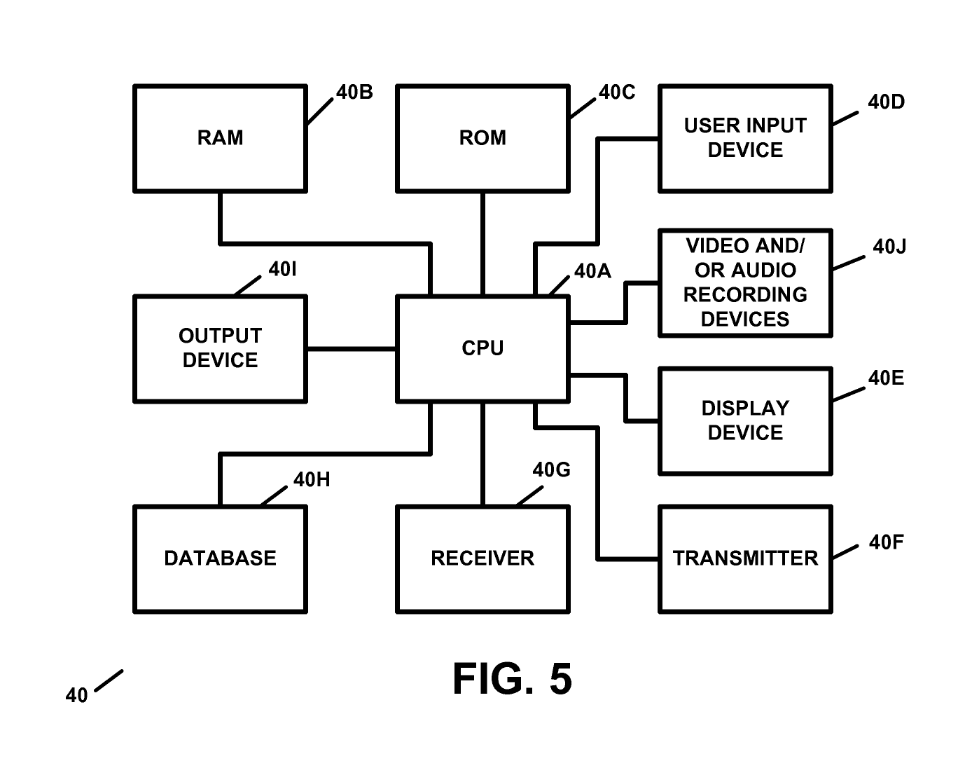

FIG. 5 illustrates the user or patient communication device 40, in block diagram form. The user or patient communication device 40, in the preferred embodiment, can be personal computer, a network computer or computer system, or any other computer or communication device, which is utilized as a patient computer. In the preferred embodiment, the user or patient communication device 40 includes a central processing unit or CPU 40A, which in the preferred embodiment, is a microprocessor. The CPU 40A may also be a microcomputer, a minicomputer, a macro-computer, and/or a mainframe computer, depending upon the application.

The user or patient communication device 40 also includes a random access memory device(s) 40B (RAM) and a read only memory device(s) 40C (ROM), each of which is connected to the CPU 40A, a user input device 40D, for entering data and/or commands into the user or patient communication device 40, which includes any one or more of a keyboard, a scanner, a user pointing device, such as, for example, a mouse, a touch pad, and/or an audio input device and/or a video input device, and/or any device, electronic and/or otherwise which can be utilized for inputting and/or entering healthcare data and/or information, for example pulse rate monitors, blood pressure monitors, electro-cardiograms, blood-sugars monitors, etc., if desired, which input device(s) are also connected to the CPU 40A.

The user input device 40D can also acquire, receive, generate and/or provide, data which can be entered by a user or individual and/or can be a device which can acquire, receive, generate and/or provide, digital data such as medical, healthcare, bio-metric, physiological, and/or any other kind of healthcare data and/or healthcare-related data. For example, a user input device 40D can be a keyboard for allowing a user to input information into the patient communication device and/or a user input device can, for example, by a heart rate monitor or EKG machine which can receive information from a patient or individual and generate a digital signal, digital data, analog data, and/or any other signal, data, and/or information, which is representative of the patient's or individual's heart rate, pulse rate, and/or cardiac activity.

The user input device 40D can also be, or can include, any one or more of, and/or any combination of, a thermometer, a digital thermometer, a stethoscope, a heart rate monitor or measurement device, a pulse rate monitor or measurement device, a blood pressure monitor or measurement device, a blood pressure measurement device, a blood analysis device or machine, a respirator, a respiration monitoring or measurement device, a dialysis machine, a dialysis device, electrocardiograph (EKG) machine or device, electrocephalograph (EEG) machine or device, electromyograph (EMG) machine or device, a magnetic resonance imaging (MRI) machine or device, X-ray machine or device, medical imaging machine or device, thermal imaging machine or device, a heart sound monitor or measurement device, a lung sound monitoring or measurement device, respiration rate monitoring or measurement device, a laprascopic device, an arthroscopic device, a vascular testing device, a catheter device, a cardiac performance testing, monitoring, or measurement device, a pulmonary performance testing, monitoring, or measurement device, a vascular system performance monitoring or measurement device, a vascular system testing, monitoring, or measurement device, a metabolism monitoring or measurement device, a sonogram imaging device, a sonogram measurement device, a sonograph device, an optical response device, an optical response measurement device, an intravenous device, an arterial blood pressure measurement or monitoring device, a respiration rate measurement or monitoring device, an ultrasound imaging device, an ultrasound measurement device, a CAT SCAN device, an optical metabolism measurement or monitoring device, a radiotelemetric device, a doppler medical device, a mammogram device, a carbon dioxide detection or measurement device, a carbon monoxide detection or measurement device, a transvascular impedance measurement or monitoring device, an ultrasonic imaging device, a bone conduction device, a brain function scan analyzer device, external pulse cardiac monitoring or measurement device, a fetal heart rate measurement, monitoring, or probing, device, an endotrachial cardiac monitoring device, a finger tip blood pressure monitoring device, a psychological monitoring device, a surgical instrument, a vital signs measurement device, ear pressure regulating device, phonocardiograph device, acoustic aneurysm detector device, blood oxygen detection device, esophageal probing device, ultrasonic probing device, ausculoscope, vital signs monitoring system, heart activity monitoring device, pulmonary activity monitoring device, sphygmomanometer, esophageal stethoscope, venous pressure measuring device, differential doppler device, physiological data measuring device, body tissue movement device, breathalyzer device, camera probing device, microscopic camera probing device, and/or any other bio-metric or physiological data measuring device(s) and/or data acquisition device data acquisition device (hereinafter referred to generally or collectively as “healthcare equipment input device”, “healthcare measurement input device”, or “healthcare monitoring input device”).

The user or patient communication device 40 also includes a display device 40E for displaying data and/or information to a user or operator.

The user or patient communication device 40 also includes a transmitter(s) 40F, for transmitting signals and/or data and/or information to any one or more of the central processing computer(s) 10, the provider communication device(s) 20, the payer communication device(s) 30, any other user or patient communication device(s) 40, and the intermediary computer(s) 50, the healthcare records computer(s) 60, the insurance exchange computer(s) 70, the social networking computer(s) 80, and/or the media computer(s) 90 described herein, which may be utilized in conjunction with the present invention. The user or patient communication device 40 also includes a receiver 40G, for receiving signals and/or data and/or information from any one or more of the central processing computer(s) 10, the provider communication device(s) 20, the payer communication device(s) 30, any other user or patient communication device(s) 40, the intermediary computer(s) 50, the healthcare records computer(s) 60, the insurance exchange computer(s) 70, the social networking computer(s) 80, and/or the media computer(s) 90 described herein, which may be utilized in conjunction with the present invention.

The user or patient communication device 40 also includes a database(s) 40H. The database 40H can contain and/or be linked to any of the data and/or information described herein as being stored in the database 10H.

The user or patient communication device 40 also includes an output device 40I for output any data, information, report, etc., described herein. In the preferred embodiment, the output device 40I can be a printer, a display, a transmitter, a modem, and/or any other device which can be used to output data.

The user or patient communication device 40 also includes a video and/or audio recording device(s) 40J which can include a camera and/or a video recording device for recording pictures or video and/or video clips and/or a microphone or an audio recording device for recording audio or audio clips which can be stored in any of the electronic healthcare, electronic medical, electronic dental, electronic pharmacy, and/or electronic behavioral healthcare, records or files described herein, and/or which can be otherwise used for communicating with other users, individuals, patients, providers, payers, or persons or entities who or which utilize the apparatus 100 and method of the present invention.

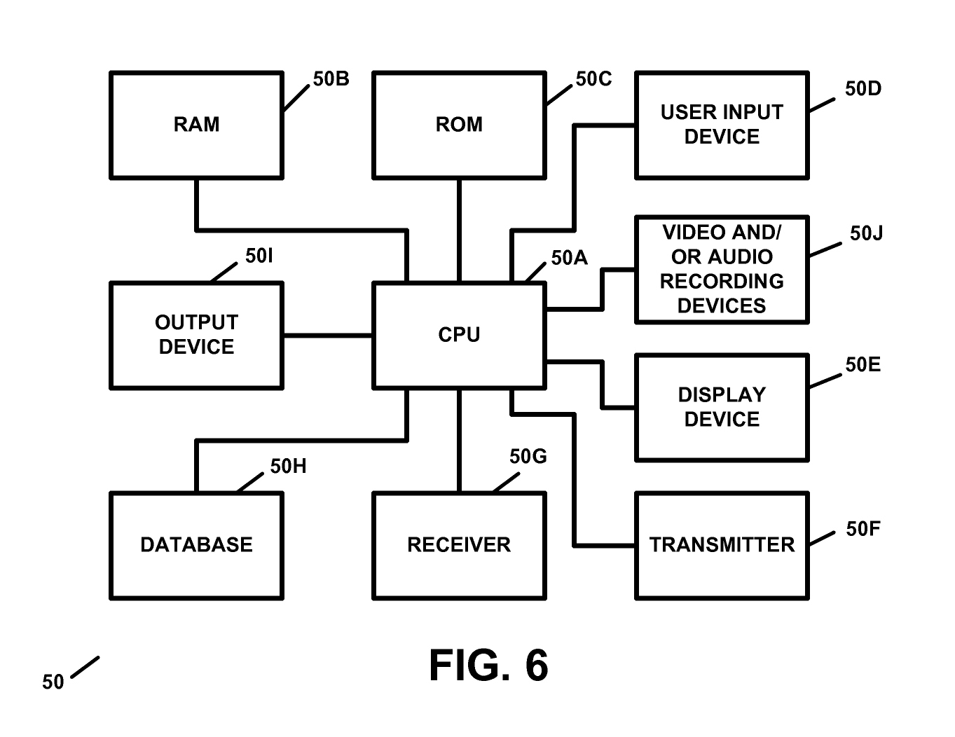

FIG. 6 illustrates the intermediary computer 50, in block diagram form. The intermediary computer 50, in the preferred embodiment, can be personal computer, a network computer or computer system, or any other computer or communication device, which is utilized as an intermediary computer 50. In the preferred embodiment, the intermediary computer 50 includes a central processing unit or CPU 50A, which in the preferred embodiment, is a microprocessor. The CPU 50A may also be a microcomputer, a minicomputer, a macro-computer, and/or a mainframe computer, depending upon the application.

The intermediary computer 50 also includes a random access memory device(s) 50B (RAM) and a read only memory device(s) 50C (ROM), each of which is connected to the CPU 50A, a user input device 50D, for entering data and/or commands into the intermediary computer 50, which includes any one or more of a keyboard, a scanner, a user pointing device, such as, for example, a mouse, a touch pad, and/or an audio input device and/or a video input device, and/or any device, electronic and/or otherwise which can be utilized for inputting and/or entering healthcare data and/or information, for example pulse rate monitors, blood pressure monitors, electrocardiograms, blood-sugars monitors, etc., if desired, which input device(s) are also connected to the CPU 50A. The intermediary computer 50 also includes a display device 50E for displaying data and/or information to a user or operator.

The intermediary computer 50 also includes a transmitter(s) 50F, for transmitting signals and/or data and/or information to any one or more of the central processing computer(s) 10, the provider communication device(s) 20, the payer communication device(s) 30, the user or patient communication device(s) 40, any other intermediary computer(s) 50, the healthcare records computer(s) 60, the insurance exchange computer(s) 70, the social networking computer(s) 80, and/or the media computer(s) 90 described herein, which may be utilized in conjunction with the present invention. The intermediary computer 50 also includes a receiver 50G, for receiving signals and/or data and/or information from any one or more of the central processing computer(s) 10, the provider communication device(s) 20, the payer communication device(s) 30, the user or patient communication device(s) 40, any other intermediary computer(s) 50, the healthcare records computer(s) 60, the insurance exchange computer(s) 70, the social networking computer(s) 80, and/or the media computer(s) 90 described herein, which may be utilized in conjunction with the present invention. which may be utilized in conjunction with the present invention.

The intermediary computer 50 also includes a database(s) 50H. The database 50H can contain and/or be linked to any of the data and/or information described herein as being stored in the database 10H.

The intermediary communication device 50 also includes an output device 50I for output any data, information, report, etc., described herein. In the preferred embodiment, the output device 50I can be a printer, a display, a transmitter, a modem, and/or any other device which can be used to output data.

The intermediary communication device 50 also includes a video and/or audio recording device(s) 50J which can include a camera and/or a video recording device for recording pictures or video and/or video clips and/or a microphone or an audio recording device for recording audio or audio clips which can be stored in any of the electronic healthcare, electronic medical, electronic dental, electronic pharmacy, and/or electronic behavioral healthcare, records or files described herein, and/or which can be otherwise used for communicating with other users, individuals, patients, providers, payers, or persons or entities who or which utilize the apparatus 100 and method of the present invention.

In any and/or all of the embodiments described herein, any one of the central processing computers 10, the provider communication devices 20, the payer communication devices 30, the patient communication devices 40, and/or the intermediary communication devices 50, can include input devices (not shown) for facilitating the data entry of a patients vital signs and or other medical data such as, but not limited to, pulse rate, blood pressure, blood-sugar level, etc., and any other data and or information which can be input into the repective computer and/or communication device and be transmitted to the central processing computer consistent with the utilization of the present invention as described herein.

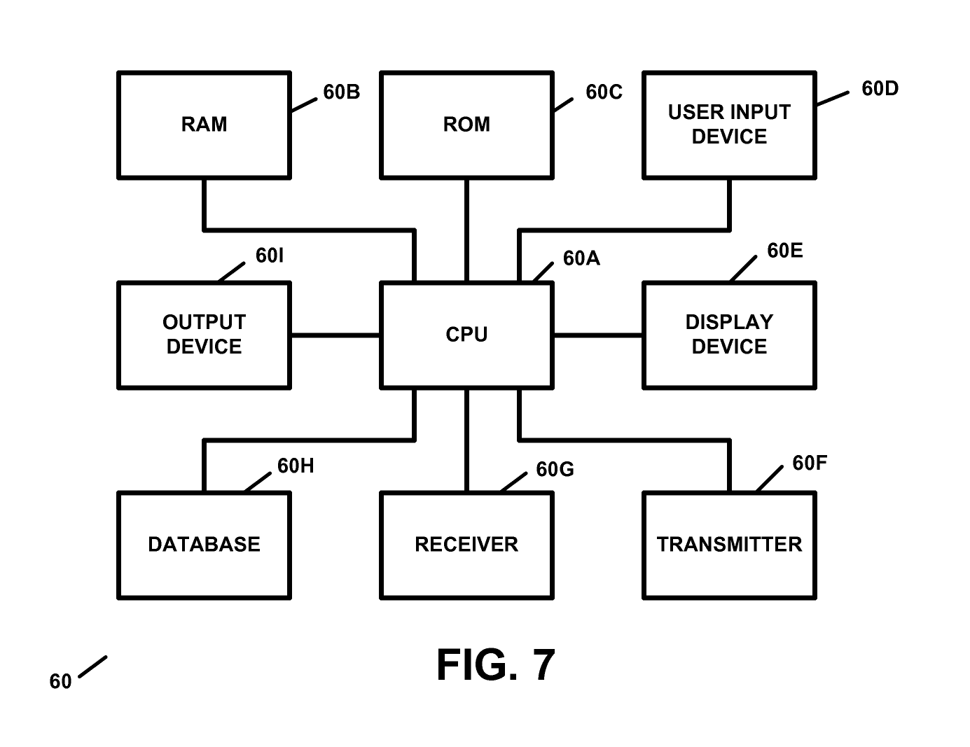

FIG. 7 illustrates the healthcare records computer 60, in block diagram form. The healthcare records computer 60, in the preferred embodiment, can be server computer or server computer system, a cloud computer or cloud computer system, a network computer or computer system, a personal computer or any other computer or communication device, or any cellular telephone, tablet, personal digital assistant, wireless communication device or wireless computer, or any other communication device, which is utilized to store an electronic healthcare record, an electronic medical record, an electronic dental record, an electronic pharmacy record, or an electronic behavioral healthcare record or any one or any number of electronic healthcare records, electronic medical records, electronic dental records, electronic pharmacy records, and/or electronic behavioral healthcare records. In a preferred embodiment, the healthcare records computer 60 can be any computer or computer system for storing any an electronic healthcare record, an electronic medical record, an electronic dental record, an electronic pharmacy record, or an electronic behavioral healthcare record which is store somewhere else other than the central processing computer. The healthcare records computer 60 can be used by, maintained by, or associated with any individual, provider, user, patient, payer, intermediary, or any other entity or third party.

In the preferred embodiment, the healthcare records computer 60 includes a central processing unit or CPU 60A, which in the preferred embodiment, is a microprocessor. The CPU 60A may also be a microcomputer, a minicomputer, a macro-computer, and/or a mainframe computer, depending upon the application.

The healthcare records computer 60 also includes a random access memory device(s) 60B (RAM) and a read only memory device(s) 60C (ROM), each of which is connected to the CPU 60A, a user input device 60D, for entering data and/or commands into the healthcare records computer 60, which includes any one or more of a keyboard, a scanner, a user pointing device, such as, for example, a mouse, a touch pad, and/or an audio input device and/or a video input device, and/or any device, electronic and/or otherwise which can be utilized for inputting and/or entering healthcare data and/or information which input device(s) are also connected to the CPU 60A. The healthcare records computer 60 also includes a display device 60E for displaying data and/or information to a user or operator.

The healthcare records computer 60 also includes a transmitter(s) 60F, for transmitting signals and/or data and/or information to any one or more of the central processing computer(s) 10, the provider communication device(s) 20, the payer computers(s) 30, the user or patient communication device(s) 40, and the intermediary computer(s) 50, any other healthcare records computer(s) 60, the insurance exchange computer(s) 70, the social networking computer(s) 80, and/or the media computer(s) 90 described herein, which may be utilized in conjunction with the present invention. The healthcare records computer 60 also includes a receiver 60G, for receiving signals and/or data and/or information from any one or more of the central processing computer(s) 10, the provider communication device(s) 20, the payer computers(s) 30, the user or patient communication device(s) 40, the intermediary computer(s) 50, any other healthcare records computer(s) 60, the insurance exchange computer(s) 70, the social networking computer(s) 80, and/or the media computer(s) 90 described herein, which may be utilized in conjunction with the present invention.

The healthcare records computer 60 also includes a database(s) 60H. The database 60H can contain and/or be linked to any of the data and/or information described herein as being stored in the database 10H and can also contain any data and/or information regarding and including any of the of electronic healthcare records, electronic medical records, electronic dental records, electronic pharmacy records, and/or electronic behavioral healthcare records which are stored in the healthcare records computer 60.

The healthcare records computer 60 also includes an output device 60I for output any data, information, report, etc., described herein. In the preferred embodiment, the output device 60I can be a printer, a display, a transmitter, a modem, and/or any other device which can be used to output data.

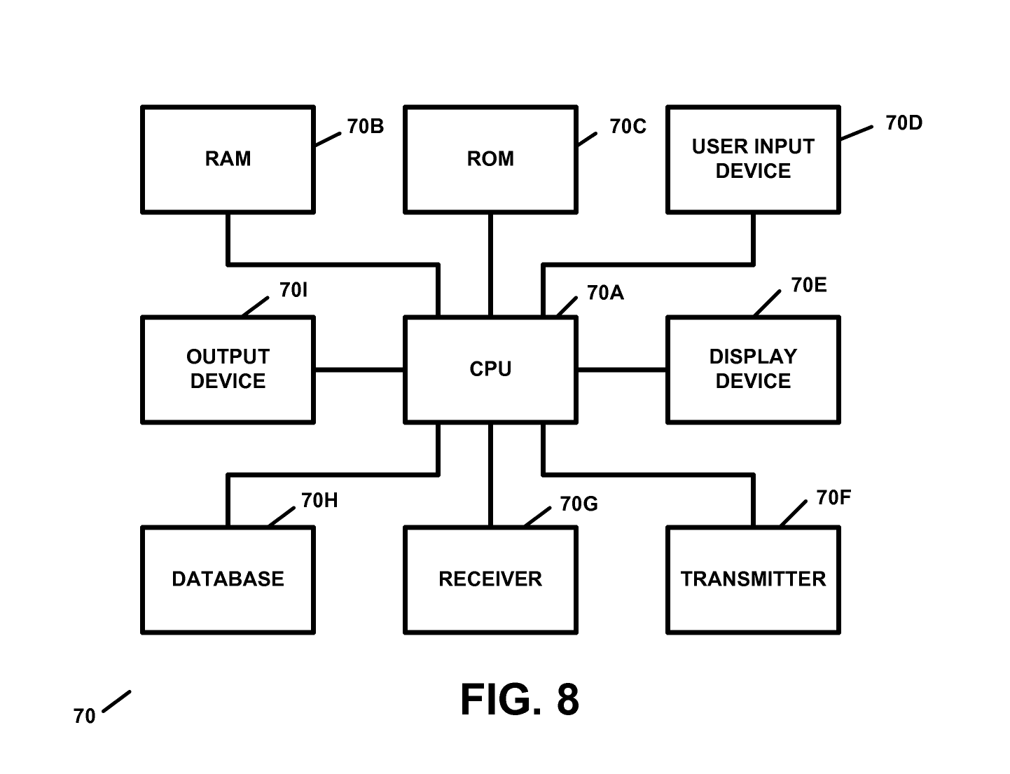

FIG. 8 illustrates the insurance exchange computer 70, in block diagram form. The insurance exchange computer 70, in the preferred embodiment, can be server computer or server computer system, a cloud computer or cloud computer system, a network computer or computer system, a personal computer or any other computer or communication device, or any cellular telephone, tablet, personal digital assistant, wireless communication device or wireless computer, or any other communication device, which is utilized to function as an insurance exchange computer 70. In a preferred embodiment, the insurance exchange computer 70 can be any computer or computer system for providing the functionality described herein as being provided by the insurance exchange computer 70.

The insurance exchange computer 70 can be used by, maintained by, or associated with any provider of any of the herein-described insurance policies, products, or services, described herein as being provided via the apparatus 100 and method of the present invention.

In the preferred embodiment, the insurance exchange computer 70 includes a central processing unit or CPU 70A, which in the preferred embodiment, is a microprocessor. The CPU 70A may also be a microcomputer, a minicomputer, a macro-computer, and/or a mainframe computer, depending upon the application.

The insurance exchange computer 70 also includes a random access memory device(s) 70B (RAM) and a read only memory device(s) 70C (ROM), each of which is connected to the CPU 70A, a user input device 70D, for entering data and/or commands into the insurance exchange computer 70, which includes any one or more of a keyboard, a scanner, a user pointing device, such as, for example, a mouse, a touch pad, and/or an audio input device and/or a video input device, and/or any device, electronic and/or otherwise which can be utilized for inputting and/or entering data and/or information which input device(s) are also connected to the CPU 70A. The insurance exchange computer 70 also includes a display device 70E for displaying data and/or information to a user or operator.

The insurance exchange computer 70 also includes a transmitter(s) 70F, for transmitting signals and/or data and/or information to any one or more of the central processing computer(s) 10, the provider communication device(s) 20, the payer communication device(s) 30, the user or patient communication device(s) 40, and the intermediary computer(s) 50, the healthcare records computer(s) 60, any other insurance exchange computer(s) 70, the social networking computer(s) 80, and/or the media computer(s) 90 described herein, which may be utilized in conjunction with the present invention. The insurance exchange computer 70 also includes a receiver 70G, for receiving signals and/or data and/or information from any one or more of the central processing computer(s) 10, the provider communication device(s) 20, the payer communication device(s) 30, the user or patient communication device(s) 40, the intermediary computer(s) 50, the healthcare records computer(s) 60, any other insurance exchange computer(s) 70, the social networking computer(s) 80, and/or the media computer(s) 90 described herein, which may be utilized in conjunction with the present invention.

The insurance exchange computer 70 also includes a database(s) 70H. The database 70H can contain and/or be linked to any of the data and/or information described herein as being stored in the database 10H and can also contain any data and/or information regarding and including any of the various insurance policies, products, or service, which can be offered for sale by the insurance exchange computer 70, as well as any data and/or information regarding insured individuals or entities, their insurance policies, products, and/or services, claims made, claims paid, and any other records typically stored or maintained by an insurance company computer, an insurance exchange computer, an electronic commerce computer or any other data and/or information for providing any of the functions or functionality described herein as being performed by the insurance exchange computer 70.

The insurance exchange computer 70 also includes an output device 70I for output any data, information, report, etc., described herein. In the preferred embodiment, the output device 70I can be a printer, a display, a transmitter, a modem, and/or any other device which can be used to output data.

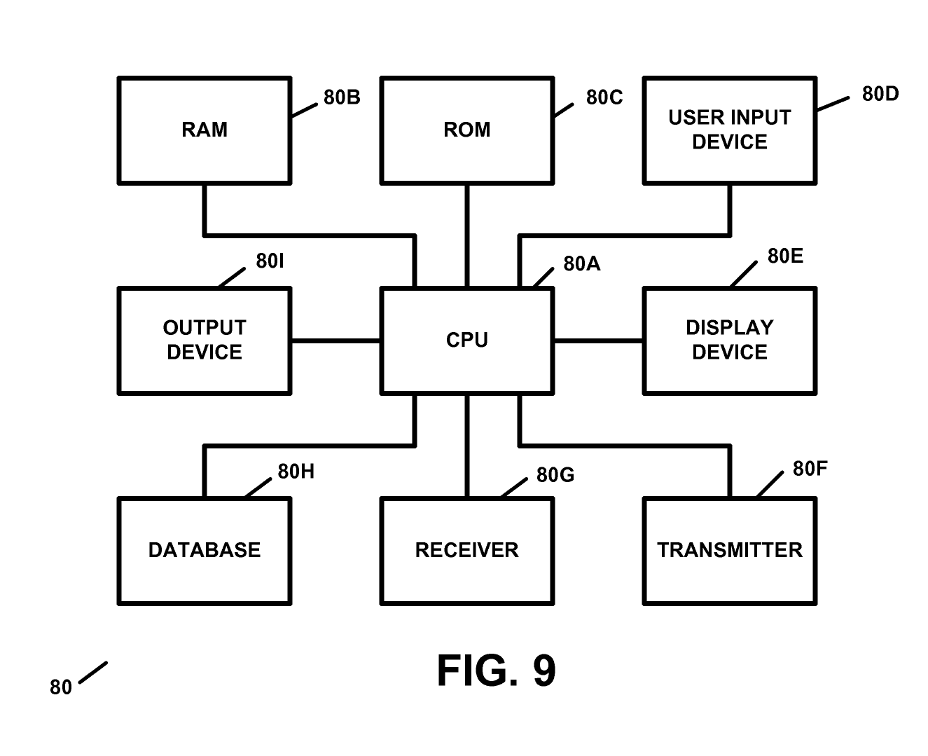

FIG. 9 illustrates the social networking computer 80, in block diagram form. The social networking computer 80, in the preferred embodiment, can be any social networking computer or computer system or any computer or computer system used by or associated with any social networking company or social networking website, or can be any suitable server computer or server computer system, a cloud computer or cloud computer system, a network computer or computer system, a personal computer or any other computer or communication device, or any cellular telephone, tablet, personal digital assistant, wireless communication device or wireless computer, or any other communication device, which is utilized to function as a social networking computer 80. In a preferred embodiment, the social networking computer 80 can be any computer of computer system for providing the functionality described herein as being provided by the social networking computer 80 or any social networking computer or website.

The social networking computer 80 can be used by, maintained by, or associated with social networking company, website, or other entity and can provide any of the herein-described social networking information, activities, and/or functionality, described herein as being provided via the apparatus 100 and method of the present invention and which can be provided by any social networking company, website, or other entity.

In the preferred embodiment, the social networking computer 80 includes a central processing unit or CPU 80A, which in the preferred embodiment, is a microprocessor. The CPU 80A may also be a microcomputer, a minicomputer, a macro-computer, and/or a mainframe computer, depending upon the application.

The social networking computer 80 also includes a random access memory device(s) 80B (RAM) and a read only memory device(s) 80C (ROM), each of which is connected to the CPU 80A, a user input device 80D, for entering data and/or commands into the social networking computer 80, which includes any one or more of a keyboard, a scanner, a user pointing device, such as, for example, a mouse, a touch pad, and/or an audio input device and/or a video input device, and/or any device, electronic and/or otherwise which can be utilized for inputting and/or entering data and/or information which input device(s) are also connected to the CPU 80A. The social networking computer 80 also includes a display device 80E for displaying data and/or information to a user or operator.

The social networking computer 80 also includes a transmitter(s) 80F, for transmitting signals and/or data and/or information to any one or more of the central processing computer(s) 10, the provider communication device(s) 20, the payer communication device(s) 30, the user or patient communication device(s) 40, and the intermediary computer(s) 50, the healthcare records computer(s) 60, the insurance exchange computer(s) 70, any other social networking computer(s) 80, and/or the media computer(s) 90 described herein, which may be utilized in conjunction with the present invention. The social networking computer 80 also includes a receiver 80G, for receiving signals and/or data and/or information from any one or more of the central processing computer(s) 10, the provider communication device(s) 20, the payer communication device(s) 30, the user or patient communication device(s) 40 the intermediary computer(s) 50, the healthcare records computer(s) 60, the insurance exchange computer(s) 70, any other social networking computer(s) 80, and/or the media computer(s) 90 described herein, which may be utilized in conjunction with the present invention.

The social networking computer 80 also includes a database(s) 80H. The database 80H can contain and/or be linked to any of the data and/or information described herein as being stored in the database 10H and can also contain any data and/or information typically found in or utilized by a social networking computer or any members of the social network serviced thereby as well as any data and/or information typically utilized in providing or performing the functionality and/or services provided or offered by the social network associated with the social networking computer 80.

The social networking computer 80 also includes an output device 80I for output any data, information, report, etc., described herein. In the preferred embodiment, the output device 80I can be a printer, a display, a transmitter, a modem, and/or any other device which can be used to output data.

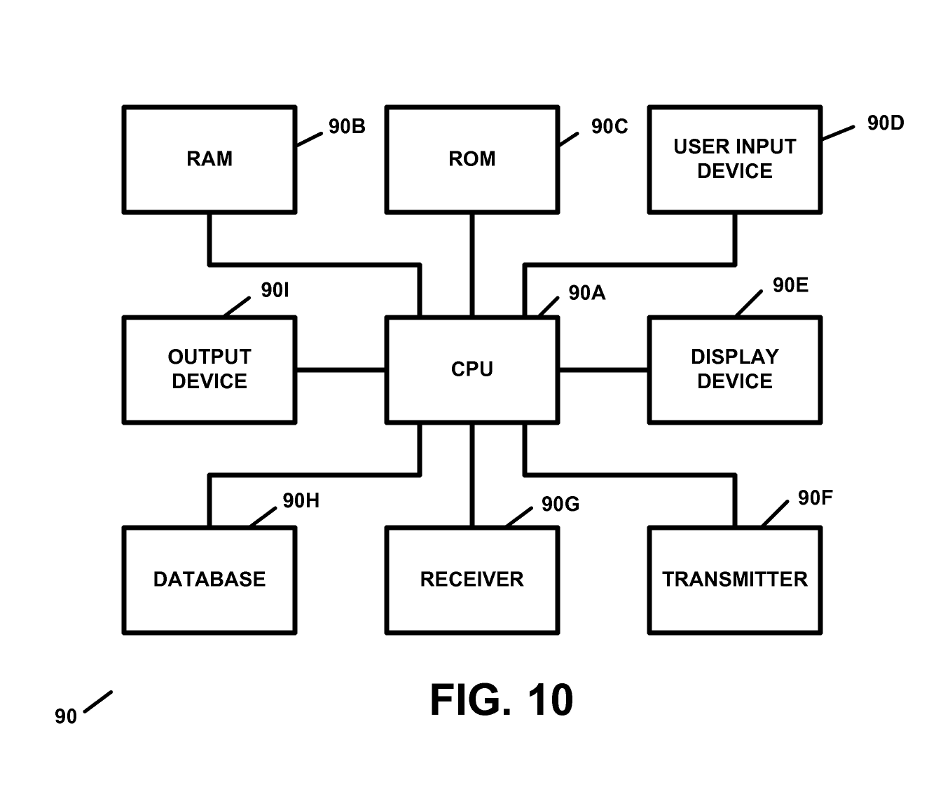

FIG. 10 illustrates the media computer 90, in block diagram form. The media computer 90, in the preferred embodiment, can be any computer or computer system used by or associated with any news information source, individual, company, or entity, any external information source, individual, company, or entity, any advertiser or advertisement source, individual, company or entity, or any marketing materials source, individual, company, or entity.

The media computer 90 can be any computer or computer system which can provide, to any of the herein-described users, individuals, patients, providers, payers, intermediaries, third parties, and/or entities who or which utilized the apparatus 100 and method of the present invention, any news, information, advertisements, or marketing materials, of any kind, nature, or type, which can include, but which is not limited to, any healthcare or healthcare-related news, information, advertisements, or marketing materials, any fitness or fitness-related news, information, advertisements, or marketing materials, any wellness or wellness-related news, information, advertisements, or marketing materials, as well as any non-healthcare or non-healthcare-related news, information, advertisements, or marketing materials. The media computer 90 provides news, information, advertisements, or marketing materials, via the apparatus 100 and method of the present invention. In a preferred embodiment, the media computer 90 can be any computer or computer system for providing the functionality described herein as being provided by the media computer 90.

The media computer 90 can be used by, maintained by, or associated with a media company or entity, a news service, information source or service, an advertiser, an advertisement company, agency, or entity, a marketer, a marketing company or entity, or any individual providing a media, news, information, advertisements, or marketing materials of or on behalf of themselves or another, The media computer 90 can provide any of the herein-described media, news, information, advertisements, or marketing materials, and/or any other information and/or can provide any of the functionality described herein as being provided via the apparatus 100 and method of the present invention.

In the preferred embodiment, the media computer 90 includes a central processing unit or CPU 90A, which in the preferred embodiment, is a microprocessor. The CPU 90A may also be a microcomputer, a minicomputer, a macro-computer, and/or a mainframe computer, depending upon the application.

The media computer 90 also includes a random access memory device(s) 90B (RAM) and a read only memory device(s) 90C (ROM), each of which is connected to the CPU 90A, a user input device 90D, for entering data and/or commands into the media computer 90, which includes any one or more of a keyboard, a scanner, a user pointing device, such as, for example, a mouse, a touch pad, and/or an audio input device and/or a video input device, and/or any device, electronic and/or otherwise which can be utilized for inputting and/or entering data and/or information which input device(s) are also connected to the CPU 90A. The media computer 90 also includes a display device 90E for displaying data and/or information to a user or operator.

The media computer 90 also includes a transmitter(s) 90F, for transmitting signals and/or data and/or information to any one or more of the central processing computer(s) 10, the provider communication device(s) 20, the payer communication device(s) 30, the user or patient communication device(s) 40, and the intermediary computer(s) 50, the healthcare records computer(s) 60, the insurance exchange computer(s) 70, the social networking computer(s) 80, and/or any other media computer(s) 90 described herein, which may be utilized in conjunction with the present invention. The media computer 90 also includes a receiver 90G, for receiving signals and/or data and/or information from any one or more of the central processing computer(s) 10, the provider communication device(s) 20, the payer communication device(s) 30, the user or patient communication device(s) 40 the intermediary computer(s) 50, the healthcare records computer(s) 60, the insurance exchange computer(s) 70, the social networking computer(s) 80, and/or any other media computer(s) 90 described herein, which may be utilized in conjunction with the present invention.

The media computer 90 also includes a database(s) 90H. The database 90H can contain and/or be linked to any of the data and/or information described herein as being stored in the database 10H and can also contain any data and/or information typically found in or utilized by a media computer as well as any of the respective media, news, information, advertisements, or marketing materials, and/or any data and/or information typically utilized in providing or performing the functionality and/or services provided or offered by the media computer 90.

The media computer 90 also includes an output device 90I for output any data, information, report, etc., described herein. In the preferred embodiment, the output device 90I can be a printer, a display, a transmitter, a modem, and/or any other device which can be used to output data.

The apparatus and method of the present invention can be utilized in numerous preferred embodiments in order to provide a vast array of healthcare and healthcare-related services for any one or more of the various parties described herein. While certain of the preferred embodiments may be described with regards to utilization by a particular party, it is important to note that any individual, patient, user, provider, payer, and/or intermediary or third party, may utilize the present invention in the same, similar and/or analogous manner. For example, a preferred embodiment for determining and/or ascertaining a medical diagnosis can be described as being utilized by a treating physician as well as be utilized by a provider to verify and/or check a diagnosis as well as by a patient or other user or individual in order to perform a self-diagnosis or double check a doctors diagnosis. In the same manner, any other preferred embodiment and/or other uses of the present invention can be utilized by any of the parties described herein.

In a preferred embodiment, the apparatus 100 of the present invention can be utilized to create and maintain a comprehensive and/or a centralized electronic healthcare record system. It is understood that different providers and insurers or payers might utilize or employ any number or types or kinds of electronic healthcare records, electronic medical records, electronic dental records, electronic pharmacy records, and/or electronic behavioral healthcare records, each of which may be located in or on different computers or located at different physical locations, and that any individual, patient, or user, may have a healthcare or healthcare-related record, a healthcare or healthcare-related file, or a healthcare or healthcare-related history, on any one or more of these separate electronic healthcare records, electronic medical records, electronic dental records, electronic pharmacy records, and/or electronic behavioral healthcare records. It is also understood that each individual or patient may also have a personal health record stored or located on his or her user or patient communication device 40.

In a preferred embodiment, any one or more of the healthcare records computers 60, can be associated with a different electronic healthcare record, electronic medical record, electronic dental record, electronic pharmacy record, and/or electronic behavioral healthcare record, or any number or combination of electronic healthcare records, electronic medical records, electronic dental records, electronic pharmacy records, and/or electronic behavioral healthcare records.

In a preferred embodiment, the database 10H can, for each individual or patient who utilize the apparatus 100 and method of the present invention, contain any number of electronic healthcare records, electronic medical records, electronic dental records, electronic pharmacy records, and/or electronic behavioral healthcare records, containing data and/or information regarding the individual or patient, and/or the database 10H can contain any number of links or hyperlinks to any number of electronic healthcare records, electronic medical records, electronic dental records, electronic pharmacy records, and/or electronic behavioral healthcare records, which are located on healthcare records computers 60, or on any other computers, or computer systems, which are separate and apart from the central processing computer 10 and which also contain data and/or information for or regarding the individual or patient.

In an preferred embodiment, and in instances where an individual's or patient's healthcare-related records, healthcare or healthcare-related files, or healthcare or healthcare-related histories, are stored and/or located in different or separate electronic healthcare records, electronic medical records, electronic dental records, electronic pharmacy records, and/or electronic behavioral healthcare records, or stored or located on different or separate computers or computer systems, including, but not limited to, the central processing computer 10, healthcare records computers 60, or any other computers or computer systems, the apparatus 100, and in particular, the database 10H or the central processing computer can also contain an master individual or patient index containing, for each individual or patient, the individual's or patient's name, address, social security number or other uniquely assigned identification number or identifying data or information, mother's maiden name, name of spouse or partner, name(s) of child, children or others for who the individual or patient is responsible for providing care legally or otherwise, each electronic healthcare records, electronic medical records, electronic dental records, electronic pharmacy records, and/or electronic behavioral healthcare records, containing data and/or information regarding the individual or patient, or in or on which the individual or patient has a record, file, history, or entry, and/or a link(s) or hyperlink(s) to each electronic healthcare records, electronic medical records, electronic dental records, electronic pharmacy records, and/or electronic behavioral healthcare records, containing data and/or information regarding the individual or patient, or in or on which the individual or patient has a record, file, history, or entry.

In a preferred embodiment, the apparatus 100 and method of the present invention can be utilized to provide for a comprehensive electronic healthcare record, file, or history, for each individual or patient as well as facilitates access to comprehensive healthcare or healthcare-related data and/or information for or regarding an individual or patient via the central processing computer 10. In a preferred embodiment, an individual's or patient's electronic healthcare record, file or history, can be contained in any number of electronic healthcare records, electronic medical records, electronic dental records, electronic pharmacy records, and/or electronic behavioral healthcare records, regardless of where each respective record is or may be stored.

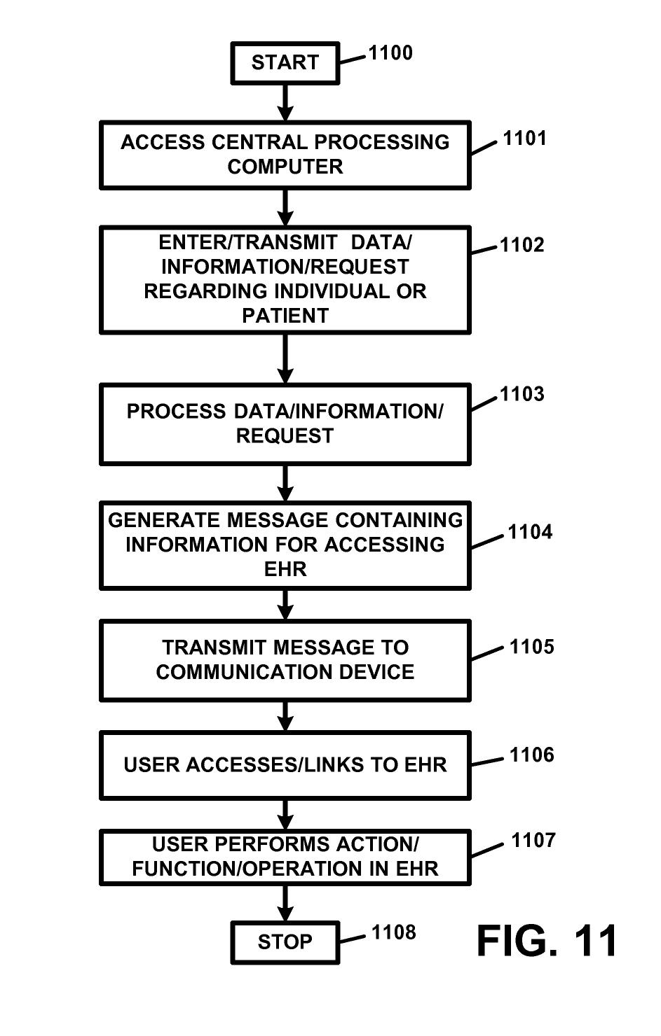

FIG. 11 illustrates a preferred embodiment method for utilizing the apparatus 100 and method of the present invention, in flow diagram form. In a preferred embodiment, any authorized user, individual, patient, provider, insurer, payer, or any authorized third party or authorized intermediary, can utilize the apparatus 100 of the present invention to access, view, change, alter, modify, or update, or make an entry or entries to, an individual's or patient's electronic healthcare record, file or history, regardless of where each component electronic healthcare record, electronic medical record, electronic dental record, electronic pharmacy record, and/or electronic behavioral healthcare record, is stored. For the sake of simplicity in describing this preferred embodiment of FIG. 11, the term “user” will be used to refer to any authorized user, individual, patient, caregiver, provider, insurer, payer, or any authorized third party or authorized intermediary, who or which uses the embodiment of FIG. 11.

With reference to FIG. 11, the operation of the apparatus 100 commences at step 1100. At step 1101, the user will access the central processing computer 10 using the user's respective communication device or computer 20, 30, 40, or 50. At step 1102, the user, who is seeking to access an individual's or patient's healthcare record, file, or history, will enter and transmit to the central processing computer 10 any data or information regarding the individual or patient and/or a request to access the healthcare, record, or history, of the individual or patient. At step 1103, the central processing computer 10 will receive and/or process the data or information, or the request.

At step 1104, the central processing computer 10 will generate a message containing information for accessing the individual's or patient's healthcare record, file, or history. In a preferred embodiment, the message can contain any number of links or hyperlinks to any and/or all of the electronic healthcare records, electronic medical records, electronic dental records, electronic pharmacy records, and/or electronic behavioral healthcare records, which contain data and/or information regarding the individual or patient, and/or any number of links or hyperlinks to any of the respective healthcare records computers 60 or other computers of computer systems on which any of the above-referenced electronic healthcare records, electronic medical records, electronic dental records, electronic pharmacy records, and/or electronic behavioral healthcare records, are stored.

At step 1105, the central processing computer 10 will transmit the message to the respective communication device or computer 20, 30, 40, or 50 being used by the user. Thereafter, the user, at step 1106, can access or link to the individual's or patient's healthcare record, file, or history, or can access or link to the pertinent or desired electronic healthcare records, electronic medical records, electronic dental records, electronic pharmacy records, and/or electronic behavioral healthcare records, or portion(s) of same containing data or information for or regarding individual or patient,

At step 1107, the user can perform any needed or desired action, function, or operation on or regarding, the individual's or patient's data and/or information. Thereafter, the operation of the apparatus 100 will cease at step 1108.

In a preferred embodiment, the user can access any one or more, or any and/or all of, the electronic healthcare records, electronic medical records, electronic dental records, electronic pharmacy records, and/or electronic behavioral healthcare records, or portion(s) of same which contain data or information for or regarding individual or patient. In this regard, the apparatus 100 and method of the present invention can be utilized to provide a comprehensive healthcare record, file, or history, for an individual or patient by providing any and/or all healthcare or healthcare-related data and/or information, for or regarding an individual or patient, and/or any and/or all link(s) or hyperlink(s) to any and/or all of the electronic healthcare records, electronic medical records, electronic dental records, electronic pharmacy records, and/or electronic behavioral healthcare records, which contain any and/or all healthcare or healthcare-related data or information for or regarding individual or patient.

In another preferred embodiment, any individual, patient, user, provider, insurer or payer, or third party or intermediary, can create any link or hyperlink to any electronic healthcare record(s), electronic medical record(s), electronic dental record(s), electronic pharmacy record(s), and/or electronic behavioral healthcare record(s), which contain or which are to contain healthcare or healthcare-related data or information for or regarding any individual or patient.

In another preferred embodiment, the apparatus 100 and method of the present invention can be utilized in order to allow an individual or a patient, or one responsible for the care of an individual or patient, to enter notes, comments, or messages, regarding or relating to the individual or patient into one or more of any of the individual's or patient's electronic healthcare record(s), electronic medical record(s), electronic dental record(s), electronic pharmacy record(s), and/or electronic behavioral healthcare record(s). Any respective note, comment, or message can be in text form, audio form, or video form, and can contain information regarding a symptom, an illness, an experience, a treatment, a diagnosis, a treatment plan, an activity, a problem, a concern, a thought or an idea, a question, a question for a healthcare provider, or any other information which the individual or patient, or one caring for the individual or patient, may deem important to be recorded or noted in the respective electronic healthcare record(s), electronic medical record(s), electronic dental record(s), electronic pharmacy record(s), and/or electronic behavioral healthcare record(s), or which can be communicated to, or otherwise made available to, a provider or an insurer or payer.

In a preferred embodiment, a healthcare provider can access, obtain, and/or use the information provided or contained in the note, comment, or message, or provided or contained in multiple notes, comments, or messages, for any suitable purpose, such as, but not limited to, for preparing for or for use during an examination or an office visit, for use during an examination with the individual or patient or for use during a procedure and an administration of a treatment, for use during a conversation or telephone discussion with the individual or patient, for use during a consultation or discussion with the individual, patient, a family member or caregiver of the individual or patient, or another provider, or a payer or insurer or any third party or intermediary, for use during reviewing, updating, modifying, or performing any other activity in connection with, an individual's or patient's healthcare records, files, or histories, for use while making a diagnosis, for use while formulating a treatment or a treatment plan, for use in reviewing or evaluating an individual's or patient's diagnosis or treatment, for use in treatment planning and/or the evaluating of same, for use in care management, for use in monitoring or evaluating a recovery, for use in providing continuing or on-going care or treatment, for use in connection with the providing of a remote healthcare services or tele-health services, and/or for any other suitable use or purpose.

In a preferred embodiment, these notes, comments or messages, can be provided by the individual or patient, or by any person caring for the individual or patient while making an appointment, in advance of an office visit or an examination or procedure, in connection with any tele-health related activity, or for the purpose of making and entering a note, comment, or message, into the individual's or patient's respective electronic healthcare record(s), electronic medical record(s), electronic dental record(s), electronic pharmacy record(s), and/or electronic behavioral healthcare record(s). In this regard, the apparatus 100 and method of the present invention allows an individual or patient, or one responsible for caring for the individual or patient, to make and enter any notes, comments, or messages, into the individual's or patient's respective electronic healthcare record(s), electronic medical record(s), electronic dental record(s), electronic pharmacy record(s), and/or electronic behavioral healthcare record(s) so as to facilitate accurate and complete healthcare information record keeping.

In a preferred embodiment, any provider of an individual or patient, any insurer or payer of an individual or patient, any caregiver of an individual or patient, or any other authorized third party, intermediary, person, or entity, can also enter and store any note(s), comment(s), or message(s) in the individual's, patient's, or caregiver's, electronic healthcare record.

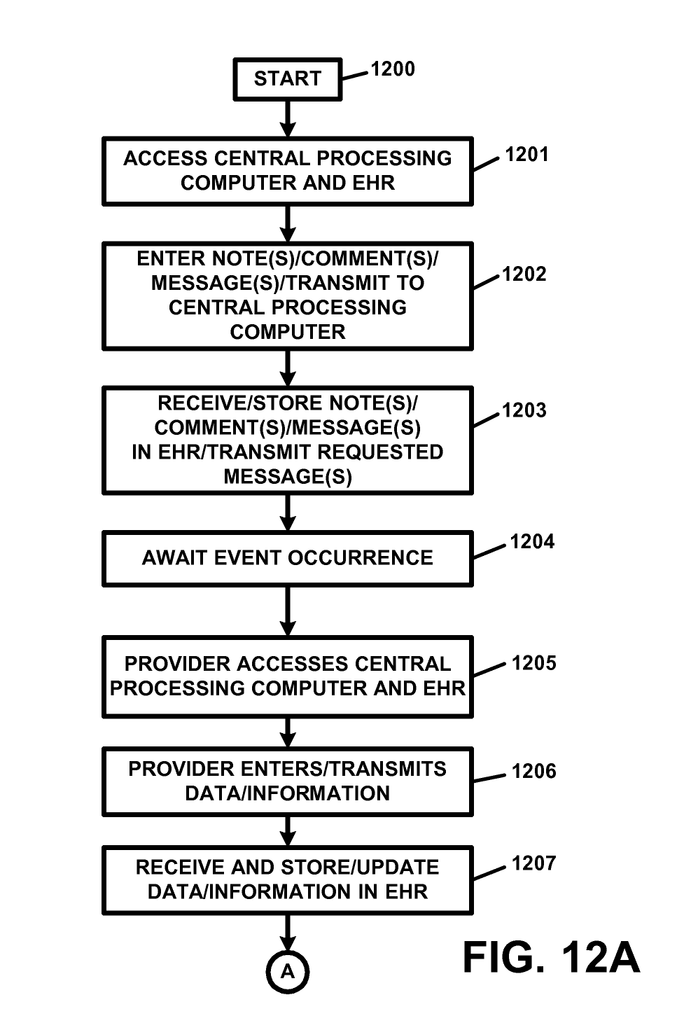

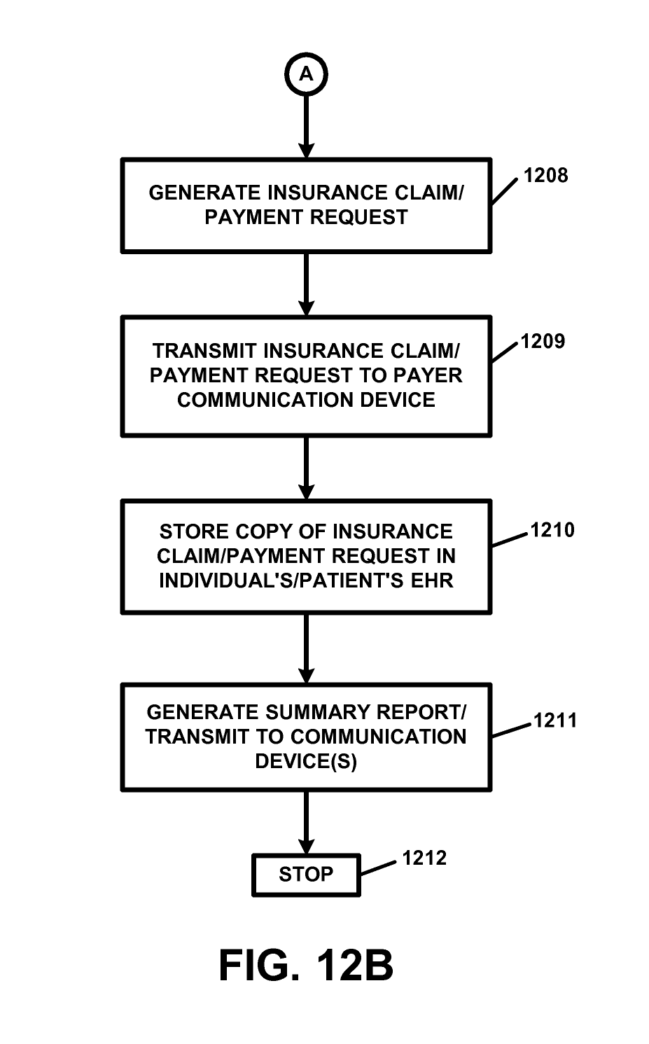

FIGS. 12A and 12B illustrate another preferred embodiment method for utilizing the apparatus 100 and method of the present invention, in flow diagram form. As an example, the embodiment of FIGS. 12A and 12B will be described as being used by an individual or patient to enter a note, comments, or a message, into his or her electronic healthcare record and that such note, comments, or message, cane be used by a healthcare provider in rendering or providing a healthcare service to or for the individual or patient. It is, however, important to note that the embodiment of FIGS. 12A and 12B can be used by any individual, patient, or any individual or user who is a spouse, family member, relative, friend, or any other person or entity or caregiver who is responsible for caring for, or who for providing care for the individual or patient. Further, it is also important to note that the embodiment of FIGS. 12A and 12B can be utilized by any other individual, user, caregiver or care provider, healthcare provider, provider, payer, insurer, third party, intermediary, or any other person or entity who or which provides case for or who provides any kind of service or services for the individual or patient.

With reference to FIGS. 12A and 12B, the operation of the apparatus 100 commences at step 1200. At step 1201, the individual or patient can access the central processing computer 10 and his or her electronic healthcare record via the user or patient communication device 40. At step 1202, the individual or patient can enter, and transmit to the central processing computer 10, any note(s), comment(s), or message(s) into his or her electronic healthcare record.

The note(s), comment(s), or message(s) can contain any information regarding the individual's or patient's state of health or well-being, an illness, a symptom, a sickness, a feeling of discomfort, notes, concerns, or questions for his or her provider, notes, concerns, or questions for or reasons for an upcoming provider appointment, examination, or procedure, notes regarding diet or food intake, notes regarding activities, or any other notes, comments, messages, or information which the individual or patient might desire to place into his or her electronic healthcare record. In a preferred embodiment, the note(s), comment(s), or message(s), can be entered as a text entry. In another preferred embodiment, the individual or patient, at step 1202, can also, or in addition to entering a text note, comment, or message, utilize any one or more of the microphone or audio recording device and/or the camera or video recording device associated with the user or patient communication device 40 in order to enter an audio message or a video or audio and video message.

At step 1202, the individual or patient can record an audio message or a video message, or provide a picture or a video clip, in addition to or instead of providing a text note, comment or message in any instances or for any reason. For example, the individual or patient may feel a need to provide a more in-depth explanation, provide a picture or video clip of a physical condition, provide an explanation while providing a picture or video clip to explain a condition, or for any reason whatsoever. At step 1202, the individual or patient can also request or instruct that his or her provider or providers, insurer(s) or payer(s), or caregiver(s), be notified of and/or be provided with the note(s), the comment(s), or the message(s). At step 1202, the respective note(s), comment(s), or message(s) along with any other information, requests, or instructions, can be transmitted to the central processing computer 10.

At step 1203, the central processing computer 10 can receive and/or store the note(s), comment(s), or message(s), in the individual's or patient's electronic healthcare record. At step 1203, the central processing computer 10 can also determine if the individual or patient requested or instructed that his or her provider or providers, insurer(s) or payer(s), or caregiver(s), be notified of and/or be provided with the note(s), the comment(s), or the message(s). If the central processing computer 10 determines that the individual or patient requested or instructed that his or her provider or providers, insurer(s) or payer(s), or caregiver(s), be notified of and/or be provided with the note(s), the comment(s), or the message(s), the central processing computer 10 will generate any and/or all notification or alert messages and transmit same to the respective provider communication device(s) 20, insurer or payer communication device(s) 30, or user or patient communications device(s) 40 used or associated with the caregiver(s).

A record or note of any such notification or alert message(s) being sent can also be recorded in the individual's or patient's electronic healthcare record and a confirmation message can be generated and sent to the individual's or patient's user or patient communication device in order to provide notification to the individual or patient that such notification or alert message(s) have indeed been sent as requested or instructed. Any and/or all of the notification or alert messages can be sent as any one or more of, or any combination of, an e-mail message, a text message, an SMS message, a telephone message, a facsimile message, or any other electronic transmission or message.

At step 1204, the apparatus 100 will await an occurrence of an event upon which the provider may access, or act on or regarding, the note(s), comment(s), or message(s) or any number of notes, comments, or messages. The event can be an office visit by the individual or patient, a conversation between the provider and the individual or patient or a caregiver, an examination of the individual or patient, an administration of a treatment to the individual or patient, a procedure being performed on or regarding the individual or patient, a review of information contained in the individual's or patient's electronic healthcare record, a diagnosis of the individual or patient, a determination of a treatment for the individual or patient, a determination of a treatment plan for the individual or patient, an evaluation of or regarding the individual or patient, or for any other event, occurrence, or happening wherein such note(s), comment(s), or message(s) might be deemed pertinent or useful.

Upon the occurrence of the event at step 1204, the operation of the apparatus 100 will proceed to step 1205. At step 1205, the provider can access the central processing computer 10, the individual's or patient's electronic healthcare record, and/or the note(s), comment(s), or message(s) and can review same. The provider can for example, access the individual's or patient's electronic healthcare record, and/or the note(s), comment(s), or message(s), prior to an office visit, a house call, or a remote or tele-health appointment, with or an examination of, the individual or patient so as to prepare for same, during an examination or a procedure, during an office visit, a house call, or a remote or tele-health appointment, with or an examination of, the individual or patient, in making a diagnosis or prescribing a treatment or a treatment plan, or for any other purpose.

At step 1206, the provider can then enter, and transmit to the central processing computer 10, via or using the provider communication device 20, any data and/or information regarding any examination finding(s), the individual's or patient's symptom(s), any observation(s), a diagnosis or diagnoses of possible diagnosis or possible diagnoses, a prescribed treatment(s), a treatment plan(s), or any other data or information regarding the individual or patient, information regarding or obtained during the examination, the procedure, or any other interaction with the patient, into the individual's or patient's electronic healthcare record. At step 1207, the central processing computer 10 can receive and store the data and/or information entered during step 1206 into any one or more of the individual's or patient's electronic healthcare record or electronic healthcare records and update the individual's or patient's electronic healthcare record or electronic healthcare records.

At step 1208, the central processing computer 10 will generate an insurance claim form or a payment request form which can meet and/or satisfy the formal claim submission requirements of the individual's or the patient's insurer, insurance company, or payer and which is suitable for submission to the respective insurer, insurance company or payer of the individual or patient. In a preferred embodiment, the insurance claim form or the payment request form is automatically generated by the central processing computer 10 in response to the storing of the data and/or information at step 1207.

At step 1209, the insurance claim form or the payment request form can be transmitted by or submitted by the central processing computer 10 to the respective payer communication device 30 of the individual or the patient. At step 1209, the insurance claim form or the payment request form or a copy of same can also be transmitted by the central processing computer 10 to the provider communication device(s) 20 of the provider. At step 1209, the insurance claim form or the payment request form or a copy of same can also be transmitted by the central processing computer 10 to the provider communication device(s) 20 of any of the individual's or patient's other providers, to the user or patient communication device 40 of the individual or patient, or to a user or patient communication device 40 of a caregiver of the individual or patient, or to a or to an intermediary computer 50 of third party or intermediary.

At step 1210, the insurance claim form or the payment request form or a copy of same can also be stored in the individual's or patient's electronic healthcare record or electronic healthcare records. In a preferred embodiment, the insurance claim form or the payment request form or the copy of same can be transmitted directly to a respective payer communication device 30, provider communication device 20, user or patient communication device 40, or intermediary communication device 50 either directly, such as via any suitable electronic or other transmission, or indirectly, such as via an e-mail server in the case when the copy of the insurance claim form or the payment request form is included in, or is attached to, an e-mail message. The copy of the insurance claim form or the payment request form can also be stored by or in the respective provider communication device 20, the respective user or patient communication device 40, or the respective intermediary communication device 50.

At step 1211, the central processing computer 10 can also generate a respective summary report regarding the office visit, the examination, the interaction with the provider, or the provider's action(s). The summary report can contain a summary or a clinical summary which can contain information regarding the office visit, the examination, or the interaction with the provider, as well as instructions for the individual or patient. A copy of the respective summary report can also be transmitted, at step 1211, by the central processing computer 10, to the user or patient communication device 40 of the individual or patient or of a caregiver of the individual or patient, to the provider communication device 20 of the provider as well as the respective provider communication device 20 of any other healthcare provider or healthcare providers of the individual or patient, to the payer communication device 30, and/or to an intermediary communication device 50.

The respective summary report can also contain individual-specific or patient-specific educational information or individual-specific or patient-specific instructional information, or a link(s) or hyperlink(s) to same, regarding a diagnosis, a treatment, a treatment plan, an office visit summary, a procedure summary, a treatment summary, or any other information relating thereto, so as to provide this educational information or instructional information to the individual or patient.

The individual or patient can thereafter access or obtain the educational information or instructional information via the apparatus 100 and method of the present invention. In this manner, the apparatus 100 and method of the present invention can provide individual-specific or patient-specific educational information or individual-specific or patient-specific instructional information regarding the diagnosis, treatment, treatment plan, or a summary of the office visit, the examination, the interaction with the provider, or the provider's action(s).

In a preferred embodiment, the apparatus 100 or the central processing computer 10 can be programmed to identify the individual-specific or patient-specific educational information or individual-specific or patient-specific instructional information regarding the diagnosis, the treatment, the treatment plan, the office visit, the examination, the interaction with the provider, or the provider's action(s), and/or any information, link(s), or hyperlink(s) relating thereto or pertaining thereto. The respective summary report can also contain a link(s) or hyperlink(s) to a social network website, a social network support group(s), a social networking activity, meeting, forum, chat room discussion, support group meeting or discussion, other individual member of a social network with whom the individual or patient can make contact with, or any other social networking or social networking-related information.

The respective summary report, in a preferred embodiment, can also be stored in the individual's or patient's electronic healthcare record.

Thereafter, the operation of the apparatus 100 will cease at step 1212.

In another preferred embodiment, as well as in any and/or all of the embodiments described herein, a caregiver can also enter a note(s), comment(s), or message(s), or any other information, into the individual's or the patient's electronic healthcare record. In a preferred embodiment, a caregiver can utilize a user or patient communication device 40 in order to enter a note(s), comment(s), or message(s), or any other information, into the individual's or the patient's electronic healthcare record.

In another preferred embodiment, the insurance claim form or the payment request form, which is transmitted to the insurer or payer communication device 30 at step 1209 can be date stamped and/or time stamped. In this manner, claim or payment request processing can be tracked or monitored so as to facilitate audits of the insurer or payer in order to ascertain if the insurer or payer is properly and/or efficiently handling a claim or payment request for the individual or patient, and/or if the insurer or payer is in compliance with any laws, rules, or regulations, governing claims or payment processing and/or handling. Information regarding the date stamped and/or time stamped claims, including the insurer's or the payer's processing or handling of same, and the response or reply to same, can also be stored in the database 10H of the central processing computer 10 and can be accessed and/or obtained by any authorized user or entity. In this manner, the apparatus 100 of the present invention can be used in order to ascertain information regarding the processing and/or handling of claims or payment requests by a respective insurer or payer for any individual or patient or for any group or groups of individuals or patients.

In another preferred embodiment, the central processing computer 10 can also generate a co-payment message or a deductible message containing information regarding a co-payment due by the individual or patient to the provider under the individual's or patient's insurance policy or payment program or a deductible which has to be met by the individual or patient under the individual's or patient's insurance policy or payment program. In another preferred embodiment, the co-payment message or the deductible message can be transmitted to the provider's communication device 20 during step 1209 or at any other time. The co-payment message or the deductible message can also be transmitted to the payer's communication device 30, to the user or patient communication device 40 of the individual or patient or a caregiver, or to a third part's or an intermediary's intermediary communication device 50.

In another preferred embodiment, the apparatus 100 and method of the present invention can be utilized in connection with or in conjunction with a personal healthcare record which an individual or patient can maintain for himself, herself, and/or for any children, parents, relatives, friends, or any other individuals whom the individual or patient may be providing care for as a caregiver or a person assisting a caregiver for another. In a preferred embodiment, the personal healthcare record can be stored on one or more user or patient communication devices 40 which can include, but which are not limited to a personal computer, a laptop computer, a tablet, a cellular telephone, a wireless telephone, a television, a digital television, a personal digital assistant (PDA), a smartphone, or any other of the herein-described devices, or other devices, which can be used as a user or patient communication device 40. The personal healthcare record can be stored in any number of user communication devices 40.

In a preferred embodiment, the individual or patient can enter notes, comments, messages, information regarding how they are feeling, information regarding a sickness, an illness, a symptom, information regarding types of medications they must take and time intervals for taking same, information regarding their diet, foods eaten, drinks ingested, exercise activity, provider information, allergies, and/or any other healthcare information, healthcare-related information, wellness information, fitness information, diet information, exercise of fitness information, nutritional information, and/or any other information which can find application in a healthcare or healthcare-related setting or scenario or any other information pertinent to the individual or patient as well as any individual(s) for whom the individual or patient is serving as a caregiver. In this manner, an individual or patient can, at any time and with any suitable user or patient communication device 40, enter or input, and store in a personal healthcare record, any relevant healthcare information, healthcare-related information, wellness information, fitness information, diet information, exercise of fitness information, nutritional information, and/or any other information which can find application in a healthcare or healthcare-related setting or scenario. In a preferred embodiment, the user or patient communication device 40 can be programmed to provide timed alerts or messages to remind the individual or patient to take medication, eat certain foods, intake certain liquids, schedule an appointment with a provider, check the status of an insurance claim or a payment claim, to exercise, provide diet or exercise reminders, or to perform any other action or activity for himself or herself or to perform any of the above for a person whom he or she is a caregiver.

The individual or patient can, at any time and from any location, access the central processing computer 10 via the user or patient communication device 40 and upload or transmit to the central processing computer 10 any and/or all information in his or her personal healthcare record into relevant portions of his or her electronic healthcare record and/or into a portion of same dedicated to receiving and storing the personal healthcare record information. In a preferred embodiment, the individual or patient can also download or receive from the central processing computer 10, any data and/or information that is stored in the individual's or patient's electronic healthcare record(s).

In another preferred embodiment, the user or patient communication device 40 can automatically receive, store or record in the personal healthcare record, and transmit to the central processing computer 20, and data and/or information which can be obtain with or from a wearable sensor or implantable sensor or device such as a wearable or implantable heart rate monitor, blood pressure monitor, blood sugar monitor, or any other device or monitor which can monitor a physiological parameter(s) or a biometric parameter(s). In a preferred embodiment, the user or patient communication device 40 can be linked via a wireless or Bluetooth or other suitable communication link with one or more of these wearable or implantable sensors. In an preferred embodiment, the data and/or information obtained from the wearable or implantable sensors can be transmitted to the central processing computer 10 and stored in the individual's or patient's electronic healthcare record(s). In another preferred embodiment, the user or patient communication device 40 and/or the personal health record utilized in connection with same, can be equipped with hardware and/or software for translating any data and/or information from one language into any other language, for translating audio information into text information for storing in the user or patient communication device 40, for storing audio information, for translating text information into audio information, for providing reminders to schedule appointments with providers, for providing reminders for scheduled appointments with providers, and/or for providing any other functions which are described herein as being performed in connection with the user or patient communication device 40.

The apparatus 100 and method of the present invention can also, in a preferred embodiment, be utilized to receive information from an individual or patient regarding a personal healthcare record, store and update an electronic healthcare record with the personal healthcare record information, and thereafter, generate a new personal healthcare record using any new or updated information from the electronic healthcare record(s). In this manner, the apparatus 100 can provide and maintain up-to-date electronic healthcare records and personal healthcare records for individuals or patients.

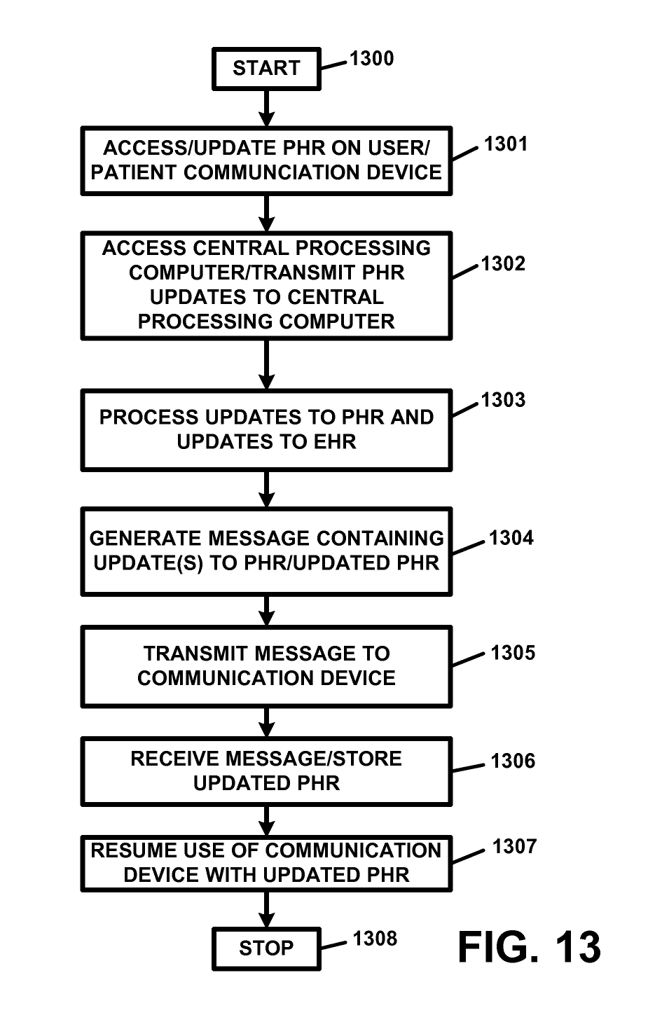

FIG. 13 illustrates another preferred embodiment method for utilizing the apparatus 100 and method of the present invention. With reference to FIG. 13, the operation of the apparatus 100 commences at step 1300. At step 1301, the individual or patient can access the personal health record located on his or her user or patient communication device 40 and can enter and store therein any pertinent data and/or information regarding himself, herself, his or her child or children, parent, relative, or any other person whom he or she is a caregiver. The data and/or information can be or can include any note(s), comment(s), or message(s), any information regarding how they or one they are providing care for are feeling, information regarding a sickness, an illness, a symptom, information regarding types of medications they or one they are providing care for must take and time intervals for taking same, information regarding the diet, foods eaten, drinks ingested, exercise activity, provider information, allergies, and/or any other healthcare information, healthcare-related information, wellness information, fitness information, diet information, exercise of fitness information, nutritional information, and/or any other information regarding them or one they are caring for which can find application in a healthcare or healthcare-related setting or scenario or any other information pertinent to the individual or patient as well as any individual(s) for whom the individual or patient is serving as a caregiver.

At step 1301, the individual or patient can also enter information regarding times for taking or administering medication(s), eating times, exercise times, provider appointments, and any other activity or activities for which the individual or patient desires to be reminded. At step 1301, any data and/or information obtained with or from a wearable or implantable device can also be entered and stored in the personal healthcare record in the user or patient communication device 40.

At step 1301, the individual or patient can also enter any other healthcare, healthcare-related, wellness, fitness, nutritional, diet, or any other data and/or information into the user or patient communication device. Audio information can also be entered into the user or patient communication device 40 and can be stored as audio information and/or translated to and stored as text information. Video information such as a picture or video clip can also be entered and stored at step 1301.

At step 1302, the individual or patient can, at any time and from any location, access the central processing computer 10 via the user or patient communication device 40. At step 1302, the individual or patient can transmit data and/or information contained in the personal healthcare record to the central processing computer 10. In a preferred embodiment, at step 1302, only new or updated data and/or information in the personal healthcare record can be transmitted to the central processing computer 10. In another preferred embodiment, at step 1302, any and/or all data and/or information can be transmitted to the central processing computer 10. At step 1303, the central processing computer 10 can receive, process, and/or store in the pertinent portion(s) of the electronic healthcare record(s) for the individual or patient or the person being cared for, the data and/or information transmitted at step 1302. At step 1303, the central processing computer can also process any new or updated information stored in the electronic healthcare record(s) for the individual or patient or the person being cared for in order to be able to provide the individual or patient with any new or updated information obtained from a provider, insurer or payer, or any other individual or patient, or caregiver. The new or updated information can be obtained from or provided by the individual or patient, or any other individuals, patients, users, provider, insurers, payers, third parties, intermediaries at any other previous time, or in or during any other previous, contemporaneous, or other, entry or update to the individual's or patient's electronic healthcare record(s). At step 1304, the central processing computer 10 can generate a message containing an update(s) to the personal healthcare record or can generate a message containing an updated personal healthcare record for the individual or patient or the person being cared for using any new or updated data and/or information obtained from the individual or patient, or any other individuals, patients, users, provider, insurers, payers, third parties, intermediaries. At step 1305, the central processing computer 10 can transmit the message to the user or patient communication device 40.

At step 1306, the user or patient communication device 40 can store the information contained in the message so as to update the personal healthcare record stored therein or so as to replace the personal healthcare record with the updated personal healthcare record generated by the central processing computer 10. In the above-described manner, the apparatus 100 and method of the present invention can be utilized to receive information from an individual or patient regarding a personal healthcare record, store and update an electronic healthcare record with the personal healthcare record information, and thereafter, generate a new personal healthcare record using any new or updated information from the electronic healthcare record(s). In this manner, the apparatus 100 can provide and maintain up-to-date electronic healthcare records and personal healthcare records for individuals or patients. At step 1307, the individual or patient can thereafter use the user or patient communication device 40 with the updated personal healthcare record in order to enter data and/or information into the personal healthcare record contained in same, to retrieve or obtain data and/or information from the personal healthcare record contained in same, to receive alerts or reminders from the user or patient communication device 40, and/or to enter or input any new or updated notes, comments, messages, or any of the other data and/or information described herein as being capable or being entered or input into the user or patient communication device 40, the personal healthcare record, the electronic healthcare record(s), or any other data and/or information described herein as being processed or provided by the apparatus 100 of the present invention, the central processing computer 10 or any of the other respective computers or communication devices 20, 30, 40, 50, and 60 described herein. Thereafter, the operation of the apparatus 100 will cease at step 1308.

In another preferred embodiment, as well as any and/or all of the embodiments described herein, the user or patient communication device 40 can be utilized to be a personal healthcare monitoring and/or planning tool or device for monitoring and/or planning healthcare and/or healthcare-related activities, events, occurrences, and/or happenings, for the individual or patient, the individual's or patient's children, parents, relatives, or those for whom the individual or patient serves or acts as a caregiver. In another preferred embodiment, as well as any and/or all of the embodiments described herein, the user or patient communication device 40 can be utilized to be a personal wellness, fitness, and/or nutritional monitoring and/or planning tool or device for monitoring and/or planning wellness or wellness-related, fitness or fitness-related, and/or nutritional or nutritional-related, activities, events, occurrences, and/or happenings, for the individual or patient, the individual's or patient's children, parents, relatives, or those for whom the individual or patient serves or acts as a caregiver. In another preferred embodiment, the user or patient communication device can be equipped with any needed or desired software or software application or any number of software applications needed, required, or desired for enabling the user or patient communication device 40 to provide the herein-described features, functions, and/or functionality. In another preferred embodiment, the apparatus 100 of the present invention, the central processing computer 10 and/or the user or patient communication device 40 can be utilized to provide information regarding individual and/or family healthcare planning, and/or monitoring, individual and/or family wellness planning and/or monitoring, individual and/or family fitness planning and/or monitoring, and/or individual and/or family nutritional planning and/or monitoring. In another preferred embodiment, the apparatus 100 of the present invention, the central processing computer 10 and/or the user or patient communication device 40 can be utilized to schedule appointments with providers and to provider automatically generated appointment reminders.

In another preferred embodiment, the apparatus 100 and method of the present invention can be utilized to provide social networking functionality and capability via an electronic healthcare record(s) or any. In this manner, any of the herein-described individuals, patients, caregivers, providers, insurers, payers, third parties, or other entities, can access a social network via any of the electronic healthcare records described herein. In a preferred embodiment, each and every type or kind of electronic healthcare record utilized in or in connection with the apparatus 100 of the present invention can have information, link(s), or hyperlink(s), to any social networking web sites, web pages, support groups, on-line forums, on-link information services, as well as social networking web sites or social networking web pages to or for social networking members, support groups, information providers, healthcare providers, as well as any of the providers, insurers, payers, individuals, patient, third parties, intermediaries, or any other persons or entities described herein who are or who may be members of any social network.

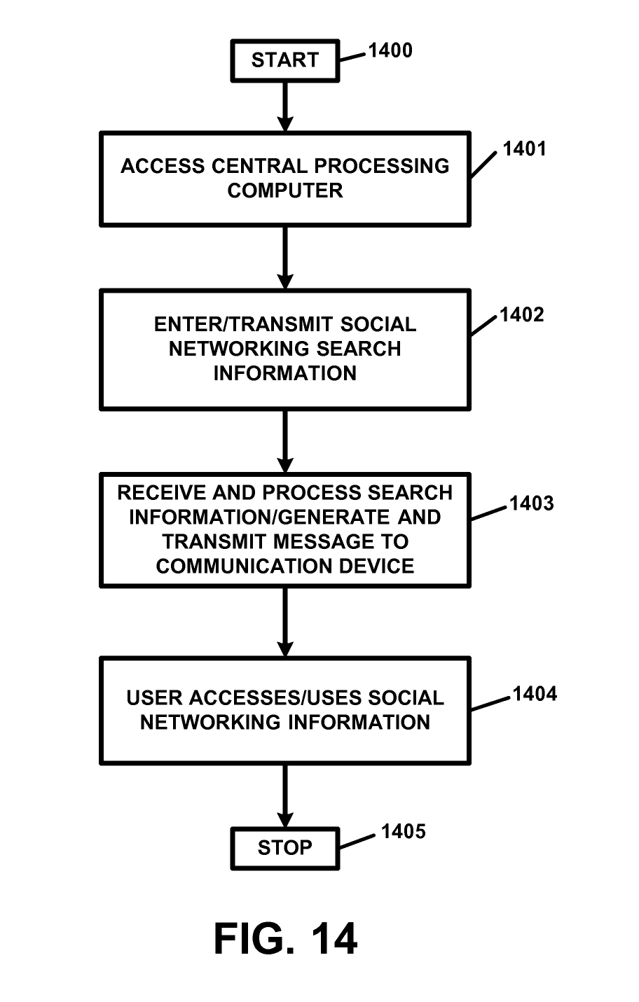

FIG. 14 illustrates another preferred embodiment method for utilizing the apparatus and method of the present invention, in flow diagram form. With reference to FIG. 14, the operation of the apparatus 100 commences at step 1400. At step 1401, the respective user, who may be any of the herein-described individuals, patients, caregivers, providers, insurers, payers, third parties, intermediary, or other entities, can access the central processing computer 10 via a respective communication device or computer 20, 30, 40, or 50. At step 1402, the user can enter, and transmit to the central processing computer 10, information for searching for or accessing a social network, a social network member, a social network information sources, a social network support group, a social network on-line forum, chat room, or discussion, or a social networking page or pages for any individual, patient, caregiver, provider, insurer, payer, third party, intermediary, or other entity. At step 1403, the central processing computer 10 will process the information received, identify any requested information for or regarding any individual, patient, provider, insurer, payer, third party, intermediary, entity, social network, social network member, social network information source(s), social network support group, social network on-line forum, chat room, or discussion, or social networking page or pages for any individual, patient, caregiver, provider, insurer, payer, third party, intermediary, or other entity requested, generate a message containing the requested information, a link(s), or a hyperlink(s), to the requested information, and transmit the message to the user's respective communication device or computer 20, 30, 40 or 50.

At step 1404, the user can access the social networking information for or regarding the individual, patient, provider, insurer, payer, third party, intermediary, entity, social network, social network member, social network information source(s), social network support group, social network on-line forum, chat room, or discussion, or social networking page or pages for any individual, patient, caregiver, provider, insurer, payer, third party, intermediary, or other entity requested. At step 1404, the user can make use of the social networking information, the social networking web site or any other information or relationships which can be created thereby in any desired and/or suitable manner. Thereafter, the operation of the apparatus 100 will cease at step 1405.

In the above described manner, any of the herein-described individuals, patients, caregivers, providers, insurers, payers, third parties, intermediaries, or other entities, can access, obtain, or link to, any social networking web site or to any social networking web pages to or for any social networking members, support groups, information providers, healthcare providers, as well as any of the providers, insurers, payers, individuals, patient, third parties, intermediaries, or any other persons or entities described herein so as to utilize social networking in a healthcare or healthcare-related application.

In another preferred embodiment the apparatus 100 and method of the present invention can be utilized to provide an individual or patient with information, or a link(s) or a hyperlink(s) to information, regarding a social networking website or a social networking company, any information provided thereby or thereat, or information regarding any social networking support groups or social networking support group members, on-line seminars, forums, chat room discussions, or others, with which or whom the individual or patient may engage upon the individual or patient being diagnosed with an illness, a sickness, or a condition, or upon the individual or patient about to undergo or undergoing a treatment, a procedure, or an operation, or about to embark upon or already involved in a treatment plan.

The providing of the social networking information to the individual or patient can serve to allow the individual or patient to learn more about a diagnosis, a treatment, or a treatment plan, to interact with others who have been diagnosed with the same or a similar illness, a sickness, or a condition, or others who may be undergoing the same or a similar treatment or who may be following a same or a similar treatment plan. The apparatus 100 and method of the present invention can be utilized so as to identify and provide the individual or patient with information or link(s) or hyperlink(s) to a social networking website, a social networking company, a support group or support groups, a member of the social network members of the social network, social networking lectures, classes, or seminars, social networking sponsored lectures, classes, or seminars, social networking discussions, question and answer sessions, or informational or other forums, or any other social networking or social networking sponsored activities or events, for any number of social networks.

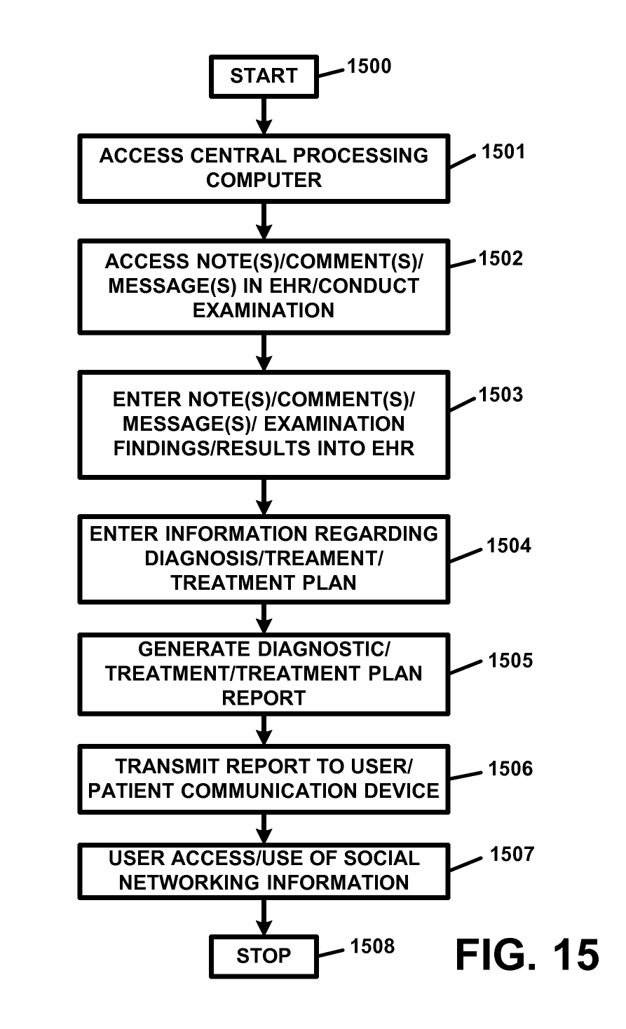

FIG. 15 illustrates yet another preferred embodiment for utilizing the apparatus 100 and method of the present invention, in flow diagram form. The preferred embodiment of FIG. 15 can be utilized by any of the herein-described providers to provide an individual or a patient, or a caregiver of an individual or patient with social networking information in connection with the providing of a diagnosis, a treatment, a treatment plan, or prior or to subsequent to a procedure being performed on the individual or patient, or at any other time and/or for any reason. The embodiment of FIG. 15 will be described in an exemplary embodiment as being utilized in connection with a provider conduction an examination of an individual or patient. It is important to note however, that the embodiment of FIG. 15 can be utilized by a provider in a same, a similar, and/or an analogous, manner in performing an examination, in conducting a tele-health or remote examination, evaluation, interview, interaction, or conversation, involving a provider and in individual or patient or a caregiver, in performing a procedure or an operation, in administering a treatment, in making a diagnosis, in deciding on a treatment, in designing or formulating a treatment plan, in evaluating a diagnosis, a treatment, course or treatment, or treatment plan, or in generating and/or submitting an insurance claim, a request for payment, or a bill.

With reference to FIG. 15, the operation of the apparatus 100 commences at step 1500. At step 1501, the provider can access the central processing computer 10 via his or her provider communication device 20 and can access the individual's or patient's electronic healthcare record and/or personal healthcare record portion of same prior to, at any time during, or subsequent to an examination of the individual or patient. At step 1502, the provider can access any note(s), comment(s), message(s), any information in the individual's or patient's electronic healthcare record and/or personal healthcare record portion of same, and any other information in the individual's or patient's electronic healthcare record. At step 1502, the provider can also conduct his or her examination of the individual or patient. At step 1503, the provider can enter, into the individual's or patient's electronic healthcare record or any portion of same, any note(s), comment(s), message(s), examination findings, examination observations, examination results, or any information obtained from the individual or patient, or any data and/or information obtained from any healthcare device, healthcare equipment, healthcare measuring device, healthcare monitoring device, diagnostic device, or any other device, machine, or equipment. At step 1503, the provider can also enter, into the individual's or patient's electronic healthcare record or any portion of same, any data and/or information as text information, as audio information or an audio clip which the central processing computer 10 can store as audio information and/or can translate and store as a text transcript of same, as a picture or as video information or as a video clip. In a preferred embodiment, the central processing computer 10 can also translate any text information or any audio information from one language into another language and also store same in the individual's or patient's electronic healthcare record.

At step 1504, the provider can enter any information regarding a diagnosis or possible diagnoses, any prescribed treatment or prescribed treatments, or any treatment plan(s), or the provider can enter an instruction or request for the central processing computer 10 to perform a diagnosis for the individual or patient, prescribe a treatment or treatment plan for the individual or patient, or prescribe a treatment plan(s) for the individual or patient, utilizing data and/or information stored in the database 10H. At step 1505, the central processing computer 10 can generate a diagnostic report, a treatment report, and/or a treatment plan report, which can contain any data and/or information regarding a diagnosis, a list of possible diagnoses, a treatment, treatments, a treatment plan or treatment plans, for or regarding the individual or patient.

The respective diagnostic report, a treatment report, and/or a treatment plan report, can also contain social networking information, which can include, but which is not limited to, any information, or a link(s) or a hyperlink(s) to information, regarding a social networking website or a social networking company, any information provided thereby or thereat, or information regarding any social networking support groups or social networking support group members, on-line seminars, forums, chat room discussions, or others, with which or whom the individual or patient may engage upon the individual or patient being diagnosed with an illness, a sickness, or a condition, or upon the individual or patient about to undergo or undergoing a treatment, a procedure, or an operation, or about to embark upon or already involved in a treatment plan.

The providing of the social networking information to the individual or patient in the respective diagnostic report, treatment report, or treatment plan report, can serve to allow the individual or patient to learn more about a diagnosis, a treatment, or a treatment plan, to interact with others who have been diagnosed with the same or a similar illness, a sickness, or a condition, or others who may be undergoing the same or a similar treatment or who may be following a same or a similar treatment plan.

The apparatus 100 and method of the present invention can be utilized so as to identify and provide the individual or patient with information or link(s) or hyperlink(s) to a social networking website, a social networking company, a support group or support groups, a member of the social network members of the social network, social networking lectures, classes, or seminars, social networking sponsored lectures, classes, or seminars, social networking discussions, question and answer sessions, or informational or other forums, or any other social networking or social networking sponsored activities or events, for any number of social networks. In a preferred embodiment, the central processing computer 10 can utilize any and all information stored in the electronic healthcare record of the individual or patient, any diagnostic report, treatment report, or treatment plan report, any note(s), comment(s), or message(s), examination findings, results, observations, measurements, or any other data and/or information, provided by the individual, the patient, or his or her caregiver, any note(s), comment(s), or message(s), examination findings, results, observations, measurements, or any other data and/or information, provided by the provider, or any of other healthcare or healthcare-related information described herein, in identifying, locating, and/or selecting, and/or in providing any social networking information or any link(s) or hyperlink(s) to same.

The respective diagnostic report, treatment report, or treatment plan report, can also contain information, a link(s) or a hyperlink(s) to any other social networking members who have been diagnosed with a same or similar diagnosis as the individual or patient, who may have undergone or are currently undergoing or about to undergo a same of a similar treatment, or procedure as the individual or patient, or who has followed or is about to follow a same or similar treatment plan as the individual or patient. The respective diagnostic report, treatment report, or treatment plan report, can also contain information, a link(s) or a hyperlink(s) to providers of or for social networking information as well as social networking information for insurer, payers, and media and information sources.

In a preferred embodiment, any of the herein-described diagnostic reports, treatment reports, or treatment plan reports, can also include or can also contain any data and/or information stored in individual's, the patient's, or the caregiver's, electronic healthcare record, a link(s) or a hyperlink(s) to data and/or information stored in the individual's, the patient's, or the caregiver's, electronic healthcare record, any notes, comments, or messages, entered by the individual, the patient, or the caregiver, into the individual's, the patient's, or the caregiver's, electronic healthcare record, and/or any link(s) or hyperlink(s) to any notes, comments, or messages, entered by the individual, the patient, or the caregiver, into the individual's, the patient's, or the caregiver's, electronic healthcare record.

At step 1506, the respective diagnostic report, treatment report, or treatment plan report, can be transmitted to the user or patient communication device 40 of or associated with the individual or patient or the caregiver of the individual or patient. At step 1506, the respective diagnostic report, treatment report, or treatment plan report, can also be transmitted to a provider communication device 20 of each provider of the individual or patient. At step 1506, the respective diagnostic report, treatment report, or treatment plan report, can also be transmitted to a payer communication device 30 of each insurer or payer of the individual or patient. At step 1506, the respective diagnostic report, treatment report, or treatment plan report, can also be transmitted to a social networking computer 80 associated with an appropriate social networking information source which may begin to provide the individual or patient or the caregiver of the individual or patient with information regarding the diagnosis, treatment, procedure, or treatment plan, or which social networking computer 80 may be associated with a support group or support group members who may reach out to help or provide assistance to the individual or patient or to the caregiver of the individual or patient. It is to be understood that, in order to be in compliance with all individual or patient healthcare privacy and confidentiality laws, rules, and regulations are complied with, any dissemination of any of the respective diagnostic reports, treatment reports, or treatment plan reports, will only be made with the individual's or patient's previous authorization and/or approval.

At step 1506, the respective diagnostic report, treatment report, or treatment plan report, can also be stored in the individual's or patient's electronic healthcare record. At step 1507, the individual or patient, or the caregiver for the individual or patient, can access and/or make use of the social networking information in any desired manner.

Thereafter, the operation of the apparatus 100 will cease at step 1508.

In another embodiment, all social networking support group members, and/or individuals or patients invited to participate in a social networking support group, can each be verified, by utilizing the data and/or information stored in the database 10H and/or in any and/or all of the electronic healthcare records, electronic medical records, electronic dental records, electronic pharmacy records, and/or electronic behavioral health records which are utilized in, or in connection with, the apparatus 100, as having been diagnosed with the same or a similar illness, sickness or condition, or as having been prescribed the same or a similar treatment or procedure, or as being prescribed the same or similar treatment plan, so as to maintain compliance with all healthcare and/or other privacy laws, rules, and regulations and other concerns as well as ensuring the integrity of the social networking support group.

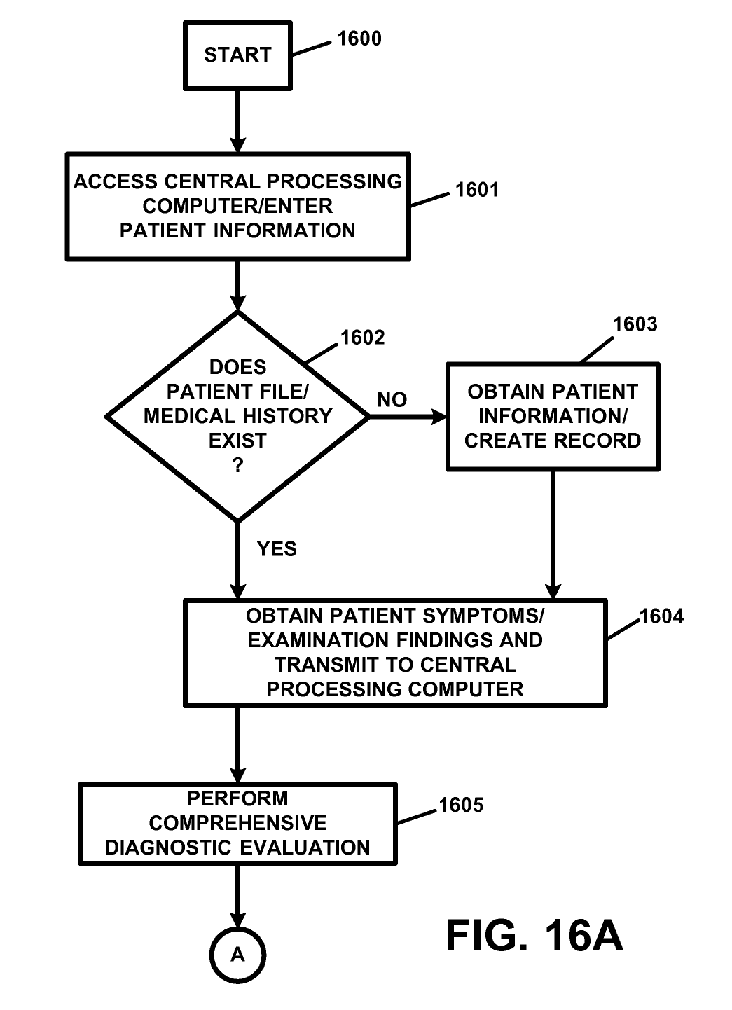

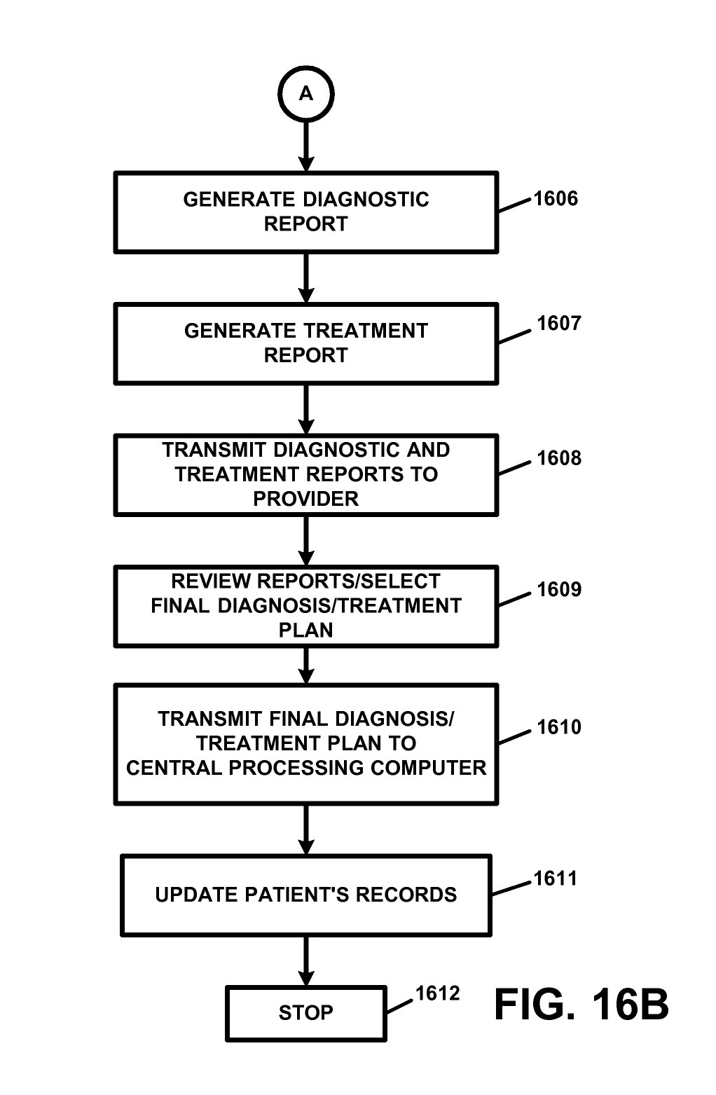

In a preferred embodiment, the present invention can be utilized in order to perform a diagnosis of, and/or to prescribe a treatment or a treatment plan for, a sickness, illness and/or other condition. FIGS. 16A and 16B illustrate another preferred embodiment method for utilizing the apparatus 100 and method of the present invention, in flow diagram form. While the method of FIGS. 16A and 16B is described in the context of a medical doctor performing a diagnosis of, and/or prescribing a treatment or a treatment plan for, a medical condition, the method of FIGS. 16A and 16B can be similarly utilized by any provider described herein, including, but not limited to, medical doctors, surgeons, physicians, dentists, orthodontists, periodontists, endodontists, oral surgeons, osteopaths, psychologists, optometrists, podiatrists, osteopaths, chiropractors, pharmacists, therapists, physical therapists, respiratory therapists, nurses, healthcare aids, nurse practitioner, physician's assistant, nutritionists, and/or any other person, individual, and/or professional who can provide healthcare, healthcare-related, wellness and/or wellness-related services and/or products, insurance companies, healthcare insurance companies, disability insurance companies, property or casualty insurance companies, health maintenance organizations, healthcare providers, and any other payer and/or provider of healthcare services and/or products, healthcare claims processing centers, healthcare insurance brokers and/or agents, and/or any other third party and/or intermediary who or which acts on behalf of another and/or assists in to providing of healthcare and/or related services, and/or any other healthcare provider or healthcare professional described herein (hereinafter referred to in this preferred embodiment as a “provider” or “user”). The method of FIGS. 16A and 16B may also be utilized by any user, individual, patient, caregiver, provider, insurer, payer, and/or intermediary in order to ascertain a diagnosis or a treatment and/or in order to check on, verify, and/or ascertain the correctness of a diagnosis of another and/or to formulate, plan, check on, verify, and/or ascertain the correctness of a diagnosis, a treatment, or a treatment plan.

The operation of the apparatus 100 commences at step 1600. At step 1601, the provider or user can access the central processing computer 10 and enter data and/or information regarding the individual or the patient. At step 1602, the central processing computer 10 will determine if an electronic healthcare record, file and/or history, exists for the individual or the patient. If, at step 1602, it is determined that an electronic healthcare record, file and/or history, does not exist for the individual or the patient, the central processing computer 10 will, at step 1603, can request that an electronic healthcare record, file and/or history, be created for the individual or the patient and/or can process information for creating and/or create an electronic healthcare record, file and/or history, for the individual or the patient family.

In another preferred embodiment, the provider or user may, at step 1602 or 1603, decide for any appropriate reason, to create an electronic healthcare record for the individual or the patient. In this regard, the apparatus 100 and method of the present invention can be utilized to create an electronic healthcare record for an individual or a patient. In a preferred embodiment, any information regarding the date and time of the creation of the electronic healthcare record, the person, individual, patient, caregiver, provider, payer, or other individual or entity, who or which created the electronic healthcare record, the reason for the creation or same, and/or any other pertinent or relevant information regarding the creation of the electronic healthcare record can be stored in the electronic healthcare record.

Any electronic healthcare record created at step 1603 can include any relevant and/or or pertinent information, name, address, social security number, caregiver information, information identifying other individuals for who the individual or patient is a caregiver, healthcare insurance or payer information, provider information, and any other data and/or information described herein as being stored in the database 10H and/or in any electronic healthcare record described herein, including personal and family healthcare history and/or other information related thereto for the individual or the patient. The information can be provided by the provider, by the individual or the patient, by a caregiver, by another individual accompanying the individual or the patient, or can be obtained with or from or provided by or from a healthcare device, healthcare monitoring equipment, or any device, system, apparatus, or equipment used in measuring, monitoring, obtaining, and/or monitoring healthcare data or information of or regarding the individual or the patient.

Upon any creation of any electronic healthcare record, file of history for the individual or patient, an alert message can be generated by the central processing computer 10 and transmitted to a respective user or patient communication device 40 of the individual, patient, or caregiver for the individual or the patient, to a provider communication device 20 of any other identified provider of the individual or the patient, to the insurer or payer communication device 30 of the insurer or payer of the individual or patient, or to any intermediary communication device 50 of any authorized intermediary. In this regard, the apparatus 100 of the present invention can provide an alert message or a notification message to the individual, the patient, or the caregiver for same, regarding any creation of an electronic healthcare record for any individual or patient. It can be readily appreciated that any such alert message or notification message can also be a deterrent to or for healthcare identity theft and/or any fraudulent activity relating to same.

Any alert message or notification message can also contain any information regarding the date and time of the creation of the electronic healthcare record, the person, individual, patient, caregiver, provider, payer, or other individual or entity, who or which created the electronic healthcare record, the reason for the creation or same, and/or any other pertinent or relevant information regarding the creation of the electronic healthcare record can be stored in the electronic healthcare record.

Any alert message or notification message can be, or can be included in, or be attached to, an e-mail message, an instant messaging message, an electronic transmission, or an electronic data transmission or electronic data interchange, or can be transmitted via any other data or information transmission, and can be transmitted via or using any appropriate or necessary computer(s) or device(s). The alert message or the notification message can also be transmitted in a recorded telephone call or in a fax transmission.

At step 1603, the information provided by the provider, the individual, the patient, the caregiver or other individual, or obtained with or from the respective healthcare device, healthcare monitoring equipment, or device, system, apparatus, or equipment, can be entered via the provider communication device 20 and transmitted to, and be stored at, the central processing computer 10 in the individual's or the patient's newly created electronic healthcare record. Thereafter, processing will proceed to step 1604.

If, at step 1602, it is determined that the individual's or the patient's electronic healthcare record does in fact already exist, the processing will proceed to step 1604. At step 1604, data and/or information regarding the individual's or the patient's symptoms, if any, and/or examination findings, procedure findings, data and/or information previously stored in the electronic healthcare record by the individual, patient, or caregiver, including any notes or comments previously stored in the electronic healthcare record prior to the provider visit or appointment, examination visit or appointment, or procedure visit or appointment, any data and/or information obtained from the individual, the patient, a caregiver or other individual, or any information obtained from any tests, procedures, examination, or any data and/or information obtained with or from any healthcare device, healthcare monitoring equipment, or device, system, apparatus, or equipment, can be entered via the provider communication device 20 and transmitted to, and can be stored at, the central processing computer 10 in the individual's or the patient's newly created electronic healthcare record.

At step 1604, data and/or information which can be obtained via any of the herein-described healthcare equipment input devices 20D, healthcare measurement input devices 20D, or healthcare monitoring input devices 20D, can also be transmitted to the central processing computer 10. The data and/or information obtained via any of the described healthcare equipment input devices 20D, healthcare measurement input devices 20D, or healthcare monitoring input devices 20D, can be transmitted from the from the provider communication device 20 to the central processing computer 10.

In this manner, the data and/or information which is transmitted to the central processing computer 10, at step 1604, can include provider or user entered data and/or information, which can be entered via the user input device 20D such as a keyboard, a mouse, a cardreader, or other input device which can be utilized in conjunction with a computer or a communication device, and/or can include data and/or information which can be obtained and/or acquired by any of the herein-described healthcare equipment input devices 20D, healthcare measurement input devices 20D, or healthcare monitoring input devices 20D.

In a preferred embodiment, both provider or user entered data and/or information obtained and/or acquired by any of the herein-described healthcare equipment input devices 20D, healthcare measurement input devices 20D, or healthcare monitoring input devices 20D, can be utilized in performing a patient diagnosis. In another preferred embodiment, only data and/or information obtained and/or acquired by any of the herein-described healthcare equipment input devices 20D, healthcare measurement input devices 20D, or healthcare monitoring input devices 20D, can be utilized in performing an individual diagnosis or a patient diagnosis. In another preferred embodiment, only provider or user entered data and/or information can be utilized in performing an individual diagnosis or a patient diagnosis.

The central processing computer 10 will, at step 1605 receive and/or process the information transmitted from the provider communication device 20 at step 1604, which can include any of the above-described data and/or information regarding the individual or the patient, the individual's or the patient symptoms, if any, examination findings, and/or any other data and/or information, in conjunction with the individual's of the patient's health, healthcare, medical or other healthcare-related information, history and/or other information, medical or healthcare theories, principles, criteria and/or other medical or healthcare information needed to make a diagnosis. At step 1605, the central processing computer 10 will perform a comprehensive diagnostic evaluation of the individual's or the patient's symptoms, illness, condition, if any, and/or the examination findings or procedure findings.

The comprehensive diagnostic evaluation or diagnosis can be based upon provider or user entered data and/or information, any data and/or information stored in or entered into the individual's or the patient's electronic healthcare record, any of the data and/or information described herein as being obtained, entered, and/or transmitted to the central processing computer 10 at step 1604, or any data and/or information obtained or acquired by any of the herein-described healthcare equipment input devices 20D, healthcare measurement input devices 20D, or healthcare monitoring input devices 20D, or the comprehensive diagnostic evaluation can be based upon only data and/or information obtained and/or acquired by any of the herein-described healthcare equipment input devices 20D, healthcare measurement input devices 20D, or healthcare monitoring input devices 20D, or the comprehensive diagnostic evaluation can be based upon only provider or user entered data and/or information.

For example, a provider can enter patient symptom information along with patient data obtained from any of the herein-described healthcare equipment input devices 20D, healthcare measurement input devices 20D, or healthcare monitoring input devices 20D. A diagnosis or a comprehensive diagnostic evaluation can, thereafter, be processed utilizing data obtained from both the provider and any of the herein-described healthcare equipment input devices 20D, healthcare measurement input devices 20D, or healthcare monitoring input devices 20D.

Individual data or patient data can also be obtained solely from any of the herein-described healthcare equipment input devices 20D, healthcare measurement input devices 20D, or healthcare monitoring input devices 20D, with such individual data or patient data being utilized in order to arrive at a diagnosis or a comprehensive diagnostic evaluation. Individual data or information or patient data or information, in another preferred embodiment, can also be obtained solely from a provider or from the individual or the patient himself or herself, or from a caregiver. An individual or patient can also utilize the apparatus 100 in this preferred embodiment in connection with or in conjunction with home healthcare equipment input devices, healthcare measurement input devices, or healthcare monitoring input devices.

In another preferred embodiment, the individual or the patient or his or her caregiver, or any other person assisting the individual or patient, can access the central processing computer 10 via the user or patient communication device 40 and, at step 1604 or at any other appropriate time, the individual, patient, caregiver, or other person, can enter or input information regarding a condition, symptom, a blood pressure reading, a heart rate or pulse rate, a blood sugar level or blood glucose level, or any other data or information pertaining to the individual or the patient. The data or information entered by the individual, patient, caregiver, or other person, can also be obtained via any of the herein-described healthcare equipment input devices, healthcare measurement input devices, or healthcare monitoring input devices, which can be located at the individual's or the patient's home, at a hospital, at an individual's or patient's bedside, or at any other appropriate or suitable location, and can also be transmitted to the central processing computer 10, via the respective device itself, or in a case where the respective device is or can be connected with or linked with the user or patient communication device 40, via the user or patient communication device 40. In this preferred embodiment, the individual, patient, caregiver or other person can enter or input information, such as, but not limited to, his or her or the individual's or patient's condition, notes, symptoms, blood pressure readings, heart rate or pulse rate readings, blood sugar level or blood glucose level, or any other data or information which can be entered by, or obtained by, the individual, patient, caregiver, or other person. The individual, patient, caregiver, or other person entered data or information can be received and stored in individual's or patient's electronic healthcare record, file, or medical history or healthcare history, at the central processing computer 10, and/or at the provider communication device 20, and can be accessed by and reviewed by the provider, or by any other authorized provider, individual, caregiver, user, insurer, payer, or other authorized individual or entity, at any time.

As and for and illustrative example, an individual or patient being treated for high blood pressure can be instructed by the provider to take his or her own blood pressure reading, or have it taken by a caregiver or other person assisting the individual or patient, each day for an instructed or pre-determined time period, and to transmit the readings to the central processing computer 10 for storage in his or her electronic healthcare record, file or medical history or healthcare history, and/or to the provider communication device 20. The readings can be transmitted to the central processing computer 10, and/or to the provider communication device 20, via the respective device or via the user's or patient's communication device 40. The provider, or any other authorized provider, individual, caregiver, user, insurer, payer, or other authorized individual or entity, can, at any time, access the individual's or the patient's electronic healthcare record, file or medical history or healthcare history, and review the blood pressure readings taken by or entered by the individual or the patient or by a caregiver or other person assisting the individual or the patient.

The provider can also utilize the individual, patient, caregiver, or other person, entered data or information in making an examination finding, noting a symptom, making a diagnosis, or prescribing a course of treatment.

In another preferred embodiment, the central processing computer 10, and/or the provider communication device 20, can be programmed to process and/or analyze the individual, patient, or caregiver, entered data or information, based on pre-defined criteria or otherwise, and can automatically generate a message and transmit or provide the message to the provider via the provider communication device 20 or to or via a second provider communication device 20 in order to provide the provider with notification of a individual's or the patient's condition. For example, if the provider wants to be notified if the individual's or the patient's blood pressure is a certain reading, above or below a certain reading, has changed, or has not changed, the provider can program the apparatus 100 or the central processing computer 10, or the provider communication device 20, to analyze the patient-entered blood pressure data or information, and if the blood pressure is determined to be a certain reading, above or below a certain reading, has changed, or has not changed, the central processing computer 10 can generate a message containing information regarding the individual's or the patient's blood pressure condition and can transmit the message to the provider communication device 20, or the provider communication device 20 can either provide the information to the provider or transmit the information to a second provider communication device 20. Thereafter, the provider can receive, review, or act in response to, the information contained in the message.

Although a blood pressure condition has been described as a monitored condition in the above example, it is important to note that the apparatus 100 and method of the present invention can be utilized to monitor any condition capable of being monitored by any of the healthcare devices or equipment or healthcare measurement devices or equipment described herein so that any data or information capable of being obtained by any of those devices or equipment can be automatically monitored, analyzed, or reported to the provider. In this regard, heart rate or pulse rate reading, a blood sugar or blood glucose level or reading, or any other data, information, or condition, can be automatically monitored or reported.

In another preferred embodiment, the provider, as well as any individual, patient, caregiver, user, insurer or payer, or any authorized intermediary, can, via his or her respective provider communication device 20, user or patient communication device 40, insurer or payer communication device 30, or intermediary communication device 50, and using the Internet and/or the World Wide Web, a telephone line, a cellular or wireless communication network, or any other communication network or system, can access, control, monitor, or obtain readings, measurements, data, or information, from or via any healthcare device(s) or healthcare monitoring device(s) or healthcare measurement device(s) or equipment, which can be or which can include, but which is not limited to, any of the devices or equipment described herein which can be used to obtain healthcare data or information or healthcare-related data or information from or for an individual or patient.

In this regard, in another preferred embodiment, the provider, or any authorized provider, or any individual, patient, caregiver, user, insurer or payer, or any authorized intermediary, can, from a remote location, monitor the patient, and/or control and/or monitor a healthcare device(s) or equipment being used to monitor the individual or the patient. The provider, or any authorized provider, or any individual, patient, caregiver, user, insurer or payer, or any authorized intermediary, can also utilize the apparatus 100 and method of the present invention to remotely monitor the individual or the patient in a hospital, a healthcare facility, or in the individual's or the patient's own home. The provider, or any authorized provider, or any individual, patient, caregiver, user, insurer or payer, or any authorized intermediary, can also be automatically notified, by means of a message being transmitted from the respective device or equipment to the respective provider communication device 20, user or patient communication device 40, insurer or payer communication device 30, or intermediary communication device 50, and/or from the central processing computer 10 to the respective provider communication device 20, user or patient communication device 40, insurer or payer communication device 30, or intermediary communication device 50, of a message or an alert or alerts obtained from the respective device or equipment, such as an emergency call or a detection of an emergency occurrence detected by or associated with the respective device or equipment. Any data or information obtained by the provider can also be transmitted to the central processing computer 10 for inclusion in the individual's or the patient's electronic healthcare record, file or medical history or healthcare history, and can be processed in the manner described herein with regard to steps 1604 and 1605 described herein, and/or in any other appropriate manner consistent with the teachings and use of the apparatus 100 and method of the present invention.

In the above described manner, the apparatus 100 and method of the present invention can be utilized in order to allow a provider, or any authorized provider, or any individual, patient, caregiver, user, insurer or payer, or any authorized intermediary, to monitor a patient or any number of patients from a remote location and via any of the respective provider communication devices 20, user or patient communication devices 40, insurer or payer communication devices 30, or intermediary communication devices 50, described herein.

At step 1606, the central processing computer 10 will generate a diagnostic report which can include a diagnosis of the individual's or the patient's condition, if needed. The diagnostic report which is generated at step 1606 can, if needed, include a single diagnosis and/or a list of possible diagnoses, along with their respective probabilities of occurrence and/or statistical information corresponding thereto, which may pertain to the individual's or the patient's condition. At step 1607, the central processing computer 10 will then generate a treatment report which will outline and/or prescribe treatment for the single diagnosis and/or for the list of possible diagnoses, if any. The central processing computer 10, when generating the treatment report, can process same in conjunction with, and consider, possible drug interactions and/or treatment interactions. In another preferred embodiment, the diagnostic report and/or the treatment report can also contain any of the notes, comments, or messages, which were, or which may have been, previously entered by the individual or patient, or by a caregiver of the individual or patient, into the individual's or patient's electronic healthcare record.

At step 1608, the central processing computer 10 will transmit the diagnostic report and/or treatment report to the provider's communication device 20 at which point the medical doctor can obtain the diagnosis or possible diagnoses, if any, and corresponding treatment plans. At step 1608, the central processing computer 10 can also transmit the diagnostic report and/or treatment report to the provider's communication device 20 of any other authorized provider, or to a user or patient communication device 40, to the individual's or patient's insurer or payer communication device 30, or to an intermediary communication device 50 associated with an authorized intermediary, at which point the respective provider, individual, patient, caregiver, insurer or payer, or intermediary can review and obtain any information contained in the respective diagnostic report and/or treatment report or any information regarding any diagnosis or possible diagnoses, if any, and corresponding prescribed treatment, treatments or treatment plans contained therein.

Upon any generation of any diagnostic report or treatment report, each can be stored in the electronic healthcare record of the individual or the patient. The diagnostic report and/or the treatment report can also be transmitted the respective user or patient communication device 40 of the individual, patient, or caregiver for the individual or the patient, to the provider communication device 20 of any other identified provider of the individual or the patient, to the insurer or payer communication device 30 of the insurer or payer of the individual or patient, or to any intermediary communication device 50 of any authorized intermediary. In this regard, the apparatus 100 of the present invention can provide a diagnostic report and/or a treatment report to the individual, the patient, or the caregiver for same, to any other provider of the individual or the patient, to any insurer or payer of the individual or patient, or to any authorized intermediary, any time a diagnostic report or a treatment report is generated for the individual or patient. It can also be readily appreciated that any such diagnostic report or treatment report being sent to any one or more of the herein-described providers, insurers or payers, the individual, patient, or caregiver for the individual or the patient can, or to an authorized intermediary, can also be used as a deterrent to or for healthcare identity theft and/or any fraudulent activity relating to same.

Any of the diagnostic reports or treatment reports can also be stored in the electronic healthcare record of the individual or the patient. At any time after receiving the diagnostic report or the treatment report, any provider, the individual, patient, or caregiver, the insurer or payer, or any intermediary can report a mistake or any fraudulent or suspected fraudulent activity by transmitting, from their a respective communication device 20, 30, 40, or 50, to the central processing computer 10, a message reporting the mistake or the fraudulent activity or the suspected fraudulent activity regarding or involving the individual or the patient, his or her electronic healthcare record, or a mistaken diagnosis, treatment, insurance claim or claim for payment, or a fraudulent diagnosis, treatment, or insurance claim or claim for payment. Any such message can also be stored in the individual's or the patient's electronic healthcare record.

Any of the herein-described diagnostic reports, treatment reports, or messages, can be, or can be included in, or be attached to, an e-mail message, an instant messaging message, an electronic transmission, or an electronic data transmission or electronic data interchange, or can be transmitted via any other data or information transmission, and can be transmitted via or using any appropriate or necessary computer(s) or device(s). The message or can also be transmitted in a recorded telephone call or in a fax transmission.

The provider or the medical doctor can then, at step 1609, review the diagnostic report and/or treatment report and choose the final diagnosis and/or treatment plan, if needed, to administer to the individual or the patient.

At step 1610, the provider or the medical doctor can transmit the final diagnosis and treatment plan, including the prescribed treatment and/or treatment plan, if any, to the central processing computer 10. The prescribed treatment and/or treatment plan can also include a prescribed treatment, treatment regimen, information or instructions regarding further or additional examination and/or tests or testing, information regarding one or more prescriptions for further examination or testing, one or more doctor referrals, one or more prescriptions for further testing, blood work, x-rays, MRIs, CAT scans, PET scans, or other information gathering or testing, one or more prescriptions for prescribed drugs, medication, therapy, physical therapy, and/or other therapy. At step 1610, any prescription for any drug, medication, or therapy, can also be transmitted to a communication device or computer of or associated with other providers such as a respective pharmacy, or therapist. Similarly, at step 1610, any prescription for further examination or for follow-up testing of any kind, or a doctor referral, can also be transmitted to a communication device or computer of or associated with a respective provider.

In another preferred embodiment, at step 1610, the provider or the medical doctor or any other provider using the apparatus 100 can also generate and/or transmit a prescription or an electronic prescription for a medication, a medicine, or a drug, or for a procedure, a test, an analysis, an analysis work-up, blood work, a treatment, or a therapy, or can generate and/or transmit a referral to another provider, for submission or transmission to the respective pharmacy or other provider, and for storage in the individual or the patient's electronic healthcare record or healthcare file.

At step 1610, any data and/or information regarding any/or all of the herein-described final diagnoses and treatment plans, prescribed treatments and/or treatment plans, treatment regimens, or any of the information or instructions regarding further or additional examination and/or tests or testing, information regarding one or more prescriptions for further examination or testing, one or more doctor referrals, one or more prescriptions for further testing, blood work, x-rays, MRIs, CAT scans, PET scans, or other information gathering or testing, prescriptions for prescribed drugs, medication, therapy, physical therapy, and/or other therapy, further examination or follow-up testing of any kind, doctor referrals, or electronic prescriptions can also be stored in the individual's or the patients electronic healthcare record, and can also be transmitted to the respective user or patient communication device 40 of the individual, patient, or caregiver for the individual or the patient, to the provider communication device 20 of any other identified provider of the individual or the patient, to the insurer or payer communication device 30 of the insurer or payer of the individual or patient, or to any intermediary communication device 50 of any authorized intermediary.

In another preferred embodiment, the final diagnosis and treatment plan, including the prescribed treatment and/or treatment plan, can also be transmitted by the central processing computer 10, at step 1610, back to the provider for his or her records, to another provider of the individual or patient, to a payer or insurer of the individual or patient, to the individual or patient, or to a third party or intermediary, by transmitting the final diagnosis and/or treatment plan, to a respective provider computer or communication device 20, to a respective payer computer or communication device 30, to a respective user or patient computer or communication device 40, or to a respective intermediary computer or communication device 50 either directly, such as via any suitable electronic or other transmission, or indirectly, such as via an e-mail server in the case when the final diagnosis and treatment plan is included in, or is attached to, an e-mail message. The copy of the final diagnosis and treatment plan can also be stored by or in the respective provider computer or communication device 20, the respective payer computer or communication device 30, the respective user or patient computer or communication device 40, or the respective intermediary computer or communication device 50.

In another preferred embodiment, the final diagnosis and treatment plan can contain individual-specific or patient-specific educational information or individual-specific or patient-specific instructional information, or a link(s) or hyperlink(s) to same, regarding the diagnosis, treatment, or treatment plan, or information relating thereto, so as to provide this educational information or instructional information to the individual or patient. The individual or patient can thereafter access or obtain the educational information or instructional information via the apparatus 100 and method of the present invention. In this manner, the apparatus 100 and method of the present invention can provide individual-specific or patient-specific educational information or individual-specific or patient-specific instructional information regarding the diagnosis, treatment, or treatment plan.

In another preferred embodiment, the apparatus 100 or the central processing computer 10 can be programmed to identify the individual-specific or patient-specific educational information or individual-specific or patient-specific instructional information regarding the diagnosis, treatment, or treatment plan, and/or any information, link(s), or hyperlink(s), relating thereto or pertaining thereto.

In another preferred embodiment, the central processing computer 10 can be programmed to identify, and to include, in a diagnostic report or a treatment report, information regarding an insurance policy, product, or service, and an insurance exchange computer(s) 70 from which same may be purchase or subscribed to which may be of interest to, or which could be helpful or beneficial to the individual or the patient based on a diagnosis, a possible diagnosis, a prescribed treatment, a prescribed treatment, drug or medication, therapy, or procedure, identified in a respective diagnostic report or treatment report, and can include information or a link, links, a hyperlink or hyperlinks, to the insurance exchange computer(s) 70.

In another preferred embodiment, the central processing computer 10 can be programmed to identify, and to include, in a diagnostic report or a treatment report, information regarding a social network computer(s) 80 containing information or links to social networking support groups or social networking-based groups or information sources which may be of interest to, or which could be helpful or beneficial to the individual or the patient based on a diagnosis, a possible diagnosis, a prescribed treatment, a prescribed treatment, drug or medication, therapy, or procedure, identified in a respective diagnostic report or treatment report, and can include information or a link, links, a hyperlink or hyperlinks, to the a social network, a social network computer(s) 80, a social networking web site or support group, a social networking blog or chat room or discussion group, or any other social networking information.

In another preferred embodiment, the central processing computer 10 can be programmed to identify, and to include, in a diagnostic report or a treatment report, information regarding a media computer 90 or a media source which can provide information which may be of interest to, or which could be helpful or beneficial to the individual or the patient based on a diagnosis, a possible diagnosis, a prescribed treatment, a prescribed treatment, drug or medication, therapy, or procedure, identified in a respective diagnostic report or treatment report, and can include information or a link, links, a hyperlink or hyperlinks, to the media computer(s) 90.

In another preferred embodiment, the central processing computer 10, in addition to generating any of the herein-described diagnostic reports, treatment reports, or treatment plans, can also generate a wellness report, an exercise report, fitness report, a nutritional report, a diet report, a rehabilitation report, a therapy report, and/or any other report containing wellness information, exercise information, fitness information, suggested exercises and/or suggested fitness routines, nutritional information, diets, rehabilitation exercises or activities, and/or therapy information. The respective wellness report, exercise report, fitness report, nutritional report, diet report, rehabilitation report, therapy report, and/or any other report, can be generated using data and/or information contained in the individual's, patient's, or caregiver's electronic healthcare record or electronic healthcare file, and/or by using any information regarding any examination findings, procedure findings, symptoms, diagnoses, possible diagnoses, treatments, treatment plans, or any other information used in generating any of the herein-described diagnostic reports, treatment reports, or treatment plans. The respective wellness report, exercise report, fitness report, nutritional report, diet report, rehabilitation report, therapy report, and/or any other report, can be generated using data and/or information provided by any individual, patient, caregiver, by any provider, by any insurer or payer, or by any intermediary or third party.

The respective wellness report, exercise report, fitness report, nutritional report, diet report, rehabilitation report, therapy report, and/or any other report, can also be generated in connection with the generation of any diagnostic report, treatment report, or treatment plan. In a preferred embodiment, any of the herein-described diagnostic reports, treatment reports, or treatment plans, can include or contain the respective wellness report, exercise report, fitness report, nutritional report, diet report, rehabilitation report, therapy report, and/or any other report, or can include or contain a link(s) or a hyperlink(s) to the respective wellness report, exercise report, fitness report, nutritional report, diet report, rehabilitation report, therapy report, and/or any other report. Any and/or all of the respective wellness reports, exercise reports, fitness reports, nutritional reports, diet reports, rehabilitation reports, therapy reports, and/or any other reports, can be stored in the individual's, the patient's, or the caregiver's, electronic healthcare record of electronic healthcare file. Any of the herein-described diagnostic reports, treatment reports, or treatment plans, wellness reports, exercise reports, fitness reports, nutritional reports, diet reports, rehabilitation reports, therapy reports, and/or any other reports, can contain or include a link(s) or hyperlink(s) to a respective individual's, patient's, or caregiver's, electronic healthcare record or electronic healthcare file and any of the herein-described electronic healthcare records or electronic healthcare files of a respective individual, patient, or caregiver, can contain or include a link(s) or hyperlink(s) to a respective diagnostic report, treatment report, or treatment plan, wellness report, exercise report, fitness report, nutritional report, diet report, rehabilitation report, therapy report, and/or any other report.

In another preferred embodiment, any individual, patient, or caregiver, provider, or insurer or payer, or any intermediary or third party, can access the central processing computer 10 with a respective communication device 40, 20, 30, or 50 can request that a respective wellness report, exercise report, fitness report, nutritional report, diet report, rehabilitation report, therapy report, and/or any other report, be generated for the individual or patient. Thereafter, the central processing computer 10 can generate the respective wellness report, exercise report, fitness report, nutritional report, diet report, rehabilitation report, therapy report, and/or any other report, transmit same to the respective communication device 40, 20, 30, or 50 of the requesting individual, patient, or caregiver, provider, or insurer or payer, or any intermediary or third party, and/or store same in the electronic healthcare record or the electronic healthcare file of the individual, patient, or caregiver.

In another preferred embodiment, any of the herein-described diagnostic reports, treatment reports, treatment plans, wellness reports, exercise reports, fitness reports, nutritional reports, diet reports, rehabilitation reports, therapy reports, and/or any other reports, can include or can contain data and/or information regarding suggested or recommended providers, healthcare facilities, treatment facilities or centers, suggested appointments with providers, lifestyle suggestions, wellness or fitness suggestions, diet suggestions, and/or a link(s) or hyperlink(s) to any of the above data and/or information.

At step 1611, the central processing computer 10 will then update the individual or the patient's electronic healthcare record in the database 10H so as to include all of the data and information herein-described as being processed and/or generated by the central processing computer 10, including, but not limited to the individual or the patient's symptoms, if any, the examination findings, the information contained in the diagnostic report and the treatment report, the final diagnosis and the prescribed treatment, as well as any other reports, messages, or other data or information described as being generated, transmitted, or exchanged, by and/or between any of the computers or communication devices 10, 20, 30, 40, 50, 70, 80, an/or 90 in the embodiment if FIGS. 16A and 16B, as well as any of the other embodiments described herein. At step 1611, the central processing computer 10 can also update any healthcare records of the individual or the patient which are stored in any healthcare records computer(s) 60 or in any respective database(s) 60H of same.

At step 1611, the central processing computer 10 can also generate a message containing information regarding the individual or the patient's conditions or symptoms, if any, the examination findings, procedure findings, or any the information contained in the diagnostic report and/or the treatment report, the final diagnosis and/or the prescribed treatment. At step 1611, the central processing computer 10 can also transmit the message as an e-mail message, as a text message, as an instant messaging message, or as any other type of message, in electronic form or otherwise, to the individual or patient such as by transmitting same to the user or patient communication device 40 of or associated with the individual or patient, and/or to any one or more of a provider communication device 20 of or associated with the provider or another provider, a payer communication device 30 of or associated with the individual's or patient's payer or insurer, or, if authorized or allowed, to an intermediary communication device 50 of or associated with an intermediary authorized or allowed to receive same.

The message or messages, or any other communication(s) or transmission(s) described herein, provided to the individual or patient, to the provider or another provider, to the payer or insurer, or to the intermediary, can also contain information such as advertisement(s) or marketing materials for a healthcare product(s) or service(s), an advertisement(s) or marketing materials for a health, wellness, or exercise, product(s) or service(s), or a news report or other information, pertinent to the individual or patient, or pertinent to or relating to the individual's or patient's condition or symptoms, if any, any examination finding(s), any information contained in the diagnostic report and/or the treatment report, or any final diagnosis and/or prescribed treatment. At step 1611, the central processing computer 10, in response to a request by the provider, can also process information in order to request or create a subscription for the individual or patient so that the individual or patient can receive future information, by mail, by e-mail, text message, or otherwise, regarding a news report or other data or information which would be of interest to the individual or patient or pertinent to the individual's or patient's condition.

In the manner described above, the individual or patient can be provided with information regarding his or her provider's actions taken on his or her behalf, or the provider's diagnosis or treatment planning, pursuant to a diagnosis or a condition. In the manner described above, news or other information regarding an individual's or patient's health condition, symptoms, diagnosis, or treatment, can also be disseminated to the individual or patient on a regular and/or on an on-going basis. In this regard, news or information, which may be pertinent, relevant, or otherwise helpful, for allowing an individual or patient to understand a diagnosis, a treatment plan or regimen, a condition, or an illness, or which can help the individual or patient to take corrective or preventive action or measures regarding a condition or an illness, can be provided to the individual or patient, or can be transmitted to the individual or the user's or patient's communication device 40, at the provider's direction or discretion, on a one-time basis, on a regular on on-going basis, or when the news or information becomes available, or otherwise.

In another preferred embodiment, information regarding a providing of news or information to the individual or patient, as with the individual's or patient's other healthcare information, can be ordered, prescribed, or otherwise disseminated or provided to the individual or patient pursuant to, and/or in accordance with, any and/or all healthcare privacy laws, rules, or regulations, in effect at the time.

The news or information described herein can be disseminated or provided to an individual or patient based on, or in response to, a diagnosis, a prescribed treatment, a treatment plan, a drug or medication which can be recommended or prescribed for the individual or patient, a recommended or prescribed procedure or operation, a recommended or prescribed physical therapy, drug or medication therapy, alternate therapy, herbal therapy, acupuncture therapy, or any other therapy which may be recommended or prescribed by any of the providers or types of providers described herein, or in response to any other action taken by any provider in response to a condition, symptom, family healthcare history, diagnosis, or any other information obtained, regarding the individual or patient.

Thereafter, operation of the apparatus 100 will cease at step 1612. The individual or the patient's records will then be updated and be available for the individual or the patient's next treatment and/or diagnosis.

In another preferred embodiment, any and/or all of the data or information which is input, transmitted to, or provided by, the apparatus 100, when used as described in the embodiment of FIGS. 16A and 16B, can be dated stamped and/or time stamped.

In yet another preferred embodiment, any and/or all of the data or information which is input, transmitted to, or provided by, the apparatus 100, when used as described in the embodiment of FIGS. 16A and 16B, can be dated stamped and/or time stamped and stored for each individual, patient, caregiver, provider, insurer or payer, intermediary, healthcare records computer 60, insurance exchange computer 70 or insurance exchange owner, operator, or company, social networking computer 80, social networking company, support group, information source, discussion group, or chat room, or media computer 90 or media source or company. The above-described information can be stored, and/or sorted, for efficient record keeping purposes, auditing purposes, evaluation purposes, or for any other purpose.

In another preferred embodiment, the diagnostic report and/or treatment reports can be accompanied by medical information, textbook materials, laboratory materials, reference materials, video clips of any pertinent information, audio clips of any pertinent information, hyperlinks to informational sources, information regarding providers and/or facilities for obtaining treatment and/or therapy, provider and/or facility contact information, and/or any other pertinent and/or relevant information.

In another preferred embodiment, the central processing computer 10, upon generating the respective diagnostic report or treatment report or treatment plan, can also processing information regarding any of the herein-described providers and can identify a provider or providers who or which may be able to provide services to the individual or patient in helping to make or arrive at a diagnosis, select a diagnosis from a list of possible diagnoses, provide a treatment, perform a needed treatment, procedure, surgery, or other service for the individual or patient, or device or design a treatment plan for the individual or patient. In a preferred embodiment, the diagnostic report to the treatment report or treatment plan can contain information regarding the identified provider or providers including their contact information.

In another preferred embodiment, the central processing computer 10 can generate and transmit a notification message to any of the identified provider or providers informing them that they have been identified as being able to provide a service to the individual or patient in the respective diagnostic report, treatment report, or treatment plan. In another preferred embodiment, the notification message can also contain the diagnostic report, the treatment report, or the treatment plan, provided that the inclusion of such information has been permitted by the individual, patient, or caregiver, and/or the provision of such information is not made in violation of any applicable healthcare privacy laws, rules, or regulations.

In another preferred embodiment, the central processing computer 10, upon generating the respective diagnostic report or treatment report or treatment plan, can also processing information regarding any of the herein-described providers of any good(s), product(s), service(s), therapy(ies), medications, blood, organs, healthcare devices or equipment, or any other goods, products, or services, which may be identified as being essential to or helpful in making or arriving at a diagnosis, selecting a diagnosis from a list of possible diagnoses, providing a treatment, performing a needed treatment, procedure, surgery, or other service for the individual or patient, or designing, implementing, and/or effectuating, a treatment plan for the individual or patient. In a preferred embodiment, the diagnostic report to the treatment report or treatment plan can contain information regarding the identified provider or providers of such good(s), product(s), service(s), therapy(ies), medications, blood, organs, healthcare devices or equipment, or any other goods, products, or services, including their contact information.

In another preferred embodiment, the central processing computer 10 can generate and transmit a notification message to any of the identified provider or providers or any goods, products, services, therapy(ies), medications, blood, organs, healthcare devices or equipment, or any other goods, products, or services, informing them that they have been identified as being able to provide a respective good, products, services, therapy, medication, blood, organ, healthcare device or equipment, or any other good(s), product(s), or service(s), to the individual or patient in the respective diagnostic report, treatment report, or treatment plan. In another preferred embodiment, the notification message can also contain the diagnostic report, the treatment report, or the treatment plan, provided that the inclusion of such information has been permitted by the individual, patient, or caregiver, and/or the provision of such information is not made in violation of any applicable healthcare privacy laws, rules, or regulations.

In another preferred embodiment, the diagnostic report and/or treatment reports can be accompanied by health and/or wellness information which can include suggestions for health and/or wellness foods, goods, products, and/or services. The diagnostic report and/or treatment reports can also be accompanied by health and/or fitness information, diets, nutritional information, and/or any other information which may be of assistance to the individual or the patient and/or provider. The diagnostic and/or treatment reports can also contain warnings regarding misdiagnoses, warnings about treatments, information about experimental treatments, etc. The diagnostic and/or treatment reports can also contain information, statistical and/or otherwise, regarding diagnoses, misdiagnoses, treatment successes, and/or treatment failures. The diagnostic and/or treatment reports can also contain information regarding alternate medicine such as treatments regarding herbal remedies and/or treatments, meditation, self-healing, faith healing, yoga, tai chi, exercise therapy, and/or other therapies and/or therapy types.

As noted above, the method of utilizing the present invention, as described in FIGS. 16A and 16B, is equally applicable to, and can be utilized in the same manner, by any and/or all of the respective healthcare providers, professionals, and/or related providers. The apparatus of FIGS. 16A and 16B can also be utilized in a same or similar manner by any of the herein-described users, individual, patients, caregivers, healthcare providers, or healthcare insurers, healthcare payers, or intermediaries. In another preferred embodiment, the apparatus 100 can ensure that all privacy laws, rules and regulations, and patient confidentiality laws, rules, and regulations, are followed, abided by, and/or complete confidentiality maintained so as to allow any of the herein-described users, individual, patients, caregivers, healthcare providers, or healthcare insurers, healthcare payers, or intermediaries to access and make use of any information which may be helpful or useful to them or others under their care or for whom they have a relationship or to who they have an obligation, duty, or responsibility.

The apparatus of FIGS. 16A and 16B can also utilize electronic signatures and/or process electronic signatures and/or electronic signature information which can correspond to any of the herein-described parties in performing any of the herein-described processing routines and/or functions.

In another preferred embodiment, the apparatus and method of the present invention can be utilized to ensure that a proper treatment and/or procedure is performed on the individual or the patient. Referring once again to FIGS. 16A and 16B and the above description of same, the apparatus 100 of the present invention can also be utilized to ensure that a subsequent treatment and/or treatments are performed as prescribed. As noted above and, in particular, a final diagnosis and prescribed treatment can be stored in the individual or the patient's electronic healthcare record, file or records in the database 10H of the central processing computer 10.

When the individual or the patient seeks treatment from a subsequent provider, medical doctor, surgeon, or other healthcare professional, the provider, medical doctor, surgeon, or other healthcare professional, can access the central processing computer 10 at the time of treatment, access the individual or the patient's electronic healthcare record or medical history and prescribed treatment plan and assess same in order to make sure that the treatment to be provided is called for in the prescribed treatment. In this manner, the apparatus 100 of the present invention can be utilized in order to prevent healthcare, medical and/or surgical mistakes, mishaps and/or other instances when improper treatment could occur.

It is also envisioned that the subsequent care provider, medical doctor, surgeon, or other healthcare professional, could also re-evaluate the individual or the patient's condition and/or electronic healthcare records and seek additional assistance and/or perform a separate and independent assessment and/or diagnosis of the individual or the patient. In any event, the present invention can provide the subsequent care provider, medical doctor, surgeon, or other healthcare professional, with the individual or the patient's complete healthcare records, healthcare or medical history, information, past diagnoses and/or past treatments and/or prescriptions. In this manner, a subsequent care provider can be provided with as complete and as up to date information as possible in order to administer treatment.

For example, the present invention can be utilized in the following manner. A patient scheduled for surgery on a certain body part (i.e. left ankle) may enter the hospital. Due to a hospital clerical error, the right ankle is noted to be operated on.

Prior to the surgery, the surgeon may access the central processing computer 10 and the individual's or the patient's electronic healthcare record, via a provider communication device 20 located in the operating room, and/or another location in the hospital, in order to verify the procedure to be performed. In response thereto, the central processing computer 10 will transmit a message that it is the left ankle which is to be operated on. Thereafter, the surgeon can investigate the situation and ensure that the correct and prescribed surgery and/or procedure is performed. Once the surgery is completed, the individual or the patient's electronic healthcare record will be updated accordingly. While a surgical procedure is described, it is important to note that any treatment, procedure, etc., which can be performed by any healthcare professional or provider described herein, and/or in any healthcare field described herein, can be verified in the above-described manner. In this manner, the apparatus 100 of the present invention can be utilized to pre-screen subsequent and/or follow-up treatments and/or procedures so as to prevent healthcare mistakes and/or mishaps.

The embodiment of FIGS. 16A and 16B can perform diagnoses by utilizing entered data and/or information and/or data and/or information which can be obtained by, acquired by, and/or measured by, any of the herein-described user input devices 20D.

In another preferred embodiment, the healthcare provider or professional can access the central processing computer 10 via the provider communication device 20, access the individual's or the patient's electronic healthcare record or the patient's or client's record and input information concerning the treatment and/or procedure to be performed. Thereafter, the central processing computer 10 can process the information and transmit a message to the healthcare provider or professional notifying the healthcare provider or professional that the treatment and/or procedure is either the prescribed treatment or procedure or that it is not the prescribed treatment and/or procedure. The message provided by the central processing computer 10, to the treating healthcare provider or professional, can also include information regarding the treatment and/or the procedure, such as instructions, steps, and/or any other accompanying information.

In any and/or all of the embodiments described herein, the central processing computer 10, in performing any processing of patient information, diagnosis information, and/or treatment information, described herein, can perform such processing in conjunction with drug and/or other treatment interaction information so as to provide an added safeguard in the diagnosis and treatment planning processes. Any and/or all processing described herein is also performed in conjunction with each individual's or patient's electronic healthcare record and any and/or all data and/or information contained or stored therein, healthcare or medical history, family history, allergic conditions information, and/or with any other information deemed important and/or essential in the individual's healthcare diagnoses and/or treatments.

In another preferred embodiment, any of the diagnostic reports or treatment reports can also contain an advertisement or advertisements for any goods, products, or services, including, but not limited to, any healthcare, healthcare-related, fitness, wellness, nutritional, and/or any other goods, products, or services.

Although described as being utilized by a provider, it is important to note that the embodiment of FIGS. 16A and 16B can be utilized in a same, a similar, and/or in an analogous manner, by any of the herein-described users, individuals, patients, caregivers providers, insurers, payers, and/or intermediaries, in order to ascertain a diagnosis or a treatment and/or in order to check on, verify, and/or ascertain the correctness of a diagnosis of another and/or to formulate, plan, check on, verify, and/or ascertain the correctness of a diagnosis, a treatment, or a treatment plan.

In another preferred embodiment, the present invention can be utilized to perform treatment evaluations and/or treatment monitoring. In this manner, the present invention can be utilized by any of the providers, insurers, payers, users, individuals, patients, caregivers, and/or intermediaries, described herein to evaluate and/or to monitor treatments, provide training and/or oversight for healthcare providers and/or professionals, and/or to allow insurers or payers and/or insurance companies to evaluate treatments, treatment plans, treatment progress, and/or any other evaluations and/or verifications for healthcare claims processing. In this embodiment, the present invention can be utilized so as to safeguard against the use of incorrect and/or unconventional and/or fraudulent treatment and/or care.

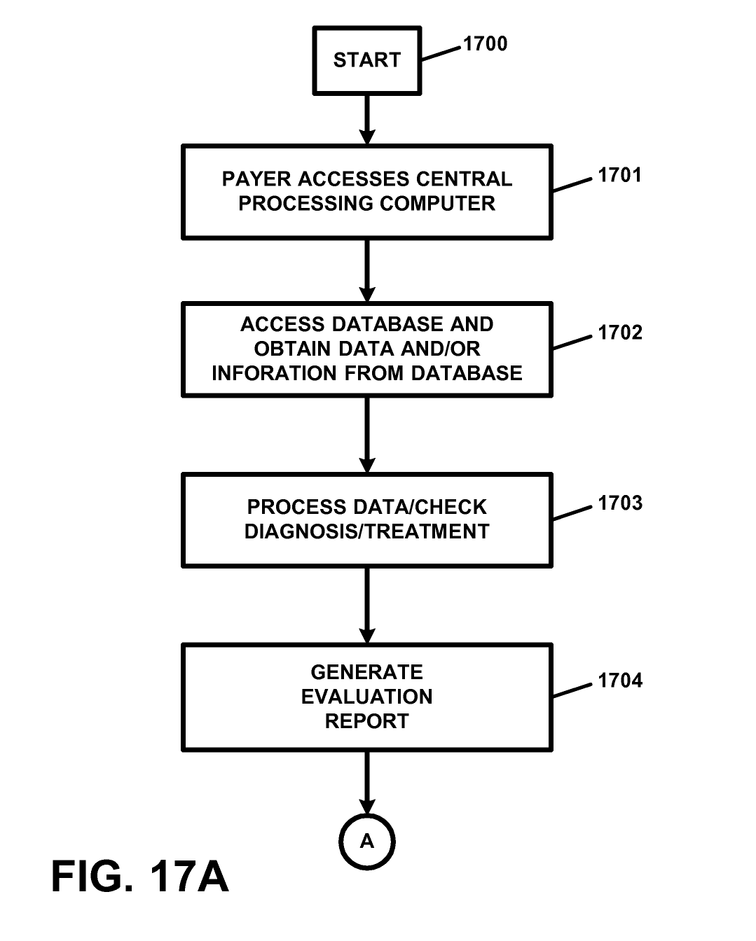

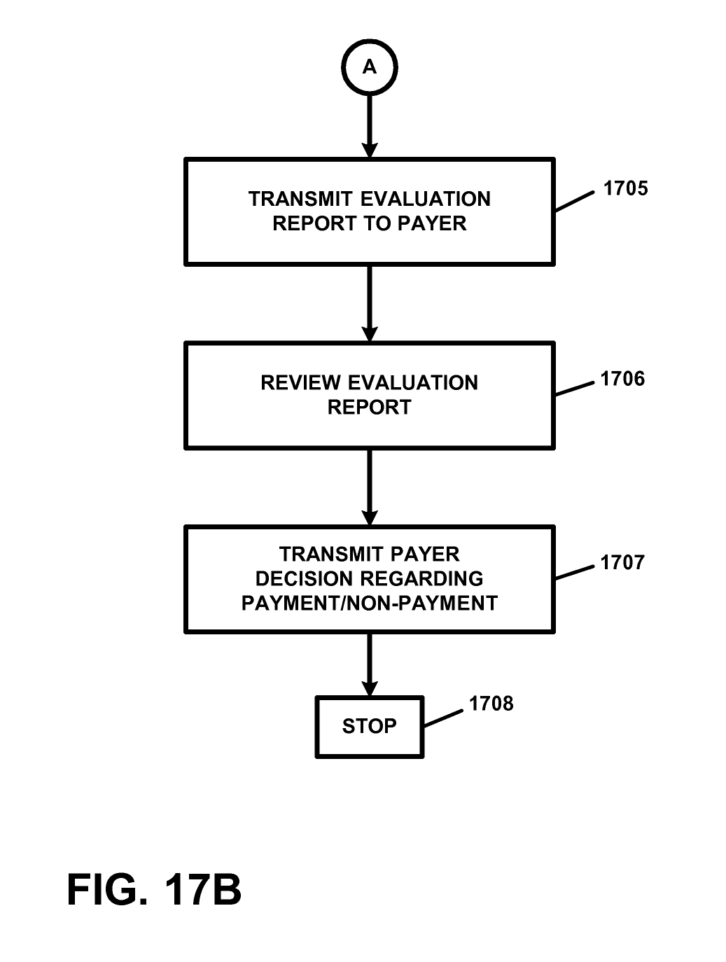

FIGS. 17A and 17B illustrate another preferred embodiment of a method of use of the present invention, in flow diagram form. FIGS. 17A and 17B illustrate a preferred embodiment method of use of the apparatus 100 of the present invention in order to evaluate and/or to monitor treatments, treatment plans and/or the administration of healthcare and/or healthcare-related services. While described as being utilized by healthcare insurers or payers and/or an insurance company in evaluating and/or monitoring treatment, it is important to note that the embodiment of FIGS. 17A and 17B can be utilized by any provider, user, individual, patient, caregiver, or intermediary, as well as by healthcare students and/or healthcare professionals-in-training, or other providers, and/or intermediaries, for obtaining the information provided by the embodiment of FIGS. 17A and 17B and utilizing it any manner they see fit.

With reference to FIGS. 17A and 17B, the operation of the apparatus 100 commences at step 1700. At step 1701, an employee of agent of the insurer or payer (hereinafter, for simplicity, referred to as the “insurer's or the payer's employee”) can access the central processing computer 10 via the insurer or payer communication device 30. At step 1701, the insurer's or payer's employee can enter and transmit, to the central processing computer 10, information concerning the individual or the patient, the treatment, and/or care, which is desired to be evaluated and/or monitored.

At step 1702, the central processing computer 10 will access the database 10H and obtain individual information or patient information, the individual's or patient's electronic healthcare record and any information contained therein, the patient's healthcare or medical history, family history, if pertinent, symptom information, provider information, diagnostic report information, treatment report information, final diagnoses information, prescribed treatment information, and/or any other information which can be relevant and/or pertinent. Any and/or all of the information described above can be stored in the database 10H from prior processing and/or use of the present invention. Any of the diagnostic reports or treatment reports previously generated by the apparatus 100 for any other individuals or patients can also be utilized in this preferred embodiment, with it being understood that personal, private, or confidential information regarding any of these other individuals or patients are properly safeguarded. Other data and/or information can also be obtained from the insurer's or payer's employee and/or from other third party and/or outside sources.

At step 1703, the central processing computer 10 will perform a processing routine in conjunction with the above-described information in order to determine if the diagnoses and associated and/or related treatment or treatments or treatment plan are appropriate and/or in-line with current standards for the given healthcare field. The central processing computer 10 can also calculate and/or provide statistical information regarding any of diagnoses and/or treatments or treatment plans under study. At step 1704, the central processing computer 10 will generate an evaluation report which will provide data and information regarding the information obtained from step 1703.

The central processing computer 10 can then, at step 1705, transmit the evaluation report and/or any other appropriate information, to the insurer or payer communication device 30. The central processing computer, in another preferred embodiment, can, at step 1703 and/or at step 1704, determine and/or provide, as part of the evaluation report, information concerning whether the diagnoses and/or treatment(s) or treatment plan are considered appropriate and/or valid, and/or in-line with current or accepted standards, as well as recommend that claims for the treatment(s) are valid and should be paid by the insurer or payer, and/or that the claims for the treatment(s) or treatment plan are invalid and should be denied.

The evaluation report can also contain information analyzing or reviewing the healthcare provider who arrived at the diagnosis or who prescribed the treatment or treatment plan. The evaluation report can also be date-stamped and/or time-stamped. At step 1705, the central processing computer 10 can also store the evaluation report in the electronic healthcare record of the individual or patient. At step 1705, the central processing computer 10 an also generate an evaluation report alert message or notification message which can contain information regarding the person or entity, or the insurer or payer who or which requested the evaluation report, the time and date of such request, and the evaluation report itself. The evaluation report alert message or notification message can also be date-stamped or time-stamped.

At step 1705, the central processing computer 10 can also transmit the evaluation report and/or the evaluation report alert message or notification message to a respective provider communication device 20 of any provider(s) of the individual or patient, to a respective insurer or payer communication device 30 of any insurer or payer of the individual or patient, to any user or patient communication device 40 of the individual, patient, or caregiver, of the individual or patient, or to any intermediary computer 50 of any authorized intermediary or third party. In another preferred embodiment, at step 1705, the evaluation report and/or the evaluation report alert message or notification message can also be stored in the individual's, the patient's, or the caregiver's, electronic healthcare record.

Thereafter, at step 1706, the insurer's or the payer's employee can review the evaluation report and take any action deemed appropriate. In another preferred embodiment, the evaluation report can also contain an advertisement(s) or marketing material for a product(s) or service(s) deemed to be of interest for the insurer or payer or for the insurer's the payer's employee. At step 1707, the insurer's or payer's employee can transmit data and/or information regarding the insurer or payer employee's action and/or decision. Step 1707 is an optional step and can be dispensed with if the insurer's or payer's employee chooses not to respond to the valuation report and/or not to transmit information to the central processing computer 10. Thereafter, the operation of the apparatus will cease at step 1708.

The apparatus 100 of FIGS. 17A and 17B can also be utilized in a same, similar, or analogous manner, by any of the herein-described providers, users, individuals, patients, caregivers, or intermediaries, as well as by healthcare students and/or healthcare professionals-in-training, or other providers, and/or intermediaries, in order to ascertain or evaluate a diagnosis, a treatment, a treatment plan, or a course of care for an individual or patient.

The apparatus 100 of FIGS. 17A and 17B can also utilize electronic signatures and/or process electronic signatures and/or electronic signature information which can correspond to any of the herein-described parties in performing any of the herein-described processing routines and/or functions.

The apparatus 100 of the present invention, when utilized as described in FIGS. 17A and 17B, can also provide treatment evaluation and/or monitoring for healthcare insurers or payers which can be utilized for performing claims processing, provider evaluations, individual or patient evaluations, and/or any other useful and/or desired purpose. The apparatus 100 of the present invention, when utilized as described in FIGS. 17A and 17B, can also be utilized by any provider, individual, patient, caregiver, insurer, payer, user, and/or intermediary, in order to evaluate and/or to monitor treatments, evaluate providers, evaluate individuals or patients, evaluate insurers or payers, ascertain insurers or payers claims paying and/or processing traits, for evaluation healthcare training scenarios, and/or for educational purposes and/or for any other useful and/or desired purpose.

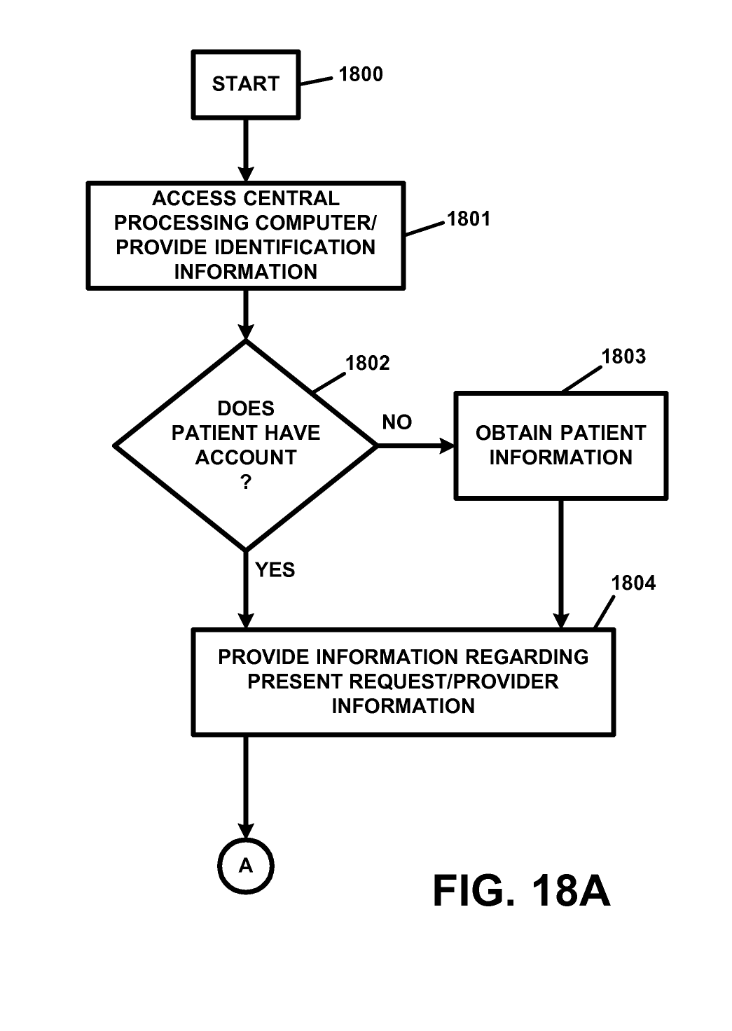

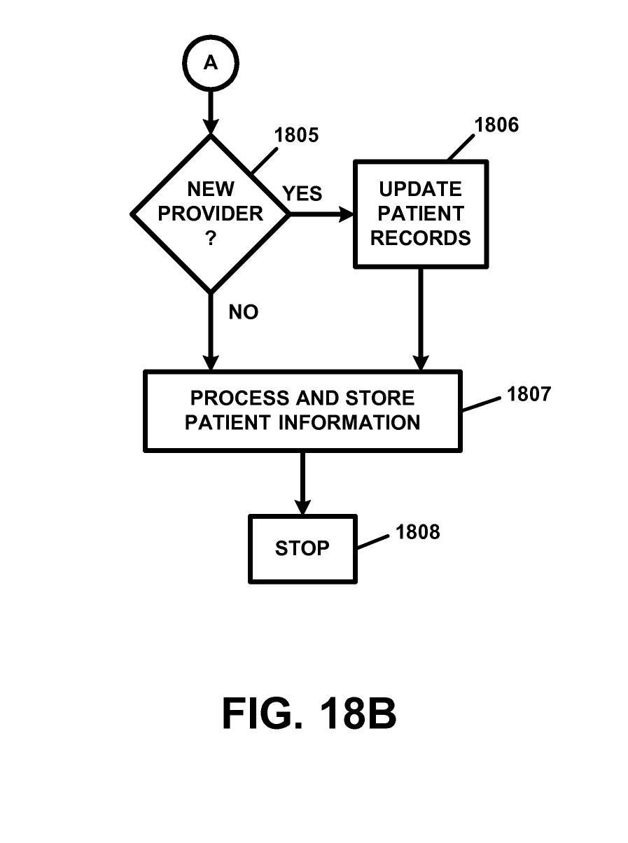

In another preferred embodiment of the present invention, the apparatus and method of the present invention can be utilized to create and maintain a comprehensive electronic healthcare record(s) or database for an individual or patient or for a caregiver of the individual or patient. FIGS. 18A and 18B illustrate another preferred embodiment use of the present invention, in flow diagram form. With reference to FIGS. 18A and 18B, the operation of the apparatus 100 commences at step 1800.

At step 1801, the individual or patient, or the caregiver for the individual or patient, can access the central processing computer 10 via the user or patient communication device 40 and provide identification information. At step 1802, the central processing computer 10 will determine whether the individual or patient has an account and/or a file, or an electronic healthcare record(s), with the central processing computer 10 and/or the service utilizing same. If, at step 1802, it is determined that the individual or the patient does not have an account and/or a file, or an electronic healthcare record(s), with the central processing computer 10, the processing will proceed to step 1803 and individual or patient or the caregiver will be prompted and/or asked to provide information to establish an electronic healthcare record, fill out any necessary forms and/or answer any questions, so as to provide a comprehensive electronic health history, medical history, dental history, and any family history, if possible.

All provided data and/or information will be entered into a newly established or created electronic healthcare record, which will be created by the central processing computer 10, and will be stored in the database 10H and an individual or patient electronic healthcare record, account, file, and/or record, will be created at step 1803. At step 1803, the central processing computer 10 will transmit a copy of the electronic healthcare record to the healthcare records computer 60 for storage and/or safeguarding thereat. Thereafter, processing will proceed to step 1804. If, at step 1802, the individual or patient is determined to have an electronic healthcare record and/or account with the central processing computer 10, processing will proceed directly to step 1804.

At step 1804, the individual, patient, or caregiver, will provide information concerning the present healthcare request and present provider information or present insurer or payer information. At step 1805, the central processing computer 10, will then determine if the present provider is a new provider and/or is the present insurer or payer is a new insurer or payer. If, at step 1805, it is determined that the present provider is a new provider or that the present insurer or payer is a new insurer or payer, the central processing computer 10 will proceed to step 1806 and update the individual's, patient's, or caregiver's, electronic healthcare record so as to include the present provider as a new provider for the individual or the patient or update the update the individual's or patient's electronic healthcare record so as to include the present insurer or payer as new insurer or payer for the individual or the patient. Thereafter, the central processing computer 10 will proceed to step 1807 and will process and store, in the database 10H and/or in the individual's, patient's, or caregiver's, electronic healthcare record, any pertinent individual or patient information, symptoms, diagnoses and/or treatments, final diagnosis and/or prescribed treatment, for the provider visit or for the event or occurrence. The central processing computer 10 will also, at step 1806, update any of the individual's, patient's, or caregiver's, electronic healthcare record(s) stored at the healthcare records computer 60.

If, however, at step 1805, it is determined that the present provider is an existing provider for the individual or patient or that the present insurer or payer is an existing insurer or payer for the individual or patient, the central processing computer 10 will proceed directly to step 1807 and process and store, in the database 10H and/or in the individual's or patient's electronic healthcare record(s), any pertinent patient information, symptoms, diagnoses and/or treatments, final diagnosis and/or prescribed treatment, for the provider visit or for the event or occurrence. The central processing computer 10 will also, at step 1807, update any of the individual's or patient's electronic healthcare record(s) stored at the healthcare records computer 60. Thereafter, operation of the present invention will cease at step 1808.

The apparatus of FIGS. 18A and 18B can also utilize electronic signatures and/or process electronic signatures and/or electronic signature information which can correspond to any of the herein-described parties in performing any of the herein-described processing routines and/or functions.

In this manner, the present invention can be utilized so as to create and maintain a comprehensive electronic healthcare record or database and/or individual or patient database which can be accessed by any provider, insurer, payer, user, individual, patient, or caregiver of the individual or patient, or any intermediary, and/or other party or user, in order to access the individual's or patient's electronic healthcare record(s). The comprehensive electronic healthcare record or database, which in the preferred embodiment of the present invention, is stored and/or maintained in the database 10H of the central processing computer 10 and in the database 60h of the healthcare records computers, can contain and/or store any of the data and/or information obtained from, and/or provided by, any and/or all of the herein-described embodiments of the present invention. Any of the electronic healthcare records stored in the database 10H of the central processing computer 10 or in the database 60H of the healthcare records computer 60 for any individual, patient, or caregiver, can also contain links or hyperlinks to any other electronic healthcare record, electronic medical record, electronic dental record, or electronic behavioral health record of the individual, patient, or the caregiver of the individual or patient.

The comprehensive electronic healthcare record or database provides a data and/or information source which can be accessed by any user, individual, patient, caregiver, provider, insurer, payer, or any other authorized person, entity, or intermediary, from anywhere in the world, and at any time, in order to obtain information about an individual or patient for any appropriate reason or purpose. For example, an individual or patient, or a caregiver for the individual or patient, traveling far from home and/or otherwise out of physical reach, can be treated by, or can obtain treatment for the individual or patient in the case of use by a caregiver, by another provider or healthcare facility who or which can access the central processing computer 10 and/or the healthcare records computer 60, from any location, and at any time, and obtain up-to-date and/or comprehensive individual or patient healthcare and/or medical and/or family history information, current healthcare and/or medical condition information, and/or current treatment and/or care and/or any other information which can facilitate optimal healthcare and/or medical treatment.

In the same manner, new providers can obtain existing information concerning the individual's or patient's healthcare and/or medical history, family history, current healthcare conditions and/or treatments, as well as any other information from the central processing computer 10 and/or from the healthcare records computer 60 thereby allowing the new provider to obtain accurate and up-to-date individual or patient information and dispensing with the need to obtain same from the individual or patient. The information provided from the apparatus 100 of the present invention can also assist the any provider in diagnosing the individual or patient. Providers can also utilize the comprehensive database provided by the apparatus 100 in order to ascertain past and/or current providers who may be contacted for assistance and/or for insight in the treatment process.

In a similar manner, insurer or payers can also utilize the comprehensive electronic healthcare record or database provided by the apparatus 100 in order to ascertain payer eligibility, the existence of pre-existing conditions, and/or to obtain any other useful information.

In another preferred embodiment, any individual, patient, or a caregiver, can access, change, modify, or update, any information in the comprehensive electronic healthcare record or database by accessing the central processing computer 10 and/or the healthcare records computer 60 via and by using a user or patient communication device 40.

The comprehensive electronic healthcare record or database can also contain, for each individual, patient, or caregiver, information, a link(s), or a hyperlink(s) to any provider communication device 20, insurer or patient communication device 30, healthcare records computer 60, insurance exchange computer 70, social networking computer 80, or media computer 90.

In another preferred embodiment, the apparatus 100 of the present invention can be utilized in order to find, identify, and/or to locate, providers and/or insurers or payers of, and for, respectively, various healthcare treatments, healthcare services and/or healthcare goods or products and/or healthcare-related goods, products, or services. Information regarding the various providers and/or insurers or payers, along with information regarding the services and/or goods or products they provide and/or insure or pay for, respectively, is stored in the database 10H.

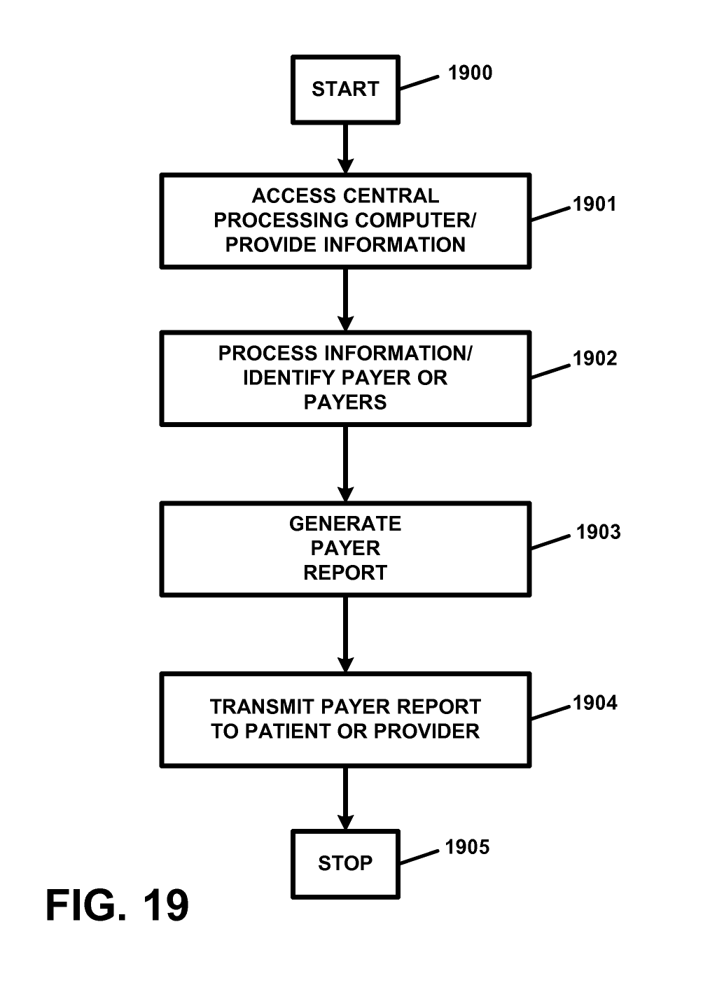

FIG. 19 illustrates another preferred embodiment method of utilizing the apparatus 100 of the present invention, in flow diagram form. In the embodiment of FIG. 19, the apparatus 100 of the present invention can be utilized by any user, individual, patient, caregiver, provider, insurer or payer, and/or intermediary, in order to find, identify, or locate, a provider and/or an insurer or payer of healthcare and/or healthcare-related services, goods, or products. For example, assume that an individual or patient has been recently diagnosed as needing an operation to repair his vision. The individual, patient, or his or her caregiver or provider would need to find a doctor who specializes in performing the needed surgical procedure. The apparatus 100 of the present invention can thereafter be utilized to locate a specialist for performing that service or function.

With reference to FIG. 19, the operation of the apparatus 100 commences at step 1900. At step 1901, the individual, patient, caregiver, or provider, can access the central processing computer 10 via a respective user or patient communication device 40 or provider communication device 20 and provide or enter and transmit information to the central processing computer 10 regarding the service needed. At step 1902, the central processing computer 10 will process the request and identify one or more specialists along with their backgrounds, insurance coverage accepted, fees, and/or any educational and/or professional experience and/or any other information about the provider. At step 1903, the central processing computer 10 can then generate a provider report and transmit same to the respective user or patient communication device 40 or provider communication device 20 at step 1904. At step 1904, the provider report can also be transmitted to the provider communication device 20 associated with the provider who or which was identified in the provider report. At step 1904, the provider report can also be stored in the individual's or patient's electronic healthcare record in the database 10H and in the database 60H of the healthcare records computer 60. At step 1904, the provider report can also be transmitted to the insurer or payer communication device 30.

In a preferred embodiment, the provider report can be, or can be included in, or be attached to, an e-mail message, an instant messaging message, an electronic transmission, or an electronic data transmission or electronic data interchange, or can be transmitted via any other data or information transmission, and can be transmitted via or using any appropriate or necessary computer(s) or device(s). The provider report can also be transmitted in a recorded telephone call or in a fax transmission. Thereafter, operation of the apparatus 100 will cease at step 1905.

In a same, similar, or analogous, manner, the embodiment of FIG. 19 can also be utilized to find, identify, or locate a healthcare or healthcare-related facility, hospital, laboratory, of other entity which can provide certain services, or provide a certain and/or desired type, kind, or form, of care and/or for obtaining a certain procedure or service. In this embodiment, the healthcare or healthcare-related facility is defined to be a provider and the apparatus 100 of the present invention can be utilized as described above. In yet another preferred embodiment, the apparatus 100 of FIG. 19 can also be utilized to find, identify, or locate, any type or kind of good, product, or service, drugs, medication, therapy services, blood or other supplies, body organs, or any other good, product, or service.

In another preferred embodiment, the apparatus 100 can also be utilized in a same, similar, or analogous, manner in order to find, identify, or locate healthcare, disability, and/or life, insurance providers or insurers, or any other healthcare insurers or payers. In this regard, the apparatus 100 of the present invention and/or the embodiment of FIG. 19 can, for example, be utilized to find, identify, or locate, a healthcare insurer or payer or an insurance company for providing a desired coverage and/or for paying for certain treatments and/or procedures and/or any goods, products, or services. In the case of finding, identifying, or locating, insurers or payers, the method of the preferred embodiment of FIG. 10 can be utilized in a same, a similar, or an analogous, manner for finding, identifying, or locating, insurers or payers of any type or kind of healthcare or healthcare-related providers, providers or goods, products, or services, and/or insurers or payers, and/or providers or fitness or wellness goods, products, or services.

In another preferred embodiment, the apparatus 100 of FIG. 19 can be utilized to obtain an insurer or payer report which can allow a user to identify or locate an insurer or payer. In such an embodiment, at step 1901, the individual, patient, caregiver, or provider, can access the central processing computer 10 using a respective communication device 40 or 20 and provide information regarding the coverage needed. At step 1902, the central processing computer 10 will process the request and identify one or more insurers or payers along with information about the respective insurer, insurers, payer, or payers. At step 1903, the central processing computer 10 can generate an insurer or payer report and, at step 1904, can transmit same to the respective communication device 40 or 20 of the individual, patient, caregiver, or provider. At step 1904, the insurer or payer report can also be transmitted to the insurer or payer communication device 30 associated with the insurer or payer who or which was identified in the insurer or payer report. The insurer or payer report can also be stored in the individual's or patient's electronic healthcare record in the database 10H and in the database 60H of the healthcare records computer 60. The insurer or payer report can also be transmitted to the insurer or payer communication device 30 of any current insurer or payer of the individual or patient.

In a preferred embodiment, the insurer or payer report can be, or can be included in, or be attached to, an e-mail message, an instant messaging message, an electronic transmission, or an electronic data transmission or electronic data interchange, or can be transmitted via any other data or information transmission, and can be transmitted via or using any appropriate or necessary computer(s) or device(s). The insurer or payer report can also be transmitted in a recorded telephone call or in a fax transmission. Thereafter, operation of the apparatus ceases at step 1905.

In another preferred embodiment of FIG. 19, the apparatus 100 and/or the embodiment of FIG. 19 can be utilized to find, identify, or locate supplies, body organs, blood, medications, drugs, healthcare devices or equipment, and/or any other goods, products, or supplies. In this embodiment, information regarding the identification, location, cost, or any other information regarding any of any of the above-described goods, products, or supplies, body organs, blood, medications, drugs, healthcare devices or equipment, and/or any other goods, products, or supplies, can be stored in the database 10H.

With reference to FIG. 19, operation of the apparatus 100 commences at step 1900. At step 1901, the user, individual, patient, caregiver, or provider, can access that central processing computer 10 via a respective communication device 40 or 20 and can enter, and transmit to the central processing computer 10, information regarding the good, products, supply, body organ, blood, medication, and/or any other good, product, or supply or supplies needed.

At step 1902, the central processing computer 10 will process the request and identify the existence and/or location of the respective good, product, supply, body organ, blood, medication, and/or any other good, product, or supply or supplies, along with its location, cost and any other pertinent information. At step 1903, the central processing computer 10 can generate a report and transmit same to the respective communication device 40 or 20 of the individual, patient, caregiver, or provider. At step 1904, the report can also be transmitted to the insurer or payer communication device 30 of the individual's or patient's insurer or payer. At step 1904, the report can also be transmitted to the provider communication device 20 associated with the provider who or which was identified in the report. The report can also be stored in the individual's or patient's electronic healthcare record in the database 10H and in the database 60H of the healthcare records computer 60. The report can also be transmitted to the insurer or payer communication device 30 of any current insurer or payer of the individual or patient.

In a preferred embodiment, the report can be, or can be included in, or be attached to, an e-mail message, an instant messaging message, an electronic transmission, or an electronic data transmission or electronic data interchange, or can be transmitted via any other data or information transmission, and can be transmitted via or using any appropriate or necessary computer(s) or device(s). The report can also be transmitted in a recorded telephone call or in a fax transmission. Thereafter, operation of the apparatus ceases at step 1905.

In another preferred embodiment, the apparatus 100 and/or the embodiment of FIG. 19 can also be utilized to find, identify, or locate, an insurer, a payer, or an insurance company for providing a desired coverage and/or for paying for certain treatments and/or procedures. In the case of locating insurers or payers, the method of FIG. 19, as described above, can be utilized for finding, identifying, or locating, an insurer(s) or payer(s) for certain healthcare services, goods or products. For example, at step 1901, the individual, patient, caregiver, or provider, can access the central processing computer 10 and enter and transmit information regarding the coverage needed. At step 1902, the central processing computer 10 will process the request and identify one or more insures or payers along with information about the insurer, insurers, payer, or payers. At step 1903, the central processing computer 10 can generate a report containing information regarding the identified insurer(s) or payer(s) and, at step 1904, can transmit same to the respective communication device 40 or 20 of the individual, patient, caregiver, or provider, patient or provider. At step 1904, the report can also be transmitted to the insurer or payer communication device 30 of each insurer or payer identified in the report. Thereafter, operation of the apparatus ceases at step 1905.

In another preferred embodiment of FIG. 19, any reports pertaining to identified insurers or payers can also be transmitted to, and stores, at the insurance exchange computer 70 so that users or subscribed of same can be apprises of the types or kinds of coverage which are needed by individuals, patients, or their caregivers or providers.

In another preferred embodiment, any of the provider reports, insurer or payer reports, or other reports, can contain an advertisement(s) or marketing material for a provider, insurer or payer, a good(s), product(s) or service(s), or any providers of same, which may deemed to be of interest to the user, individual, patient, provider, or insurer or payer.

The embodiment of FIG. 19 can also be utilized by intermediaries, such as insurance brokers who need to find, identify, or locate, certain insurance companies, insurers, and/or payers, who meet the needs of certain individuals, patients and/or clients, and/or other individuals and/or third parties.

In another preferred embodiment of FIG. 19, any user, individual, patient, caregiver, provider, insurer or payer, and/or intermediary, can request to be notified of the availability of a provider, the emergence of an individual or patient in need of a certain care, the availability of an insurer, payer, or an insurance company, to offer a policy or a certain policy, the availability of a healthcare facility to provide certain care, the availability of certain goods, products, supplies, a body organ, a blood type, an expiration of an insurance policy (i.e. healthcare insurance, life insurance, disability insurance, etc.) and/or the occurrence of any event which may be of interest to any of the users, individuals, patients, caregivers, providers, insurers or payers, and/or intermediaries, described herein.

In this embodiment, the party requesting to be notified of the event or occurrence, whichever it may be, (hereinafter the “requesting party”), can access the central processing computer 10 via their respective communication device. Thereafter, the requesting party can enter his or her request, provide any conditions attached to the request, and provide contact information. The central processing computer 10 can process the information received from the requesting party and store all pertinent information in the database 10H.

Thereafter, another party (hereinafter the “supplying party”) can access the central processing computer 10 in order to enter information about the occurrence of an event and/or the availability of a good, product, supply, a body organ, a blood type, an expiration of an insurance policy (i.e. healthcare insurance, life insurance, disability insurance, etc.) any occurrence of any event or other envisioned occurrence, or in order to review requests which have been previously submitted, to which the supplying party may be interested in responding.

If the entry of the supplying party can satisfy a request of a requesting party, and/or if the supplying party desires to satisfy a request of a requesting party, the central processing computer 10 will generate and/or transmit a message, an e-mail message, a beeper or pager message, and/or a telephone call, and/or other communication or communication transmission to the communication device of the requesting party.

The communication or message can include information for bringing the requesting party and the supplying party together to act towards effecting and/or consummating the transaction. Thereafter, upon notification to the central processing computer 10 by either the requesting party and/or the supplying party, or both, the central processing computer 10 can remove the request from the database 10H. In this manner, the central processing computer 10 and/or the apparatus 100 can be utilized as a clearinghouse for effecting transactions for or involving any of the services, goods, and/or products, and/or any other entities, described herein.

In another preferred embodiment, the present invention can be utilized to schedule appointments for, with, or by any of the users, individuals, patients, caregivers, providers, insurers or payers, and/or intermediaries, described herein. In this manner, for example, an individual or patient, or a caregiver, can make an appointment with a provider using the apparatus 100 of the present invention and/or over the communication network which services the apparatus 100 of the present invention.

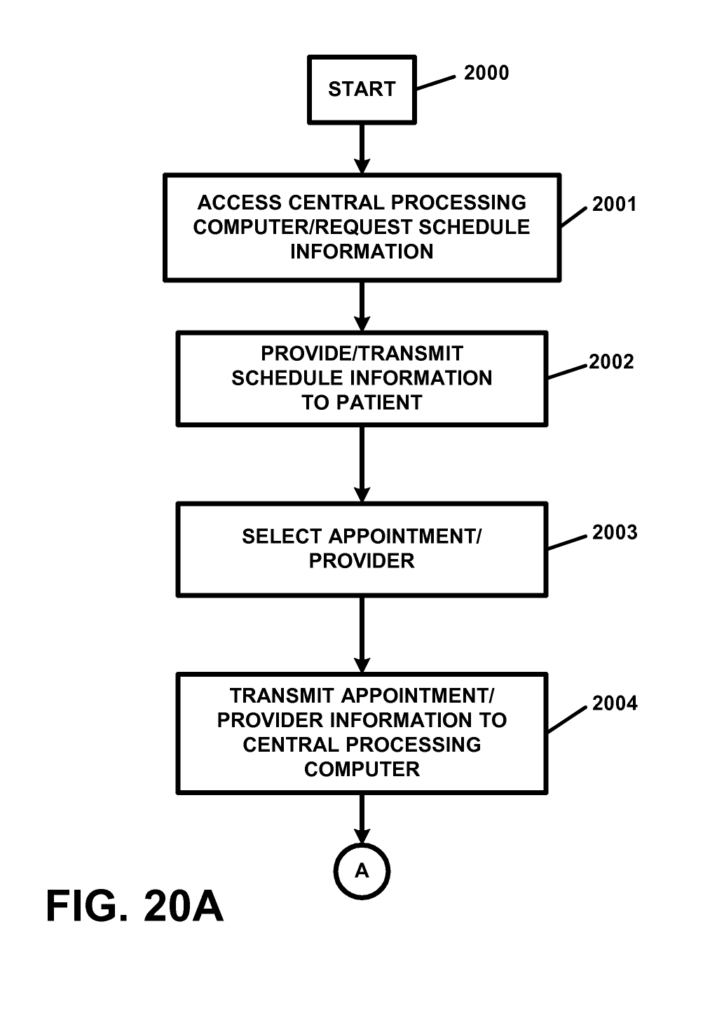

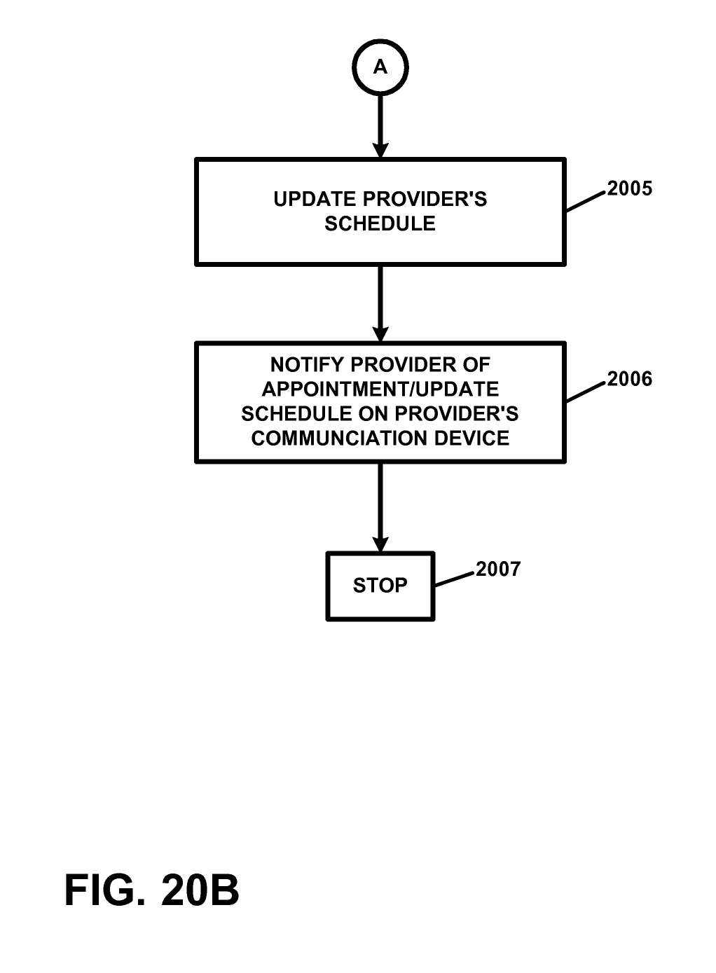

FIGS. 20A and 20B illustrate another preferred embodiment method of using the apparatus 100 of the present invention, in flow diagram form. In the embodiment of FIGS. 20A and 20B, provider schedules or provider scheduling information can be stored in the database 10H for any provider who or which utilizes the apparatus 100 and method of the present invention. With reference to FIGS. 20A and 20B, the operation of the apparatus 100 commences at step 2000. At step 2001, the user, individual, patient, or caregiver, can access the central processing computer 10 via a respective user or patient communication device 40 and can enter a request for the schedule or schedules of a provider or a number of providers. At step 2002, the central processing computer 10 can process the request and can transmit the schedule information for the provider or providers to the user or patient communication device 40 associated with or used by the user, individual, patient, or caregiver. At step 2003, the user, individual, patient, or caregiver can select the appointment he or she wishes to make with a provider.

At step 2004, the appointment information can be provided in an appointment message or signal and can be transmitted to and received at and by the central processing computer 10. At step 2005, the central processing computer 10 will update the provider's schedule to reflect the new appointment. At step 2006, the central processing computer 10 will transmit the appointment message or signal, such as and/or in an e-mail and/or other transmission and/or communication transmission or communication to the provider communication device 20 associated with the provider with whom the appointment is being made so as to notify the provider and to update the provider's schedule on the provider computer 20. In the preferred embodiment, the scheduling files stored on the database 10H of the central processing computer 10 and the database 20H of the provider communication device 20, and/or any portions and/or fields, or records, of same, can be dynamically linked to one another so that changes made to the schedule or schedules by either on or by the central processing computer 10 and/or on or by the provider communication device 20 will be updated and stored on or in both the central processing computer 10 and the provider communication device 20 so that the appointment is shown and is reflected in real-time on both the central processing computer 10 and the provider communication device 20 so as to ensure that the most up-to-date schedules are available at all times on both the central processing computer 10 and the provider communication device 20. At step 2006, the central processing computer 10 can also store information regarding the appointment or the appointment message in the individual's or patient's electronic healthcare record in the database 10H of the central processing computer 10 and in the database 60H of the healthcare records computer 60. In another preferred embodiment, the appointment message or signal can also contain an advertisement(s) or marketing material for a good(s), product(s), or service(s) deemed to be of interest to the provider.

In another preferred embodiment, the central processing computer 10 can generate an appointment reminder message anytime prior to the appointment, or at any pre-determined or pre-programmed time, before and/or on the appointment date and time. The appointment reminder message can contain information for reminding the individual, patient, or caregiver, of the scheduled appointment. Thereafter, the central processing computer 10 can transmit the appointment reminder message as and/or in an e-mail message, as an instant message, as a text message, as a pre-recorded or electronically generated telephone message, or as any other appropriate message, to the user or patient communication device 40 of or associated with the individual, patient, or caregiver. The central processing computer 10 can also transmit multiple appointment reminder messages to multiple communication devices 40 such as a computer, a cellular telephone, a wireless telephone, a mobile telephone, a personal digital assistant, a digital television, an interactive television, a beeper, a pager, and/or a telephone.

The operation of the apparatus 100 will thereafter cease at step 2007. In another preferred embodiment, the central processing computer 10 and/or the provider communication device 20 can generate and/or transmit an e-mail message to the user or patient communication device 40 in order to confirm the appointment and/or to serve as a reminder to the individual, the patient, or the caregiver.

In another preferred embodiment, the apparatus 100 can be programmed to automatically identify and locate a provider for the individual or patient upon the generation of the diagnostic report at step 1606 of the embodiment of FIGS. 16A and 16B, or upon the generation of the treatment report or the treatment plan at step 1606 of the embodiment of FIGS. 16A and 16B, can automatically make an appointment for the individual or patient with the identified or located provider, and can automatically include the appointment information in the respective diagnostic report, treatment report or treatment plan.

In the same, similar, or analogous, manner, any user, individual, patient, caregiver, provider, insurer or payer, and/or intermediary, can utilize the apparatus 100 and/or the preferred embodiment of FIGS. 20A and 20B in order to schedule an appointment with any other user, individual, patient, caregiver, provider, insurer or payer, and/or intermediary, described herein.

In another preferred embodiment, the apparatus 100 of the present invention can also be utilized by intermediaries, such as, but not limited to brokers, insurance brokers, agents, and others, in order to service their respective clients. For example, the database 10H can contain insurance policy information, conditions, premiums, insurers providing same, as well as any other useful information in servicing insured's needs. The database 10H can also contain client or insured individual information, policy requirements for any of the health insurance, life insurance, and/or disability insurance, policies in force for the client of insured individual along with premiums paid and/or expiration dates.

In another preferred embodiment, a broker, for example can prepare policy quotes, compare available policies, generate policies, and service policy claims via the information provided by the central processing computer 10 and/or the apparatus 100 of the present invention. The broker may also request to be notified, electronically and/or otherwise via a message generated and/or transmitted via the central processing computer 10, of times and/or instances when an insured's policy is up for renewal.

In another preferred embodiment, any electronic healthcare record described herein can contain or include insurance policy expiration dates or information. The central processing computer 10, in another preferred embodiment, can be programmed to detect upcoming insurance policy expiration dates and generate policy expiration notice messages which can be transmitted to the respective provider communication devices 20 of a provider(s) of the individual or patient, insurer or payer communication devices 30 of an insurer(s) of the individual or patient, user or patient communication devices 40 or the individual or patient, and/or intermediary communication devices 50 of any intermediary of the individual or patient.

In another preferred embodiment, a broker, agent, or other intermediary, may utilize any of the information provided by, and/or contained in, the database 10H of the apparatus 100 of the present invention in order to respond to an insured client's needs and/or requests, such as, but not limited to, preparing policy quotes for comparison purposes, identifying, locating, or finding a policy and/or policies for addressing the insured client's particular needs, assisting in resolving claims issues and/or claims processing issues, and/or assisting and/or providing any other information which could allow the broker, agent, or other intermediary, to provide assistance to, and/or to provide added value to, its client or clients.

In this, manner, the present invention can provide a platform for allowing a broker, agent, or intermediary, to provide improved services to and for his or her insured clients while also providing for a more paperless working environment or relationship.

In another preferred embodiment of the present invention, the apparatus 100 of the present invention can be utilized in order to provide notification to any of the individuals, patients, caregivers, providers, insurers or payers, users, and/or intermediaries, of and/or upon the occurrence or happening of a pre-specified event. For example, a medical specialist can be electronically and/or otherwise notified if a patient is diagnosed with an illness and/or a condition which he or she specializes in treating.

As another example, an insurer or payer can be electronically and/or otherwise notified when an individual or patient is or has been, or may be, admitted to a hospital and/or other facility for care. The apparatus 100 of the present invention can also be utilized to electronically and/or otherwise notify a provider when his or her patient has been diagnosed with an illness even when the patient may not be under the provider's care, and/or to notify an individual, patient, or caregiver, if and/or when a provider has become available to perform a treatment and/or a procedure on, and/or for, the individual or patient.

The apparatus 100 of the present invention can also be utilized in order to provide notification, electronically and/or otherwise, to any respective party, regarding any event, happening, and/or occurrence, which is described herein and/or which may be reasonably foreseen from the comprehensive nature of the present invention in providing comprehensive healthcare information processing and/or in facilitating the providing of comprehensive healthcare services.

In another preferred embodiment, the apparatus 100 present invention can be utilized in order to provide notification to any of the users, individuals, patients, caregivers, providers, insurers or payers, and/or intermediaries. For example, a medical specialist can be electronically and/or otherwise notified if an individual or patient is diagnosed with an illness and/or a condition which he or she specializes in treating.

As another example, an insurer or payer can be electronically and/or otherwise notified when an individual or patient is, may be, or is about to be, admitted to a hospital and/or other facility for care. The apparatus 100 of the present invention can also be utilized to electronically and/or otherwise notify a provider when an individual or his or her patient has been diagnosed with an illness even when individual or the patient may not be under the provider's care, and/or to notify an individual or patient if a provider has become available to perform a treatment and/or a procedure on, and/or for, the individual or patient.

The apparatus 100 of the present invention can also be utilized in order to provide notification, electronically and/or otherwise, to any respective party, regarding any event, happening, and/or occurrence, which is described herein and/or which may be reasonably foreseen from the comprehensive nature of the apparatus 100 of the present invention in providing comprehensive healthcare and/or healthcare-related information processing.

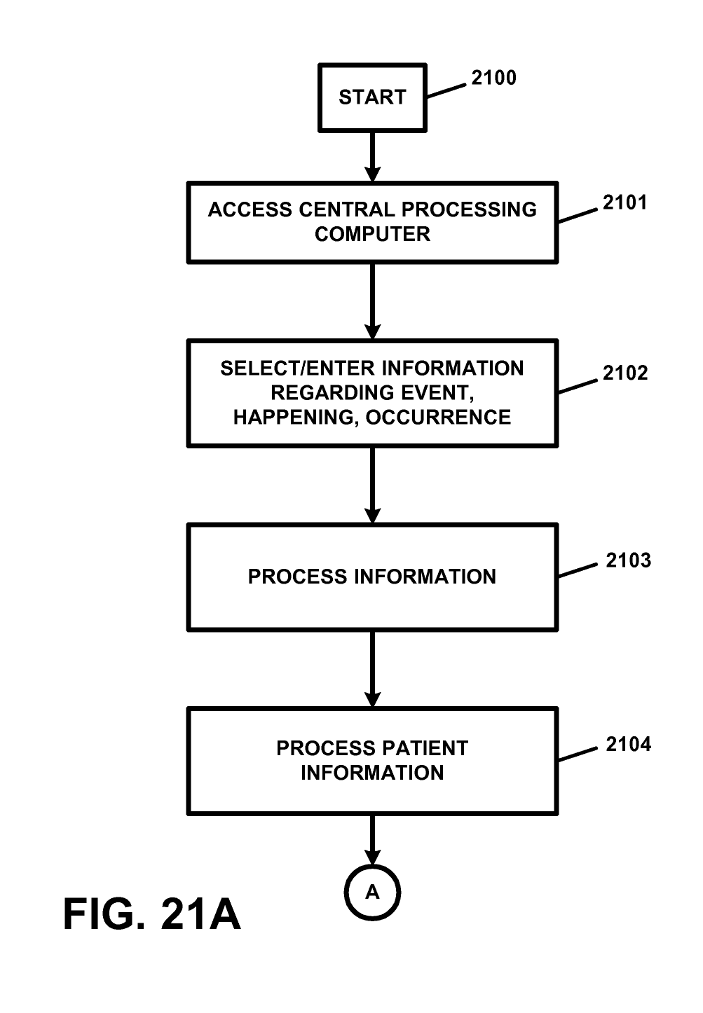

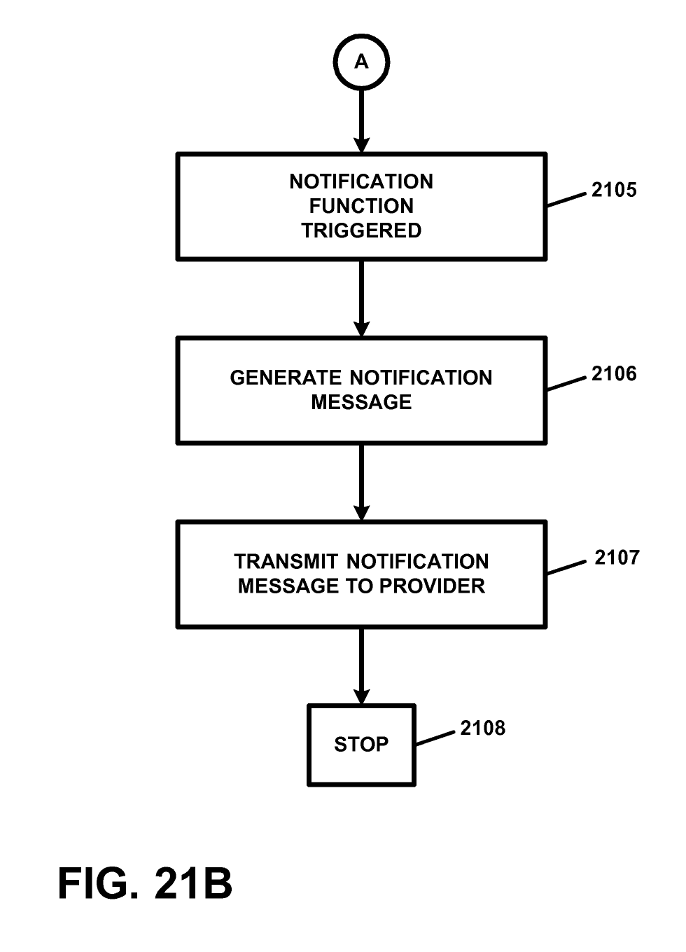

FIGS. 21A and 21B illustrate another preferred embodiment method of utilizing the apparatus 100 of the present invention, in flow diagram form. In the preferred embodiment of FIGS. 21A and 21B, the apparatus 100 of the present invention can provide notification to any respective party, electronically and/or otherwise, in response to the occurrence of an event, happening, and/or occurrence.

While the description of the embodiment of FIGS. 21A and 21B is directed to notifying a provider or doctor or other healthcare provider when an individual or patient requires the provider's treatment and/or care, it is important to note that the embodiment of the FIGS. 21A and 21B can also be utilized in order to provide notification services and/or functionality for any defined event, happening, and/or occurrence, and to any of the respective users, individuals, patients, caregivers, providers, insurers or payers, and/or intermediaries, described herein.

With reference to FIGS. 21A and 21B, the operation of the apparatus 100 commences at step 2100. At step 2101, the provider can access the central processing computer 10 via the provider communication device 20. At step 2102, the provider can select and/or enter the information concerning the notifying event, happening, and/or occurrence, and/or the conditions for notifying the provider. For example, an obstetrician can request to be notified when a pregnant patient enters a hospital in labor. At step 2103, the central processing computer 10 processes the above information. At step 2104, the central processing computer 10, upon receiving information concerning the pregnant patient's admission to a hospital, will process the pregnant patient's information.

At step 2105, the central processing computer 10 will identify and/or ascertain that the provider's condition for notification has been met or has been triggered. Thereafter, at step 2106, the central processing computer 10 will generate an appropriate notification message to notify the provider. At step 2107, the central processing computer 10 can transmit the notification message to the provider's communication device 20 as any one or more of an e-mail message, a beeper or pager message, a telephone call, and/or in any other manner. The central processing computer 10 can also transmit multiple notification messages to multiple provider communication devices 20 of or associated with the provider, such as, for example, a computer, a personal digital assistant, a beeper or pager and/or a telephone.

In a preferred embodiment, the notification message can include or contain information regarding the individual or patient, the nature of the occurrence or event giving rise to the notification messaging event, the date and time of the occurrence of the event, the place or location of the event, any individual, user, caregiver, provider or providers, insurer or insurers, or intermediaries, to whom the notification message is being sent, transmitted, or provided, information obtained from or regarding the individual or patient, or any information, notes, or comments provided by the individual, patient, caregiver, or other person present with the individual or patient. The notification message can also contain a link or hyperlink to the individual's or patient's electronic healthcare record(s).

In a preferred embodiment, the occurrence or event, which can give rise to a notification message being generated and transmitted as described herein, can be any occurrence or event which may be of interest to, or for which notification might be deemed to be requested, desired, required, or otherwise wanted, by any of the herein-described users, individuals, patients, caregivers, providers, insurers or payers, or intermediaries. In an preferred embodiment, the occurrence or event can include, but is not limited to, an entry of a note, comment, or other information, by any individual, patient, or caregiver, into an individual's or patient's electronic healthcare record, the making of an appointment with a provider, an entry into an electronic healthcare record of an individual or patient by any user, individual, patient, caregiver, provider, insurer or payer, or intermediary, the entering of a provider's notes or comments, laboratory results, therapy results, treatment results, information regarding a diagnosis, a treatment, a treatment plan, an appointment for a procedure or a surgery, results of a procedure or surgery, an administration of a treatment, or a diagnosis, regarding the individual or patient, information regarding an admission of the individual or patient to an hospital or healthcare facility, an entry or any of the herein-described diagnostic reports, treatment reports, treatment plans, evaluation reports, or any other reports or messages entered into the individual's or patient's electronic healthcare record(s), a filing or submission of an insurance claim or claim for payment by a user, individual, patient, caregiver, provider, insurer or payer, or intermediary, a payment of an insurance claim or claim for payment by an insurer or payer on behalf of an individual or patient, a denial of an insurance claim or claim for payment by an insurer or payer on behalf of an individual or patient, a re-filing or re-submission of an insurance claim or claim for payment by a user, individual, patient, caregiver, provider, insurer or payer, or intermediary, an admission to a care facility or a hospital, a providing or a treatment, therapy, procedure, test, or other service, a referral to an provider, a referral to an insurer or payer, a need for a referral to another provider, a diagnosis, a suggested treatment or treatment plan, an provider's unavailability, an provider providing coverage or services in place of another provider, an assignment or designation of a caregiver for an individual or patient, an assignment a new caregiver, an assignment of a healthcare power or attorney, living will, or healthcare proxy, by or for an individual or patient, a change in a provider or an addition of a new provider for the individual or patient, a change in an insurer or payer or an addition of a new insurer or payer for the individual or patient, or any other occurrence, event, or happening, regarding any individual or patient, or his or her caregiver, provider(s), insurer(s) or payer(s), or any intermediary(ies) which may deemed to be of interest to, or for which notification is desired by, any of the herein-described users, individuals, patients, caregivers, providers, insurers or payers, or intermediaries.

Any of the notification messages described herein can be, or can be included in, or be attached to, an e-mail message, an instant messaging message, an electronic transmission, or an electronic data transmission or electronic data interchange, or can be transmitted via any other data or information transmission, and can be transmitted via or using any appropriate or necessary computer(s) or device(s). The notification message can also be transmitted in a recorded telephone call or in a fax transmission. At step 2107, the notification message can also be transmitted to a user or patient communication device 40 of or associated with the individual or patient, to a user or patient communication device of or associated with a caregiver of the individual or patient, to a provider communication device(s) 20 of any other provider(s) of the individual or patient, to an insurer or payer communication device 30 of an insurer or payer of the individual or patient, or to an intermediary communication device 50 of an authorized intermediary. At step 2107, the notification message can also be stored in the individual's or patient's electronic healthcare record(s) in the database 10H of the central processing computer 10 or in the database 60H of the healthcare records computer 60. Thereafter, operation of the apparatus 100 will cease at step 2108.

In a same, similar, or analogous manner, an insurer or payer may also request to be notified upon the admission of an individual or patient to a hospital and/or other care facility. An individual or patient may also request that certain providers and/or insurers or payers be notified by the apparatus 100 of the present invention of any event, happening, and/or occurrence, involving the individual, patient, or caregiver of the individual or patient. There is no limit to the scenarios and/or alternate embodiments in which the apparatus 100 of the present invention can be utilized in order to provide notification to any of the users, individuals, patients, caregivers, providers, insurers or payers, and/or intermediaries, described herein. For example, a provider or an insurer or payer can be notified upon an admission of the individual or patient to a healthcare facility, an administration of a treatment, an administration of a procedure, a making of a diagnosis, or any other pre-defined event, happening, or occurrence.

In another preferred embodiment, in the case of a making of a diagnosis, the notification message can be in the form of an e-mail message or an instant message, or any other communication transmission, and/or can contain or can include, or can contain a link(s) or a hyperlink to the individual's or patient's electronic healthcare record, to a digital or electronic copy of lab results, procedure results, test results, an x-ray or copies of x-rays, an MRI image or MRI images, a CAT scan image or CAT scan images, a PET scan image or images, a copy of any other type of image obtained from any type of healthcare equipment or device, a test result or test results, a blood pressure reading or blood pressure readings, a heart pulse rate or reading, a note or notes regarding the individual or patient, a photograph or photographs of the individual or patient, a photograph or photographs of an accident scene, information regarding a vital sign or vital signs, or any other data or information which may be useful for, or of interest to, the provider or insurer or payer to have access to regarding the individual or patient or regarding the event, happening, or occurrence.

Any of the notification messages described herein can also be store in the individual's or patient's electronic healthcare record in the database 10 of the central processing computer 10 and/or in the database 60H of the healthcare records computer 60.

In still another preferred embodiment, the apparatus 100 of the present invention can be utilized to facilitate, and/or provide for, healthcare claims processing. Any of the individuals, patients, caregivers, providers, insurers or payers, and/or intermediaries or third parties, or any other users, can file claims with the respective insurer, payer, or party, electronically via the apparatus 100 of the present invention. The claim forms for each insurer or payer and/or any other party can be accessed from the respective party's insurer or payer communication device 30, or from the central processing computer 10, can be filled out, and can be submitted electronically by a claiming party or claimant, or by any individual, patient, or caregiver, or by any provider or healthcare provider. Any and/or all submissions can be electronically dated, date-stamped and/or time-stamped, and/or otherwise marked, the status of the claim can be provided to the claimant, or to the individual, patient, or caregiver, or to the provider or healthcare provider, at any time and any interested third parties may be notified of any action taken on a claim.

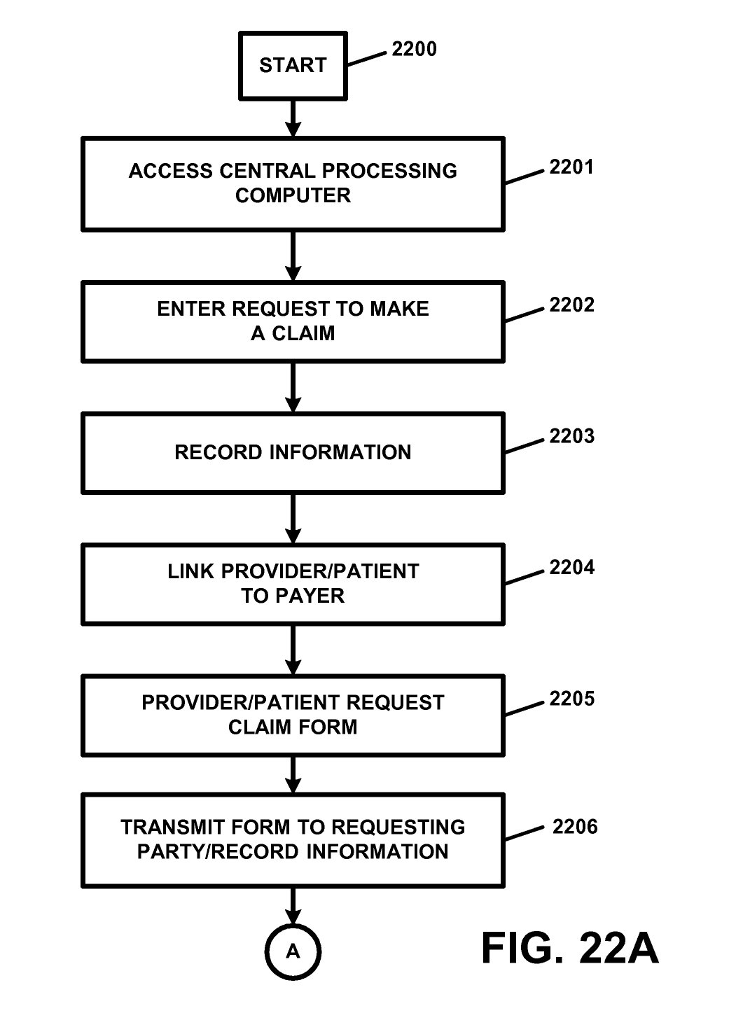

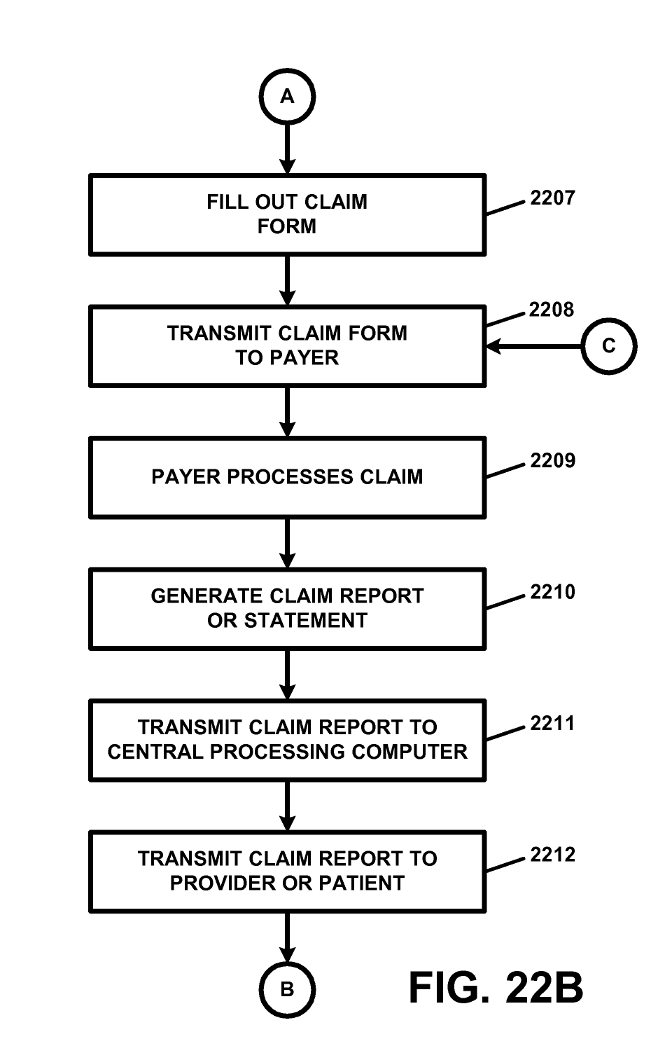

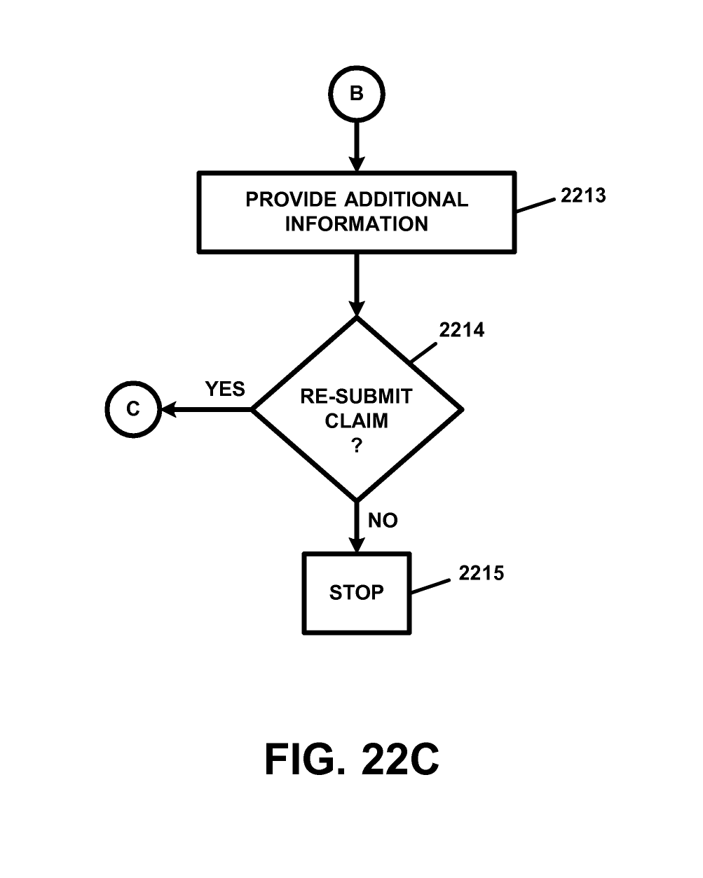

FIGS. 22A, 22B and 22C illustrate another preferred embodiment method of utilizing the apparatus 100 of the present invention, in flow diagram form. FIGS. 22A, 22B and 22C illustrate a preferred embodiment method of utilizing the apparatus 100 of the present invention in order to perform claims processing services and/or to submit an insurance claim or a claim or a request for payment to an insurer or payer. While it is understood that any appropriate party can file claims with any party described herein, for simplicity, a preferred embodiment where providers and/or individual, patients, or caregivers, file claims is described herein. The method, however, can be adapted for use by any party, individual, patient, caregiver, provider, insurer or payer, third party, intermediary, or user, described herein.

With reference to FIGS. 22A, 22B and 22C, the operation of the apparatus 100 commences at step 2200. At step 2201, the provider or the individual, the patient, or the caregiver, whichever the case may be, can access the central processing computer 10 via the respective communication device 20 or 40. At step 2202, the provider or the individual, the patient, or the caregiver, can enter a request to make a claim.

At step 2203, the central processing computer 10 will record any information regarding the claim request and, thereafter, at step 2204, provide the provider or the individual, the patient, or the caregiver, with information for making an insurance claim or making a claim for payment, or the central processing computer 10 can link the provider or the individual, the patient, or the caregiver, directly to the respective insurer or payer communication device 30. At step 2205, the provider or the individual, the patient, or the caregiver, can request a claim form or a request for payment form. At 2206, the claim form or request for payment form will then be transmitted from the central processing computer 10, or from the insurer or payer communication device 30 via the central processing computer 10, which central processing computer 10 can record the occurrence of same, to the respective communication device 20 or 40 of the respective provider or the individual, the patient, or the caregiver. The provider or the individual, the patient, or the caregiver, can then enter any information for filling out the claim form or the request for payment form, or fill out the claim form or the request for payment form, using or on the respective communication device 20 or 40 at step 2207.

At step 2208, the provider or the individual, the patient, or the caregiver can then transmits the completed insurance form or request for payment form from the respective communication device 20 or 40 to the insurer or payer communication device 30 via the central processing computer 10 which will record the occurrence of same. At step 2209, the insurer or payer, or the insurer or payer communication device 30 can process the claim or request for payment and, at step 2210, generate a claim report, a request for payment report, or a statement. At step 2211, the claim report, request for payment report, or statement, can be transmitted to the central processing computer 10, which can then record the occurrence of same as well as record any information regarding the action taken by the insurer or payer (i.e. claim or request approved or claim or request denied).

Thereafter, the central processing computer 10 will, at step 2212, transmit the claim report, the request for payment report, or the statement, to the respective communication device 20 or 40, respectively, of the provider or the individual, the patient, or the caregiver. Thereafter, at step 2213, if the claim or request for payment is denied or rejected, the provider or the individual, the patient, or the caregiver, can, provide additional information and/or re-submit the claim form or request for payment form to the central processing computer. At step 2214, the central processing computer 10 will determine if the provider or the individual, the patient, or the caregiver, has provided additional information and/or has decided to resubmit the claim of the request for payment.

If, at step 2214, it is determined that additional information has been provided and/or that the claim is to be re-submitted, the processing will proceed to step 2208 and the processing of steps 2208 through 2214 will be repeated until a resolution is reached between the parties involved. Thereafter, the operation of the apparatus 100 will cease at step 2215. If at step 2214, it is determined that no new additional information has been submitted and/or that the claim or the request for payment is not to be re-submitted, then the operation of the apparatus 100 will cease at step 2215.

In this manner, the apparatus 100 of the present invention can facilitate an expedited and/or a paperless claim process or request for payment process. Further, records of the actions taken or transactions involved, such as, but not limited to, a claim request or a request for payment, a claim form or a request for payment form request and/or delivery of same, a claim or request for payment submission, a claim processing, a claim report, a request for payment report, or a statement, a claim re-submission, a provision of additional information, and/or information regarding any and/or all of the actions, forms, data and/or information involved or exchanged, or any information regarding any actions or transactions, which occur during the claim or request for payment processing procedure or process, can be recorded and maintained at the central processing computer 10 so as to provide for a third party record and/or monitoring of same, in the individual's, the patient's, or the caregiver's, electronic healthcare record in the database 10H of the central processing computer 10, in the individual's, the patient's, or the caregiver's, electronic healthcare record in the database 40H of the user or patient communication device 40, in the database 20H of the provider communication device 20, in the database 30H of the insurer or payer communication device 30, in the database 50H of the intermediary communication device 50, in the individual's, the patient's, or the caregiver's, electronic healthcare record in the database 60H of the healthcare records computer 60, or in the database 70H of the insurance exchange computer 70.

In another preferred embodiment, the central processing computer 10, can provide notification to a respective individual, patient, caregiver, provider, insurer or payer, intermediary, or third party, or any other party described herein, as well as any third parties, regarding any event, happening, occurrence, and/or any aspect of any claim submission, request for payment submission, and/or any related or associated processing activities. The central processing computer 10, in a preferred embodiment, can provide such notification by generating and by transmitting a notification message, containing information regarding the event, the happening, the occurrence, and/or any aspect of any claim submission, request for payment submission, and/or any related or associated processing activities, to a respective computer or communication device 40, 30, 30, or 50 associated with or used by the respective individual, patient, caregiver, provider, insurer or payer, intermediary, or third party, or any other party described herein, as well as any third parties.

In a preferred embodiment, and as and for an example, a provider can be notified at regular interval regarding an insurer's or a payer's or insurers or payers decisions to pay for certain treatments and/or procedures. Similarly, an individual's, a patient's, or a caregiver's, employer can be notified regarding claim payments made by its group health insurer so as to ensure that its employees are being properly serviced and/or provided for by the insurer. Other information may similarly be provided to any appropriate requesting party described herein and/or any qualified and/or appropriate third party. Notification can be provided to any appropriate party, via any of the communication methods and/or techniques described herein, and can be for or regarding, and/or can include, any pertinent information.

The apparatus of FIGS. 22A and 22B can also utilize electronic signatures and/or process electronic signatures and/or electronic signature information which can correspond to any of the herein-described parties in performing any of the herein-described processing routines and/or functions.

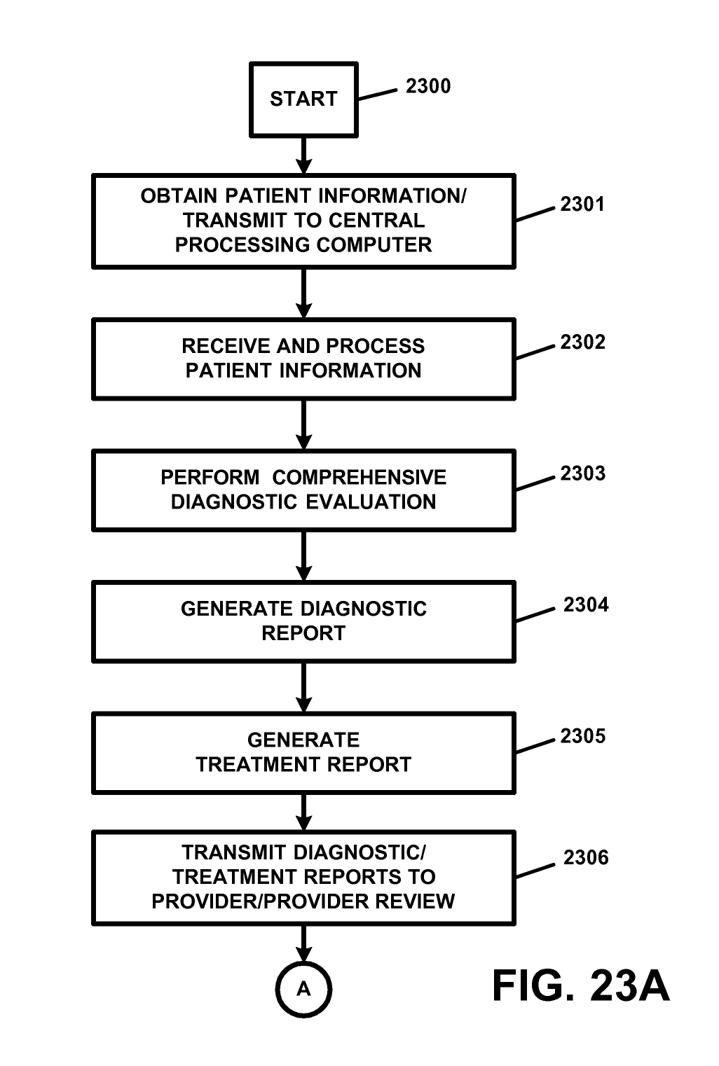

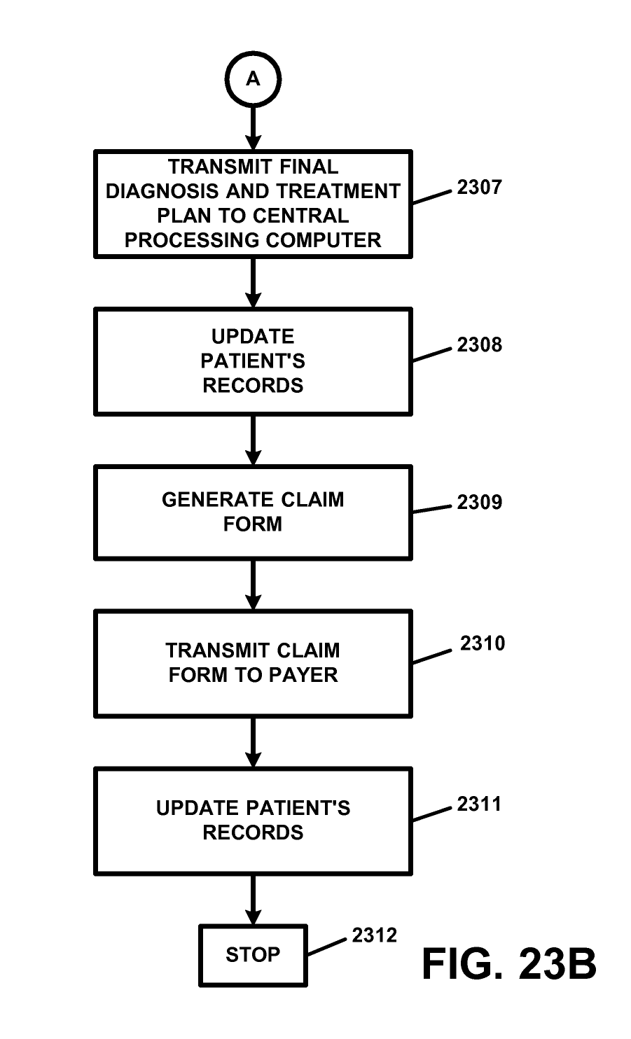

In another preferred embodiment, the apparatus 100 of the present invention can provide for automatic claim submission or request for payment submission via the central processing computer 10 once a final diagnosis and/or a treatment has been prescribed by a provider and/or upon the occurrence of an examination and/or the administration of a treatment, or the performance of a procedure. FIGS. 23A and 23B illustrate another preferred embodiment method of utilizing the apparatus 100 of the present invention, in flow diagram form.

With reference to FIGS. 23A and 23B, the operation of the apparatus 100 commences at step 2300. At step 2301, provider or other user can access the central processing computer via the provider communication device 20. At step 2301, information regarding the individual or the patient, which can include, but which is not limited to, the individual's or patient's symptoms, if any, and/or examination findings are or can be obtained from the individual or the patient and can be entered into the provider communication device 20 and transmitted from the provider communication device 20 to the central processing computer 10. The information regarding the individual or the patient, which is entered into the provider communication device 20, can also contain or include any of the herein-described notes, comments, or messages, which were previously entered by the individual, the patient, or the caregiver, into the individual's, the patient's, or the caregiver's electronic healthcare record or electronic healthcare file.

The central processing computer 10 will, at step 2302, receive and/or process the information regarding the individual or patient which can include individual or patient symptoms, if any, and/or the examination findings, in conjunction with the individual's, the patient's, or the caregiver's, electronic healthcare record or electronic healthcare file, medical history, and/or other information, healthcare or medical theories, principles, criteria and/or other healthcare or medical information needed to make a diagnosis. At step 2303, the central processing computer 10 will perform a comprehensive diagnostic evaluation of the individual's, the patient's, or the caregivers, symptoms, if any, and/or the examination findings.

At step 2304, the central processing computer 10 will generate a diagnostic report which can include a diagnosis of the individual's or the patient's condition. The diagnostic report which is generated at step 2304 can, if needed, include a single diagnosis and/or a list of possible diagnoses along with their respective probabilities, which may pertain to the individual's or the patient's condition. At step 2305, the central processing computer 10 can then generate, if needed, a treatment report which can or will outline and/or prescribe a treatment(s) for the single diagnosis and/or for the list of possible diagnoses. At step 2305, the central processing computer can also generate a treatment plan. The central processing computer 10, when generating the treatment report, can, if needed, process same in conjunction with, and consider, possible drug interactions and/or treatment interactions.

In a preferred embodiment, any of the herein-described diagnostic reports, treatment reports, or treatment plans, can include or can contain data and/or information stored in individual's, the patient's, or the caregiver's, electronic healthcare record, a link(s) or a hyperlink(s) to data and/or information stored in the individual's, the patient's, or the caregiver's, electronic healthcare record, any notes, comments, or messages, entered by the individual, the patient, or the caregiver, into the individual's, the patient's, or the caregiver's, electronic healthcare record, and/or any link(s) or hyperlink(s) to any notes, comments, or messages, entered by the individual, the patient, or the caregiver, into the individual's, the patient's, or the caregiver's, electronic healthcare record.

At step 2306, the central processing computer 10 will transmit the diagnostic report and/or treatment report and/or the treatment plan to the provider's provider communication device 20 at which point the provider, or the healthcare provider or medical doctor, can obtain the diagnosis or list of possible diagnoses and corresponding treatment report or treatment plans, if any. The provider, or the healthcare provider or medical doctor, can then review the diagnostic report and/or the treatment report and/or the treatment plan, and choose, select, or decide upon, a final diagnosis and/or a treatment plan to administer to the individual or the patient. At step 2307, the provider, or the healthcare provider or medical doctor, will transmit the final diagnosis and treatment plan, including the prescribed treatment and/or treatment plan, to the central processing computer 10. In another preferred embodiment, at step 2307, the provider, or the healthcare provider or medical doctor, or any other provider using the apparatus 100 can also generate and/or transmit a prescription or an electronic prescription for a medication, a medicine, or a drug, or for a procedure, a test, an analysis, an analysis work-up, blood work, a treatment, or a therapy, or can generate and/or transmit a referral to another provider, for submission or transmission to the respective pharmacy or other provider, and for storage in the individual's, the patient's, or the caregiver's, electronic healthcare record or electronic healthcare file.

In another preferred embodiment, the final diagnosis and/or treatment plan, including the prescribed treatment and/or treatment plan, can also be transmitted by the central processing computer 10, at step 2307, to the provider communication device 20 associated with or used by the provider for the provider's records, to a provider communication device 20 associated with or used by another provider of the individual, patient, or caregiver, to a payer or insurer communication device 30 associated with or used by the insurer or payer of the individual or patient, to the user or patient communication device 40 associated with or used by the individual, the patient, or the caregiver, or to an intermediary communication device 50 associated with or used by a third party or an intermediary. In this regard, in a preferred embodiment, the central processing computer 10 can transmit the final diagnosis and/or the treatment plan to a respective provider communication device 20, to a respective insurer or payer communication device 30, to a respective user or patient communication device 40, or to a respective intermediary communication device 50 either directly, such as via any suitable electronic or other transmission, or indirectly, such as via an e-mail server in the case when the final diagnosis and/or treatment plan is included in, or is attached to, an e-mail message.

In a preferred embodiment, the final diagnosis and/or treatment plan, the diagnostic report, the treatment report, or the treatment plan, or a respective copy of same, can also be transmitted to and/or stored by or in the respective provider communication device 20, the respective insurer or payer communication device 30, the respective user or patient computer or communication device 40, the respective intermediary computer or communication device 50, the healthcare records computer 60, and/or the insurance exchange computer 70.

In a preferred embodiment, the final diagnosis and/or treatment plan, the diagnostic report, the treatment report, or the treatment plan, or a respective copy of same, can also be transmitted to and/or stored by or in the individual's, the patient's, or the caregiver's, electronic healthcare record in the database 10H of the central processing computer 10, in the database 40H of the user or patient communication device 40, in the individual's, the patient's, or the caregiver's, electronic healthcare record in the database 60H of the healthcare records computer 60, or in the database 70H of the insurance exchange computer 70.

In another preferred embodiment, the final diagnosis and/or treatment plan can contain individual-specific or patient-specific educational information or individual-specific or patient-specific instructional information, or a link(s) or hyperlink(s) to same, regarding the diagnosis, treatment, or treatment plan, or information relating thereto, so as to provide this educational information or instructional information to the individual, patient, or caregiver. The individual, patient, or caregiver, can thereafter access or obtain the educational information or instructional information via the apparatus 100 and method of the apparatus 100 of the present invention. In this manner, the apparatus 100 and method of the present invention can provide individual-specific or patient-specific educational information or individual-specific or patient-specific instructional information regarding the diagnosis, treatment, or treatment plan.

In another preferred embodiment, the apparatus 100 or the central processing computer 10 can be programmed to identify the individual-specific or patient-specific educational information or individual-specific or patient-specific instructional information regarding the diagnosis, treatment, or treatment plan, and/or any information, link(s), or hyperlink(s) relating thereto or pertaining thereto.

At step 2308, the central processing computer 10 will then update the individual's, the patient's, or the caregiver's, electronic healthcare records in the database 10H so as to include all of the data and information described as being processed and/or generated by the central processing computer 10, including, but not limited to the individual's or the patient's symptoms, the information contained in the diagnostic report and the treatment report, and/or the information contained in the final diagnosis and the prescribed treatment. At step 2308, the central processing computer 10 can also generate a co-payment message or a deductible message containing information regarding a co-payment due by the individual, the patient, or the caregiver, under the individual's, the patient's, or the caregiver's, insurance policy or a deductible which has to be met by the individual, the patient, or the caregiver, under the individual's, the patient's, or the caregiver's, insurance policy. At step 2308, the co-payment message or the deductible message can be transmitted to the provider communication device 20 associated with or used by the provider. At step 2308, the co-payment message or the deductible message can also be transmitted to the insurer or payer communication device 30 associated with or used by the insurer or payer of the individual, the patient, or the caregiver, to the user or patient communication device 40, associated with or used by the individual, the patient, or the caregiver, and/or to an intermediary communication device 50 associated with or used by an intermediary or third party.

At step 2308, the co-payment message or the deductible message can also be transmitted to and/or stored by or in the individual's, the patient's, or the caregiver's, electronic healthcare record in the database 10H of the central processing computer 10, in the database 40H of the user or patient communication device 40, in the individual's, the patient's, or the caregiver's, electronic healthcare record in the database 60H of the healthcare records computer 60, or in the database 70H of the insurance exchange computer 70.

At step 2308, the central processing computer 10 can also generate a benefit eligibility message containing information regarding the individual's, the patient's, or the caregiver's, eligibility to receive benefits under an insurance policy, a payment policy, or a payment plan. At step 2308, the benefit eligibility message can be transmitted to the provider's computer or communication device 20. At step 2308, the benefit eligibility message can also be transmitted to the insurer or payer's computer or communication device 30, to the user's or patient's computer or communication device 40, or to an intermediary's computer or communication device 50. At step 2308, the benefit eligibility message can also be transmitted to and/or stored by or in the individual's, the patient's, or the caregiver's, electronic healthcare record in the database 10H of the central processing computer 10, in the database 40H of the user or patient communication device 40, in the individual's, the patient's, or the caregiver's, electronic healthcare record in the database 60H of the healthcare records computer 60, or in the database 70H of the insurance exchange computer 70.

Thereafter, at step 2309, the central processing computer 10 will generate a claim form or a request for payment form (hereinafter “claim form”) which can meet the formal claim submission requirements of the individual's, the patient's, or the caregiver's, insurer or payer or insurance company.

In a preferred embodiment, the claim form can include or can contain any data and/or information stored in individual's, the patient's, or the caregiver's, electronic healthcare record, a link(s) or a hyperlink(s) to the individual's, the patient's, or the caregiver's, electronic healthcare record, a link(s) or a hyperlink(s) to any data and/or information stored in the individual's, the patient's, or the caregiver's, electronic healthcare record, any notes, comments, or messages, entered by the individual, the patient, or the caregiver, into the individual's, the patient's, or the caregiver's, electronic healthcare record, and/or any link(s) or hyperlink(s) to any notes, comments, or messages, entered by the individual, the patient, or the caregiver, into the individual's, the patient's, or the caregiver's, electronic healthcare record. In this regard, in a preferred embodiment, any data and/or information contained or included in the individual's, the patient's, or the caregiver's, electronic healthcare record can be readily available to and/or can be readily accessible by any insurer or payer, or any employee or agent of same, or by any other user, person, or entity, who or which reviews or is to review the claim form.

At step 2310, the claim form can or will be submitted or transmitted by or from the central processing computer 10 to the respective insurer or payer computer 30. In another preferred embodiment, the claim form, or a copy of same, can also be transmitted by the central processing computer 10, at step 2310, to the provider, to the individual, patient, or caregiver, or to a third party or intermediary, by transmitting the claim form, or a copy of same, to a respective provider computer or communication device 20 associated with or used by the provider or any other provider of the individual, the patient, or the caregiver, to a respective user or patient computer or communication device 40 associated with or used by the individual, the patient, or the caregiver, or to a respective intermediary computer or communication device 50 associated with or used by an intermediary or third party, either directly, such as via any suitable electronic or other transmission, or indirectly, such as via an e-mail server in the case when the copy of the claim form is included in, or is attached to, an e-mail message.

The claim form, or a copy of same, can also be stored by or in the respective provider computer or communication device 20, the respective user or patient computer or communication device 40, or the respective intermediary computer or communication device 50. The claim form, or a copy of same, can also be transmitted to and/or stored by or in the healthcare records computer 60 and/or the insurance exchange computer 70.

At step 2310, the claim form, or a copy of same, can be stored in the individual's, the patient's, or the caregiver's, electronic healthcare record in the database 10H of the central processing computer 10, and/or can be transmitted to and/or stored in the user or patient communication device 40 where it can be stored in the individual's, the patient's, or the caregiver's, electronic healthcare record in the database 40H of same, and/or can be transmitted to and/or stored in healthcare records computer 60 where it can be stored in the individual's, the patient's, or the caregiver's, electronic healthcare record in the database 60H of same, and/or can be transmitted to and/or stored in database 70H of the insurance exchange computer 70.

At step 2311, any and/or all pertinent information regarding the claim form, the claim submission, the individual, the patient, the caregiver, the provider visit, and/or any diagnoses and/or treatments considered, the final diagnosis and/or the prescribed treatment, any diagnostic report(s), treatment report(s), and/or treatment plan(s), can be stored and the individual's, the patient's, or the caregiver's, electronic healthcare record in the database 10H of the central processing computer 10, and any data and/or information contained in the individual's, the patient's, or the caregiver's, electronic healthcare record in the database 10H of the central processing computer 10, in the database 40H of the user or patient communication device 40, and/or in the database 60H of the healthcare records computer 60 can then be updated and be available for the individual's, the patient's, next treatment and/or diagnosis.

In another preferred embodiment, at step 2311, the central processing computer 10 can generate a respective office visit summary report, a procedure summary report, a treatment summary report, a provider or healthcare facility or hospital discharge report, or any other report containing information regarding a summary or clinical summary of or relating to an office visit, a procedure, a treatment, a hospital stay, or any other interaction with a provider or healthcare facility, as well as instructions for the individual, patient, or caregiver. The respective office visit summary report, procedure summary report, treatment summary report, provider or healthcare facility or hospital discharge report, or other report, or a copy of same, can also be transmitted, at step 2311, by the central processing computer 10, to the user or patient communication device 40 associated with or used by the individual, the patient, or the caregiver, to the provider computer or communication device 20 of the provider as well as the respective provider computer or communication device 20 of any other healthcare provider or healthcare providers of the individual, patient, or caregiver, who or which is authorized or selected by the individual, patient, or caregiver, to receive same, to the insurer or payer communication device 30 associated with or used by the insurer or payer, and/or to an intermediary computer or communication device 50 associated with or used by an intermediary or user.

In another preferred embodiment, the respective office visit summary report, procedure summary report, treatment summary report, or provider or healthcare facility or hospital discharge report, or any other report, can contain individual-specific or patient-specific educational information or individual-specific or patient-specific instructional information, or a link(s) or hyperlink(s) to same, regarding a diagnosis, a treatment, a treatment plan, an office visit summary, a procedure summary, a treatment summary, a provider or healthcare facility or hospital discharge report, or any other report, or any other information relating thereto, so as to provide this educational information or instructional information to the individual, patient, or caregiver. The individual, patient, or caregiver, can thereafter access or obtain the educational information or instructional information via the apparatus 100 and method of the apparatus 100 of the present invention. In this manner, the apparatus 100 and method of the apparatus 100 of the present invention can provide individual-specific or patient-specific educational information or individual-specific or patient-specific instructional information regarding the diagnosis, treatment, treatment plan, office visit summary, procedure summary, treatment summary, or provider or healthcare facility or hospital discharge report, or other report.

In another preferred embodiment, the respective office visit summary report, a procedure summary report, a treatment summary report, a provider or healthcare facility or hospital discharge report, or any other report containing information regarding a summary or clinical summary of or relating to an office visit, a procedure, a treatment, a hospital stay, or any other interaction with a provider or healthcare facility, as well as instructions for the individual, patient, or caregiver, can also be stored in the individual's, the patient's, or the caregiver's, electronic healthcare record in the database 10 of the central processing computer 10. In another preferred embodiment, the respective office visit summary report, a procedure summary report, a treatment summary report, a provider or healthcare facility or hospital discharge report, or any other report containing information regarding a summary or clinical summary of or relating to an office visit, a procedure, a treatment, a hospital stay, or any other interaction with a provider or healthcare facility, as well as instructions for the individual, patient, or caregiver, can also be transmitted to the user or patient communication device 40 and can be stored in the individual's, the patient's, or the caregiver's, electronic healthcare record in the database 40H of same and/or can be transmitted to the healthcare records computer 60 and can be stored in the individual's, the patient's, or the caregiver's, electronic healthcare record in the database 60H of same.

In another preferred embodiment, the apparatus 100 or the central processing computer 10 can be programmed to identify the individual-specific or patient-specific educational information or individual-specific or patient-specific instructional information regarding the diagnosis, the treatment, the treatment plan, the office visit summary, the procedure summary, the treatment summary, or the provider or healthcare facility or hospital discharge report, or the other report, and/or any information, link(s), or hyperlink(s) relating thereto or pertaining thereto.

In another preferred embodiment, the claim form or claim submission, which is either submitted at step 2310 and/or stored at step 2311, can be date stamped and/or time stamped. In this manner, claim processing can be tracked or monitored so as to facilitate audits of the insurer or payer or insurance company in order to ascertain if the insurer or payer or insurance company is properly and/or efficiently handling a claim or claims for the individual, patient, or caregiver, and/or if the insurer or payer or insurance company is in compliance with any laws, rules, or regulations, governing claims processing and/or handling. Information regarding the date stamped and/or time stamped claim forms or claims, including the insurer's or the payer's, or the insurance company's, processing or handling of same, and the response or reply to same, can also be stored in the individual's, the patient's, or the caregiver's. electronic healthcare record in the database 10H of the central processing computer 10, and/or in the database 10H of the central processing computer 10 and can be accessed and/or obtained by any authorized user or entity. In this manner, the apparatus 100 of the present invention can be used in order to ascertain information regarding the processing and/or handling of claims or claim forms by a respective insurer or payer or insurance company for any individual, patient, caregiver, or for any group or groups of individuals, patients, or caregivers.

The operation of the apparatus 100 will then cease at step 2312. In this manner, the apparatus 100 of the present invention can provide for the automatic and/or for the programmed submission of healthcare claims, claim forms, claim requests, benefit requests, requests for payments, and/or any other claim or request for payment, upon the conclusion of a provider's service, consultation, treatment, procedure, and/or any other event which triggers coverage under an insurer or payer policy, plan, program, or relationship, a healthcare insurance policy, and/or a payer's liability to pay for services and/or treatments.

In another preferred embodiment of FIGS. 23A and 23B, the apparatus 100 of the present invention can be utilized by any provider to submit a claim form or a request for payment form, so that the provider can be paid or compensated, for any tele-healthcare or tele-healthcare-related activities, such as, but not limited to, the provider performing any remote, distance, or tele-health, services, any remote monitoring and/or control of any of the herein-described healthcare devices, healthcare equipment, healthcare testing devices or equipment, healthcare information gathering devices or equipment, or healthcare monitoring devices or equipment, or any remote, distance, or tele-health, appointment, examination, procedure, treatment, conference, or discussion, with, involving, or regarding, an individual, patient, or caregiver, any remote, distance, or tele-health, performance of a procedure or surgery, administration of a treatment, monitoring of a treatment or treatment plan, any conduction of a consultation or an interview, or any involvement in any session with an individual, patient, or caregiver. In this regard, any remote, distance, or tele-healthcare, activities or actions performed by, or taken by, the provider regarding or involving an individual, patient, or caregiver, or involving any activity regarding, involving, or relating to, the individual's, the patient's, or the caregiver's, electronic healthcare record(s) or electronic healthcare files, can be an activity or an event for which the provider can be paid or compensated

In another preferred embodiment, in instances where a diagnosis, a reported laboratory finding, or other determination warrants providing notice or reporting to a public health agency or to the public, the apparatus 100 or the central processing computer 10 can, at step 2311, store information regarding the diagnosis, the reported laboratory finding, or the other determination, in the database 10H, generate a determination finding report, and transmit the determination finding report to one or more provider computers or communication devices 20 associated with a public health agency or department, and/or when authorized or allowed, to a provider computer or communication device 20 associated with a healthcare provider, to a insurer or payer computer or communication device 30, or to a user or patient communication device 40, and/or to the healthcare records computer 60, to the insurance exchange computer 70, to the social networking computer 80, and/or to the media computer 90. In a preferred embodiment, the dissemination of the determination finding report and any related or other information can be effectuated and/or facilitated via the respective computers 60, 70, 80, or 90.

In another preferred embodiment, in a same, a similar, or an analogous, manner as described above for a diagnosis, reported laboratory finding, or other determination which warrants providing notice of same or reporting same, advance directives for patients or individuals 65 years of age or older, or any other prescribed or selected age, can also be stored in the database 10H and be reported to a public agency by generating and transmitting an advance directive report message to one or more provider computers or communication devices 20 associated with a public health agency or department, and/or, where authorized or allowed, to a provider computer or communication device 20 associated with a healthcare provider, to a insurer or payer computer or communication device 30, or to a user or patient communication device 40, and/or to the healthcare records computer 60, to the insurance exchange computer 70, to the social networking computer 80, and/or to the media computer 90. In a preferred embodiment, the dissemination of the advance directive report message and any related or other information can be effectuated and/or facilitated via the respective computers 60, 70, 80, or 90.

In another preferred embodiment, in a same, a similar, or an analogous manner, as described above for a diagnosis, reported laboratory finding, or other determination which warrants providing notice of same or reporting same, syndromic surveillance data or information can also be submitted to a public health agency or public health agencies or departments. In instances where a syndromic surveillance data or information is obtained, the apparatus 100 or the central processing computer 10 can, at step 2311, store information regarding the syndromic surveillance data or information in the database 10H, generate a syndromic surveillance data or information report, and transmit that syndromic surveillance data or information report to one or more provider computers or communication devices 20 associated with a public health agency or department, and/or when authorized or allowed, to a provider computer or communication device 20 associated with a healthcare provider, to a insurer or payer computer or communication device 30, or to a user or patient communication device 40, and/or to the healthcare records computer 60, to the insurance exchange computer 70, to the social networking computer 80, and/or to the media computer 90. In a preferred embodiment, the dissemination of the syndromic surveillance data or information report and any related or other information can be effectuated and/or facilitated via the respective computers 60, 70, 80, or 90.

In another preferred embodiment, the claim form transmitted to the insurer or payer computer 30 can have attached thereto, or can include, a link(s) or a hyperlink(s) to the individual's, the patient's, or the caregiver's, electronic healthcare record, and/or any notes, comments, or messages, entered by an the individual, the patient, or the caregiver, into the electronic healthcare record. In another preferred embodiment, the claim form transmitted to the insurer or payer computer 30 can have attached thereto, or can include, or can include a link(s) or a hyperlink(s) to, an x-ray, x-rays, a lab result or lab results, an MRI image, MRI images, a CAT scan image, a PET scan image, provider notes, individual, patient, or caregiver, records or information, individual, patient, or caregiver, provided information, etc, and/or any other information which can be obtained by or with any healthcare, medical, or dental, equipment or device, or any other information which may be requested of, or obtained from, a provider or which may be used by a insurer or payer or insurance company in processing, investigating, or evaluating, a claim submission.

In this regard, the claim form can also, for example, contain or include, or can have attached thereto, or can contain a link or links to or a hyperlink or hyperlinks to, a digital or electronic copy of an x-ray or copies of x-rays, a MRI image or MRI images, a CAT scan image or CAT scan images, a PET scan image or images, a copy of any other type of image obtained from any type of healthcare equipment or device, a test result or test results, a blood pressure reading or blood pressure readings, a heart pulse rate or reading, a note or notes regarding the individual, the patient, or the caregiver, a photograph or photographs of the individual, the patient, or the caregiver, a photograph or photographs of an accident scene, information regarding a vital sign or vital signs, or any other information which may be requested of, or obtained from, a provider, or information which may be requested of, or obtained from, the individual, the patient, or the caregiver, or which may be used by a insurer or payer or insurance company in processing, investigating, or evaluating, a claim form or a claim submission or a request for payment.

In another preferred embodiment of the embodiment of FIGS. 23A and 23B, or any and/or all the herein-described embodiments, the apparatus 100 or the central processing computer 10 can provide information regarding ICD, ICD-10, ICD-9, or other, codes, diagnostic codes, symptom codes, treatment codes, billings codes, or any other codes or information useful in entering or recording individual, patient, or caregiver, information into a electronic healthcare record or an electronic healthcare file of the individual, patient, or caregiver. In this manner, the apparatus 100 of the present invention can provide any user, individual, patient, caregiver, provider, insurer or payer, insurer, or intermediary, or any other individual or person, using the apparatus 100 of the present invention, with accurate and current data or information so as to ensure that the information described herein as being stored in the electronic healthcare records or the electronic healthcare files of individuals, patients, or caregivers, records or files of providers, insurer or payers, insurers, third parties, or intermediaries, or any claim forms, request for payments, insurance claims, prescriptions, referrals, or any other information, described herein as being processed, generated, or stored, by the apparatus 100 of the present invention, is accurate, correct, and up-to-date with current standards in the healthcare field or any related fields.

In the embodiment of FIGS. 23A and 23B, as well as any and/or all of the other embodiments described herein, the apparatus 100 of the present invention can also process and/or store information regarding a payment made, or a co-payment made, by or on behalf of the individual, the patient, or the caregiver, to the provider. In another preferred embodiment, as well as any and/or all of the other embodiments described herein, any one or more of the apparatus 100, the central processing computer 10, the provider communication device 20, the insurer or payer communication device 30, the user or patient communication device 40, or the intermediary communication device 50, can process a payment, or information regarding a payment, made by, for, or on behalf of, any individual, patient, or caregiver, which involves a payment being from a healthcare spending account associated with the individual, patient, or caregiver. In another preferred embodiment, as well as any and/or all of the other embodiments described herein, any one or more of the apparatus 100, the central processing computer 10, the provider communication device 20, the insurer or payer communication device 30, the user or patient communication device 40, or the intermediary communication device 50, can process a payment, a deposit, or a withdrawal, or information regarding a payment, a deposit, or a withdrawal, made to or from a healthcare spending account associated with any individual, patient, or caregiver.

In the embodiment of FIGS. 23A and 23B, as well as any and/or all of the other embodiments described herein, the apparatus 100 of the present invention can also process and/or store information regarding an insurance claim made by or on behalf of the individual, the patient, or the caregiver. In this regard, in another preferred embodiment, the individual, the patient, or the caregiver, or any individual acting on behalf of the individual, the patient, or the caregiver, to submit a healthcare insurance claim for the individual, the patient, or the caregiver, can access the central processing computer 10 via a user or patient communication device 40 or via any other communication device, access and fill out an insurance claim form for the individual's, the patient's, or the caregiver's respective insurer or payer or insurance company, and submit the claim form to the insurer or payer communication device 30 of or associated with the individual's, the patient's, or the caregiver's insurer or payer or insurance company. In this regard, providers and individual's, patient's, or caregiver's, or individuals acting on behalf of an individual(s), patient(s), or caregiver(s), can submit insurance claims to the central processing computer 10.

In another preferred embodiment, any healthcare provider of the individual, the patient, or the caregiver, any insurer or payer or insurer of the individual, the patient, or the caregiver, or the individual, the patient, or the caregiver, himself or herself, can program the central processing computer 10 to generate a reminder message or reminder messages, at any desired or selected times or time intervals, for follow-up care, preventative care, and/or to remind the individual, the patient, or the caregiver, to follow certain procedures and instructions for his or her care and/or well being. The central processing computer 10 can transmit the reminder message or reminder messages to the user or patient computer or communication device 40. The reminder messages can be sent on an on-going basis, as desired, to provide the individual, the patient, or the caregiver, with these reminders.

In another preferred embodiment, any of the individuals, patients, or caregivers, described herein can, at any time, access the central processing computer 10 via his or her user or patient communication device 40 and can request to be provided with an electronic copy of his or her electronic healthcare record or electronic healthcare file, or any portion of same, or an electronic copy of office visit summaries and/or instructions, discharge summaries, procedures, or instructions, symptom summaries, diagnosis summaries, treatment summaries, treatment plan summaries, diagnostic test results, lab or laboratory test results, problem lists, allergy lists, medication lists, medicine or drug lists, medication allergy information, medicine allergy information, drug allergy information, information regarding side effects of medications, medicines, or drugs, claim forms or requests for payment which have been submitted to an insurer or payer, and/or any other healthcare information or healthcare-related information. The central processing computer 10 can process the request, generate the respective report, summary, message, or information, containing the electronic copy of the electronic healthcare record or the electronic healthcare file, or any portion of same, or the electronic copy of one or more of the office visit summaries and/or instructions, discharge summaries, procedures, or instructions, symptom summaries, diagnosis summaries, treatment summaries, treatment plan summaries, diagnostic test results, lab or laboratory test results, problem lists, allergy lists, medication lists, medicine lists or drug lists, medication allergy information, medicine allergy information, drug allergy information, information regarding side effects of medication, medicines, or drugs, claim forms or requests for payment which have been submitted to an insurer or payer, and/or any other healthcare information or healthcare-related information, and transmit the respective report, summary, message, or information, to the user or patient communication device 40.

In another preferred embodiment, the respective report, summary, message, or information, can also be transmitted to the provider communication device 20 of an authorized provider or providers and/or to an insurer or payer communication device 30 of an authorized insurer or payer, to an intermediary computer or communication device 50 of an authorized third party or intermediary, to the healthcare records computer 60, and/or to the insurance exchange computer 70. In this regard, any authorized provider and/or insurer or payer of the individual, patient, or caregiver, or any authorized third party or intermediary, can be provided with an electronic copy of the electronic healthcare record or electronic healthcare file, or any portion of same, or an electronic copy of one or more of the office visit summaries and/or instructions, discharge summaries, procedures, or instructions, symptom summaries, diagnosis summaries, treatment summaries, treatment plan summaries, diagnostic test results, lab or laboratory test results, problem lists, allergy lists, medication lists, medicine lists or drug lists, medication allergy information, medicine allergy information, drug allergy information, information regarding side effects of medication, medicines, or drugs, claim forms or requests for payment which have been submitted to an insurer or payer, and/or any other healthcare information or healthcare-related information.

In another preferred embodiment, any authorized provider or insurer or payer of the individual, the patient, or the caregiver, can exchange information regarding the individual, patient, or caregiver, with any other authorized provider or insurer or payer of the individual, the patient, or the caregiver.

In another preferred embodiment, an individual, a patient, or a caregiver, or an individual acting on behalf of an individual, a patient, or a caregiver, can also submit employee benefits-related healthcare insurance claims utilizing the apparatus 100 and method of the present invention. In this regard, the apparatus 100 and method of the present invention can, in another preferred embodiment, process information regarding a healthcare insurance claim or a healthcare benefit claim made by the individual, the patient, or the caregiver, or by an individual on behalf of the individual, the patient, or the caregiver, to an insurer or payer or an insurance company of or associated with the individual, the patient, or the caregiver, pursuant to a healthcare-related employee benefit.

In the embodiment of FIGS. 23A and 23B, as well as any and/or all of the other embodiments described herein, the apparatus 100 of the present invention can also store information, regarding a claim form, a request for payment form, a claim submission, a request for payment submission, a claim made, a request for payment made, a claim submitted, a request for payment submitted, by a provider or by an individual, a patient, or a caregiver, or on behalf of the patient, or the apparatus 100 can also store information regarding a payment made or a co-payment made, or a charge incurred, or outstanding charges which remain unpaid, by an individual, a patient, or a caregiver, in the individual's, the patient's, or the caregiver's, credit report information or credit history information which is described herein as being stored in the database 10H. In another preferred embodiment, the apparatus 100 of the present invention can also generate and transmit a message, including any changes made to, or any new information added to, or stored in, the individual's, the patient's, or the caregiver's, credit report information or credit history information, to any appropriate credit reporting company, bureau, or agency, or any of the other entities described herein, such as credit card companies or financial institutions, for inclusion into a credit report or credit history of the individual, the patient, or the caregiver.

In another preferred embodiment of FIGS. 23A and 23B, as well as any of the other embodiments described herein, the central processing computer 10 can generate a message anytime an individual's, a patient's, or a caregiver's, credit report or credit reports, or credit history, is or has been accessed, obtained, changed, altered, modified, or updated, or upon a new entry of information being stored in same, or being attempted to be stored in same. Thereafter, the message can be transmitted by the central processing computer 10 to the user or patient communication device 40, or to a communication device, computer, e-mail server, or any other appropriate or suitable device which can be used to relay the message to the user or patient communication device 40, as a telephone message, an e-mail message, an instant messaging message, a message sent to a cellular telephone or personal digital assistant, or any other suitable message, in order to provide the individual, patient, or caregiver, with notification of the event or occurrence involving the individual's, the patient's, or the caregiver's, credit report or credit reports, or credit history. In another preferred embodiment, the message can be transmitted before the accessing, obtaining, changing, alteration, modification, or updating, to the credit report or credit reports, or credit history, is completed, so that the individual, patient, or caregiver, can intervene, via the user or patient communication device 40 or via any other appropriate communication device, so as to dispute or prevent the accessing, obtaining, changing, alteration, modification, or updating, to his or her credit report or credit reports, or credit history.

In the embodiment of FIGS. 23A and 23B, as well as any and/or all of the other embodiments described herein, the apparatus 100 of the present invention can utilize and/or process electronic signatures in order to effectuate and/or process any of the respective transactions which are described as taking place between, and/or which can transpire involving, any of the respective individuals, patients, caregivers, providers, healthcare providers, insurers or payers, healthcare insurers, intermediaries, third parties, and/or any other persons, entities, or parties, described herein.

The apparatus 100 of the present invention can also be utilized, in the manner described above, in order to claim or request healthcare insurance benefits, disability insurance benefits, and/or life insurance benefits.

In another preferred embodiment, the apparatus 100 can administer and/or maintain financial accounts for, and/or on behalf of, any of the individuals, patients, caregivers, users, providers, insures or payers, and/or intermediaries or third parties, described herein. In this manner, any of the respective individuals, patients, caregivers, providers, healthcare providers, insurers or payers, healthcare insurers, intermediaries, third parties, and/or any other persons, entities, or parties, described herein as utilizing the services of the apparatus 100, and/or the central processing computer 10, can have all financial transaction managed and/or monitored by the central processing computer 10. In the preferred embodiment, the financial accounts can be conventional savings accounts, checking account, credit accounts, debit accounts, electronic money accounts, digital money accounts, etc., and/or any other appropriate account(s).

In the preferred embodiment, any of the respective individuals, patients, caregivers, providers, healthcare providers, insurers or payers, healthcare insurers, intermediaries, third parties, and/or any other persons, entities, or parties, described herein may select to have the central processing computer 10 administer any financial transactions on their behalf. For example, an insurer or payer may deposit a sum of money which can be ear-marked for payment of healthcare provider services. A provider may open an account and deposit a sum of money to pay any vendor bills. The provider may also open an account to receive payment from insurers or payers and/or from individuals, patients, or caregivers, for services rendered. Each time a financial transaction is to occur, such as, for example, the payment from an insurer or payer to a provider resulting from an individual's, patient's, or caregiver's, claim, the central processing computer 10 will transfer funds (and/or deduct funds) from the insurer's or payer's account and deposit the funds (and/or add the funds) into the provider's account. Notwithstanding the examples provided above, the central processing computer 10 can effectuate any type of financial transaction(s) for, between, and/or on behalf of, any of the respective individuals, patients, caregivers, providers, healthcare providers, insurers or payers, healthcare insurers, intermediaries, third parties, and/or any other persons, entities, or parties, described herein. Further, the apparatus 100 and/or the central processing computer 10 can also process electronic signatures which can be associated with and/or which can correspond to any of the respective individuals, patients, caregivers, providers, healthcare providers, insurers or payers, healthcare insurers, intermediaries, third parties, and/or any other persons, entities, or parties, described herein who or which are a party to a transaction.

The central processing computer 10, in the preferred embodiment, can maintain detailed records of any and/or all of such transfer and/or transactions and provide periodic account statements to the respective parties maintaining accounts with the central processing computer 10. In this manner, the present invention can provide an apparatus and a method for maintaining financial accounts, effecting financial transactions, and/or providing accounting and/or other notification services, for, and/or on behalf, any of the individuals, patients, caregivers, providers, healthcare providers, insurers or payers, healthcare insurers, intermediaries, third parties, and/or any other persons, entities, or parties, described herein.

In another preferred embodiment, the apparatus 100 or the present invention can provide for an individual, a patient, or a caregiver, or for each provider or for each insurer or payer associated with the individual, patient, or caregiver, a financial report which can contain or include data or information regarding insurance premiums or payments, or premiums or payments for an insurer or payer policy, plan or program, which are or were made by or on behalf of the individual, patient, or caregiver, any and/or all insurance claim(s) or request(s) for payment(s) made by or on behalf of the individual, patient, or caregiver, provider bills or provider charges submitted in an insurance claim or a request for payment, provider amounts or provider charges billed for goods, products, or services, amounts paid by an insurer or payer for the amounts billed or charged by a provider, amounts paid or amounts of co-payments paid by or on behalf of the individual, patient, or caregiver, for the amounts billed, deductibles paid by or on behalf of the individual, patient or caregiver, and/or any other data and/or information regarding charges, bills, insurance claims, requests for payments, amounts paid by insurers or payers, and/or any amounts paid by or on behalf of the respective individual, patient, or caregiver.

In a preferred embodiment, an individual, patient, or caregiver, or a provider or insurer or payer, or any authorized intermediary or third party (the “requesting party”), can access the central processing computer 10 with a respective communication device 40, 20, 30, or 50 and transmit a request for the financial report along with any specific information requested. The central processing computer 10 can thereafter process the request, generate the financial report which can contain or include the requested information, and transmit the financial report to the respective communication device 40, 20, 30, or 50 associated with or used by the requesting party. Thereafter the requesting party can review the financial report. The financial report, along with information regarding the requesting party and the time and/or date of the request, can also be stored in the database 10H of the central processing computer 10 and/or in the electronic healthcare record or electronic healthcare file of the individual, patient, or caregiver, who is the subject of the request. In another preferred embodiment, the central processing computer 10 can also generate an financial report request alert message and transmit same to the user or patient communication device 40 associated with the individual, patient, or caregiver, so as to provide notification to the individual, patient, or caregiver, that a financial report has been requested. The financial report request alert message can also be stored in the database 10H of the central processing computer 10, in the individual's, the patient's, or the caregiver's, electronic healthcare record or electronic healthcare file in the database 10H of the central processing computer, in the database 60H of the healthcare records computer 60, in the database 40H of the user of patient communication device 40 associated with the individual, patient, or caregiver, or in any of the herein described computers or communication devices 20, 30, 40, 50, 60, 70, and/or 80.

In another preferred embodiment, the financial reports can be used to perform audits of, for, or regarding, any individual, patient, caregiver, any provider, and/or any insurer or payer.

In another preferred embodiment, the apparatus 100 and method of the present can be utilized as a healthcare training simulator for any of the providers, healthcare providers, healthcare professionals, and/or other providers described herein. The present invention can also be utilized by any other user and/or individual, patient, or caregiver, or any other person, wishing to learn about a certain healthcare field or topic. The present invention can be utilized to provide formal training, supplemental training, informal training, continuing education training, and/or any other training

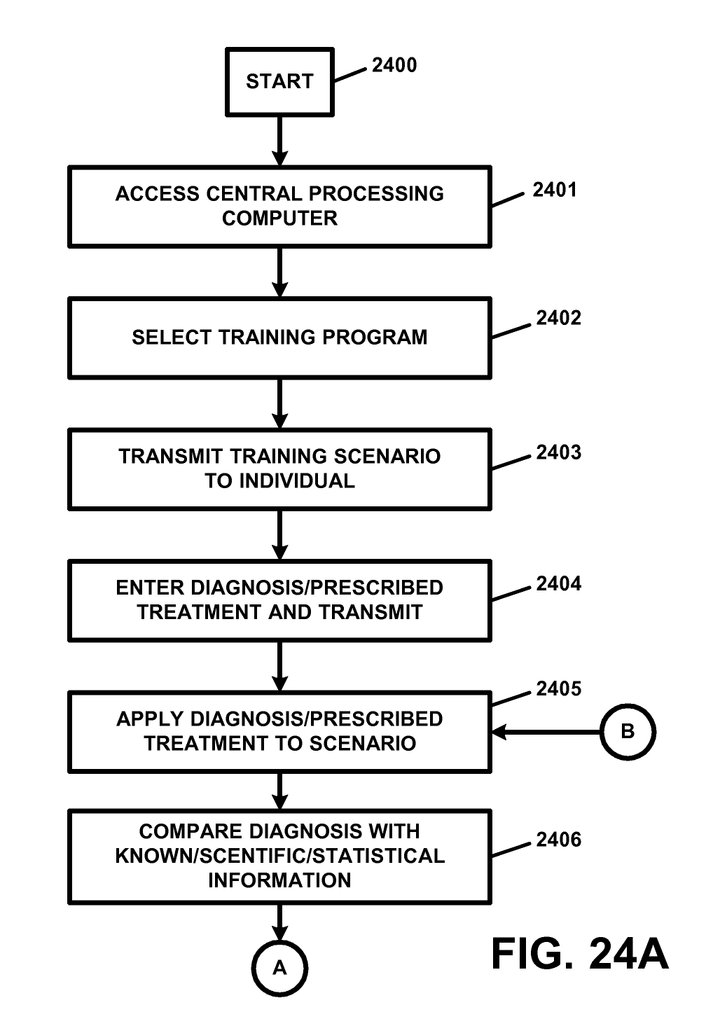

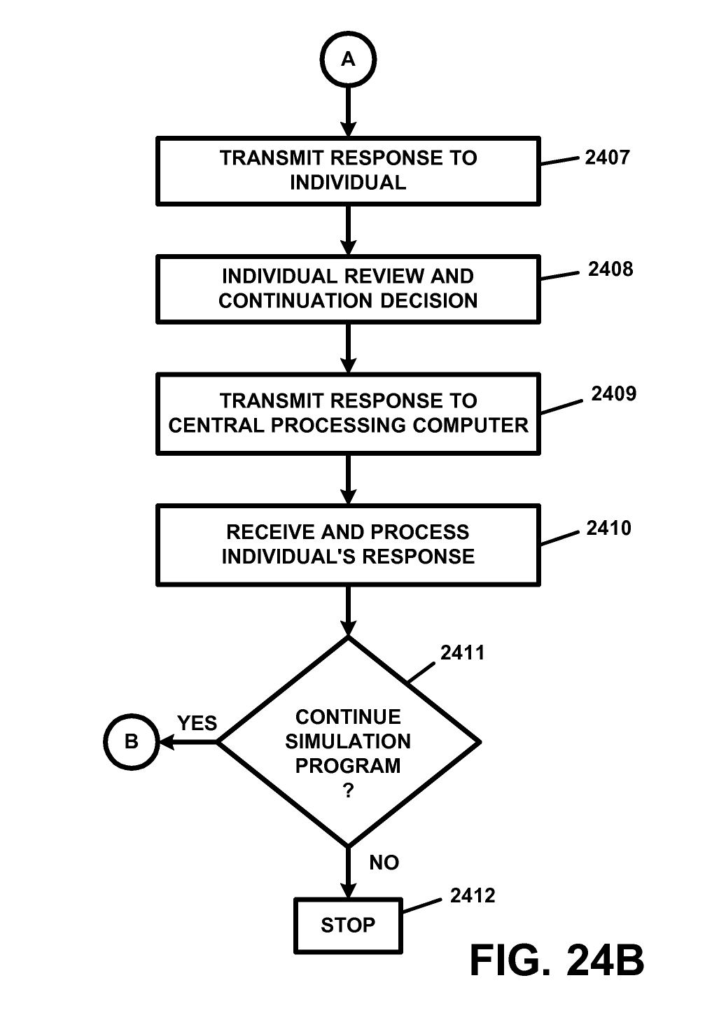

FIGS. 24A and 24B illustrate another preferred embodiment method for utilizing the apparatus 100 of the present invention, in flow diagram form. The operation of the apparatus 100 commences at step 2400. At step 2401, the individual or user utilizing the training simulator (referred to hereinafter as “the user”) who could be any provider, healthcare provider or professional, student provider, and/or any other individual, patient, or caregiver, or any person or party described herein, can access the central processing computer 10 via an appropriate computer or communication device. At step 2402, the user can select the training program which he or she wishes to train from. At step 2403, the central processing computer 10 will transmit the training scenario and/or information, including the symptoms and/or conditions of a hypothetical patient. The training scenario can include any one or more of text information, a video tapped file or video clip, audio information, and/or any other multimedia information.

At step 2404, the user can enter his or her diagnosis and prescribed treatment and/or treatments for the presented scenario and transmit same to the central processing computer 10. At step 2405, the user's diagnosis and prescribed treatment can be applied to the scenario. At step 2406, the central processing computer 10 will compare the diagnosis against any diagnosis or diagnoses which are known to be correct and/or against any scientific and/or statistical norms. At step 2406, the central processing computer 10 will apply the prescribed treatment or treatments to the hypothetical patient and compute a revised set of symptoms and/or conditions which can result from the applied treatment and/or treatments. Once again, statistical information can be utilized to arrive at a realistic response to the treatment and/or treatments. The user's diagnosis and prescribed treatment, as well as information regarding the correctness and/or viability of same can be recorded by the central processing computer 10 at step 2406.

At step 2407, the central processing computer 10 will transmit a response to the user's diagnosis and prescribed treatment. The response can include the patient's response to the prescribed treatment, and/or an evaluation of the diagnosis and prescribed treatment or treatments. The response can also include training materials, which can include any one or more of text information, video information, and/or audio information.

At step 2408, the user can review the material and/or information contained in the response and can decide whether he or she wishes to continue the training simulation. At step 2409, the user will transmit a response to the central processing computer 10 which contains an instruction to either continue the simulation, in which case the user's response will also include a revised diagnosis and prescribed treatment or treatments, or to terminate the training simulation.

At step 2410, the central processing computer 10 will receive and/or process the user's response provided at step 2409. At step 2411, the central processing computer 10 will determine whether the user desires to continue the simulation or whether the user desires to terminate the simulation. If, at step 2411, it is determined that the user desires to continue the training simulation, the operation of the central processing computer 10 returns to step 2405 and the above-described process will be repeated from step 2405. If, however, it is determined that the user desires to terminate the training simulation the operation of the apparatus 100 will cease at step 2412. User responses, including diagnostic and treatment decisions, and/or performance, can be recorded and/or can be stored and, thereafter the information can be utilized to evaluate the user and/or for comparing the user's progress and/or improvements, as well as aptitude and skills, in the pertinent field of training, and/or the information can be utilized for any other useful purpose.

In this manner the apparatus 100 and method of the present invention can be utilized to provide an interactive healthcare training simulator which can be utilized for training in any and/or all of the fields of medicine, surgery, psychiatry, psychology, psychotherapy, dentistry, oral surgery, nutrition, health and fitness, wellness, and/or in any other healthcare and/or healthcare-related field.

Data and/or information collected and/or stored by the apparatus 100, which relates to symptoms and/or conditions, as well as responses to treatments, can be utilized in order to present realistic and confidential training scenarios. In this manner, the apparatus 100 of the present invention can be utilized to compile a vast amount of information relating to the various fields of healthcare. The information can then be utilized to provide realistic training for providers and/or student providers. In this manner, the apparatus 100 of the present invention can utilize information obtained from other preferred embodiments in order to provide simulated training scenarios.

In another preferred embodiment, the apparatus 100 of FIGS. 24A and 24B can utilize any of the herein-described data/or information contained in any of the herein-described individual's, patient's, or caregiver's, notes, comments, or messages, stored in the respective individual's, patient's, or caregiver's, electronic healthcare records, provider's notes or comments, examination findings, diagnostic reports, treatment reports and/or treatment plans, and/or any other information stored in the database 10H of the central processing computer 10 or in the database 60H of the healthcare records computer 60, with the respective individual's, patient's, or caregiver's, identity concealed, privacy maintained, and/or with all data or information utilized anonymously, in order to provide or facilitate real-life training scenarios.

In another preferred embodiment, the apparatus 100 and method of the present invention can be utilized in order to maintain individual, patient, or caregiver, electronic healthcare records or electronic healthcare files private and/or to safeguard individual, patient, or caregiver, electronic healthcare records or electronic healthcare files, by restricting and/or by limiting access to the respective electronic healthcare records or electronic healthcare files.

The apparatus 100 and/or the central processing computer 10 can process information regarding the identity of, and/or the information which is authorized and/or allowed to be provided to, a requesting individual or entity who or which can be any individual, patient, caregiver, provider, insurer or payer, and/or intermediary, or any other individual, user, or entity, who or which may request information regarding an individual's, a patient's, or a caregiver's, electronic healthcare records or electronic healthcare files. Thereafter, the apparatus 100 and/or the central processing computer 10 can determine whether the requesting individual or entity who or which can be any individual, patient, caregiver, provider, insurer or payer, and/or intermediary, or any other individual, user, or entity, is authorized or allowed to access, obtain, modify, change, alter, and/or update, any data and/or information contained in a respective individual's, a patient's, or a caregiver's, electronic healthcare records or electronic healthcare files.

The apparatus 100 and/or the central processing computer 10 can utilize and/or process passwords, electronic signatures, and/or any other information and/or encoded and/or encrypted information in determining an individual's, a patient's, a caregiver's, a provider's, an insurer's or payer's, or an intermediary's, or any other individual's, user's, or entity's, authorization to access, obtain, modify, change, alter, and/or update, any data and/or information contain in a respective electronic healthcare record(s) or electronic healthcare file(s).

If the apparatus 100 and/or the central processing computer 10 determines that a respective individual, patient, caregiver, provider, insurer or payer, and/or intermediary, or any other individual, user, or entity, is authorized or allowed to access, obtain, modify, change, alter, and/or update, any data and/or information contained in a respective individual's, patient's, or caregiver's, electronic healthcare record(s) or electronic healthcare file(s), the apparatus 100 and/or the central processing computer 10 will respectively allow access to the information, provide the information, and/or process and store changes, alterations, modifications, and/or updates, to the respective electronic healthcare record(s) or electronic healthcare file(s) or to any data and/or information contained therein. If, however, the apparatus 100 and/or the central processing computer 10 determines that a respective individual, patient, caregiver, provider, insurer or payer, and/or intermediary, or any other individual, user, or entity, is not authorized or not allowed to access, obtain, modify, change, alter, and/or update, any data and/or contained in a respective individual's, patient's, or caregiver's, electronic healthcare record(s) or electronic healthcare file(s), the apparatus 100 and/or the central processing computer 10 will prohibit or disallow his, her, or it's, access to the electronic healthcare record(s) or electronic healthcare file(s), and/or to any data and/or information contained therein.

In another preferred embodiment of the apparatus 100 and method of the present invention, the apparatus 100 can provide notification or a notification message or an alert message to an individual, patient, or caregiver, when any individual, patient, caregiver, provider, insurer or payer, and/or intermediary, or any other individual, user, or entity, is attempting to access, has accessed, has obtained access to individual's, patient's, or caregiver's, electronic healthcare record(s) or electronic healthcare file(s) or any data and/or information contained therein, and/or has made, has attempted to make, or is in the process of making, a modification, a change, an alteration, and/or an update or an updating, to their respective electronic healthcare records or electronic healthcare files. The apparatus 100 can also provide notification to providers or to healthcare providers, including but not limited to, the individual's, the patient's, or the caregiver's, provider or providers, insurer, insurers, payer, payers, or healthcare payers or insurance providers, including, but not limited to, the individual's, the patient's, or the caregiver's, insurer or payer, or healthcare payer(s) or insurance provider(s), when another individual, patient, caregiver, provider, insurer or payer, and/or intermediary, or any other individual, user, or entity, has attempted to access or obtain, or has accessed or obtained, and/or has attempted to, is attempting to, or is in the process of making, a modification, a change, an alteration, and/or an update or an updating, to their respective electronic healthcare records or electronic healthcare files.

It is envisioned that electronic healthcare records or electronic healthcare files can be accessed, obtained, modified, changed, altered, and/or updated, by any one or more of a patient, an individual, a caregiver, a relative of a patient, a relative of an individual, an interested third party or intermediary, a provider, a healthcare provider, a healthcare provider of or to the individual, patient, or caregiver, an insurer or payer, a healthcare insurer or payer, an insurance provider, and/or an insurer or payer, or a healthcare insurer or payer, or an insurance provider, of the individual, patient, or caregiver. In this manner, the apparatus 100 and method of the present invention can maintain and/or safeguard electronic healthcare records or electronic healthcare files for any of the individuals, patients, or caregivers, described herein. In the same manner, the apparatus 100 and method of the present invention can also maintain and safeguard records and/or files of, or regarding, any of the herein-described providers, healthcare providers, insurers or payers, or healthcare insurers or payers.

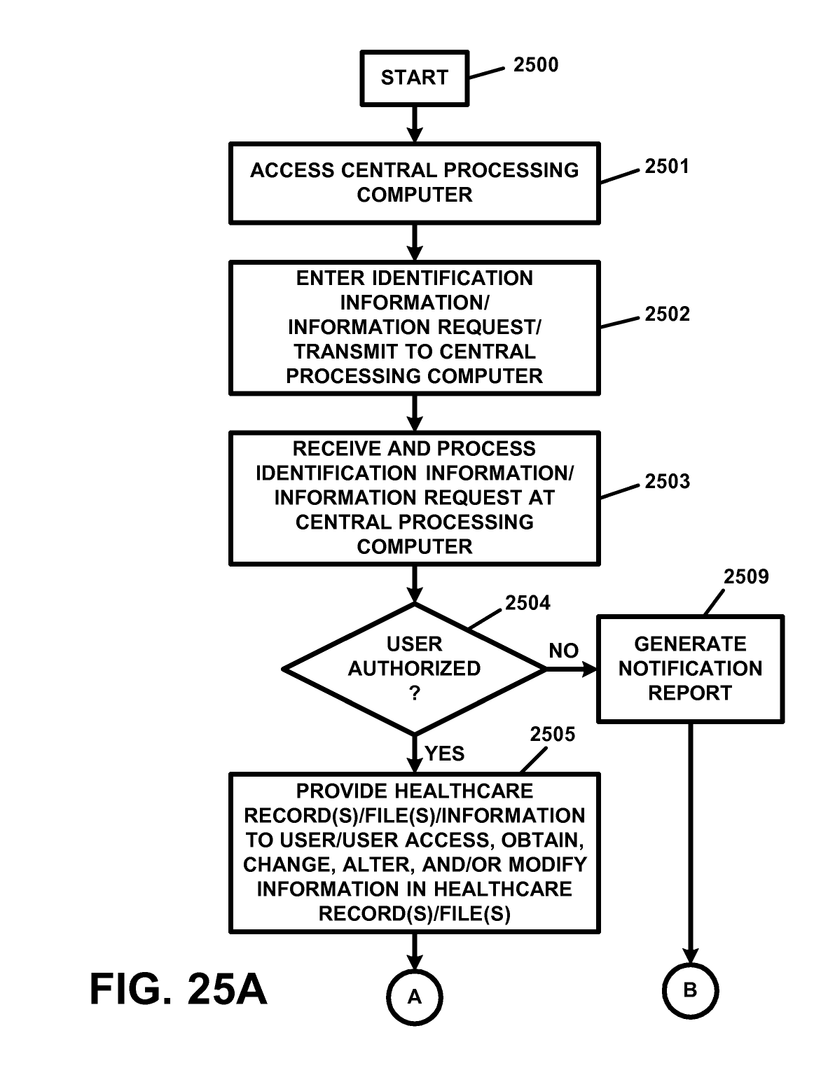

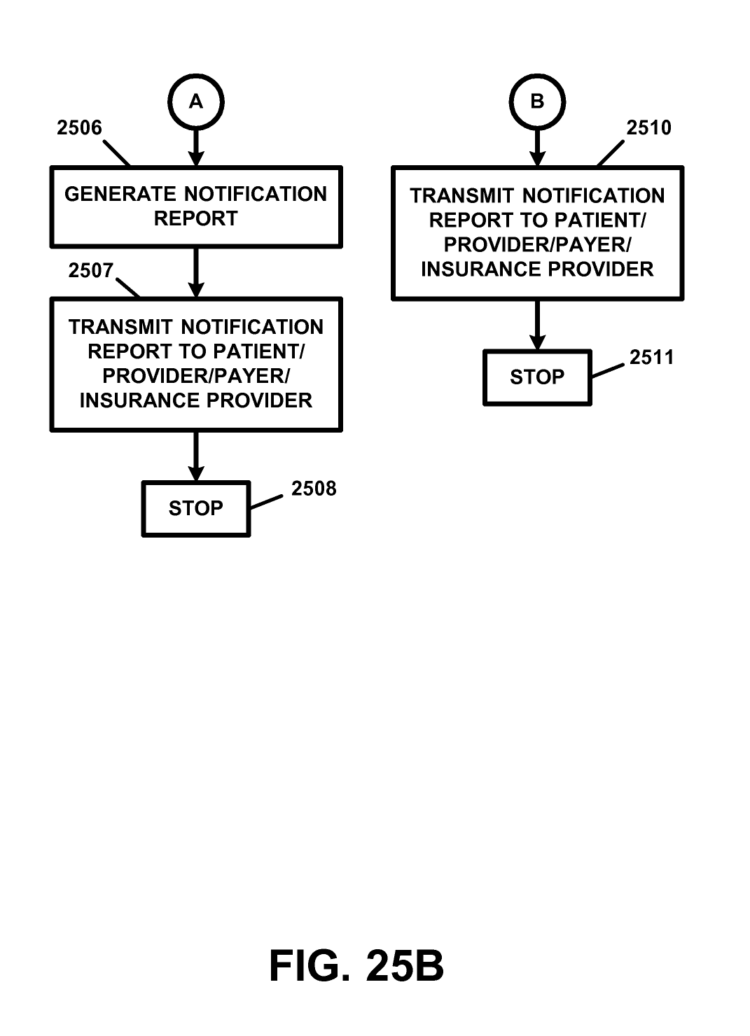

In another preferred embodiment, the apparatus 100 and method of the present invention can provide notification to an individual, patient, or caregiver, when his or her electronic healthcare record(s) or electronic healthcare file(s), or any portion thereof, has been accessed, obtained, modified, changed, altered, and/or updated, and/or when a request has been made to access, obtain, modify, change, alter, and/or update, his or her electronic healthcare record(s) or electronic healthcare file(s), or any portion thereof FIGS. 25A and 25B illustrate another preferred embodiment method for utilizing the apparatus 100 of the present invention, in flow diagram form.

With reference to FIGS. 25A and 25B, the operation of the apparatus 100 commences at step 2500. At step 2501, any one or more of an a respective individual, patient, caregiver, a relative of a individual, patient, or caregiver, provider, a healthcare provider, insurer or payer, a healthcare insurer or payer, an insurance provider, a third party, an intermediary, or any other individual, user, or entity, or any other third party individual or entity (hereinafter referred to as “user”) can access the central processing computer 10 via a respective computer or communication device and/or via his, hers, or it's, respective computer or communication device.

For example, a provider or a healthcare provider can access the central processing computer 10 in order to access, obtain, modify, change, alter, or update, data and/or information contained in an individual's, patient's, or caregiver's, electronic healthcare record(s) or electronic healthcare file(s) for any appropriate reason or purpose, such as, but not limited to, updating data and/or information, updating a record or file, making a diagnosis, prescribing a treatment, providing a treatment plan or program, providing information to other providers, submitting insurance claim information or a claim for payment, and/or for any other reason or purpose.

An insurer or payer, or a healthcare insurer or payer, or an insurance provider, can access the central processing computer 10 in order to access, obtain, modify, change, alter, or update, data and/or information contained in an individual's, patient's, or caregiver's, electronic healthcare record(s) or electronic healthcare file(s) for any appropriate reason or purpose, such as, but not limited to, processing an insurance claim, obtaining additional information regarding the individual, patient, or caregiver, and/or for any other reason or purpose.

An individual, patient, or caregiver, can also access, obtain, modify, change, alter, or update, data and/or information contained in an individual's, patient's, or caregiver's, electronic healthcare record(s) or electronic healthcare file(s) for any appropriate reason or purpose, such as, but not limited to, updating an electronic healthcare record or an electronic healthcare file, providing information to a provider or a healthcare provider, providing information to an insurer or payer, or a healthcare insurer or payer, or an insurance provider, obtaining treatment information, obtaining provider information, or obtaining healthcare provider information, obtaining insurer or payer information or obtaining healthcare insurer or payer information, or obtaining insurance provider information, and/or for any other reason or purpose.

Any user or any third party individual or entity can also access, obtain, modify change, alter, or update, data and/or information contained in an individual's, a patient's, or a caregiver's, electronic healthcare record(s) or electronic healthcare file(s) for any appropriate reason or purpose, such as, but not limited to, updating an electronic healthcare record or electronic healthcare file, providing information regarding an individual(s), a patient(s), or a caregiver(s), providing information to a provider or a healthcare provider, providing information to an insurer or payer or a healthcare insurer or payer, or an insurance provider, obtaining treatment information, obtaining provider information, obtaining insurer or payer information, obtaining insurance provider information, and/or for any other reason or purpose.

At step 2502, the user can enter identification information, a password, an electronic signature, a code, and/or any other information which may be needed for accessing the data and/or information stored in the central processing computer 10. The identification information can be entered by the user and/or be provided by the user's computer or communication device which can be a user or patient communication device 40 or any other computer or communication device described herein. At step 2502, the user can also enter an information request and/or a request to access, obtain, modify. change, alter, or update, data and/or information contained in an individual's, a patient's, or a caregiver's, electronic healthcare record(s) or electronic healthcare file(s). At step 2502, the user's identification information and information regarding the user's request can also be transmitted to the central processing computer 10.

At step 2503, the central processing computer 10 will receive and/or process the user's identification information and information regarding the user's request. At step 2504, the central processing computer 10 will determine whether the user is an authorized user. At step 2504, the central processing computer 10 can also determine whether the user is authorized to access, obtain, modify, change, alter, or update, any data and/or information in or, the requested individual's, patient's, or caregiver's, electronic healthcare record(s) or electronic healthcare file(s) and/or whether the user is authorized to access, obtain, modify, change, alter, or update, the requested information contained in the requested individual's, patient's, or caregiver's, electronic healthcare record(s) or electronic healthcare file(s). If, at step 2504, the central processing computer 10 determines that the user is an authorized user and/or that the user is authorized to access, obtain, modify, change, alter, or update, the requested individual's, patient's, or caregiver's, electronic healthcare record(s) or electronic healthcare file(s), the operation of the apparatus 100 will proceed to step 2505.

At step 2505, central processing computer 10 will provide to the user the requested individual's, patient's, or caregiver's, electronic healthcare record(s) or electronic healthcare file(s) or will provide to the user any data and/or information in the requested individual's, patient's, or caregiver's, electronic healthcare record(s) or electronic healthcare file(s). At step 2505, the user can any one or more of access any data and/or information contained in the respective electronic healthcare record(s) or electronic healthcare file(s), obtain any data and/or information contained in the respective electronic healthcare record(s) or electronic healthcare file(s), modify any data and/or information contained in the respective electronic healthcare record(s) or electronic healthcare file(s), change any data and/or information contained in the respective electronic healthcare record(s) or electronic healthcare file(s), alter any data and/or information contained in the respective electronic healthcare record(s) or electronic healthcare file(s), or update any data and/or information contained in the respective electronic healthcare record(s) or electronic healthcare file(s), and/or modify any data and/or information contained in the respective electronic healthcare record(s) or electronic healthcare file(s).

For example, a provider can obtain individual, patient, or caregiver, data and/or information, update an individual's, a patient's, or a caregiver's, electronic healthcare record(s) or electronic healthcare file(s), submit an insurance claim or a claim for payment, prescribe a treatment for the individual or patient, and/or perform any other task on, or involving, the data and/or information contained in the individual's, the patient's, or the caregiver's, electronic healthcare record(s) or electronic healthcare file(s). Any individual, patient, or caregiver, can also update his or her own electronic healthcare record(s) or electronic healthcare file(s) or any data and/or information contained therein, such as by providing medical, dental, or healthcare history, information, or any information regarding sickness, illness, symptoms, wellness or fitness, or any other healthcare or healthcare-related information. An insurer or payer, or an insurance provider, can update claim information, update payment information, or obtain information for processing and/or analyzing insurance claims, claims for payment, or obtain information for performing any other task, activity, or function.

At step 2505, the respective user can obtain, access, modify, change, alter, or update, any of the data and/or information contained in the individual's, the patient's, or the caregiver's, electronic healthcare record(s) or electronic healthcare file(s), for which the user is authorized. At step 2505, the respective user can also perform any task on, or regarding, any data and/or information contained in the individual's, the patient's, or the caregiver's, electronic healthcare record(s) or electronic healthcare file(s).

At step 2506, the central processing computer 10 will generate a notification report, a notification message, or an alert message (hereinafter “the notification report”), containing information regarding the user who or which accessed, obtained, modified, changed, altered, or updated, the electronic healthcare record(s) or electronic healthcare file(s) or any data and/or information contained therein, user identification information, the time and date the user accessed, obtained, modified, changed, altered, or updated, the electronic healthcare record(s) or electronic healthcare file(s) or any data and/or information contained therein, the reason for the user accessing, obtaining, modifying, changing, altering, or updating, the healthcare record(s) or electronic healthcare file(s) or any data and/or information contained therein, the nature or substance of any changes, alterations, modifications, or updates, made to the data and/or information contained in the electronic healthcare record(s) or electronic healthcare file(s) or any data and/or information contained therein, the subject of, and/or the actual, changes, alterations, modifications, or updates, made to the electronic healthcare record(s) or electronic healthcare file(s) or any data and/or information contained therein, and/or any other information regarding the user's accessing, obtaining, modifying, changing, altering, or updating, the electronic healthcare record(s) or electronic healthcare file(s) or any data and/or information contained therein.

At step 2507, the central processing computer 10 will transmit the notification report to the user or patient communication device 40 associated with or used by the individual, the patient, or the caregiver, whose electronic healthcare record(s) or electronic healthcare file(s) were accessed by, or were being accessed by, the user. The notification report can be transmitted as an e-mail message, an instant messaging message, as an SMS message, as a communication, as a communication transmission, as a beeper message, as a pager message, as a telephone call, as a pre-recorder telephone call message, as a facsimile message, as an electronic transmission, or a physical letter/mail delivery, and/or as any other information transmission or message. At step 2507, the notification report can also be transmitted to any one or more of, or to any number of, user or patient communication devices 40. At step 2507, the notification report can also be stored in the individual's, the patient's, or the caregiver's, electronic healthcare record or electronic healthcare file in the database 10H of the central processing computer 10, and/or in the individual's, the patient's, or the caregiver's, electronic healthcare record or electronic healthcare file in the database 60H of the healthcare records computer 10.

At step 2507, the notification report can also be transmitted to a provider communication device 20 associated with a provider of the individual, patient, or caregiver, can be transmitted to any respective provider communication device 20 associated with or used by any one or more, or all, of the providers or healthcare providers of the individual, patient, or caregiver, can be transmitted to an insurer or payer communication device 30 associated with or used by an insurer or payer of the individual, patient, or caregiver, can be transmitted to any respective insurer or payer communication device 30 associated with or used by any one or more, or all, of the insurers or payers, healthcare insurers or payers, insurance providers, or healthcare insurance providers, of the individual, patient, or caregiver, and/or can be transmitted to any intermediary communication device 50 associated with or used by any intermediary or third party authorized to receive the notification report. The notification report can also be transmitted to any of the respective computers or communication devices 20, 30, or 50, associated with any of the respective providers, healthcare provider(s), insure(s) or payer(s), healthcare payer(s), insurance provider(s), of the individual, the patient, or the caregiver, and/or third party individual(s), entity, or entities.

In a preferred embodiment, the apparatus 100 or the central processing computer 10 can transmit the notification report to all of the providers and/or insurer or payers of the individual, the patient, or the caregiver, and/or to their respective provider communication devices 20 or insurer or payer communication devices 30. In a preferred embodiment, the apparatus 100 or the central processing computer 10 can also transmit the notification report to all of the intermediaries or third parties authorized to receive same and/or to their respective intermediary communication devices 50.

Thereafter, the operation of the apparatus 100 will cease at step 2508.

If, however, at step 2504, it is determined that the user is not an authorized user and/or that the user is not authorized to access, obtain, modify, change, alter, or update, the requested electronic healthcare record(s) or electronic healthcare file(s), or any information contained therein, then the operation of the apparatus 100 will proceed to step 2509.

At step 2509, the central processing computer 10 will generate a notification report containing information regarding the user who or which attempted to obtain, access, modify, change, alter, or update, the electronic healthcare record(s) or electronic healthcare file(s), user identification information, the time and date of the user's attempted access of the electronic healthcare record(s) or electronic healthcare file(s), the reason for the user's attempted access of the electronic healthcare record(s) or electronic healthcare file(s), and/or any other information regarding the user's attempted access of the electronic healthcare record(s) or electronic healthcare file(s). At step 2509, the notification report can also be stored in the individual's, the patient's, or the caregiver's, electronic healthcare record or electronic healthcare file in the database 10H of the central processing computer 10, and/or in the individual's, the patient's, or the caregiver's, electronic healthcare record or electronic healthcare file in the database 60H of the healthcare records computer 10.

At step 2510, the central processing computer 10 will transmit the notification report to the user or patient communication device 40 associated with or used by the individual, the patient, or the caregiver, whose electronic healthcare record(s) or electronic healthcare file(s) were attempted to be accessed by the user or upon which access was attempted. The notification report can be transmitted as an e-mail message, an instant messaging message, as an SMS message, as a communication, as a communication transmission, as a beeper message, as a pager message, as a telephone call, as a pre-recorded telephone call message, as a facsimile message, as an electronic transmission, or a physical letter/mail delivery, and/or as any other information transmission or message. At step 2510, the notification report can also be transmitted to any one or more of, or to any number of, user or patient communication devices 40. At step 2510, the notification report can also be stored in the individual's, the patient's, or the caregiver's, electronic healthcare record or electronic healthcare file in the database 10H of the central processing computer 10, and/or in the individual's, the patient's, or the caregiver's, electronic healthcare record or electronic healthcare file in the database 60H of the healthcare records computer 60.

At step 2510, the notification report can also be transmitted to a provider communication device 20 associated with a provider of the individual, patient, or caregiver, can be transmitted to any respective provider communication device 20 associated with or used by any one or more, or all, of the providers or healthcare providers of the individual, patient, or caregiver, can be transmitted to an insurer or payer communication device 30 associated with or used by an insurer or payer of the individual, patient, or caregiver, can be transmitted to any respective insurer or payer communication device 30 associated with or used by any one or more, or all, of the insurers or payers, healthcare insurers or payers, insurance providers, or healthcare insurance providers, of the individual, patient, or caregiver, and/or can be transmitted to any intermediary communication device 50 associated with or used by any intermediary or third party authorized to receive the notification report.

The notification report can also be transmitted to any of the respective computers or communication devices 20, 30, or 50, associated with any of the respective providers, healthcare provider(s), insure(s) or payer(s), healthcare payer(s), insurance provider(s), of the individual, the patient, or the caregiver, and/or third party individual(s), entity, or entities.

In a preferred embodiment, the apparatus 100 or the central processing computer 10 can transmit the notification report to all of the providers and/or insurer or payers of the individual, the patient, or the caregiver, and/or to their respective provider communication devices 20 or insurer or payer communication devices 30. In a preferred embodiment, the apparatus 100 or the central processing computer 10 can also transmit the notification report to all of the intermediaries or third parties authorized to receive same and/or to their respective intermediary communication devices 50.

Any of the notification reports described herein as being provided by the apparatus 100 of FIGS. 25A and 25B can be transmitted to the respective individual, patient, caregiver, provider, healthcare provider, insurer or payer, healthcare payer, insurance provider, and/or third party, and/or to their respective computer or communication device in real-time, in a time-delayed manner, and/or in any other appropriate manner.

Thereafter, the operation of the apparatus 100 will cease at step 2511.

In a preferred embodiment, any of the notification reports can also be transmitted to the healthcare records computer 60 and/or to the insurance exchange computer 70.

In another preferred embodiment of FIGS. 25A and 25B, a respective individual, patient, caregiver, provider, healthcare provider, insurer or payer, healthcare payer, insurance provider, and/or third party or intermediary, upon receiving notification that a user is any one or more of accessing, obtaining, modifying, changing, altering, and/or updating, data and/or information contained in the individual's, the patient's, or the caregiver's, electronic healthcare record or electronic healthcare file, can terminate the accessing, obtaining, modifying, changing, altering, and/or updating, of any data and/or information contained in individual's, the patient's, or the caregiver's, electronic healthcare record or electronic healthcare file, in real-time, or otherwise, such as by transmitting a “terminate message” or a “deny access message” or signal to the central processing computer 10 via a respective computer or communication device 40, 20, 30, or 50. Upon receiving and processing the “terminate message” or the “deny access message” or signal, the central processing computer 10 can terminate the user's access, or deny the user's access to the individual's, the patient's, or the caregiver's, electronic healthcare record or electronic healthcare file.

The “terminate message” or “deny access message”, a record of or regarding same, and/or information confirming that the central processing computer 10 terminated or denied the user's access to the individual's, the patient's, or the caregiver's, electronic healthcare record or electronic healthcare file can also be stored in the individual's, the patient's, or the caregiver's, electronic healthcare record or electronic healthcare file in the database 10H of the central processing computer 10, and/or in the individual's, the patient's, or the caregiver's, electronic healthcare record or electronic healthcare file in the database 60H of the healthcare records computer 60.

In another preferred embodiment of FIGS. 25A and 25B, a respective individual, patient, caregiver, provider, healthcare provider, insurer or payer, healthcare payer, insurance provider, and/or third party or intermediary, upon receiving notification that a user has already performed or completed an unauthorized accessing, obtaining, modifying, changing, altering, or updating, of data and/or information contained in the individual's, the patient's, or the caregiver's, electronic healthcare record or electronic healthcare file, the individual, patient, caregiver, provider, healthcare provider, insurer or payer, healthcare payer, insurance provider, and/or third party or intermediary, can undo, or negate, or can void, clear out, or nullify, any such, or any affects of such, unauthorized accessing, obtaining, modifying, changing, altering, and/or updating, of any data and/or information contained in individual's, the patient's, or the caregiver's, electronic healthcare record or electronic healthcare file, in real-time, or otherwise, such as by transmitting an “undo changes message” or a “negate changes message” or signal to the central processing computer 10 via a respective computer or communication device 40, 20, 30, or 50.

Upon receiving and processing the “undo changes message” or the “negate changes message” or signal, the central processing computer 10 can process any data and/or information, and/or perform any processing routines, in order to undo any changes made, or to negate, or to void, clear out, or nullify, any changes made, to the individual's, the patient's, or the caregiver's, electronic healthcare record or electronic healthcare file by user, and/or to automatically restore the data and/or information stored to the individual's, the patient's, or the caregiver's, electronic healthcare record or electronic healthcare to its pre-change state or condition prior to the changes made being made by the user.

The “undo changes message” or “negate changes message”, a record of or regarding same, and/or information confirming that the central processing computer 10 undid or negated, or voided, cleared out, or nullified, any changes made by the user, and/or restored the data and/or information in the individual's, the patient's, or the caregiver's, electronic healthcare record or electronic healthcare file to the pre-change state or condition, can also be stored in the individual's, the patient's, or the caregiver's, electronic healthcare record or electronic healthcare file in the database 10H of the central processing computer 10, and/or in the individual's, the patient's, or the caregiver's, electronic healthcare record or electronic healthcare file in the database 60H of the healthcare records computer 60.

In another preferred embodiment, the apparatus 100 of FIGS. 25A and 25B, and in particular, the central processing computer 10, can, for any and/or all of the electronic healthcare records or electronic healthcare files stored in the database 10H, store information regarding any accessing of, obtaining of, modifying of, changing of, altering of, and/or updating of, or any attempt to access, obtain, modify, change, alter, and/or update, any of the data and/or information contained in a respective individual's, patient's, or caregiver's, electronic healthcare record or electronic healthcare file by any herein-described user(s), or by any other individual, patient, caregiver, provider, healthcare provider, insure or payer, healthcare insure or payer, healthcare payers, insurance providers, or any third party or intermediary.

The stored information, regarding any access or attempted access of a respective individual's, patient's, or caregiver's, electronic healthcare record or electronic healthcare file, can include any one or more of the date, time, reason, purpose, and/or the nature, of the accessing, obtaining, modifying, changing, altering, and/or updating, or any attempt of any of the above actions, of or regarding any of the data and/or information contained in any of the individual's, patient's, or caregiver's, electronic healthcare records or electronic healthcare files by any herein-described user(s), or by any other individual, patient, caregiver, provider, healthcare provider, insure or payer, healthcare insure or payer, healthcare payers, insurance providers, or any third party or intermediary. The stored information can also include the subject matter of any changes, alterations, modifications, or updates, and/or actual changes made, to the respective electronic healthcare record(s) or electronic healthcare file(s).

In another preferred embodiment, the central processing computer 10 can also generate and/or provide activity reports regarding any accessing, obtaining, modifying, changing, altering, and/or updating, or any attempts to do so, of or regarding any of the data and/or information contained in any of the electronic healthcare records or electronic healthcare files by any of the herein-described user(s), or by any other individual, patient, caregiver, provider, healthcare provider, insure or payer, healthcare insure or payer, healthcare payers, insurance providers, or any third party or intermediary.

In a preferred embodiment, the central processing computer 10 can generate an activity report or activity reports upon demand and/or upon request. The central processing computer 10 can also be programmed to generate activity reports periodically, such as daily, weekly, monthly, bi-monthly, quarterly, annually, and/or for any other time period.

The activity reports can include information regarding any number of electronic healthcare records or electronic healthcare files for any number of individuals, patients or caregivers.

The central processing computer 10 can transmit the activity report or activity reports to the respective individual, patient, caregiver, provider, healthcare provider, insure or payer, healthcare insurer or payer, insurance provider, third party, or intermediary, by transmitting same to a respective computer or communication device 40, 20, 30, or 50 of the respective individual, patient, caregiver, provider, healthcare provider, insure or payer, healthcare insurer or payer, insurance provider, third party, or intermediary. The central processing computer 10 can transmit the activity report or activity reports to the healthcare records computer 60 or to the insurance exchange computer 70. Any of the activity reports described herein as being provided or transmitted by the apparatus 100 of FIGS. 25A and 25B can be transmitted to the respective computer or communication device in real-time, in a time-delayed manner, and/or in any other appropriate manner.

The activity report can be transmitted as an e-mail message, an instant messaging message, as an SMS message, as a communication, as a communication transmission, as a beeper message, as a pager message, as a telephone call, as a pre-recorded telephone call message, as a facsimile message, as an electronic transmission, or a physical letter/mail delivery, and/or as any other information transmission or message.

In another preferred embodiment, the central processing computer 10 can store any activity report or activity reports, described herein as being generated by the central processing computer 10 in the individual's, the patient's, or the caregiver's, electronic healthcare record or electronic healthcare file in the database 10H of the central processing computer 10, and/or in the individual's, the patient's, or the caregiver's, electronic healthcare record or electronic healthcare file in the database 60H of the healthcare records computer 60.

In another preferred embodiment, the apparatus 100 of the present invention can be utilized in order to allow individual, patients, or their caregivers, to restrict and/or limit access to their electronic healthcare records or electronic healthcare files. In this manner, the individual, patient, or his or her caregiver, can restrict access of information contained in the individual's, the patient's, or the caregiver's, electronic healthcare record(s) or electronic healthcare file(s) to only certain healthcare providers, healthcare insures or payers, healthcare insurance providers, intermediaries, or any other individuals, users, and/or entities. In this manner, the individual, patient, or caregiver, can restrict access to his or her electronic healthcare record and any data and/or information contained therein or electronic healthcare file and any data and/or information contained therein to his or her healthcare provider(s), to his or her healthcare insure(s) or payer(s), to his or her insurance provider(s), to his or her relatives, family members, spouse, next-of-kin, caregiver(s) and/or any other designated authorized third party, intermediary, individual(s), user(s), or entities or entities.

The individual, patient, or caregiver, can also limit or restrict an individual's, a user's, a provider's, an insurer's or payer's, an intermediary's or third party's, the ability to access, ability to obtain, ability to change, ability to alter, ability or modify, and/or ability to update, any data and/or information contained in his or her electronic healthcare record(s) or electronic healthcare file(s). The individual, the patient, or the caregiver, can also limit or restrict access to, or the ability to access, ability to obtain, ability to change, ability to alter, ability or modify, and/or ability to update, only certain data and/or information, certain portions of data and/or information, or only certain subject matter. For example, an individual, patient, or caregiver, can restrict a medical doctor's access to his or her electronic dental records, electronic dental files, electronic psychological files, etc. An individual, patient, or caregiver, can also restrict a healthcare insurer's or payer's access to unrelated or irrelevant information. An individual, patient, or caregiver, can also restrict a third party individual's access to certain information. An individual can also limit or restrict access to his or her electronic healthcare records to certain times of the day, certain days, weeks, months, or other time periods. Further, limitations or restrictions can be defined differently for each individual, user, provider, insurer or payer, intermediary, or third party.

The individual, patient, or caregiver, can also limit or restrict access to any of his or her electronic healthcare record(s) or electronic healthcare file(s), and/or to any portions or sections of same, by any of the herein-described providers, healthcare providers, insurers or payers, healthcare payers, insurance providers, and/or any third parties, intermediaries, individuals, or entities, to that extant that said limited or restricted access can be is lawful and/or legal and/or for a limited purpose. The individual, patient, or caregiver, can also limit or restrict access to any of his or her electronic healthcare record(s) or electronic healthcare file(s), and/or to any portions or sections of same, by any of the herein-described providers, healthcare providers, insurers or payers, healthcare payers, insurance providers, and/or any third parties, intermediaries, individuals, or entities, to the extent sufficient or necessary in order to maintain confidentiality, to keep certain information secret or accessible to a select few, and/or to address patient privacy concerns.

The individual, patient, or caregiver, can also limit or restrict access to information, by any of the herein-described providers, healthcare providers, insurers or payers, healthcare payers, insurance providers, and/or any third parties, intermediaries, individuals, or entities, to only certain information or sections of information contained in his or her electronic healthcare record(s) or electronic healthcare file(s), and/or to limit or restrict access to certain information or sections of information contained in his or her electronic healthcare record(s) or electronic healthcare file(s), for use for only specifically designated purposes.

For example, an individual, patient, or caregiver, can limit or restrict a provider's access to certain medical history information only to the extent that said information can be utilized to perform a diagnosis for a certain ailment(s), illness, condition, or symptom(s), and/or to allow for the submission of an insurance claim, a claim for payment, and/or for any other reason. An individual, patient, or caregiver, can also, for example, limit or restrict a provider's or an insurer's or payer's access to certain information to the extent of verifying or disproving certain conditions or pre-existing conditions, or to process an insurance claim submission or a claim for payment submission, and/or for any other reason or purpose.

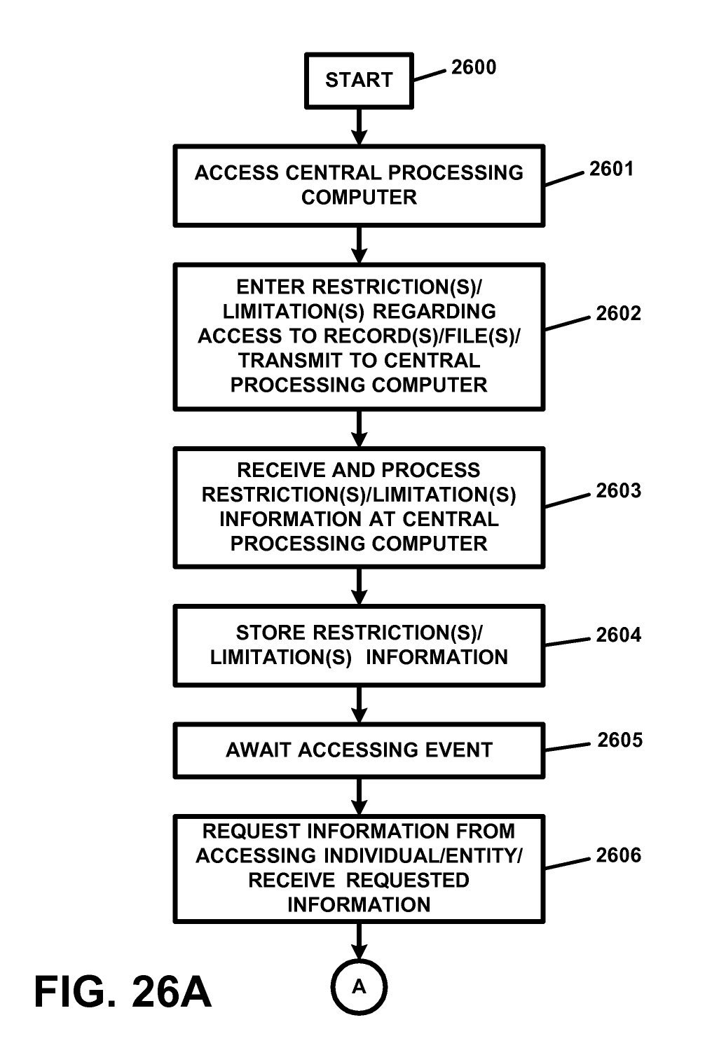

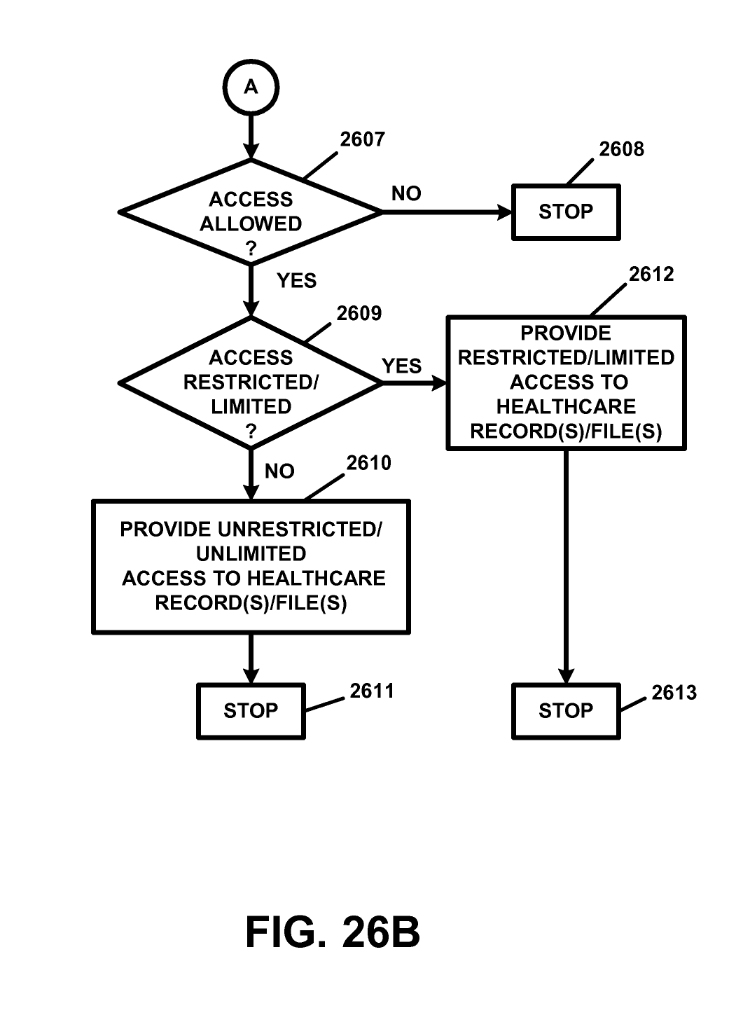

FIGS. 26A and 26B illustrate another preferred embodiment method of utilizing the apparatus 100 of the present invention, in flow diagram form. With reference to FIGS. 26A and 26B, the operation of the apparatus 100 commences at step 2600. At step 2601, the individual, patient, or caregiver, can access the central processing computer 10 via his or her user or patient communication device 40. At step 2602, the patient can enter information regarding the limitations and/or restrictions regarding the access to his or her electronic healthcare record(s) or electronic healthcare file(s), and/or limitations or restrictions regarding the ability to access, the ability to obtain, the ability to change, the ability to alter, the ability or modify, and/or the ability to update, any data and/or information contained in his or her electronic healthcare record(s) or electronic healthcare file(s).

At step 2602, the individual, patient, or caregiver, can enter information regarding any limitations and/or restrictions regarding the access to his or her electronic healthcare record(s) or electronic healthcare file(s) to only a certain providers, healthcare provider(s), a certain type of healthcare provider(s), to a certain healthcare insurer(s) or payer(s), a certain type of healthcare insurer(s) or payer(s), a certain insurance provider(s), a certain type of insurance provider(s), a certain individual(s), third party, third parties, or intermediaries. At step 2602, the individual, patient, or caregiver, can enter information regarding any and/or limitations or restrictions regarding an individual's, user's, provider's, insurer's or payer's, or any third party's or intermediary's ability to access, obtain, change, alter, modify, and/or update, any data and/or information contained in his or her electronic healthcare record(s) or electronic healthcare file(s).

At step 2602, the individual, patient, or caregiver, can also limit and/or restrict access to, and/or the ability to access, obtain, change, alter, modify, and/or update, any data and/or information contained in his or her electronic healthcare record(s) or electronic healthcare file(s), or any information and/or portions of information contained in his or her electronic healthcare record(s) or electronic healthcare file(s), or to limit or restrict access to same for only certain designated purposes, such as, but not limited to, making or checking a diagnosis, designing or checking a treatment plan, performing provider or insurer or payer evaluations, obtaining a second opinion, making an insurance claim or a claim for payment submission, processing an insurance claim or a claim for payment, or in performing any healthcare or healthcare-related data and/or information processing, providing or obtaining healthcare or healthcare-related information, or in using the apparatus 100 of the present invention in any of the herein-described embodiments or for any other reason or purpose.

The individual, patient, or caregiver, can also limit and/or restrict access to his or her electronic healthcare record(s) or electronic healthcare file(s), or any information and/or portions of information contained in his or her electronic healthcare record(s) or electronic healthcare file(s), to certain times, days, dates, or other designated times. The individual, patient, or caregiver, can also limit or restrict access to his or her electronic healthcare record(s) or electronic healthcare file(s), or any information and/or portions of information contained in his or her electronic healthcare record(s) or electronic healthcare file(s), until such time as certain pre-conditions are met.

For example, the pre-condition can be the establishment of a doctor-patient or provider-patient relationship, the establishment of an insured-insurer relationship, the establishment of a family or next-of-kin relationship, the establishment of a caregiver relationship and/or the satisfaction of any condition or pre-condition which can be defined by, or dictated by, any of the herein-described individuals, patients, caregivers, providers, healthcare providers, insurers or payers, healthcare payers, insurance providers, and/or third parties or intermediaries. The individual, patient, or caregiver, can also limit or restrict the ability of a provider, a healthcare provider, an insurer or payer, a healthcare payer, an insurance provider, an individual, patient, caregiver, or an intermediary and/or a third party, to obtain, access, change, alter, modify, or update, any information contained in the individual's, the patient's, of the caregiver's electronic healthcare record or electronic healthcare file(s).

The patient can enter any other restriction or limitations to access to his or her electronic healthcare record(s) or electronic healthcare file(s), and/or to any data and/or information and/or any portions of data and/or information contained therein, at step 2602.

At step 2602, the limitation or restriction information can be transmitted to the central processing computer 10. At step 2603, the central processing computer 10 will receive and/or process the limitation or restriction information in conjunction with the individual's, the patient's, or the caregiver's, electronic healthcare record(s) or electronic healthcare file(s). At step 2604, the central processing computer 10 will store the limitation or restriction information in the database 10H of the central processing computer and in the individual's, the patient's, or the caregiver's, electronic healthcare record(s) or electronic healthcare file(s).

At step 2605, the apparatus 100 will await the accessing of the central processing computer 10 by any individual, user, provider, healthcare provider, insurer or payer, healthcare payer, insurance provider, and/or any third party or intermediary, or entity, who or which desires to access the individual's, the patient's, or the caregiver's, electronic healthcare record(s) or electronic healthcare file(s). Upon the attempted accessing of the individual's, the patient's, or the caregiver's, electronic healthcare record(s) or electronic healthcare file(s), by any of the herein-described individuals, users, providers, healthcare providers, insurers or payers, healthcare payers, insurance providers, and/or any third parties or intermediaries, or entities, the operation of the apparatus 100 will proceed to step 2606. At step 2606, the apparatus 100 and/or the central processing computer 10 can request information from the respective any individual, user, provider, healthcare provider, insurer or payer, healthcare payer, insurance provider, and/or any third party or intermediary, or entity, who or which desires to access the patient's electronic healthcare record(s) or electronic healthcare file(s).

The requested information can include the name or identity of the respective individual, user, provider, healthcare provider, insurer or payer, healthcare payer, insurance provider, and/or any third party or intermediary, or entity, the type, nature, or credentials, of the respective any individual, user, provider, healthcare provider, insurer or payer, healthcare payer, insurance provider, and/or any third party or intermediary, or entity, the nature or purpose of the requested access of the individual's, the patient's, or the caregiver's, electronic healthcare record(s) or electronic healthcare file(s), information regarding the satisfaction and/or the existence of any conditions or pre-conditions to access individual's, the patient's, or the caregiver's, electronic healthcare record(s) or electronic healthcare file(s), and/or to any data and/or information and/or sections of data and/or information contained in the individual's, the patient's, or the caregiver's, electronic healthcare record(s) or electronic healthcare file(s).

At step 2606, the central processing computer 10 can receive the respective individual's, user's, provider's, healthcare provider's, insurer's or payer's, healthcare payer's, insurance provider's, and/or any third party's or intermediary's, or entity's, response(s) to the requested information. In another preferred embodiment, the central processing computer 10 can generate an access request alert message, which can contain any information regarding the identify of the individual, user, provider, healthcare provider, insurer or payer, healthcare payer, insurance provider, and/or any third party or intermediary, or entity, requesting access to the individual's, the patient's, or the caregiver's, electronic healthcare record or electronic healthcare file(s) and the nature or purpose of the requested access. At step 2606, the central processing computer 10 can transmit the access request alert message to the user or patient communication device 40 associated with or used by the individual, the patient, or the caregiver. At step 2606, the central processing computer 10 can also await a response to the access alert message by the individual, the patient, or the caregiver, which response can be received from the individual, the patient, or the caregiver, or can be transmitted from the user or patient communication device 40 being used by the individual, the patient, or the caregiver and received by the central processing computer 10. In a preferred embodiment, the central processing computer 10 can wait for any pre-determined or pre-specified time period, after which the central processing computer 10 can dispense with waiting for a response to the access alert message from the individual, the patient, or the caregiver.

At step 2607, the central processing computer 10 will determine if the individual's, user's, provider's, healthcare provider's, insurer's or payer's, healthcare payer's, insurance provider's, and/or any third party's or intermediary's, or entity's, access to the individual's, the patient's, or the caregiver's, electronic healthcare record(s) or electronic healthcare file(s) is allowed. At step 2607, the central processing computer 10 can make the determination of whether or not the access is allowed by using only the limitation or restriction information stored in the database 10H. In anther preferred embodiment, wherein a response to the access alert message is received from the individual, the patient, or the caregiver, or from the user or patient communication device 40 being used by the individual, the patient, or the caregiver, the central processing computer 10 can use information contained in the response in determining whether or not access is allowed.

If, at step 2607, it is determined that the individual's, user's, provider's, healthcare provider's, insurer's or payer's, healthcare payer's, insurance provider's, and/or any third party's or intermediary's, or entity's, access is not allowed the operation of the apparatus 100 will cease at step 2608. If, at step 2607, it is determined that individual's, user's, provider's, healthcare provider's, insurer's or payer's, healthcare payer's, insurance provider's, and/or any third party's or intermediary's, or entity's, access is allowed, the operation of the apparatus 100 will proceed to step 2609.

At step 2609, the central processing computer 10 will determine whether individual's, user's, provider's, healthcare provider's, insurer's or payer's, healthcare payer's, insurance provider's, and/or any third party's or intermediary's, or entity's, access is limited or restricted in any way or manner. If, at step 2609, it is determined that the individual's, user's, provider's, healthcare provider's, insurer's or payer's, healthcare payer's, insurance provider's, and/or any third party's or intermediary's, or entity's, access is not limited or is not restricted, then the operation of the apparatus 100 will proceed to step 2610. At step 2610 the apparatus 100 and/or the central processing computer 10 will provide the respective individual's, user's, provider's, healthcare provider's, insurer's or payer's, healthcare payer's, insurance provider's, and/or any third party's or intermediary's, or entity's, with unlimited and/or unrestricted access to the patient's electronic healthcare record(s) or electronic healthcare file(s). Thereafter, the operation of the apparatus will cease at step 2611.

If, at step 2609, it is determined that the individual's, user's, provider's, healthcare provider's, insurer's or payer's, healthcare payer's, insurance provider's, and/or any third party's or intermediary's, or entity's, access is limited or restricted, then the operation of the apparatus 100 will proceed to step 2612. At step 2612, the apparatus 100 and/or the central processing computer 10 will provide the respective individual, user, provider, healthcare provider, insurer or payer, healthcare payer, insurance provider, and/or any third party or intermediary, or entity, with the limited and/or restricted access to the individual's, the patient's, or the caregiver's, electronic healthcare record(s) or electronic healthcare file(s). Thereafter, the operation of the apparatus 100 will cease at step 2613.

In another preferred embodiment, data and/or information regarding any and/or all of the limitations or restrictions regarding the individual's, the patient's, or the caregiver's, electronic healthcare record or electronic healthcare file, the time and date of same being placed, the individual, patient, or caregiver, placing same, any and/or all attempted and successful accesses of the individual's, the patient's, or the caregiver's, electronic healthcare record or electronic healthcare file, the time and date of same, any actions performed on or with the individual's, the patient's, or the caregiver's, electronic healthcare record or electronic healthcare file, any and/or all access alert messages generated and transmitted to the user or patient communication device 40 associated with or used by the individual, patient, or caregiver, the time and date of the transmission of same to the user or patient communication device 40 associated with or used by the individual, patient, or caregiver, and/or any information regarding any response(s) and/or any non-response(s) to any and/or all of the access alert messages, can be stored in the individual's, the patient's, or the caregiver's, electronic healthcare record or electronic healthcare file in the database 10H of the central processing computer 10 and/or in the individual's, the patient's, or the caregiver's, electronic healthcare record or electronic healthcare file in the database 60H of the healthcare records computer 60.

In another preferred embodiment, any of the herein-described data and/or information regarding any and/or all of the limitations or restrictions regarding the individual's, the patient's, or the caregiver's, electronic healthcare record or electronic healthcare file, the time and date of same being placed, the individual, patient, or caregiver, placing same, any and/or all attempted and successful accesses of the individual's, the patient's, or the caregiver's, electronic healthcare record or electronic healthcare file, the time and date of same, any actions performed on or with the individual's, the patient's, or the caregiver's, electronic healthcare record or electronic healthcare file, any and/or all access alert messages generated and transmitted to the user or patient communication device 40 associated with or used by the individual, patient, or caregiver, the time and date of the transmission of same to the user or patient communication device 40 associated with or used by the individual, patient, or caregiver, and/or any information regarding any response(s) and/or any non-response(s) to any and/or all of the access alert messages, can also be accessed by, requested by, and/or provided to, the individual, the patient, the caregiver, or any of the individual's, the patient's, or the caregiver's, providers, insurers or payers, or any third parties or intermediaries, or any authorized provider, insurer or payer, third party, or intermediary, by or via the central processing computer 10 or by or via the healthcare records computer 60 and by using his, her, or its respective communication device 20, 30, 40, or 50.

In another preferred embodiment, a provider can utilize the apparatus 100 and method of the present invention to issue prescriptions or scripts for medicines, medications, or drugs, to pharmacies on an individual's or a patient's behalf, or to issue prescriptions or scripts for procedures, tests, analyses, analysis work-ups, blood work, treatments, therapy, therapy sessions, physical therapy, physical therapy sessions, or any other prescribed goods, services, or activities, or to issue referrals to other healthcare providers or providers of any other goods or services. In this regard, the apparatus 100 and method of the present invention can be used by a provider to issue a prescription, or an electronic prescription or e-prescription, or to issue a referral, via the central processing computer 10 and/or via an electronic healthcare record or electronic healthcare file of an individual, a patient or a caregiver.

In another preferred embodiment, a provider can generate a respective prescription or referral via his or her provider communication device 20 using the central processing computer 10 or information contained in an individual's, a patient's, or a caregiver's, electronic healthcare record or electronic healthcare file, and can then transmit the respective prescription or referral to a respective pharmacy, provider, therapist, or other provider of healthcare medications, drugs, goods, products, or services, a provider of wellness goods, products, or services, or a provider or providers of any other goods, products, or services.

A copy of the respective prescription or referral can be stored in the database 10H in the central processing computer 10, in the individual's, the patient's, or the caregiver's, electronic healthcare record or the electronic healthcare file, and/or can be transmitted to and stored in the provider communication device(s) 20 of the provider(s) of the individual, the patient, or the caregiver, the insurer or payer communication device(s) 30 of the insurer(s) or payer(s) of the individual, the patient, or the caregiver, the user or patient communication device 40 of the individual, patient, or caregiver, or to an intermediary's intermediary computer or communication device 50, and/or can also be transmitted to healthcare records computer 60 and stored in the individual's, the patient's, or the caregiver's, electronic healthcare record in the database 60H of same and/or to the insurance exchange computer 70 and stored in the database 70H of same.

In another preferred embodiment, the central processing computer 10, in processing information for generating the respective prescription or referral, can also perform any drug-drug and drug-allergy interaction checks. In a preferred embodiment, the central processing computer can be programmed to automatically perform any drug-drug and drug-allergy interaction checks.

In another preferred embodiment, the healthcare provider or a healthcare facility can place orders for medications, medicines, drugs, supplies, or other goods, products, or services, with a respective supplier or provider of same by placing the order via the central processing computer 10. The central processing computer 10 can then forward the order to a respective provider computer or communication device 20 associated with the respective supplier or provider.

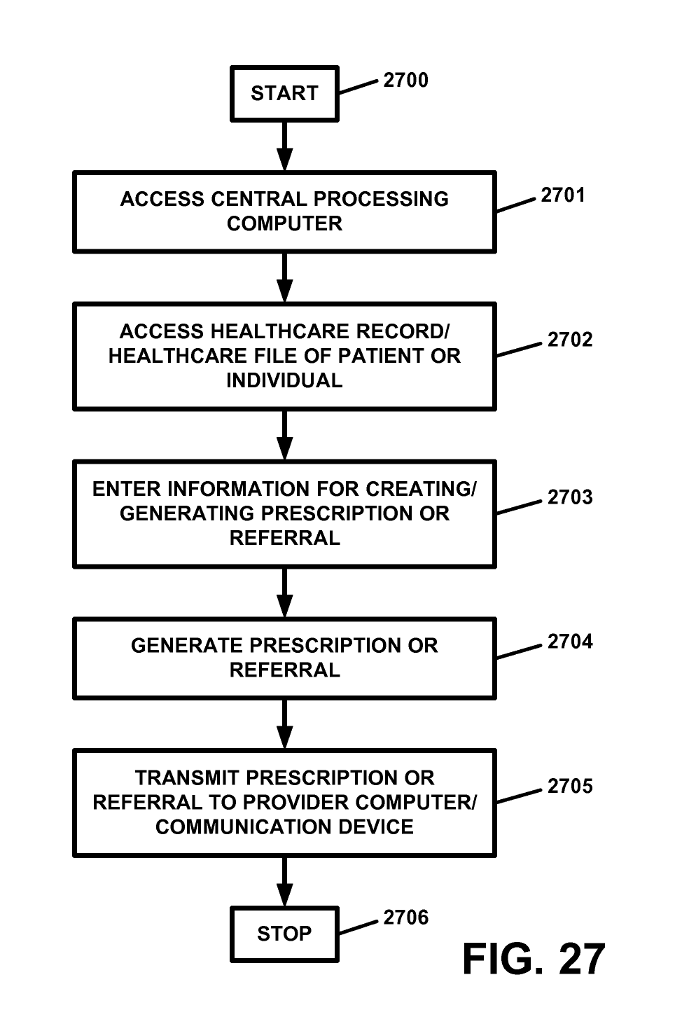

FIG. 27 illustrates another preferred embodiment method for utilizing the apparatus 100 and method of the present invention, in flow diagram form. FIG. 27 illustrates another preferred embodiment method for utilizing the apparatus 100 and method of the present invention in order to allow a provider to issue a respective prescription for a medicine, a medication, or a drug, to a pharmacy or other provider on an individual's or a patient's behalf, or to issue a respective prescription or script for a procedure, a treatment, a therapy, a therapy session, a physical therapy, a physical therapy session, or any other prescribed good, product, service, or activity, for or on behalf of an individual or a patient, or to issue a respective referral to a healthcare provider or a provider of any goods, products, or services, for or on behalf of a individual, a patient, or a caregiver. With reference to FIG. 27, the operation of the apparatus 100 commences at step 2700.

At step 2701, the provider can access the central processing computer 10 via his or her provider communication device 20. At step 2702, the provider can access the electronic healthcare record or the electronic healthcare file of the individual, the patient, or the caregiver. At step 2703, the provider can enter information for creating or generating a prescription or a referral for the individual, the patient, or the caregiver, individual via the provider communication device 20. In the case of creating or generating a prescription, the provider can enter information for generating a prescription script or a prescription form containing information regarding a prescription for a medication, a medicine, a drug, a procedure, a test, an analysis, an analysis work-up, blood work, a treatment, a therapy, a therapy session, physical therapy, a physical therapy session, a course of physical therapy, or any other prescribed good, product, service, or activity, for the patient or the individual. In the case of creating or generating a referral or a referral form, the provider can enter information for generating a referral or a referral form containing information regarding a referral to a healthcare provider or any other provider of a good, product, or service.

At step 2704, the central processing computer 10 can generate the respective prescription or script, or the prescription form, or can generate the respective referral or the referral form, using the information entered by the provider and/or by using any pertinent information stored in the individual's, the patient's, or the caregiver's, electronic healthcare record or electronic healthcare file, which is stored in the database 10H of the central processing computer 10.

In another preferred embodiment, the respective prescription or script, the prescription form, the respective referral, or the referral form, which is generated at step 2704, can contain and/or include a link(s) or a hyperlink(s) to, or a link(s) or a hyperlink(s) to data and/or information stored in, the individual's, the patient's, or the caregiver's, electronic healthcare record or electronic healthcare file.

At step 2705, the central processing computer 10 can transmit the respective prescription or script, or prescription form, or the respective referral or referral form, to a provider communication device 20, which, in the case of a prescription, is associated with or used by the provider who or which is to fulfill the prescription, such as a pharmacy in the case of a prescription for a medicine, a medication, or a drug, or to a provider, lab, laboratory, testing facility, healthcare care facility, or other entity, who or which is to perform the prescribed service or services or who or which is the provide the prescribed goods or products, or, in the case of a referral, the referral can be transmitted to a provider communication device 20 associated with or used by the provider to which the individual or patient is referred for a respective treatment, procedure, service, good, or product. In instances where a respective provider utilizes a facsimile machine or fax machine to receive prescriptions or referrals, the prescription or referral can also be transmitted to the provider's facsimile machine or fax machine.

At step 2705, the respective prescription or script or prescription form, or a copy of the respective referral or referral form, or a copy of same, can be stored in the individual's, the patient's, or the caregiver's, electronic healthcare record or electronic healthcare file in the database 10H of the central processing computer 10, and/or can be transmitted to and/or stored at the prescribing or referring provider's provider communication device 20, can be transmitted to and/or stored at the insure or payer communication device 30 of the insurer or payer of the individual, patient, or caregiver, can be transmitted to and/or stored at the user or patient communication device 40 of the individual, the patient, or the caregiver, or can be transmitted to and/or stored at an intermediary's intermediary communication device 50. At step 2705, the respective prescription or script or prescription form, or a copy of the respective referral or referral form, or a copy of same, can be transmitted to and/or stored in the individual's, the patient's, or the caregiver's, electronic healthcare record or electronic healthcare file in the database 60H of the healthcare records computer 60 and/or the insurance exchange computer 70.

Thereafter, the operation of the apparatus 100 will cease at step 2706.

In another preferred embodiment, the apparatus 100 and method of the present invention can be used to provide for the remote control and/or monitoring of healthcare devices, healthcare equipment, healthcare testing devices or equipment, healthcare information gathering devices or equipment, healthcare monitoring devices or equipment, blood pressure measurement devices, blood pressure monitoring devices, heart rate or pulse rate measurement devices or monitoring devices, blood-sugar measurement devices or monitoring devices, EKG measurement or monitoring devices, an X-Ray, MRI, CAT SCAN, PET Scan, and/or any other devices, machines, or equipment, medicine or drug dispensing devices or equipment, medicine or drug feeding devices or equipment, feeding devices or equipment, or any other device or equipment described herein which can be used to monitor or to care for an individual or patient. In this regard, the apparatus 100 and method of the present invention can be utilized to provide telehealth or telemedicine services or functions.

In another preferred embodiment, the present invention can be used to control or monitor, or to receive and/or store any data or information provided by, any of the healthcare devices or healthcare equipment described herein. In another preferred embodiment, the apparatus 100 of the present invention can be utilized to allow a provider to remotely control, and/or monitor healthcare devices or equipment, instruments, surgical instruments, and/or any other devices which can be used in performing a procedure, a surgery, or a surgical procedure, on an individual or patient, and/or to administer a treatment to the individual or patient, via data, information, link(s), or a hyperlink(s), contained in the individual's or patient's electronic healthcare record. In this regard, in a preferred embodiment, the apparatus 10 can be utilized to allow a provider to control and monitor, as well as manipulate, if needed, any instruments, surgical instrument, procedure instruments, or any other healthcare devices or equipment, via the individual's or patient's electronic healthcare record in order to remotely perform a procedure, a surgery, or a surgical procedure, or any other procedure, and/or to administer a treatment.

The healthcare device(s) or healthcare equipment can, for example, include, but not be limited to, any of the aforementioned healthcare devices, healthcare equipment, blood pressure measurement devices, blood pressure monitoring devices, heart rate or pulse rate measurement devices or monitoring devices, blood-sugar measurement devices or monitoring devices, EKG measurement or monitoring devices, medicine or drug dispensing devices or equipment, medicine or drug feeding devices or equipment, feeding devices or equipment, or any other herein-described device or equipment which can be used to monitor, obtain information regarding, analyze information regarding, care for, or treat, an individual or patient. The healthcare device(s) or healthcare equipment can also be any one or more of, and/or any combination of, a thermometer, a digital thermometer, a stethoscope, a heart rate monitor or measurement device, a pulse rate monitor or measurement device, a blood pressure monitor or measurement device, a blood pressure measurement device, a blood analysis device or machine, a respirator, a respiration monitoring or measurement device, a dialysis machine, a dialysis device, an electrocardiograph (EKG) machine or device, an electrocephalograph (EEG) machine or device, an electromyograph (EMG) machine or device, a magnetic resonance imaging (MRI) machine or device, an X-ray machine or device, a medical imaging machine or device, a thermal imaging machine or device, a heart sound monitor or measurement device, a lung sound monitoring or measurement device, a respiration rate monitoring or measurement device, a laprascopic device, an arthroscopic device, a vascular testing device, a catheter device, a cardiac performance testing, monitoring, or measurement, device, a pulmonary performance testing, monitoring, or measurement, device, a vascular system performance monitoring or measurement device, a vascular system testing, monitoring, or measurement, device, a metabolism monitoring or measurement device, a sonogram imaging device, a sonogram measurement device, a sonograph device, an optical response device, an optical response measurement device, an intravenous device, an arterial blood pressure measurement or monitoring device, a respiration rate measurement or monitoring device, an ultrasound imaging device, an ultrasound measurement device, a CAT SCAN device, a PET scan device, an optical metabolism measurement or monitoring device, a radiotelemetric device, a doppler medical device, a mammogram device, a carbon dioxide detection or measurement device, a carbon monoxide detection or measurement device, a transvascular impedance measurement or monitoring device, an ultrasonic imaging device, a bone conduction device, a brain function scan analyzer device, an external pulse cardiac monitoring or measurement device, a fetal heart rate measurement, monitoring, or probing, device, an endotrachial cardiac monitoring device, a finger tip blood pressure monitoring device, a psychological monitoring device, a surgical instrument, a vital signs measurement device, an ear pressure regulating device, a phonocardiograph device, an acoustic aneurysm detector device, a blood oxygen detection device, an esophageal probing device, an ultrasonic probing device, an ausculoscope, a vital signs monitoring system, a heart activity monitoring device, a pulmonary activity monitoring device, a sphygmomanometer, an esophageal stethoscope, a venous pressure measuring device, a differential doppler device, a physiological data measuring device, a body tissue movement device, a breathalyzer device, a camera probing device, a microscopic camera probing device, and/or any other bio-metric or physiological data measuring device(s) and/or data acquisition device(s).

The healthcare device or healthcare equipment can also be, or can include, a camera, a video camera, a video recording device, a microphone, an audio recording device, a telephone, a video conferencing device, a device for storing pictures, photographs, images, video, audio, and/or related data or information, which device can be located in a room or other location where an individual or patient can be located or situated in order to allow the individual or patient to be observed and/or in order to allow for communication with the individual or patient.

The healthcare device or healthcare equipment can also be, or can include, any instruments, surgical instrument, procedure instruments, or any other healthcare devices or equipment, via the individual's or patient's electronic healthcare record in order to remotely perform a procedure, a surgery, or a surgical procedure, or any other procedure, and/or to remotely administer a treatment.

In a preferred embodiment, audio and/or video of any procedure, surgery, or surgical procedure, or any treatment, can be recorded and/or stored with or by any of the herein-described microphones, audio recording devices, cameras, and/or video recording devices, and any data and/or information obtained with, by, or from, any healthcare device(s) or healthcare equipment reading(s) utilized in or during the respective procedures, surgery, or surgical procedure, and/or administration of a treatment, and can be stored in the individual's electronic healthcare record or electronic healthcare file.

In this regard, procedures, surgeries, or surgical procedures, and/or administrations of treatments, can be performed using the apparatus 100 and any data and/or information regarding same, including audio information, video information, and/or a video and audio recording or the respective procedure, surgery, or surgical procedure, and/or the administration of a treatment, and/or any data and/or information obtained with, by, or from, any healthcare device(s) or healthcare equipment reading(s) utilized in or during the respective procedure, surgery, or surgical procedure, and/or administration of a treatment, can be stored in the individual's or patient's electronic healthcare record or electronic healthcare file.

In another preferred embodiment, the respective healthcare device or healthcare equipment being used can be implantable in the individual, patient, or caregiver, or can be worn, or can be wearable, by the individual, patient, or caregiver, in any appropriate manner. In another preferred embodiment, the respective healthcare device or healthcare equipment being used can also be provided or situation in an article of clothing. In another preferred embodiment, the respective healthcare device or healthcare equipment being used can be any mobile or wireless device or can include a mobile or wireless communication device. In another preferred embodiment, the respective healthcare device or healthcare equipment being used can be worn or integrated with any type or kind of clothing or accessory. The respective healthcare device or healthcare equipment being used can also be worn or integrated with any type or kind of item of jewelry, a watch, a bracelet, a necklace, or any other wearable item.

In another preferred embodiment, the respective healthcare device or healthcare equipment, which can be any one or any combination of any of the herein-described devices or equipment, or any implantable or wearable device, can also be, or can also include, all of the components of a user or patient communication device 40 associated with or used by a individual, patient, or caregiver, or can be, or can be utilized as, an input device 40D of the user or patient communication device 40.

In a preferred embodiment, in an situation where a healthcare device or healthcare equipment, or a plurality of healthcare devices(s) or a plurality of pieces of healthcare equipment, is or are to be utilized in connection with the apparatus 100 of the present invention, in order allow a healthcare provider, provider, insurer or payer, or any intermediary or third party, or another individual or user, to remotely monitor an individual or patient, or to remotely control or monitor a healthcare device or healthcare equipment for an individual or patient, information, a link, or a hyperlink, corresponding to, or associated with, each healthcare device or each piece of healthcare equipment, assigned to or used for an individual or a patient, can be stored in the database 10H of the central processing computer 10, in the electronic healthcare record or electronic healthcare file of the individual, the patient, or the caregiver, in the electronic healthcare record or electronic healthcare file of the individual, the patient, or the caregiver, which is stored in the database 10H of the central processing computer 10, or in the electronic healthcare record or electronic healthcare file of the individual, the patient, or the caregiver, which is stored in the database 60H of the healthcare records computer 60.

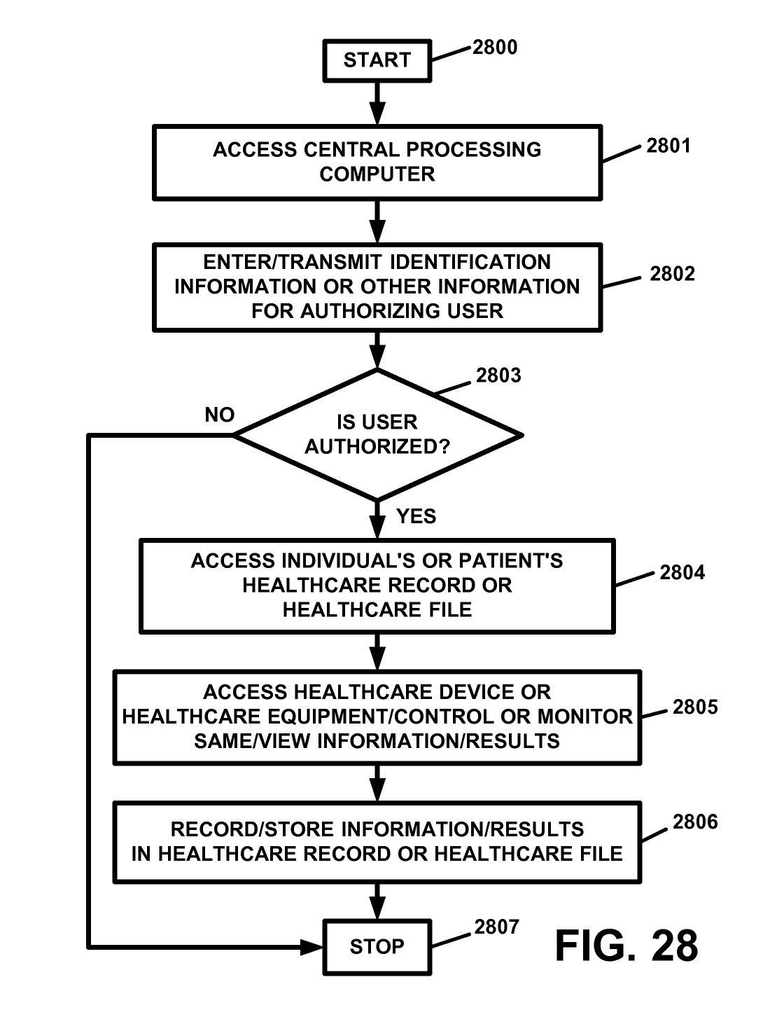

FIG. 28 illustrates another preferred embodiment method for utilizing the apparatus 100 and method of the present invention, in flow diagram form. FIG. 28 illustrates another preferred embodiment method for utilizing the apparatus 100 and method of the present invention in order to allow, or to facilitate, a remote monitoring and/or treatment, of an individual or patient by a healthcare provider, a provider, an insurer, a payer, or any intermediary or third party, or another individual or user, and/or to allow or facilitate a remote control and/or monitoring of a healthcare device or piece of healthcare equipment, used to monitor, to diagnose, to evaluate, to treat, or to care for, the individual or the patient, by a healthcare provider, a provider, an insurer, a payer, or any intermediary or third party, or any other individual or user.

The apparatus 100 and method of the present invention can also be utilized in order to allow, or to facilitate, a remote monitoring and/or treatment, of an individual or patient by a caregiver and/or to allows or facilitate a remote control and/or monitoring of a healthcare device or piece of healthcare equipment, used to monitor, to diagnose, to evaluate, to treat, or to care for, the individual or the patient, by a caregiver.

With reference to FIG. 28, the operation of the apparatus 100 commences at step 2800. At step 2801, the respective healthcare provider, provider, insurer, payer, or any intermediary or third party, or any other individual or user, or the caregiver, can utilize a respective provider communication device 20, an insurer or payer communication device 30, a user or patient communication device 40, an intermediary communication device 50, or any other computer or communication device, in order to access the central processing computer 10. At step 2802, the respective healthcare provider, provider, insurer, payer, or any intermediary or third party, or any other individual or individual, or the caregiver, can enter and transmit to the central processing computer 10, and the central processing computer 10 can receive, store, or process, any appropriate identification information, authorization information, an access code, a password, or any other data or information, which can be used to ensure that the respective healthcare provider, provider, insurer, payer, or any intermediary or third party, or any other individual or user, or the caregiver, is authorized to access the central processing computer 10, is authorized to perform a remote control or monitoring operation regarding the individual or patient, or is authorized to access the electronic healthcare record or the electronic healthcare file of the individual or patient.

At step 2803, the central processing computer 10 will determine whether or not the respective healthcare provider, provider, insurer, payer, or any intermediary or third party, or any other individual or user, or the caregiver, is authorized to access the central processing computer 10, is authorized to perform a remote control or monitoring operation regarding the individual or patient, or is authorized to access the electronic healthcare record or the electronic healthcare file of the individual or patient. If, at step 2803, the central processing computer 10 determines that the respective healthcare provider, provider, insurer, payer, or any intermediary or third party, or any other individual or user, or the caregiver, is not authorized to access the central processing computer 10, is not authorized to perform a remote control or monitoring operation regarding the individual or patient, or is not authorized to access the electronic healthcare record or the electronic healthcare file of the individual or patient, the operation of the apparatus 100 will cease at step 2807. If, at step 2803, the central processing computer 10 determines that the respective healthcare provider, provider, insurer, payer, or any intermediary or third party, or any other individual or user, or the caregiver, is authorized to access the central processing computer 10, is authorized to perform a remote control or monitoring operation regarding the individual or patient, or is authorized to access the electronic healthcare record or the electronic healthcare file of the individual or patient, the operation of the apparatus 100 will proceed to step 2804.

At step 2804, the respective healthcare provider, provider, insurer, payer, or any intermediary or third party, or any other individual or user, or the caregiver, can then access the individual's or the patient's electronic healthcare record or electronic healthcare file, and select the respective healthcare device or healthcare devices, or the healthcare equipment or pieces of healthcare equipment which he or she desires to access, control, or monitor. The respective healthcare provider, provider, insurer, payer, or any intermediary or third party, or any other individual or user, or the caregiver, can then access the healthcare device or healthcare devices or the healthcare equipment or pieces of healthcare equipment by using data or information obtained from the individual's or the patient's electronic healthcare record or electronic healthcare file. The respective healthcare provider, provider, insurer, payer, or any intermediary or third party, or any other individual or user, or the caregiver, can also access the healthcare device or healthcare devices or the healthcare equipment or pieces of healthcare equipment via an appropriate link or hyperlink to each respective healthcare device or healthcare equipment, which link or hyperlink can be stored in, accessed via, or otherwise obtained from, the individual's or the patient's electronic healthcare record or electronic healthcare file.

At step 2805, the respective healthcare provider, provider, insurer, payer, or any intermediary or third party, or other individual or user, or the caregiver, can then access the healthcare device or healthcare equipment. As and for an illustrative example, and for the sake or simplicity, in a situation where an individual or patient is under a healthcare provider's care for high blood pressure, the healthcare provider, seeking to monitor an individual's or a patient's blood pressure, can access the individual's or patient's blood pressure measurement device, which is the healthcare device in this example, and obtain, and record, a blood pressure measurement or reading for the individual or patient. In a preferred embodiment, where this blood pressure reading can be performed live such as by appointment, the healthcare provider can take the individual's or patient's blood pressure live or in real-time. A same, a similar, or an analogous, method can also be employed using any of the other herein-described healthcare devices or healthcare equipment. In another preferred embodiment, the individual or patient can take his or her own blood pressure measurement or reading, or can take it with the help or assistance of another individual, and the measurement or reading can be stored in the blood pressure measurement device. Likewise, a same, a similar, or an analogous, method can also be employed using any of the other herein-described healthcare devices or healthcare equipment.

At step 2805, the respective healthcare provider, provider, insurer, payer, or any intermediary or third party, or other individual or user, or the caregiver, can also control an operation of the respective healthcare device or healthcare equipment, can monitor an operation of the respective healthcare device or healthcare equipment, or can view or observe data, information, video, audio, or other information provided by the healthcare device or healthcare equipment, or by any camera, microphone, or videoconferencing device or equipment. At step 2805, the respective healthcare provider, provider, insurer, payer, or any intermediary or third party, or other individual or user, or the caregiver, can also view results obtained or recorded by the healthcare device or healthcare equipment, retrieve previously stored or recorded information or results obtained via or with the healthcare device or healthcare equipment, or can perform any desired operation, function, or task, with or using the healthcare device or healthcare equipment.

At step 2805, the healthcare provider can also activate a video camera, a microphone or audio recording device, video conferencing equipment, a telephone, or an intercom, so as to communicate with the individual or patient or any other person.

Upon obtaining the information or results from the healthcare device, the respective healthcare provider, provider, insurer, payer, or any intermediary or third party, or other individual or user, or the caregiver, can then, at step 2806, view and store or record the obtained information or results in the individual's or patient's electronic healthcare record or electronic healthcare file. In instances when multiple healthcare devices or multiple pieces of healthcare equipment are to be accessed, steps 2805 and 2806 can be repeated as described above for each healthcare device or for each piece of healthcare equipment. In another preferred embodiment, data and/or information regarding any actions taken or performed by the respective healthcare provider, provider, insurer, payer, or any intermediary or third party, or other individual or user, or the caregiver, the time, date, and/or duration of same, any healthcare or other devices or equipment involved or utilized, any data and/or information obtained from same, and any observations, notes, comments or messages, made by the respective healthcare provider, provider, insurer, payer, or any intermediary or third party, or other individual or user, or the caregiver, and/or any other data or information, can be stored in the individual's or patient's electronic healthcare record or electronic healthcare file in the database 10H of the central processing computer 10. Any of the above-described data and/or information can also be stored in the individual's or patient's electronic healthcare record or electronic healthcare file in the database 60H of the healthcare records computer 60. Upon the completion of the operation at step 2806, the operation of the apparatus 100 will cease at step 2807.

In another preferred embodiment, the respective healthcare provider, provider, insurer, payer, or any intermediary or third party, or other individual or user, or the caregiver, can, at step 2805 can perform a respective monitoring or data or information gathering activity, perform an examination, engage in making a diagnosis, effectuate a treatment, perform a procedure, observer and/or interact with the individual or the patient, or engage in any other activity. Any data and/or information regarding, or obtained, along with any notes, comments, or messages, made, can be stored in the individual's or patient's electronic healthcare record or electronic healthcare file.

In another preferred embodiment, any use of the apparatus 100 of FIG. 28 by a provider or healthcare provider can also be an activity for which an insurance claim or a claim for payment can be made. In such an embodiment, the central processing computer 10 can, at step 2806, also automatically generate and an insurance claim or an insurance claim form, or a claim for payment, in any manner described herein, and can automatically transmit or submit same to a insurer or payer communication device 30 associated with or used by an insurer or payer of the individual, patient, or caregiver.

In another preferred embodiment of the present invention, the apparatus 100 can be used by any of the herein-described healthcare providers, providers, insurers, payers, intermediary, intermediaries, third party, third parties, or any other individual, user, or person, or by a caregiver, in order to remotely access, control, monitor, obtain information from, or otherwise use, any of the herein-described, or any other electrically or electronically controlled or operated, healthcare device or piece of healthcare equipment.

In another preferred embodiment, an individual or patient, a caregiver, or a person assisting the individual or patient, can also use a healthcare device or healthcare equipment in order to obtain information or results regarding the individual or patient and can store or record the obtained information or results in the healthcare device or healthcare equipment or in a personal computer or any other computer. In this embodiment, the respective provider or healthcare provider can thereafter access the respective healthcare device, healthcare equipment, personal computer, or other computer, remotely, in person, or otherwise, and can retrieve, obtain, or upload, the information or results. The healthcare provider can then review and store or record the obtained information or results in the individual's or patient's electronic healthcare record or electronic healthcare file.

In another preferred embodiment, the embodiment of FIG. 28 can be utilized by a provider or healthcare provider in order to perform a procedure, a surgery, or a surgical procedure, on an individual or patient, or to administer a treatment to an individual or patient, remotely, and/or via data, information, link(s), or a hyperlink(s), contained in the individual's or patient's electronic healthcare record or electronic healthcare file by allowing the provider or healthcare provider to access, control, manipulate, and/or monitor, healthcare devices or equipment, instruments, surgical instruments, and/or any other devices or equipment which can be used in performing any procedure, surgery, or surgical procedure, on an individual or patient, and/or in administering a treatment to an individual or patient. In this regard, in a preferred embodiment, the apparatus 10 can be utilized in order to allow a provider or healthcare provider to perform procedures, surgeries, or surgical procedures, or administer treatments remotely and via data, information, link(s), or a hyperlink(s), contained in the individual's or patient's electronic healthcare record or electronic healthcare file. Any data and/or information regarding these procedures, surgeries, or surgical procedures, or administer treatments can be recorded with or by any of the herein-described microphones, audio recording devices, cameras, and/or video recording devices, and any data and/or information obtained with, by, or from, any healthcare device(s) or healthcare equipment reading(s) utilized in or during the respective procedures, surgery, or surgical procedure, and/or administration of a treatment and can be stored in the individual's electronic healthcare record or electronic healthcare file.

In this regard, procedures, surgeries, or surgical procedures, and/or administrations of treatments, can be performed using the apparatus 100 and any data and/or information regarding same, including audio information, video information, and/or any data and/or information obtained with, by, or from, any healthcare device(s) or healthcare equipment reading(s) utilized in or during the respective procedure, surgery, or surgical procedure, and/or administration of a treatment, can be stored in the individual's or patient's electronic healthcare record or electronic healthcare file.

In another preferred embodiment, a provider or an insurer or payer can access, control, monitor, perform a diagnostic check on or regarding, repair, reset, calibrate, perform maintenance on, or re-program, any of the herein-described artificial limbs, artificial organs, implanted or implantable devices, and/or prosthetic devices via a link(s) or hyperlink(s) to same which can be stored in an individual's, patient's. or caregiver's, electronic healthcare record or electronic healthcare file. Data and/or information regarding any such accessing, controlling, monitoring, performing of a diagnostic check on or regarding, repairing, or re-programming, of any of the herein-described artificial limbs, artificial organs, implanted or implantable devices, and/or prosthetic devices, by a provider, including, but not limited to, the date and/or time of same and/or any and/or all actions taken or services performed by the provider, can also be stored in the individual's, patient's, or caregiver's, electronic healthcare record or electronic healthcare file, and the central processing computer 10 can thereafter, in a manner described herein or otherwise, generate and/or transmit a respective insurance claim or request for payment to the respective insurer or payer of the individual, patient, or caregiver so as to ensure the provider is compensate for his or her services.

In any and/or all of the embodiments described herein, any data and/or information described herein as being stored in the individual's or patient's electronic healthcare record or electronic healthcare file can be stored in the individual's or patient's electronic healthcare record or electronic healthcare file in the database 10H of the central processing computer 10 and/or in the database 60H of the healthcare records computer 60.

In another preferred embodiment, an individual or patient, a caregiver, or a person assisting the individual or patient, can use a healthcare device or healthcare equipment in order to obtain information or results regarding the individual or patient and store or record the obtained information or results in the healthcare device or healthcare equipment or in a user or patient computer or communication device 40. Thereafter, the individual or patient, the caregiver, or the person assisting the individual or patient, can access the central processing computer 10 using the user or patient communication device 40, access the individual's or patient's electronic healthcare record or electronic healthcare file, and transmit the information or results to the central processing computer 10, and the information or results can then be stored in the individual's or patient's electronic healthcare record or electronic healthcare file in the database 10H of the central processing computer 10. Thereafter, a respective healthcare provider, provider, insurer, payer, or any intermediary or third party, or any other individual or user, can access the central processing computer 10, access the individual's or patient's electronic healthcare record or electronic healthcare file, and obtain or review the information or results.

In another preferred embodiment, the embodiment of FIG. 28 can be used by a respective healthcare provider, provider, insurer, payer, or any intermediary or third party, or any other individual or user, or a caregiver, in order to monitor an individual or patient at home, at work, in a hospital, at a healthcare facility, during an operation or a procedure, during a test, during an office visit with another provider, during an MRI, a Cat Scan, a PET scan, or any other procedure, during an exercise session, while asleep, while on vacation, while in surgery, during a stress test, or at any other time or place.

In another preferred embodiment, the embodiment of FIG. 28 can be used by a respective healthcare provider, provider, insurer, payer, or any intermediary or third party, or any other individual user, or a caregiver, in order to monitor an individual or patient while they are located at any type or kind of premises, including, but not limited to, a residential premises, a commercial premises, or a healthcare facility or premises, or while they are located in, or traveling in, any type of land, sea, air, or space vehicle. The embodiment of FIG. 28 can also be used by a respective healthcare provider, provider, insurer, payer, or any intermediary or third party, or any other individual or user, or a caregiver, in order to monitor an individual or patient while they are located at, or while they are located in, or traveling in, a motor vehicle, an automobile, a mass transportation vehicle, a truck, a tractor trailer, a bus, a school bus, a commercial vehicle, commercial equipment, industrial equipment, a military vehicle, a snowmobile, a jetski, a scooter, a recreational vehicle, a motorcycle, a minibike, a go-cart, a moped, an unmanned vehicle, a train, a subway train, an aircraft, an airplane, a jet, a helicopter, a glider, a spacecraft, a space shuttle, a satellite, an unmanned aircraft, a commercial aircraft, a military aircraft, a boat, a marine vessel, a marine vehicle, a motor boat, a sailboat, a ship, a cruise ship, a commercial boat, a military boat, an unmanned boat, or a submarine.

In the above-described embodiment, any necessary or appropriate information, or a link(s) or hyperlink(s), for facilitating access to the respective premises, vehicle, healthcare device, or healthcare equipment, or for facilitating an accessing, a controlling, or a monitoring, of any healthcare device, healthcare equipment, video device, audio device, videoconferencing device, or communication device, can be provided or stored, or otherwise made available, in the individual's or patient's electronic healthcare record or electronic healthcare file in the database 10H of the central processing computer 10, or in the central processing computer 10 or in the database 10H of same, or in the individual's or patient's electronic healthcare record or electronic healthcare file stored in the database 60H of the healthcare records computer 60.

In another preferred embodiment, the embodiment of FIG. 28 can be used by a respective healthcare provider, provider, insurer, payer, or any intermediary or third party, or any other individual or user, or a caregiver, to be virtually or remotely present while an individual or patient is being examined, cared for, or treated, by another provider. For example, if an individual or patient is injured while traveling abroad and is treated at a hospital, the individual's or patient's primary care physician can be contacted and, when provided with appropriate information, a link, or a hyperlink, can remotely access and monitor the examination session or a procedure, and/or can communicate with and/or confer with the treating provider, the individual or patient or a caregiver, and/or any other individual or person. In a preferred embodiment, the primary care physician can be contacted via an e-mail message or other message. Any necessary or appropriate information, or a link(s) or hyperlink(s), for facilitating access to the respective premises, vehicle, healthcare device, or healthcare equipment, or for facilitating an accessing, a controlling, or a monitoring, of any healthcare device, healthcare equipment, video device, audio device, videoconferencing device, or communication device, can be provided or stored, or otherwise made available, in the individual's or patient's electronic healthcare record or electronic healthcare file in the database 10H of the central processing computer 10, or in the central processing computer 10 or in the database 10H of same, or in the individual's or patient's electronic healthcare record or electronic healthcare file stored in the database 60H of the healthcare records computer 60.

In another preferred embodiment of the embodiment of FIG. 28, a respective healthcare provider, provider, insurer, payer, or any intermediary or third party, or any other individual or user, or a caregiver, can control a dispensing of a medication, a medicine, or a drug, can dispense a medication, a medicine, or a drug, to the individual or patient so as to administer same to the individual or patient, can issue an emergency call for help or a 911 call, can issue a prescription for a medication, a medicine, or a drug, or can issue a referral for a good or a service.

In another preferred embodiment, any and/or all information, links, or hyperlinks, needed to perform any of the functionality, functions, or operations, described herein with reference to the embodiment of FIG. 28, can be stored in, and/or can be obtained from, the electronic healthcare record or electronic healthcare file of the individual or patient in the database 10H of the central processing computer 10, in the database 10H of the central processing computer 10, or in the database 60H of the healthcare records computer 60, thereby providing a electronic healthcare record or electronic healthcare file having a remote monitoring, remote care, remote care management, remote control, or telehealth or telemedicine, capability.

In any and/or all of the herein-described embodiments, an individual, a patient, a caregiver, a provider of an individual, patient, or caregiver, an insurer or payer of an individual, patient, or caregiver, or any authorized third party or intermediary, can, if so authorized, access the individual's or the patient's electronic healthcare record or electronic healthcare file and obtain any of the data, information, measurements, readings, vital signs, photographs, pictures, video clips, transcripts, audio clips, X-rays, MRI image, CAT scan, or PET scan, or other scan films or scan results, test results, lab test results, any measurements or readings obtained with or from any healthcare device or healthcare equipment, healthcare histories, prescriptions, referrals, records, files, insurance claims, payment histories, or any other data or information described herein as being provided, processed, or stored, by, from, or in, the apparatus 100 and/or method of the present invention, the central processing computer 10 or the database 10H of same, or any electronic healthcare record, electronic healthcare file, or healthcare history. The individual, patient, or caregiver, a provider of an individual, patient, or caregiver, an insure or payer of an individual, patient, or caregiver, or any authorized third party or intermediary, can access the central processing computer 10 via a respective computer or communication device, which can be any one of the herein-described computers or communication devices 20, 30, 40, or 50, or any other computer or communication device, can access the individual's or patient's electronic healthcare record or electronic healthcare file, and can request or select, and can be provided with the desired data, information, photograph(s), picture(s), video clip(s), transcript(s), audio clip(s), X-rays, MRI image, CAT scan, or PET scan, or other scan films or scan results, test results, lab test results, any measurements or readings obtained with or from any healthcare device or healthcare equipment, healthcare history or histories, prescription(s), referral(s), record(s), file(s), insurance claim(s), payment history or histories, or any other data or information described herein as being provided, processed, or stored, by, from, or in, the apparatus 100 and/or method of the present invention, the central processing computer 10 or the database 10H of same, or any electronic healthcare record, electronic healthcare file, or healthcare history.

In any and/or all the herein-described embodiments, the apparatus 100 or the central processing computer 10, can also provide information regarding ICD, ICD-10, ICD-9, or other codes, diagnostic codes, symptom codes, treatment codes, billings codes, or any other codes or information useful in entering individual, patient, or caregiver, information into a electronic healthcare record or a electronic healthcare file of the individual, patient, or caregiver. In this manner, the present invention can provide any individual, patient, caregiver, user, provider, insurer or payer, third party or intermediary, or any other individual, person, or entity, using the apparatus 100 of the present invention, with accurate and current data or information, so as to ensure that any information described herein as being stored in the electronic healthcare records or electronic healthcare files of individuals, patients, or caregiver, any records or files of providers, insurers or payers, third parties, or intermediaries, or any insurance claims, prescriptions, referrals, or other information, described herein as being processed, generated, or stored, by the apparatus 100 of the present invention, is accurate, correct, and up-to-date with current standards in the healthcare field and/or in related fields.

In any and/or all of the herein-described embodiments, any appropriate rules algorithms can be utilized by the apparatus 100, by the central processing computer 10, and/or by any of the computers or communication devices 20, 30, 40, or 50, so that all processing routines, data or information storing routines, insurance claim generation routines, or prescription or referral generation routines, are performed, created, or generated, correctly and accurately, and/or pursuant to current standards in the electronic healthcare filed or related fields.

In any and/or all of the embodiments described herein, any individual, patient, caregiver, provider, insurer or payer, user, third party, or intermediary, can access any one or more of the central processing computer(s) 10, the providers communication devices (20), the payer communication devices 30, the patient communication devices 40, and/or the intermediate communication devices 50, the healthcare records computer 60, the insurance exchange computer 70, the social networking computer 80, or the media computer 90, via any one or more of the said computers and/or communication devices 10, 20, 30, 40, and/or 50, as well as via any computer and/or communication device. In this manner, any of the herein-described individuals, patients, caregivers, providers, insurers or payers, users, third parties, or intermediaries, or any other persons, parties, or entities can access the present invention from any computer and/or communication device. Public kiosks with links to any of the computers and/or communication devices 10, 20, 30, 40, and/or 50, can also be utilized to access and utilize the present invention and/or any of the computers and/or communication devices described herein.

In any and/or all of the embodiments described herein, access to any and/or all of the data, information, records. files, etc., which is stored in any of the databases 10H, 20H, 30H, 40H, 50H, 60H, 70H, 80H, and/or 90H can be restricted to preserve the security and confidentiality of same. Any of the individuals, patients, caregivers, users, providers, insurers or payers, third parties, or intermediaries, can also be provided with an identification card(s) and/or other cards which can have any and/or all pertinent data and/or information regarding the respective individual, patient, caregiver, user, provider, insurer or payer, third party, or intermediary, stored therein or thereon or provided on the card(s).

The identification card, in the preferred embodiment can contain a magnetic strip for storing any and/or all pertinent data and/or information, a “smart card” for storing data and/or information, and/or a bar code or bard codes for storing identification data and/or information as well as any other data and/or information described herein as being pertinent to the respective patient, user, provider, payer, and/or intermediary.

Each of the central processing computer(s) 10, the providers communication devices 20, the insurer or payer communication devices 30, the user or patient communication devices 40, and/or the intermediate communication devices 50, as well as any other computer and/or communication device, can include suitable devices for reading, scanning, and/or obtaining data and/or information which may be stored on the identification card. In this manner, access to the present invention, and the respective use thereof, can be facilitated by the above-described identification card(s).

In another preferred embodiment, an identification card or device can also be utilized to store any and/or all pertinent data and/or information regarding an individual, patient, or caregiver, such as, but not limited to, identification information, contact information, any of the healthcare information or medical, dental, surgical, or other history, files, records, or any other information described herein as being stored in the electronic healthcare record of the individual, patient, or caregiver, or stored in the database 10H regarding the individual, patient, or caregiver, or stored or provided in or by data and/or information regarding the individual's, patient's, or caregiver's, providers, insurers or payers, insurance company or companies or healthcare insurance information, information regarding an emergency contact or contacts or next of kin contact information, and/or any other information regarding the individual, patient, or caregiver, which is described herein as being utilized or provided via the apparatus 100 of the present invention. In a preferred embodiment, the identification card or device can be, or can include, a “smart” card or device or a microprocessor or other computer chip and a memory device for storing any of the herein-described information regarding the individual, patient, or caregiver.

In another preferred embodiment, the identification card or device can also include any of the devices described herein as being included in the user or patient communication device 40, such as, for example, an input device, a receiver for receiving data or information via a communication network, and/or a transmitter for transmitting data or information via a communication network of for providing voice communication via a communication network, and/or a display device for displaying data or information. In another preferred embodiment, the identification card or device can include any of the components described herein which can be included in the user or patient communication device 40 of FIG. 5. In this regard, the identification card or device can contain any of the devices or components 40A, 40B, 40C, 40D, 40E, 40F, 40G, 40H, and/or 40I of the user or patient communication device illustrated in FIG. 5.

In another preferred embodiment, the identification card or device can also be utilized by the individual patient, caregiver, or by another person, in order to make a 911 or other emergency call in case the individual or patient needs to call for emergency help or emergency medical help or assistance. In another preferred embodiment, the identification card or device can take the form of, or be included in, a user or patient communication device 40. In another preferred embodiment, data or information in the individual's, patient's, or caregiver's, electronic healthcare record, healthcare history, record, or file, described herein as being stored in the database 10H, can also be accessed by the identification card or device and can be downloaded to the identification card or device. In another preferred embodiment, the identification card or device and all of its component parts can be implemented in or as a cellular telephone, a mobile telephone, a wireless telephone, a personal digital assistant, a tablet, a tablet computer, a beeper, a pager, an electronic wallet, a conventional wallet, a purse, or a tote or a pocket book, an electronic personal valet, a watch, a bracelet, an article of jewelry, a locket, a wearable article, or a wearable article of clothing. In this manner, the identification card or device can be carried by the individual, patient, or caregiver, at any time or at all times and can contain any of the herein-described healthcare or healthcare-related information of or pertaining to the individual, patient, or caregiver, which is described herein as being stored in the individual's, the patient's, or the caregiver's, electronic healthcare record or in the database 10H.

In another preferred embodiment, the identification card or device, or the information contained therein or thereon, can be stored in, or can take the form of, a device which can be implantable within the human body. In another preferred embodiment, the identification card or device, or the information contained therein or thereon, can be stored in, or can take the form of, a device which can worn by, or which can be wearable by, an individual, patient, or caregiver. In this regard, any authorized provider or authorized person may obtain access to the individual's, the patient's, or the caregiver's, electronic healthcare record, healthcare information or healthcare-related information in or during an emergency or in or during a treatment setting. For example, if the individual, patient, or caregiver, is traveling abroad or at a distance from home, emergency or medical or healthcare personnel, called upon to treat or otherwise attend to the individual or patient in an emergency or other treatment setting, can gain access to the individual's, the patient's, or the caregiver's electronic healthcare record or other medical or healthcare information or other healthcare-related information in order to provide appropriate treatment and/or care for the individual or patient.

In another preferred embodiment, the database 10H, as well as any of the other herein-described databases 20H, 30H, 40H, 50H, 60H, 70H, 80H, and/or 90H, can also contain language translation information or software so that any of the data or information described herein as being stored in the respective database(s), or as being provided by the apparatus 100 of the present invention, can be translated into any language necessary. In this regard, if the individual, patient, or caregiver, may need to seek healthcare in a foreign country, information in the individual's, patient's, or caregiver's, electronic healthcare record, healthcare history, record, or file, can be accessed and translated into the language of the provider or other person who is attending to the individual or patient, or who is seeking or attempting to provide care, or to administer care, to or for the individual or patient, or who may otherwise be attempting to assist the individual or patient in any other manner deemed necessary or appropriate. In this regard, any information described herein as being stored in the database 10H, as well as any of the other herein-described databases 20H, 30H, 40H, 50H, 60H, 70H, 80H, and/or 90H, any diagnostic reports, treatment reports, evaluation reports, or any other messages or reports described herein as being generated or provided by the apparatus 100 of the present invention, or any other data, information, materials, reports, results, news reports, news information, news reports, published reports, theses, study reports, or any other data or information regarding described herein, which can be generated by or provided by or via the apparatus 100, can be translated upon request into any requested, selected, or desired, language.

In a preferred embodiment, the requesting person or entity can access the central processing computer 10 via any suitable communication device or computer, request the information and the language into which the requested information is to be translated. Thereafter, the central processing computer 10 will receive and/or process the request, retrieve the requested information from the respective electronic healthcare record or from the database 10H, translate same into the requested language, and generate a message containing the requested information in the translated language. Thereafter, the central processing computer 10 will transmit the message to the communication device or computer of the requesting person or entity.

Any data or information, or any function, described-herein as capable of being provided by or performed by the apparatus 100 of the present invention, can, if needed, be translated or converted, by the apparatus 100 of the present invention, or by the central processing computer 10 or by any of the computers or communication devices 20, 30, 40, 50, 60, 70, 80, or 90, or by any other device, used in connection with the present invention, into a foreign language or a foreign language counterpart or can be translated or converted into a corresponding foreign language code or information. In an preferred embodiment, any translation or conversion can be performed automatically in response to a respective individual, patient, caregiver, healthcare provider, provide, insurer or payer, intermediary, or third party, registering or requesting a language preference or translation or conversion request or order with the apparatus 100 at any time, or in response to a request or a selection to provide, display, of store, the data or information, or code, or to convert the data or information, or code, into a foreign language at any time. In a preferred embodiment, any individual, patient, caregiver, healthcare provider, provide, insurer or payer, intermediary, or third party, can view any information or information screens provided by the apparatus 100 in any selected foreign language, can request and be provided with a translation or a conversion of any data, information, or codes, described herein, into any selected foreign language, or can generate or transmit any claim forms, claims, requests, messages, reports, of other information, in any selected foreign language.

In a preferred embodiment, any translation or conversion from one language to another can be performed using a pre-stored look-up table or translation software, which can stored or provided in the database 10H of the central processing computer 10, or stored or provided in any of the databases 20H, 30H, 40H, 50H, 60H, 70H, 80H, and/or 90H, of any of the respective communication devices or computers described herein, each of which communication devices or computers can also contain, can be equipped with, or can have, foreign language translations or foreign language counterparts of data, information, or codes, which can be used, stored, processed, or generated, in connection with the use of any of the embodiments or functionality of the apparatus 100 of the present invention described herein. In a preferred embodiment, any translation or conversion can also be performed using a language translation or code translation software of processing routines. In a preferred embodiment, the apparatus 100 of the present invention can translate or convert any of the data or information, or any codes, described herein, into any number of foreign languages. In a preferred embodiment, information in any look-up tables or software can be entered and stored manually so as to ensure accurate, correct, and up-to-date translations. In another preferred embodiment, the apparatus 100 or the central processing computer 10 can also perform any translations or conversions using language translation software or processing routines.

In another preferred embodiment, any or all of the International Classification of Diseases (ICD) codes, ICD-10 codes, ICD-9, or any other ICD codes, or any other codes, billing codes, diagnostic codes, treatment codes, symptom codes, as well as any other codes or coding information which pertains to healthcare, the administration of healthcare services, electronic healthcare record keeping, healthcare billing, healthcare diagnostics, healthcare treatments, or any of the healthcare or healthcare-related functions or services, or any information or function described-herein as capable of being provided by the apparatus 100 and method of the present invention, can, if needed, be translated by the apparatus 100, by the central processing computer 10, or by any of the other computers or communication devices 20, 30, 40, 50, 60, 70, 80, and/or 90, into a foreign language or translated or converted into a foreign language counterpart or corresponding code or information. In a preferred embodiment, any translation or conversion can be performed automatically in response to a respective individual, patient, caregiver, healthcare provider, provider, insurer or payer, intermediary, or third party, or any other person or entity, registering or selecting a language preference with the apparatus 100 or with the central processing computer 10 at any time.

In another preferred embodiment, the apparatus 100 and method of the present invention can be used to provide, and the database 10H can contain, information regarding audits or other information regarding, for each insurer or payer, the insurer's or payer's responsiveness to process or pay claims, the insurer's or the payer's time to pay claims, information regarding why the insurer or the payer rejects a claim or has rejected a claim, claim rejection information regarding the insurer or the payer, claims allowed information regarding the insurer or the payer, payment rates or schedules for goods or services paid for by the insurer or the payer, reimbursement rates paid by the insurer or the payer, or any other information which can be used to provide information regarding the insurer or the payer. In this embodiment, the apparatus 100 or the central processing computer 10 can record or store information regarding each and every claim submitted to an insurer or a payer, as well as information regarding the insurer's or the payer's responsiveness to process or pay claims, the insurer's or the payer's time to pay claims, information regarding why the insurer or the payer rejects a claim or has rejected a claim, claim rejection information regarding the insurer or the payer, claims allowed information regarding the insurer or the payer, payment rates or schedules for a good or a service paid for by the insurer or the payer, reimbursement rates paid by the insurer or the payer, and/or any other information which can be used to provide information regarding the insurer or the payer.

Any time a respective individual, patient, caregiver, healthcare provider, provider, insurer or payer, or any intermediary or third party, or any other individual or user, desires to obtain any of the herein-described or other information regarding the insurer or the payer, he, she, or it, can access the central processing computer 10 via a respective provider communication device 20, a insurer or payer communication device 30, a user or patient communication device 40, or an intermediary communication device 50, or any other computer or communication device, and request and obtain an insurer or payer report (hereinafter “payer report”). In this manner, the apparatus 100 and method of the present invention can be used to audit an insurer or a payer or to monitor any of the herein-described or other pertinent information regarding the insurer or the payer.

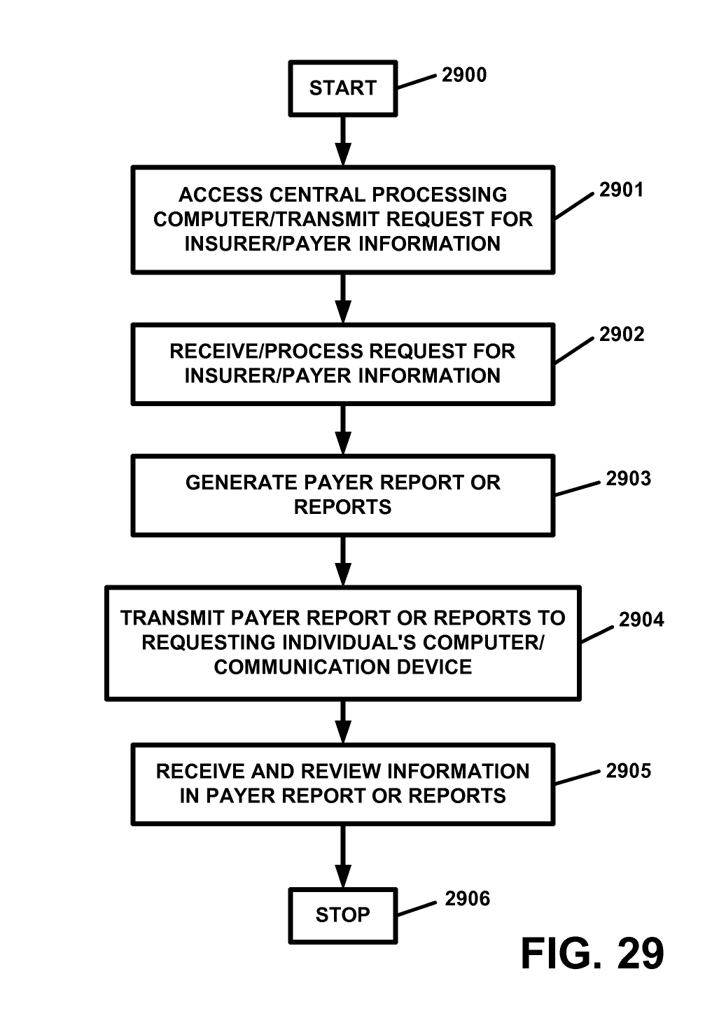

FIG. 29 illustrates, in flow diagram form, another preferred embodiment method for utilizing the apparatus 100 and method of the present invention in order to audit or otherwise obtain data and/or information regarding an insurer or payer or to monitor any of the herein-described or other pertinent information regarding the insurer or a payer.

With reference to FIG. 29, the operation of the apparatus 100 commences at step 2900. At step 2901, the respective individual, patient, caregiver, healthcare provider, provider, insurer or payer, or any intermediary or third party, or any other individual or user, desiring to obtain any of the herein-described or other information regarding the insurer or the payer, can access the central processing computer 10 via a respective computer or communication device 20, 30, 40, or 50, or via any other computer or communication device. At step 2901, the respective individual, patient, caregiver, healthcare provider, provider, insurer or payer, or any intermediary or third party, or any other individual or user, can transmit the request to obtain, for a particular insurer or payer, or for particular insurers or payers, any one or more of the, or each, insurer's or payer's responsiveness to process or pay claims, the, or each, insurer's or payer's time to pay claims, information regarding why the, or each, insurer or payer rejects a claim or has rejected a claim, claim rejection information regarding the, or each, insurer or payer, claims allowed information regarding the, or each, insurer or payer, payment rates or schedules for goods or services paid for by the, or each, insurer or payer, reimbursement rates paid by the, or each, insurer or payer, or any other information which can be used to provide information regarding the, or each, payer or insurer.

Any and/or all of the data and/or information described above can be obtained from data and/or information stored in and retrievable from, the database 10H of the central processing computer 10, any and/or all of the electronic healthcare records, electronic healthcare files, or electronic healthcare histories stored in the database 10H of the central processing computer 10, any data and/or information stored in any and/or all of the electronic healthcare records, electronic healthcare files, or electronic healthcare histories stored in the database 60H of the healthcare records computer 60, any data and/or information stored in the database 70H of the insurance exchange computer 70, any and/or all data and/or information stored in the database(s) 20H of any and/or all provider communication devices 20 used in connection with the apparatus 100, any and/or all data and/or information stored in the database(s) 30H of any and/or all insurer or payer communication devices 30, and/or used in connection with the apparatus 100, and/or any data and/or information stored in the database 30H the insurer or payer communication device 30 associated with or used by the insurer or payer who or which is the subject of the respective audit or data and/or information request.

At step 2902, the central processing computer 10 will receive and/or process the request or requests, process or gather any data and/or information from the database 10H and/or from any electronic healthcare records or electronic healthcare files stored in the database 10H, process or gather any data and/or information from any of the other computers or communication devices 20, 30, 40, 60, or 70, described herein, or perform any necessary querying operations or functions with, on, or using, the data or information stored in the database 10H or in any of the other computers or communication devices 20, 30, 40, 60, or 70, described herein. At step 2903, the central processing computer 10 will generate a payer report or reports containing data or information responsive to the request or requests. At step 2904, the payer report or reports can be transmitted to the respective computer or communication device 20, 30, 40, or 50, or any other computer or communication device, associated with or used by the respective requesting individual, patient, caregiver, healthcare provider, provider, insurer or payer, or any intermediary or third party, or any other individual or user. At step 2904, the payer report or reports can also be transmitted to each of the healthcare records computer 60, the insurance exchange computer 70, the social networking computer 80, and/or the media computer 90.

At step 2905, the payer report or reports can be received by the respective computer or communication device 20, 30, 40, or 50, and the respective requesting individual, patient, caregiver, healthcare provider, provider, insurer or payer, or any intermediary or third party, or any other individual or user, can review the data or information contained in the report or reports. At step 2905, the report or reports can also be received by the healthcare records computer 60, the insurance exchange computer 70, the social networking computer 80, and/or the media computer 90, and the any requesting individual, user, member, or subscriber to same, can review the data or information contained in the payer report or reports. The healthcare records computer 60, the insurance exchange computer 70, the social networking computer 80, and/or the media computer 90 can also store the payer report or reports and same can be accessed by any requesting and/or authorized individual, patient, caregiver, healthcare provider, provider, insurer or payer, or any intermediary or third party, or any other individual or user, member, or subscriber. Thereafter, the operation of the apparatus will cease at step 2906.

In another preferred embodiment, the payer report or reports can also be stored in the individual's or patient's electronic healthcare record in the database 10H of the central processing computer 10 and/or in the individual's or patient's electronic healthcare record in the database 60H of the healthcare records computer 60.

In another preferred embodiment, a respective individual, patient, caregiver, healthcare provider, provider, insurer or payer, or any intermediary or third party, or any other individual or user, can program the apparatus 100, or the central processing computer 10, to generate and send, or transmit to, him, her, or it, any of the herein-described or other payer report or reports at any time, at various time intervals, on certain specified dates, quarterly, semi-annually, annually, or at any time, or upon the occurrence or a pre-specified event or events. In this embodiment, a respective individual, patient, caregiver, healthcare provider, provider, insurer or payer, or any intermediary or third party, or any other individual or user, can program the apparatus 100 such as by registering the request or requests at any time in order to receive a future payer reports for any insurer or payer.

In this regard, a respective individual, patient, caregiver, healthcare provider, provider, insurer or payer, or any intermediary or third party, or any other individual or user, can program the apparatus 100, or the central processing computer 10, to generate and to send, or transmit to, him, her, or it, any of the herein-described or other payer reports or insurer reports at any time, at various time intervals, on certain specified dates, quarterly, semi-annually, annually, or at any time, or upon the occurrence or a pre-specified event or events. In this preferred embodiment, a respective individual, patient, caregiver, healthcare provider, provider, insurer or payer, or any intermediary or third party, or any other individual or user, can program the apparatus 100, or the central processing computer 10, such as by registering the request or requests at any time in order to receive future payer reports or insurer reports. Any payer reports or insurer reports can be stored in the database 10H for later retrieval or use by any user of the apparatus 100.

In another preferred embodiment, the central processing computer 10 can generate and transmit, to the user or patient communication device 40, a payer report alert message in order to notify the individual, patient, or caregiver, of the newly generated or newly available payer report or reports. Any payer report or reports can also be stored in the database 10H for later retrieval or use by any user of the apparatus 100. Any of the herein-described payer report or reports can also be stored in the individual's or patient's electronic healthcare record in the database 10H of the central processing computer 10 and/or in the individual's or patient's electronic healthcare record in the database 60H of the healthcare records computer 60. In another preferred embodiment, the any of the herein-described payer report or reports can also be transmitted to stored at the any provider communication device 20 of any provider, transmitted to and stored at the insurer or payer communication device 30 or the insurer or payer who or which is the subject of the report and/or to any insurer or payer communication device(s) 30 of any insurer(s) or payer(s), transmitted to and stored at any user or patient communication device 40 associated with or used by any individual, patient, or caregiver, who utilizes the apparatus 100, transmitted to and stored at any intermediary communication device 50, transmitted to and stored at the healthcare records computer 60, transmitted to and stored at the insurance exchange computer 70, transmitted to and stored at the social network computer 80, and/or transmitted to any stored at the media computer 90, from which communication devices or computers 60, 70, 80, and 90, the payer reports can be made available to the public, and/or be available upon request by any individual, patient, caregiver, healthcare provider, provider, insurer or payer, or any intermediary or third party, or any other individual or user, and/or be available for dissemination to any individual, patient, caregiver, healthcare provider, provider, insurer or payer, or any intermediary or third party, or any other individual or user, for any reason or purpose.

In another preferred embodiment, the apparatus 100 and method of the present invention can be used to audit or monitor a healthcare provider, healthcare providers, or any other provider or providers described herein. In this regard, the apparatus 100 and method of the present invention can be used to provide, and the database 10H can contain, information regarding, for each healthcare provider or other provider, the respective healthcare provider's or other provider's insurances accepted, fees, fee schedules, claim success rates, diagnosis success rates, treatment success rates, time to update patient electronic healthcare record or electronic healthcare file from service time or date, time to submit insurance claims or claims for payment from service time or date, number of visits per illness, individual, patient, caregiver, or client, satisfaction information or comments, individual, patient, caregiver, or client, reviews, malpractice claims made against the healthcare provider, complaints made against the healthcare provider, satisfaction ratings, competence ratings, number of individuals, patients, or clients, under care, and/or any other information regarding the healthcare provider or other provider.

Any time a respective individual, patient, caregiver, client, healthcare provider, provider, insurer, payer, or any intermediary or third party, or any other individual or user, desires to obtain any of the herein-described or other information regarding a healthcare provider or other provider, he, she, or it, can access the central processing computer 10 via a respective provider communication device 20, an insurer or payer communication device 30, a user or patient communication device 40, an intermediary communication device 50, or any other computer or communication device, and request and obtain a provider report. In this manner, the apparatus 100 and method of the present invention can be used to audit a healthcare provider or other provider or to obtain and/or monitor any of the herein-described or other pertinent information regarding the healthcare provider or other provider.

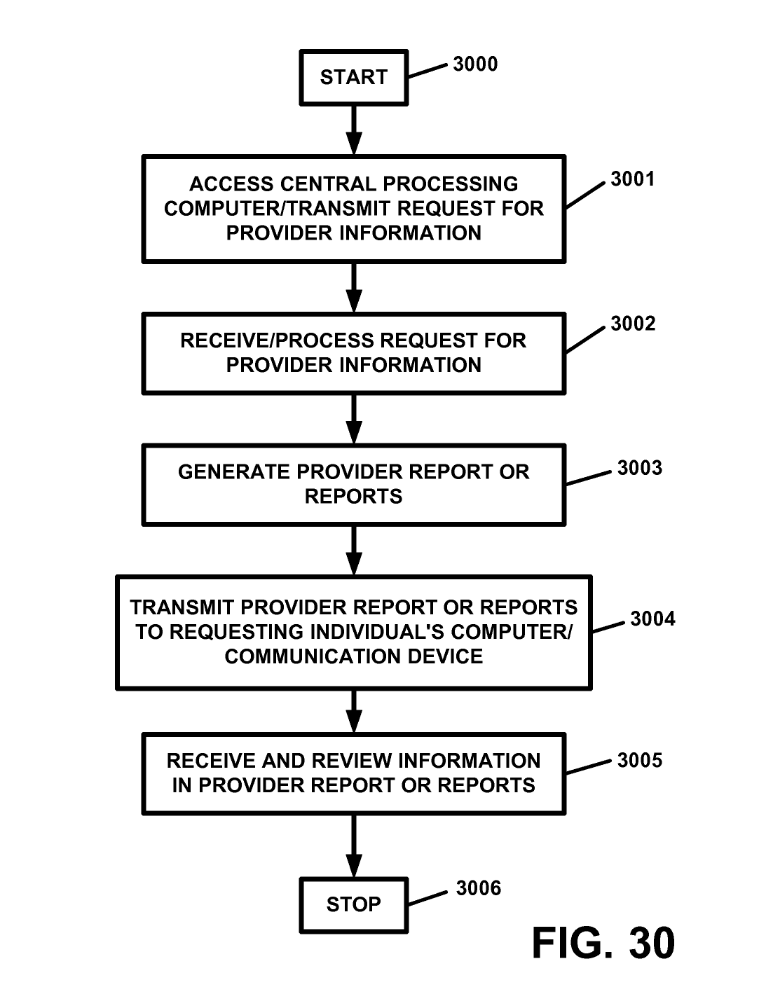

FIG. 30 illustrates, in flow diagram form, another preferred embodiment method for utilizing the apparatus 100 and method of the present invention in order to audit a healthcare provider or other provider or to obtain or monitor any of the herein-described or other pertinent information regarding the healthcare provider or other provider. With reference to FIG. 30, the operation of the apparatus 100 commences at step 3000.

At step 3001, the respective individual, patient, caregiver, healthcare provider, provider, insurer or payer, or any intermediary or third party, or any other individual or user, desiring to obtain any of the herein-described or other information regarding the healthcare provider or other provider, can access the central processing computer 10 via a respective computer or communication device 20, 30, 40, or 50, or via any other computer or communication device. At step 3001, the respective individual, patient, caregiver, healthcare provider, provider, insurer or payer, or any intermediary or third party, or any other individual or user, can transmit the request to obtain, for a particular healthcare provider or other provider, or for particular healthcare providers or other providers, any one or more of the, or each, healthcare provider's or other provider's insurances accepted, fees, fee schedules, claim success rates, diagnosis success rates, treatment success rates, time to update patient electronic healthcare record or electronic healthcare file from service time or date, time to submit insurance claim from service time or date, number of visits per illness, individual, patient, caregiver, or client, satisfaction information or comments, individual, patient, caregiver, or client, reviews, notes, ratings, or comments, regarding the healthcare provider or provider, malpractice claims made against the healthcare provider or provider, complaints made against the healthcare provider or provider, satisfaction ratings, competence ratings, number of individuals, patients, or clients, under care, and/or any other information regarding the healthcare provider or other provider.

In another preferred embodiment, any of the information regarding satisfaction information or comments, individual, patient, caregiver, or client, reviews, notes, ratings, or comments, regarding the healthcare provider or provider, malpractice claims made against the healthcare provider or provider, complaints made against the healthcare provider or provider, satisfaction ratings, competence ratings, can also be stored in the individual's or patient's electronic healthcare record in the database 10H of the central processing computer 10, in the database 60H of the healthcare records computer 69, in the insurance exchange computer 70, and/or in the social networking computer 80.

At step 3002, the central processing computer 10 will receive and/or process the request or requests, process or gather data of information from the database 10H, and/or from any electronic healthcare records or electronic healthcare files stored in the database 10H, or perform any necessary querying operations or functions with, on, or using, the data or information stored in the database 10H. At step 3003, the central processing computer 10 will generate a provider report or reports containing data or information responsive to the request or requests. At step 3004, the provider report or reports can be transmitted to the respective computer or communication device 20, 30, 40, or 50, or any other computer or communication device, associated with or used by the respective requesting individual, patient, caregiver, healthcare provider, provider, insurer or payer, or any intermediary or third party, or any other individual or user. At step 3004, the provider report or reports can also be transmitted to each of the healthcare records computer 60, the insurance exchange computer 70, the social networking computer 80, and/or the media computer 90.

At step 3005, the report or reports can be received by the respective computer or communication device 20, 30, 40, or 50, and/or by the healthcare records computer 60, the insurance exchange computer 70, the social networking computer 80, and/or the media computer 90, and the respective requesting individual, patient, caregiver, healthcare provider, provider, insurer or payer, or any intermediary or third party, or any other individual, can review the data or information contained in the provider report or reports. The healthcare records computer 60, the insurance exchange computer 70, the social networking computer 80, and/or the media computer 90 can also store the provider report or reports and same can be accessed by any requesting and/or authorized individual, patient, caregiver, healthcare provider, provider, insurer or payer, or any intermediary or third party, or any other individual or user. At step 3005, the provider report or reports can also be stored in the individual's or patient's electronic healthcare record in the database 10H of the central processing computer 10 and/or in the individual's or patient's electronic healthcare record in the database 60H of the healthcare records computer 60. Thereafter, the operation of the apparatus 100 will cease at step 3006.

In another preferred embodiment, a respective individual, patient, caregiver, healthcare provider, provider, insurer or payer, or any intermediary or third party, or any other individual or user, can program the apparatus 100, or the central processing computer 10, to generate and send, or transmit to, him, her, or it, any of the herein-described or other provider report or reports at any time, at various time intervals, on certain specified dates, quarterly, semi-annually, annually, or at any time, or upon the occurrence or a pre-specified event or events. In this embodiment, a respective individual, patient, caregiver, healthcare provider, provider, insurer or payer, or any intermediary or third party, or any other individual or user, can program the apparatus 100 such as by registering the request or requests at any time in order to receive a future provider reports for any healthcare provider or other provider.

In another preferred embodiment, the central processing computer 10 can generate and transmit, to the user or patient communication device 40, a provider report alert message in order to notify the individual, patient, or caregiver, of the newly generated or newly available provider report or reports. Any provider report or reports can also be stored in the database 10H for later retrieval or use by any user of the apparatus 100. Any of the herein-described provider report or reports can also be stored in the individual's or patient's electronic healthcare record in the database 10H of the central processing computer 10 and/or in the individual's or patient's electronic healthcare record in the database 60H of the healthcare records computer 60. In another preferred embodiment, the any of the herein-described provider report or reports can also be transmitted to stored at the any provider communication device 20 of the provider who is the subject of the provider report or any other provider, transmitted to and stored at any insurer or payer communication device 30, transmitted to and stored at any user or patient communication device 40 associated with or used by any individual, patient, or caregiver, who utilizes the apparatus 100, transmitted to and stored at any intermediary communication device 50, transmitted to and stored at the healthcare records computer 60, transmitted to and stored at the insurance exchange computer 70, transmitted to and stored at the social network computer 80, and/or transmitted to any stored at the media computer 90, from which communication devices or computers 60, 70, 80, and 90, the provider reports can be made available to the public, and/or be available upon request by any individual, patient, caregiver, healthcare provider, provider, insurer or payer, or any intermediary or third party, or any other individual or user, and/or be available for dissemination to any individual, patient, caregiver, healthcare provider, provider, insurer or payer, or any intermediary or third party, or any other individual or user, for any reason or purpose.

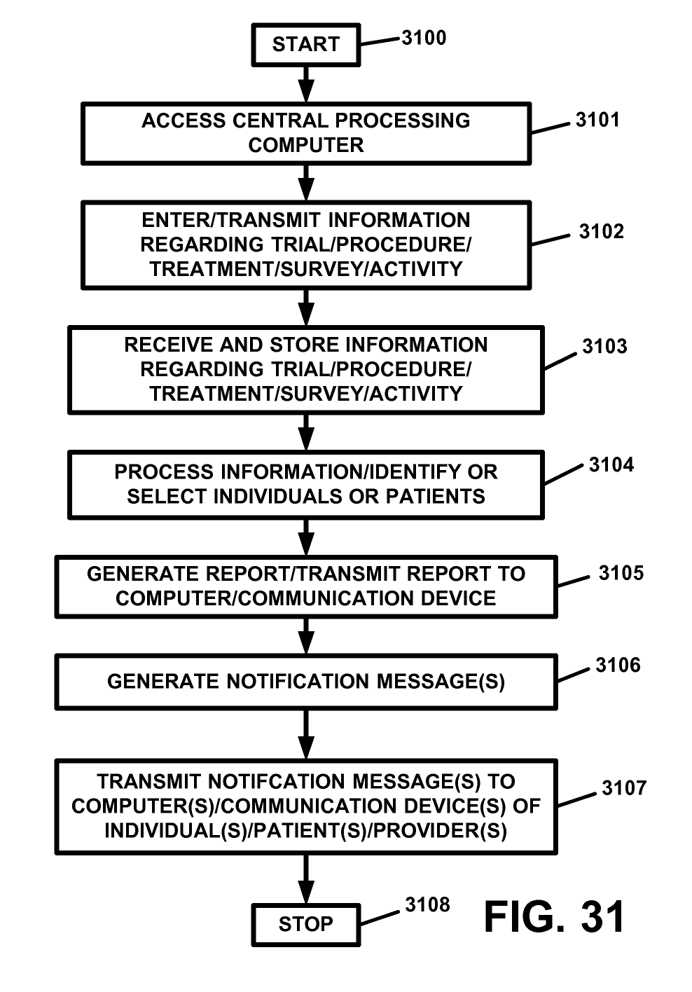

In another preferred embodiment, the apparatus 100 and method of the present invention can be utilized in order to identify or select individuals or patients for clinical trials, experimental procedures, experimental treatments, healthcare focus groups, discussion groups, support groups, healthcare surveys, or for any other activities or events which involve one or more individuals or patients. FIG. 31 illustrates, in flow diagram form, another preferred embodiment method for utilizing the apparatus 100 and method of the present invention in order to identify or select individuals or patients for clinical trials, experimental procedures, experimental treatments, healthcare focus groups, discussion groups, support groups, healthcare surveys, or for any other activities or events which involve one or more individuals or patients. With reference to FIG. 31, the operation of the apparatus 100 commences at step 3100. At step 3101, any individual, patient, caregiver, healthcare provider, provider, insurer or payer, or any intermediary or third party, or any other individual or user, seeking to identify or select one or more individuals or patients for a clinical trial, an experimental procedure, an experimental treatment, a healthcare focus group, a discussion group, a support group, a healthcare survey, or any other activity or event, can access the central processing computer 10 via a respective computer or communication device 20, 30, 40, or 50, via a healthcare records computer 60, an insurance exchange computer 70, a social networking computer 80, or a media computer 90, or via any other computer or communication device.

At step 3102, the individual, patient, caregiver, healthcare provider, provider, insurer or payer, or any intermediary or third party, or any other individual or user, can enter information or criteria regarding the respective clinical trial, experimental procedure, experimental treatment, healthcare focus group, a discussion group, a support group, healthcare survey, or the other activity or event, into the respective computer or communication device 20, 30, 40, 50, 60, 70, 80, or 90, or any other computer or communication device, and can transmit the respective information or criteria to the central processing computer 10. At step 3103, the central processing computer 10 can receive and store the information or criteria regarding the respective clinical trial, experimental procedure, experimental treatment, healthcare focus group, discussion group, support group, healthcare survey, or the other activity or event. At step 3104, the central processing computer 10 will process the information or criteria regarding the respective clinical trial, experimental procedure, experimental treatment, healthcare focus group, discussion group, support group, healthcare survey, or the other activity or event, using the data or information contained in the database 10H, as well as any data or information contained in any of the electronic healthcare records, electronic healthcare files, or electronic healthcare histories, stored in the database 10H, and identify or select one or more individuals or patients for, for use in, or for participation in, the respective clinical trial, experimental procedure, experimental treatment, healthcare focus group, discussion group, support group, healthcare survey, or the other activity or event. At step 3104, the central processing computer 10 will also generate a list of the identified or selected individual(s) or patient(s).

At step 3105, the central processing computer 10 can generate, and store in the database 10H, a report containing information regarding the individual or patient or the individuals or patients identified or selected for use in, or for participation in, the respective clinical trial, experimental procedure, experimental treatment, healthcare focus group, discussion group, support group, healthcare survey, or the other activity or event, and/or containing the list of the identified or selected individual(s) or patient(s). Information regarding the respective clinical trial, experimental procedure, experimental treatment, healthcare focus group, discussion group, support group, healthcare survey, the specific condition(s), or the other activity or event, and the individual(s) or patient(s) identified or selected for same, or identified or selected as having or satisfying any specified or specific condition(s) or criteria, can also be stored in the database 10H and can also be transmitted to and stored each of the healthcare records computer 60, the insurance exchange computer 70, the social networking computer 80, and/or the media computer 90. At step 3105, the report can be transmitted from the central processing computer 10 to the respective computer or communication device 20, 30, 40, 50, 60, 70, 80, or 90 or any other computer or communication device, associated with or used by the requesting individual or user.

At step 3106, the central processing computer 10 can also generate a notification message containing information regarding, for each identified or selected individual or patient, or his or her caregiver, the individual's or patient's having been or being identified or selected for the respective clinical trial, experimental procedure, experimental treatment, healthcare focus group, healthcare survey, or other activity or event, information regarding the respective clinical trial, experimental procedure, experimental treatment, healthcare focus group, discussion group, support group, healthcare survey, or other activity or event, or information regarding the individual or patient having been or being identified or selected for same, including, but not limited to, contact information or other information, such as a link or hyperlink, for allowing the individual or patient to register for the respective clinical trial, experimental procedure, experimental treatment, healthcare focus group, discussion group, support group, healthcare survey, or the other activity or event.

In the case of a link or hyperlink being provided, an individual or patient, or his or her caregiver, can register the individual or patient for the respective clinical trial, experimental procedure, experimental treatment, healthcare focus group, discussion group, support group, healthcare survey, or other activity or event, via the central processing computer 10 using the link or the hyperlink. At step 3106, a notification message can be generated for each individual or patient, for any one, or each, healthcare provider of the individual or patient, as well as for the person, company, organization, or entity, administering or holding the respective clinical trial, experimental procedure, experimental treatment, healthcare focus group, discussion group, support group, healthcare survey, or other activity or event, or for a healthcare facility, associated with the individual or patient and/or a healthcare facility or provider facility or any electronic forum hosting or sponsoring a respective, or any other facility which can be the site or location for the respective, clinical trial, experimental procedure, experimental treatment, healthcare focus group, discussion group, support group, healthcare survey, or other activity or event.

At step 3107, the notification message can be transmitted to a respective user or patient communication device 40 associated with the individual, patient, or his or her caregiver, to a provider communication device 20 associated with a healthcare provider of the individual or patient, to a provider communication device 20 associated with a healthcare facility or other facility, or to a provider communication device 20 associated with a public health agency or department, or to any computer of communication device associated with the person, company, organization, or entity, administering or holding the respective clinical trial, experimental procedure, experimental treatment, healthcare focus group, discussion group, support group, healthcare survey, or other activity or event. In the case of a healthcare provider receiving the notification message instead of or in addition to the individual, patient, or caregiver, receiving same, the healthcare provider may be provided with the opportunity to discuss the respective clinical trial, experimental procedure, experimental treatment, healthcare focus group, discussion group, support group, healthcare survey, or other activity or event, as well as any specific condition(s) regarding the individual, or the patient or any specific condition(s) regarding the respective clinical trial, experimental procedure, experimental treatment, healthcare focus group, discussion group, support group, healthcare survey, or other activity or event, with the individual or patient.

In a preferred embodiment, any notification message or notification messages sent to an individual, patient, or to his or her caregiver, can also be stored in the individual's, patient's, or caregiver's, electronic healthcare record in the database 10H of the central processing computer 10 and can also be stored in the individual's, patient's, or caregiver's, electronic healthcare record in the database 60H of the healthcare records computer 60.

At step 3107, the individual, the patient, or the caregiver, can register for and/or join or become a member or participant of the respective clinical trial, experimental procedure, experimental treatment, healthcare focus group, discussion group, support group, healthcare survey, or other activity or event, the individual, the patient, or the caregiver, can take steps to address the specific condition(s) he or she has, or the individual, the patient, or the caregiver, can disregard the notification message. At step 3107, the healthcare provider of the individual or patient can also register the individual or patient for the respective clinical trial, experimental procedure, experimental treatment, healthcare focus group, discussion group, support group, healthcare survey, or other activity or event, or any treatment program.

In a preferred embodiment, any information regarding the respective clinical trial, experimental procedure, experimental treatment, healthcare focus group, discussion group, support group, healthcare survey, or other activity or event, and/or the individual's, patient's caregiver's, registration, membership, or participation, in same can also be stored in the individual's, patient's, or caregiver's, electronic healthcare record in the database 10H of the central processing computer 10 and can also be stored in the individual's, patient's, or caregiver's, electronic healthcare record in the database 60H of the healthcare records computer 60. In a preferred embodiment, the individual's, patient's, or caregiver's, electronic healthcare record, whether stored in the database 10H or in the database 60H can include or contain a link(s) or hyperlink(s) to information regarding, an electronic meeting or discussion place or an electronic meeting or discussion forum, registration information, participation information, news regarding, or any other information regarding, the respective clinical trial, experimental procedure, experimental treatment, healthcare focus group, discussion group, support group, healthcare survey, or other activity or event.

Thereafter, the operation of the apparatus 100 will cease at step 3108.

Any results of, for, or regarding, the individual's or patient's participation in the respective clinical trial, experimental procedure, experimental treatment, healthcare focus group, discussion group, support group, healthcare survey, or other activity or event, can be stored in the individual's or patient's electronic healthcare record, electronic healthcare file, or electronic healthcare history, as well as in any record or file, electronic or otherwise, regarding the respective clinical trial, experimental procedure, experimental treatment, healthcare focus group, discussion group, support group, healthcare survey, or other activity or event.

In the above described manner, the apparatus 100 of the present invention can be used to test new medications, medicines, drugs, pharmaceutical products, pharmaceutical services, healthcare devices, goods, products, or services, new or experimental treatments or procedures, treatment plans, or care management plans, and/or can be used to obtain survey information or focus group information from the identified or selected individuals and/or patients. Any information or results obtained can be stored in the database 10H of the central processing computer 10, in the healthcare records computer 60, in the insurance exchange computer 70, in the social networking computer 80, and/or in the media computer 90 for later use, retrieval or access, by any user, including, but not limited to, any individual, patient, caregiver, healthcare provider, provider, insurer or payer, or any intermediary or third party, or any other individual, user, or entity.

In another preferred embodiment of the embodiment of FIG. 31, the apparatus 100 and method of the present invention can be utilized, in a same, a similar, or an analogous, manner, in order to identify or select, and/or to generate a list of individuals or patients with or having a specific condition(s), which list of individuals or patients can be used for research, quality improvement, outreach, reduction of disparities, care management, treatment planning, infection disease control, or any other healthcare-related activity. In this preferred embodiment, the list of individuals or patients, with or having a specific condition(s), can be determined by the central processing computer 10 which can then generate a message containing information regarding the list of individuals or patients. The message can be generated in response to a request for the list of individuals or patients entered by a user or individual and transmitted from a respective computer or communication device, which can be any one of the computers or communication devices 20, 30, 40, 50, 60, 70, 80, or 90, or any other computer or communication device, and received and stored by the central processing computer 10.

The message can then be transmitted from the central processing computer 10 to any provider communication device 20, any insurer or payer communication device 30, any user or patient communication device 40, any intermediary communication device 50, any healthcare records computer 60, any insurance exchange computer 70, any social networking computer 80, or any media computer 90, or any other computer or communication device, associated with or used by the requesting individual, person, or entity, healthcare provider, provider of any good or service, insurer or payer, any individual, patient or caregiver, any public health agency or department, any research institution, any healthcare facility, any research center, any university, any college, or any school, or any other person or entity who or which might use the information contained in the message for purposes of research, quality improvement, outreach, reduction of disparities, care management, treatment planning, infection disease control, or any other healthcare-related activity or purpose. The message can also be transmitted to a user or patient communication device 40 associated with the individual, the patient, or the caregiver, identified as having the specific condition(s). The message, in a preferred embodiment, can also contain information, or links or hyperlinks, to other and additional information. In a preferred embodiment, any message sent to an individual, patient, or to his or her caregiver, can also be stored in the individual's, patient's, or caregiver's, electronic healthcare record in the database 10H of the central processing computer 10 and can also be stored in the individual's, patient's, or caregiver's, electronic healthcare record in the database 60H of the healthcare records computer 60.

In another preferred embodiment, the apparatus 100 and method of the present invention can be used to determine or to measure the effectiveness of, or side effects experienced or associated with, any medications, medicines, drugs, dietary supplements, supplements, vitamins, over-the-counter products or substances, or to measure the effectiveness of, or the side effects experienced or associated with, any procedures, treatments, treatment plans, care management plans, or any other goods, products, or services which can be offered in the marketplace.

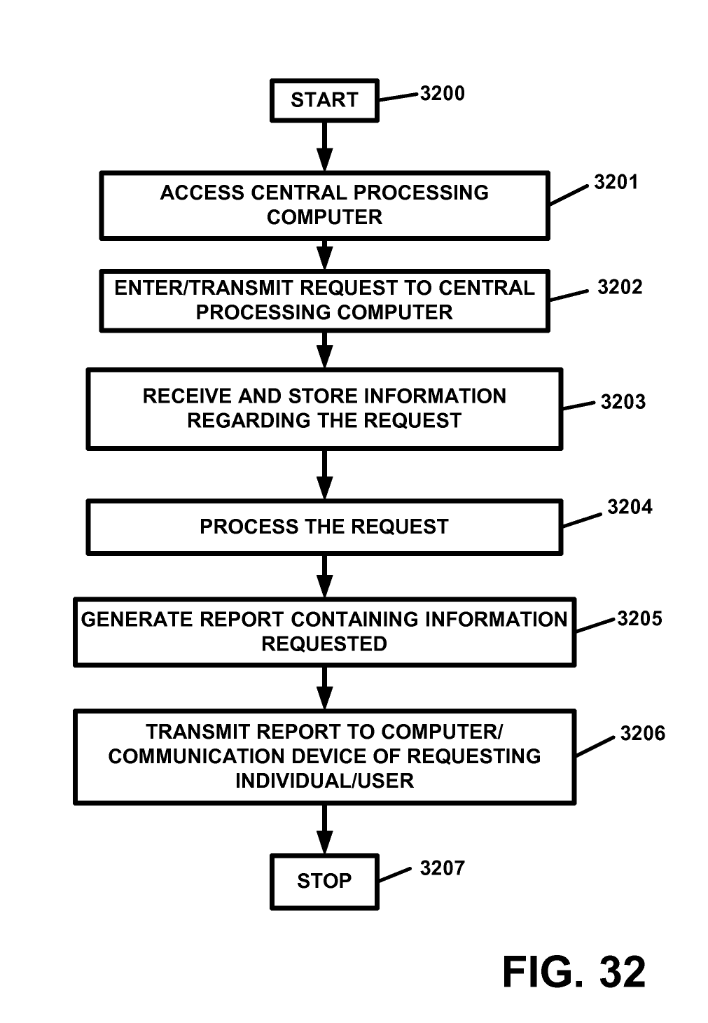

FIG. 32 illustrates, in flow diagram form, another preferred embodiment method for utilizing the apparatus 100 and method of the present invention in order to determine or measure the effectiveness of, or side effects experienced or associated with, any medications, medicines, drugs, dietary supplements, supplements, vitamins, over-the-counter products or substances, or the effectiveness of, or side effects experienced or associated with, any procedures, treatments, treatment plans, care management plans, or any other good, product, or service, which can be offered in the marketplace.

With reference to FIG. 32, the operation of the apparatus 100 commences at step 3200. The preferred embodiment of FIG. 32 can be utilized by any individual, patient, caregiver, healthcare provider, provider, insurer or payer, or any intermediary or third party, or any other individual or user (hereinafter referred to in the description of this preferred embodiment as “individual” or “user”). At step 3201, an individual or user seeking to determine or measure the effectiveness of, or side effects experienced or associated with, any medications, medicines, drugs, dietary supplements, supplements, vitamins, over-the-counter products or substances, or the effectiveness of, or side effects experienced or associated with, any procedures, treatments, treatment plans, care management plans, or any other goods, products, or services, which can be offered in the marketplace, can access the central processing computer 10 via a respective computer or communication device 20, 30, 40, or 50, or any other computer or communication device.

At step 3202, the individual or user can enter information regarding the request regarding the effectiveness of, or side effects experienced or associated with, or regarding, a respective medication, medicine, drug, dietary supplement, supplement, vitamin, over-the-counter product or substance, procedure, treatment, treatment plan, care management plan, or other good, product, or service, into the respective computer or communication device 20, 30, 40, or 50, or any other computer or communication device and can transmit same to the central processing computer 10.

At step 3203, the central processing computer 10 can receive and store the information regarding the request or contained in the request. At step 3204, the central processing computer 10 will process the information regarding the request using the data or information contained in the database 10H as well as any data or information contained in any of the electronic healthcare records, electronic healthcare files, or healthcare histories, stored in the database 10. In another preferred embodiment, the central processing computer 10 can utilize any information stored in any individual or patient electronic healthcare records stored in the database 10H of the central processing computer 10 and can also utilize any individual or patient electronic healthcare records store in the database(s) 60H of the healthcare records computer(s) 60.

At step 3205, the central processing computer 10 can generate, and store in the database 10H, a report containing information regarding the effectiveness of, or side effects experienced or associated with, or regarding, the respective medication, medicine, drug, dietary supplement, supplement, vitamin, over-the-counter product or substance, procedure, treatment, treatment plan, care management plan, or other good, product, or service, which is the subject of the request.

At step 3206, the central processing computer 10 can transmit the report to the computer or communication device 20, 30, 40, or 50 of the requesting individual or user and the individual or user can review the information contained in the report.

At step 3206, the central processing computer 10 can also store the report in an electronic healthcare record for each individual, patient, or caregiver, who may have used or been prescribed the respective medication, medicine, drug, dietary supplement, supplement, vitamin, over-the-counter product or substance, procedure, treatment, treatment plan, care management plan, or other good, product, or service, which is the subject of the request. At step 3206, the central processing computer can also generate an alert message containing the report and transmit the alert message to the respective user or patient communication device 40 of each individual, patient, or caregiver, who may have used or been prescribed the respective medication, medicine, drug, dietary supplement, supplement, vitamin, over-the-counter product or substance, procedure, treatment, treatment plan, care management plan, or other good, product, or service, which is the subject of the request. At step 3206, the central processing computer can also transmit the alert message to the provider communication device(s) 20 of any provider(s) of the individual, patient, or caregiver and/or to the insurer or payer communication device(s) 30 of any insurer or payer of the individual, patient, or caregiver. The alert message(s) can also be stored in the individual's or patient's electronic healthcare record stored in the database 10H of the central processing computer 10 or stored in the database(s) 60H of the healthcare records computer(s) 60.

In another preferred embodiment, at step 3206, the central processing computer 10 can also transmit the alert message to any provider communication device(s) 20, to any insurer or payer communication device(s) 30, to any intermediary computer 50, of any respective provider, insurer or payer, or intermediary, and/or can also transmit the alert message to any healthcare records computer 60, any insurance exchange computer 70, any social networking computer 80, and/or media computer 90. In a preferred embodiment, any provider or insurer or payer can access the alert report and information contained therein via their respective provider communication device 20 or insurer or payer communication device 30 and any user, member, or subscriber, of or to any of the healthcare records computers 60, insurance exchange computers 70, social networking computers 80, and/or media computers 90 can also access the alert report and information contained therein.

Thereafter, the operation of the apparatus 100 will cease at step 3207.

In another preferred embodiment, any individual or user seeking to obtain information regarding the effectiveness of, or side effects experienced or associated with, any medications, medicines, drugs, dietary supplements, supplements, vitamins, over-the-counter products or substances, or the effectiveness of, or side effects experienced or associated with, any procedures, treatments, treatment plans, care management plans, or any other good, product, or service, which can be offered in the marketplace, can program the apparatus 100 or the central processing computer 10 to generate and transmit and/or disseminate any of the reports and/or alert messages, as described above, automatically at a specified time, at regular time intervals, monthly, annually, or at any at specified time interval, upon an updating of information in the database 10H regarding the respective medication, medicine, drug, dietary supplement, supplement, vitamin, over-the-counter product or substance, procedure, treatment, treatment plan, care management plan, or other good, product, or service, or any individual or patient using same or being treated or cared for by, with, or using, same, or upon any other pre-specified occurrence or happening.

In this manner, the apparatus 100 can provide updated reports and alert messages regarding the effectiveness of, or side effects experienced or associated with, any medications, medicines, drugs, dietary supplements, supplements, over-the-counter products or substances, or the effectiveness of, or side effects experienced or associated with, any procedures, treatments, treatment plans, care management plans, or any good, product, or service, in the manner described herein and/or in any other manner, automatically or on an on-going basis. Any reports or alert messages can also be stored in the database 10H of the central processing computer 10, in the electronic healthcare record of each individual, patient, or caregiver, who utilizes the apparatus 100, in the healthcare records computer 60, in the insurance exchange computer 70, in the social networking computer 80, and/or in the media computer 90, for retrieval by any of the herein-described users, individuals, patients, caregivers, healthcare providers, other providers, insurers or payers, intermediaries, or third parties, or any other persons or entities who or which utilize the apparatus 100 and method of the present invention.

In another preferred embodiment, the apparatus 100 and method of the present invention can be used to provide information regarding health conditions, healthcare conditions, illnesses, diagnoses, symptoms, treatments, treatment plans, care management practices, care management plans, insurance information, information regarding type of insurance, wellness information, healthcare practices, healthcare history patterns, healthcare history patterns, healthcare trends, treatment trends, statistics, statistical analyses, studies, study trends, or any other pertinent healthcare or healthcare-related information, regarding any number or type of groups of individuals or patients. In a preferred embodiment, the apparatus 100 can provide any of the above-described information for any number of groups of individuals or patients based on gender, sex, age, occupation, education, ethnicity, country of origin, nationality, race, religion, any demographic criteria or demographics, or any other criteria. The apparatus 100 can also be utilized in order to provide statistical information or probability information regarding any of the above-described or herein-described information.

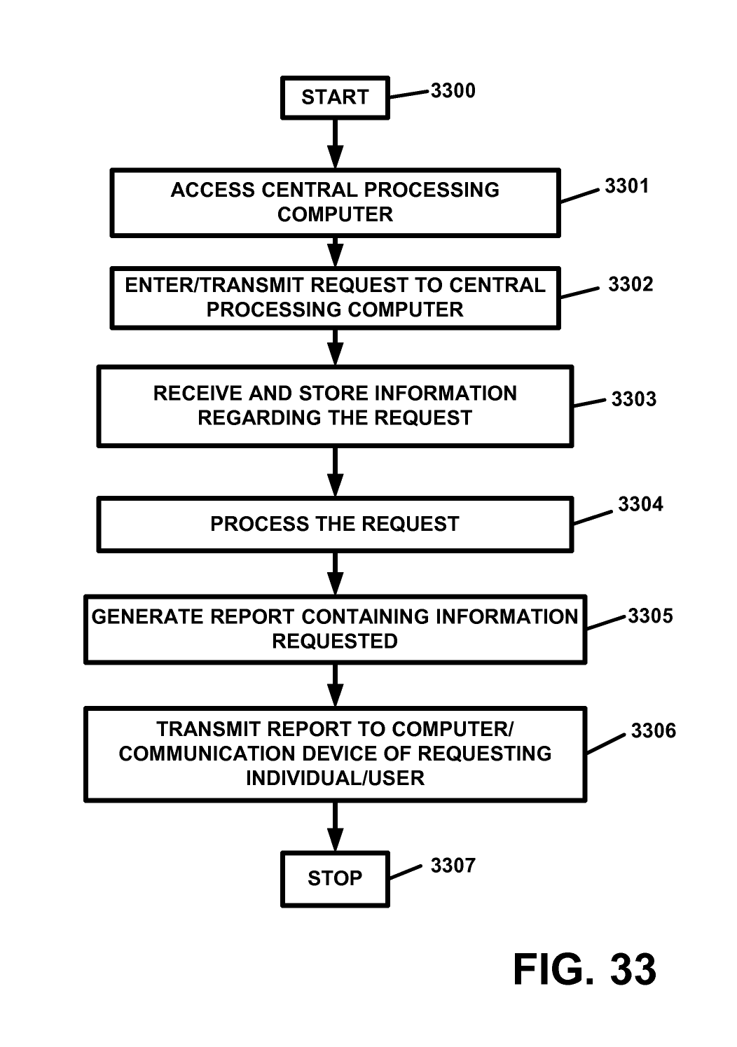

FIG. 33 illustrates, in flow diagram form, another preferred embodiment method for utilizing the apparatus 100 and method of the present invention in order to provide information regarding health conditions, healthcare conditions, illnesses, diagnoses, symptoms, treatments, treatment plans, care management practices, care management plans, insurance information, information regarding type of insurance, wellness information, healthcare practices, healthcare history patterns, healthcare trends, treatment trends, statistics, statistical analyses, studies, study trends, or any other pertinent healthcare or healthcare-related information, regarding any number or type of groups of individuals or patients, or to provide any of the herein-described information for any number of groups of individuals or patients based on gender, sex, age, occupation, education, ethnicity, country of origin, nationality, race, religion, any demographic criteria or demographics, or any other criteria.

With reference to FIG. 33, the operation of the apparatus 100 commences at step 3300. The preferred embodiment of FIG. 33 can be utilized by any individual, patient, caregiver, healthcare provider, provider, insurer or payer, or any intermediary or third party, or any other individual or user (hereinafter referred to in the description of this preferred embodiment as “individual” or “user”). At step 3301, an individual or user desiring to obtain any of the above-described information can access the central processing computer 10 via a respective computer or communication device 20, 30, 40, or 50, or any of the healthcare records computer 60, the insurance exchange computer 70, the social networking computer 80, or the media computer 90, or any other computer or communication device.

At step 3302, the individual or user can enter information regarding the request for information regarding health conditions, healthcare conditions, illnesses, diagnoses, symptoms, treatments, treatment plans, care management practices, care management plans, insurance information, information regarding type of insurance, wellness information, healthcare practices, healthcare history patterns, healthcare trends, treatment trends, statistics, statistical analyses, studies, study trends, or any other pertinent healthcare or healthcare-related information, regarding any number or type of groups of individuals or patients, or information for any number of groups of individuals or patients based on gender, sex, age, occupation, education, ethnicity, country of origin, nationality, race, religion, any demographic criteria or demographics, or any other criteria, into the respective computer or communication device 20, 30, 40, or 50, or into the healthcare records computer 60, the insurance exchange computer 70, the social networking computer 80, or the media computer 90, or into any other computer or communication device and transmit same to the central processing computer 10.

At step 3303, the central processing computer 10 can receive and store the information contained in the request. At step 3304, the central processing computer 10 will process the information regarding the request using the data or information contained in the database 10H as well as any data or information contained in any of the electronic healthcare records, electronic healthcare files, or electronic healthcare histories, stored in the database 10 for any of the herein-described individuals, patients, or caregivers, who utilize the apparatus 100 or for whom an electronic healthcare record, an electronic healthcare file, or an electronic healthcare history is stored or maintained.

At step 3305, the central processing computer 10 can generate, and store in the database 10H, a report containing information regarding the health conditions, healthcare conditions, illnesses, diagnoses, symptoms, treatments, treatment plans, care management practices, care management plans, insurance information, information regarding type of insurance, wellness information, healthcare practices, healthcare history patterns, healthcare trends, treatment trends, statistics, statistical analyses, studies, study trends, or any other pertinent healthcare or healthcare-related information, regarding any number or type of groups of individuals or patients, or information for any number of groups of individuals or patients based on gender, sex, age, occupation, education, ethnicity, country of origin, nationality, race, religion, any demographic criteria or demographics, or any other criteria, which is the subject of the request.

At step 3306, the central processing computer 10 can transmit the report to the computer or communication device 20, 30, 40, or 50, of the requesting individual or user and the individual or user can review the information contained in the report. At step 3306, the central processing computer 10 can also transmit the report to the healthcare records computer 60, the insurance exchange computer 70, the social networking computer 80, or the media computer 90, and the report can be accessed and/or made available to any individuals, users, members, or subscribed of the respective computer 60, 70, 80, or 90.

In another preferred embodiment, for each of the individuals or patients in the respective group which is the subject of the report, the central processing computer 10 can transmit the report to the user or patient communication device 40 of each individual, patient, or the caregiver of the individual or patient. At step 3306, the central processing computer 10 can, for each individual or patient in the subject group, also store, in the database 10H of the central processing computer 10 and/or in the database 60H of the healthcare records computer 60, the report in the electronic healthcare record of each individual or patient, or his or her caregiver. At step 3306, the central processing computer 10 can also, for each individual or patient in the subject group, transmit the report to the respective provider communication device 20 associated with or used by any and/or all of providers of each individual or patient in the subject group.

At step 3306, the central processing computer 10 can also, for each individual or patient in the subject group, transmit the report to the respective insurer or payer communication device 30 associated with or used by any and/or all of providers of each individual or patient in the subject group. In another preferred embodiment, the central processing computer 10, at step 3306, can also generate a report alert messages which can contain or include the report and can transmit the report alert message to a user or patient communication device 40 of any individual or patient in the subject group or of his or her caregiver, to any provider communication device 20 of any individual or patient in the subject group, to any insurer or payer communication device of any insurer or payer of the individual, patient, or his or her caregiver, to any user or patient communication device 20 of any individual or user desiring to receive the report alert message, to any provider communication device 20 of any provider desiring to receive the report alert message, to any insurer or payer communication device 30 of any insurer or payer desiring to receive the report alert message, and/or to any intermediary computer 50 of any intermediary desiring to receive the report alert message. The central processing computer 10 can also transmit the report alert message to any healthcare records computer 60, to any insurance exchange computer 70, to any social networking computer 80, and/or to any media computer 90, and any information contained therein can be accessed, obtained, or disseminated to any individual or user, member, or subscriber of the respective computer 60, 70, 80, or 90.

At step 3306, any of the reports or report alert messages can be stored in the electronic healthcare record of any individual or patient in the subject group or in the electronic healthcare record of the individual's or patient's caregiver. The central processing computer 10 can store, in the database 10H, the reports or report alert messages in the respective electronic healthcare record of the individual, patient, or caregiver.

Thereafter, the operation of the apparatus 100 will cease at step 3307.

In another preferred embodiment, the individual or user seeking to obtain information regarding health conditions, healthcare conditions, illnesses, diagnoses, symptoms, treatments, treatment plans, care management practices, care management plans, insurance information, information regarding type of insurance, wellness information, healthcare practices, healthcare history patterns, healthcare trends, treatment trends, statistics, statistical analyses, studies, study trends, or any other pertinent healthcare or healthcare-related information, regarding any number or type of groups of individuals or patients, or any of the herein-described information for any number of groups of individuals or patients based on gender, sex, age, occupation, education, ethnicity, country of origin, nationality, race, religion, any demographic criteria or demographics, or any other criteria, can program the apparatus 100 or the central processing computer 10 to generate the above-described reports and report alert messages automatically, at a specified time, at regular time intervals, monthly, annually, or at any specified time interval, upon an updating of information in the database 10H regarding the respective health conditions, healthcare conditions, illnesses, diagnoses, symptoms, treatments, treatment plans, care management practices, care management plans, insurance information, information regarding type of insurance, wellness information, healthcare practices, healthcare history patterns, healthcare trends, treatment trends, statistics, statistical analyses, studies, study trends, or any other pertinent healthcare or healthcare-related information, regarding any number or type of groups of individuals or patients, or regarding any of the herein-described information for any number of groups of individuals or patients based on gender, sex, age, occupation, education, ethnicity, country of origin, nationality, race, religion, any demographic criteria or demographics, or any other criteria, or upon any other pre-specified occurrence or happening.

In this manner, the apparatus 100 can provide updated reports and/or report alert messages regarding health conditions, healthcare conditions, illnesses, diagnoses, symptoms, treatments, treatment plans, care management practices, care management plans, insurance information, information regarding type of insurance, wellness information, healthcare practices, healthcare history patterns, healthcare trends, treatment trends, statistics, statistical analyses, studies, study trends, or any other pertinent healthcare or healthcare-related information, regarding any number or type of groups of individuals or patients, or any of the herein-described information for any number of groups of individuals or patients based on gender, sex, age, occupation, education, ethnicity, country of origin, nationality, race, religion, any demographic criteria or demographics, or any other criteria, in the above-described manner, automatically or on an on-going basis.

Any reports and/or report alert messages can also be stored in the database 10H for retrieval by any of the herein-described users, individuals, patients, caregivers, healthcare providers, other providers, insurers or payers, intermediaries, or third parties, or any other persons or entities who or which utilize the apparatus 100 and method of the present invention.

In any and/or all of the embodiments described herein, any signals, messages, reports, notifications messages, alert messages, report alert messages, or any other communications or communication transmissions, described herein as being transmitted from one device, computer, or communication device, to another, can be, or can be included in, or can be attached to, an e-mail message, an instant messaging message, an electronic transmission, an electronic data interchange, or electronic data transmission or any other data or information transmission. In any and/or all of the embodiments described herein, any signals, messages, reports, notifications messages, alert messages, report alert messages, or any other communications or communication transmissions, described herein as being transmitted from one device, computer, or communication device, to another, can be, or can be included in, a telephone call, a pre-recorded telephone message, or a facsimile transmission.

In any and/or all of the embodiments described herein, any of the herein-described individuals, patients, caregivers, healthcare providers, providers, insurers or payers, third parties, or intermediaries, or any other persons or entities, who or which utilize the apparatus 100 or method of the present invention, if so authorized, can program the apparatus 100 or the central processing computer 10 so as to have any of the herein-described data, information, reports, signals, messages, notification messages, alert messages, report alert messages, news reports, study reports, news of developments pertinent to the healthcare field or healthcare related fields, or any other information described herein as being provided by the apparatus 100, transmitted to he, she, or it, or to a respective computer or communication device used by or associated with he, she, or it, as the respective data, information, report, signal, message, notification message, news report, study report, news of a development pertinent to the healthcare field or healthcare related field, or any other information, is generated by or stored by the apparatus 100 or is made available to the apparatus 100.

In any and/or all of the embodiments described herein, any time a medication, a medicine, or a drug, is prescribed, is being considered as part of a treatment, or is about to be administered, to an individual or a patient, the apparatus 100 or the central processing computer 10, as part of a respective processing of any information regarding same, can determine whether or not the respective medication, medicine, or drug, being considered could result in any adverse drug interaction(s) or any adverse reaction(s) with any other medication, medicine, or drug, the individual or patient may currently be taking, or the apparatus 100 or the central processing computer 10, can determine whether or not the individual or patient is, or may be, allergic to the respective medication, medicine, or drug.

In any and/or all of the embodiments described herein, the apparatus 100 or the central processing computer 10, when processing information for generating any of the treatment reports or treatment plans described herein, can also determine whether or not any respective medication, medicine, or drug, or treatment, being considered could result in any adverse drug interaction(s), adverse reaction(s), or have any other adverse effect, with any other medication, medicine, or drug, or treatment, the individual or patient may currently be taking, may be undergoing, or may have undergone, or the apparatus 100 or the central processing computer 10, can determine whether or not the individual, the patient, or the caregiver, is, or may be, allergic to the respective medication, medicine, or drug, or treatment.

In any and/or all of the embodiments described herein, the apparatus 100 or the central processing computer 10, can also perform drug formulary checks for or regarding any medication, medicine, or drug, for which information may be stored in the database 10H or otherwise processed by the apparatus 100 of the present invention. In any and/or all of the embodiments described herein, the apparatus 100 or the central processing computer 10, can also perform drug formulary checks for or regarding any medication, medicine, or drug, being considered for an individual or patient so as to ensure that same is appropriate for the individual or patient, so as to ensure safety in treatment, or so as to ensure effectiveness in treatment, or for any other appropriate reason.

In any and/or all of the embodiments described herein, the apparatus 100 or the central processing computer 10, can also perform processing routines to effectuate medication, medicine, or drug, reconciliation at any time in or during a treatment, care, or care management, of or for an individual or patient. These medication, medicine, or drug, reconciliation processing routines can be performed continuously during a treatment, a treatment course, a treatment regimen, a treatment duration, or in or during a care setting for an individual or patient, as well as in between treatment or care settings for the individual or patient.

In any and/or all of the embodiments described herein, the information contained in the database 10H, or in the electronic healthcare records, electronic healthcare files, or healthcare histories, contained therein, can include immunization records and information for each individual, as well as other immunization data and/or information. In another preferred embodiment, the apparatus 100, or the central processing computer 10, at any appropriate time, or upon any updating of immunization information, upon an updating of a certain number of immunization records, upon an updating of immunization information for a specified number of individuals or patients, at any pre-specified or pre-selected time, at pre-specified time intervals, upon request by a public health agency or department, upon request by an immunization center or an immunization registry, or upon request by a healthcare provider, a healthcare facility, a hospital, a research center or facility, a payer or insurer, an intermediary, or any person, individual, or entity, can generate an immunization information report and can transmit same to a respective computer or communication device 20, 30, 40, or 50, or any other computer or communication device, associated with or used by the requesting public health agency or department, immunization center or immunization registry, healthcare provider, healthcare facility, hospital, research center or facility, payer or insurer, intermediary, or person, individual, or entity. The central processing computer 10 can also transmit the immunization report to the healthcare records computer 60, to the insurance exchange computer 70, to the social networking computer 80, or to the media computer 90, and the immunization report can be accessed, obtained, or disseminated, by or to any individuals, users, members, or subscribers, of the respective healthcare records computer 60, insurance exchange computer 70, social networking computer 80, or media computer 90.

In this regard, in another preferred embodiment, the apparatus 100 and method of the present invention, and/or the central processing computer 10, can, and/or can be used to, submit or transmit electronic immunization data or information to an immunization center or immunization registry, a healthcare provider, a healthcare facility, a hospital, a research center facility, a payer or an insurer, an intermediary, a person, an individual, or an entity, or any immunization information system.

In another preferred embodiment, as well as any and/or all of the embodiments described herein, the apparatus 100 or the central processing computer 10, can receive and/or process a request, by any healthcare provider, any other provider, an individual, patient, or caregiver, an insurer or a payer, a secondary insurer or a secondary payer, a tertiary or other insurer or payer, or any authorized third party or intermediary, to provide co-payment information and/or deductible information regarding an insurance policy, a healthcare insurance policy, a disability insurance policy, or a life insurance policy, of or for any individual, patient, or caregiver, described herein, or to provide co-payment information and/or deductible information regarding any healthcare insurer or payer or any healthcare insurance policy, payment policy, or plan.

In a preferred embodiment, the apparatus 100 or the central processing computer 10 can process the request and generate a co-payment message or a deductible information message and transmit same the respective computer or communication device 20, 30, 40, or 50, of, associated with, or used by, the requesting healthcare provider, other provider, the individual, patient or caregiver, insurer or payer, secondary insurer or secondary payer, tertiary or other insurer or payer, or authorized third party or intermediary. In another preferred embodiment, any individual, patient, caregiver, insurer or payer, secondary insurer or secondary payer, tertiary or other insurer or payer, or authorized third party or intermediary, can also pay the respective co-payment or deductible via the respective computer or communication device 30, 40, or 50, via the apparatus 100 of the present invention, such as by making or submitting payment to the central processing computer 10 which can receive and/or process the payment for or on behalf of a respective healthcare provider, other provider, or insurer or payer.

In another preferred embodiment, the apparatus 100 and method of the present invention can also be utilized to provide employee benefits information, to allow an individual, a patient, a caregiver, a beneficiary, or any other person or third party, to enroll in an employee benefit or in employee benefits, to submit a claim or claims or to make a request for, or pursuant to, an employee benefit or an insurance policy or payment policy or plan, to take or retain an employee benefit from one employment relationship, job, or position, to another employment relationship, job, or position, or to maintain an employee benefit after leaving an employment relationship, job, or position, or retiring from an employment relationship, job, or position, thereby providing benefits portability, or to post information regarding a need, a requirement, or a desire, for or to obtain, or enroll in, an employee benefit or policy.

In another preferred embodiment, the apparatus 100 and method of the present invention can also be utilized to allow a benefit provider, a benefits provider, or an insurance provider, to provide information to individuals, patients, caregivers, beneficiaries, or any other persons or third parties, of an availability or an offering of a benefit, a policy, an insurance policy, or other policy, plan, or program, being offered by the benefit provider.

In another preferred embodiment, the apparatus 100 and method of the present invention can be used to provide a user, individual, patient, or caregiver, or any other authorized person, with information regarding any employee benefit(s) or employee benefit(s) insurance policies or plans which the user, individual, patient, or caregiver, or other authorized person, may have or be covered under as a beneficiary. In another preferred embodiment, information, links, or hyperlinks, regarding, or providing a link to or hyperlink to, any employee benefit(s), healthcare insurance policy or policies, disability insurance policy or policies, life insurance policy or policies, healthcare payment plan or plans, individual retirement account(s) (IRA(s)), self-employed pension (SEP) account(s), bank account(s), savings account(s), financial account(s), or a vacation time benefit, a personal time benefit, a sick time benefit, a healthcare insurance benefit, a disability insurance benefit, a life insurance benefit, an employee discount benefit, a buying service benefit, a tuition reimbursement benefit, an educational assistance benefit, an in-house training benefit, a child care benefit, a day care program benefit, a stock option benefit, a pension benefit, a retirement benefit, a credit union benefit, an employee stock ownership benefit, a profit sharing benefit, an educational assistance program benefit, a child care program benefit, or any other employee benefit which can be offered to an employee by a respective employer, or any other employee benefit or employee benefits described herein, can be included in the database 10H of the central processing computer 10, and/or in any of the other databases 20H, 30H, 40H, and/or 50H, described herein, and can also be stored and/or maintained in the database 70H of the insurance exchange computer 70.

In another preferred embodiment, information, links, or hyperlinks, regarding, or providing a link to or hyperlink to, any employee benefit or employee benefits, healthcare insurance policy or policies, disability insurance policy or policies, life insurance policy or policies, healthcare payment plan or plans, individual retirement account(s) ((IRA(s)), self-employed pension (SEP) account(s), bank account(s), savings account(s), financial account(s), or any other employee benefit or employee benefits described herein, or any employer(s) or benefits provider(s), can also be included in the electronic healthcare record or electronic healthcare file of each individual, patient, or caregiver, in, stored in, and/or maintained in, the database 10H of the central processing computer 10, in the database 60H of the healthcare records computer 60, or in the database 70H of the insurance exchange computer 70.

The apparatus 100 and method of the present invention can provide the herein-described functionality to employees, independent contractors, temporary workers, freelancers, or any other individuals or users who are provided with, or who maintain for themselves, any employee benefits or any benefits that can or may be offered as an employee benefit.

In another preferred embodiment, the apparatus 100 of the present invention can be utilized by an individual, a patient, or a caregiver, having a electronic healthcare record or a electronic healthcare file stored in the database 10H of the central processing computer 10, to access or obtain information regarding an employee benefit via the apparatus 100, via the central processing computer 10, via the insurance exchange computer 70, or via, or using information, a link, or a hyperlink, contained in or stored in the individual's or the patient's electronic healthcare record or electronic healthcare file.

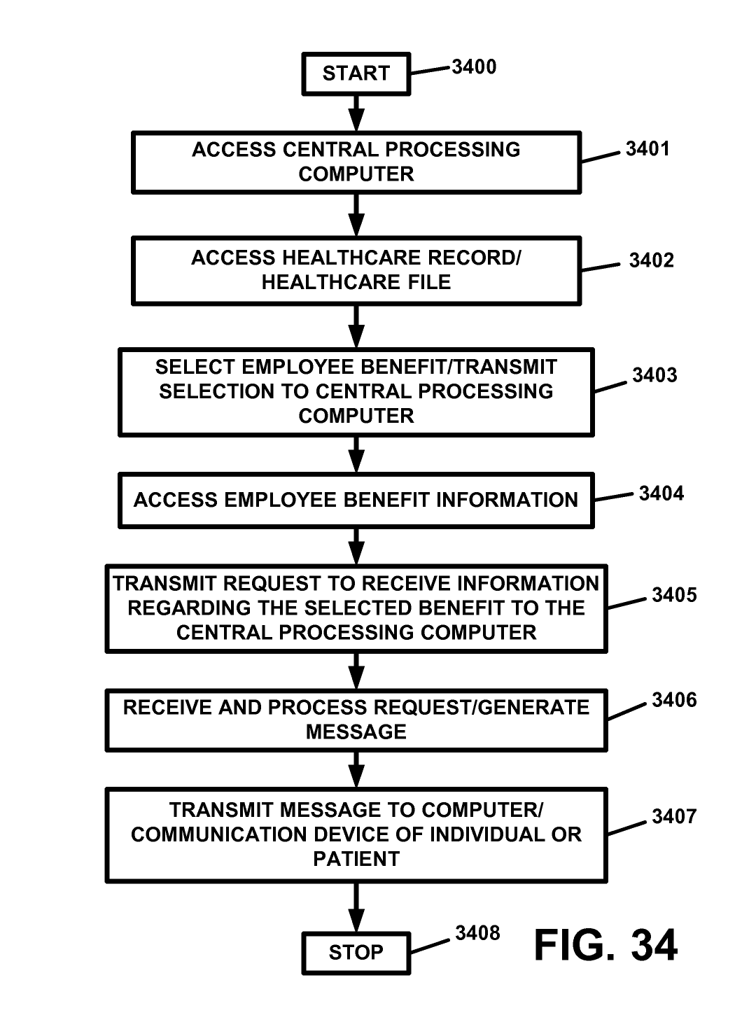

FIG. 34 illustrates, in flow diagram form, another preferred embodiment method for utilizing the apparatus 100 and method of the present invention in order to allow an individual, a patient, or a caregiver, to obtain information regarding one of more employee benefits the individual, the patient, or the caregiver, may have or under which the individual, the patient, or the caregiver, may be a beneficiary.

With reference to FIG. 34, the operation of the apparatus 100 commences at step 3400. At step 3401, the individual, the patient, or the caregiver, can access the central processing computer 10 via his or her user or patient communication device 40. At step 3402, the individual, the patient, or the caregiver, can access his or her electronic healthcare record or electronic healthcare file. At step 3403, the individual, the patient, or the caregiver, can then select the employee benefit for which he or she desires to obtain information, and can transmit information regarding the selection of same to the central processing computer 10. At step 3404, the individual, the patient, or the caregiver, can access the information he or she desires regarding the employee benefit.

At step 3404, the information can be stored in, or can be accessed via, the electronic healthcare record or the electronic healthcare file of the individual, the patient, or the caregiver, or the information can be accessed via a link(s) or a hyperlink(s) to the information, or via a link(s) or a hyperlink(s) to a respective computer or communication device 20, 30, or 50, associated with or used by the benefit provider of the employee benefit, which link(s) or hyperlink(s) can be stored in the electronic healthcare record or electronic healthcare file of the individual, the patient, or the caregiver. In another preferred embodiment, the information can be accessed via a link(s) or a hyperlink(s) to information stored or maintained, or which can be accessed via, the insurance exchange computer 70, which link(s) or hyperlink(s) can also be stored in the electronic healthcare record or electronic healthcare file of the individual, the patient, or the caregiver.

In a preferred embodiment, the benefit provider, if such benefit provider is a provider of goods or services, including, but not limited to, healthcare goods, products, or services or any other type or kind of goods, products, or services, can also use or have associated therewith a provider computer or provider communication device 20. In another preferred embodiment, the benefit provider, if the benefit provider is an insurer or a payer, can use or have associated therewith an insurer or payer communication device 30. In another preferred embodiment, the benefit provider, if a third party or an intermediary, can also use or have associated therewith an intermediary communication device 50.

In another preferred embodiment, as well as any and/or all of the embodiments described herein, a link(s) or a hyperlink(s) to any of the benefits providers described herein, or any of their respective computers or communication devices 20, 30, or 50, or other computers or communication devices, can also be stored in the database 10H or in any of the other databases 20H, 30H, 40H, 50H, or 70H, or in any other database(s).

At step 3405, the individual, the patient, or the caregiver, can transmit, to the central processing computer 10 or to the computer or communication device associated with the respective benefit provider, a request to obtain or receive the information which he or she desires regarding the selected employee benefit. At step 3406, the central processing 10, or the computer or communication device associated with the benefit provider, can receive and/or process the request and can generate a message containing the requested information or containing information regarding the requested information or a response to the request. At step 3407, the central processing 10, or the computer or communication device associated with the benefit provider, can then transmit the message to the user or patient communication device 40. At step 3407, the individual, the patient, or the caregiver, can then review the information requested or any other information contained in the message. Thereafter, the operation of the apparatus 100 will cease at step 3408.

In another preferred embodiment, the central processing computer 10 can also record and/or store, in the individual's or the patient's electronic healthcare record or electronic healthcare file, or in the database 10H, or in the database 70H of the insurance exchange computer 70, any information regarding the individual's or the patient's request for information and/or the information provided in response thereto or the information contained in the message.

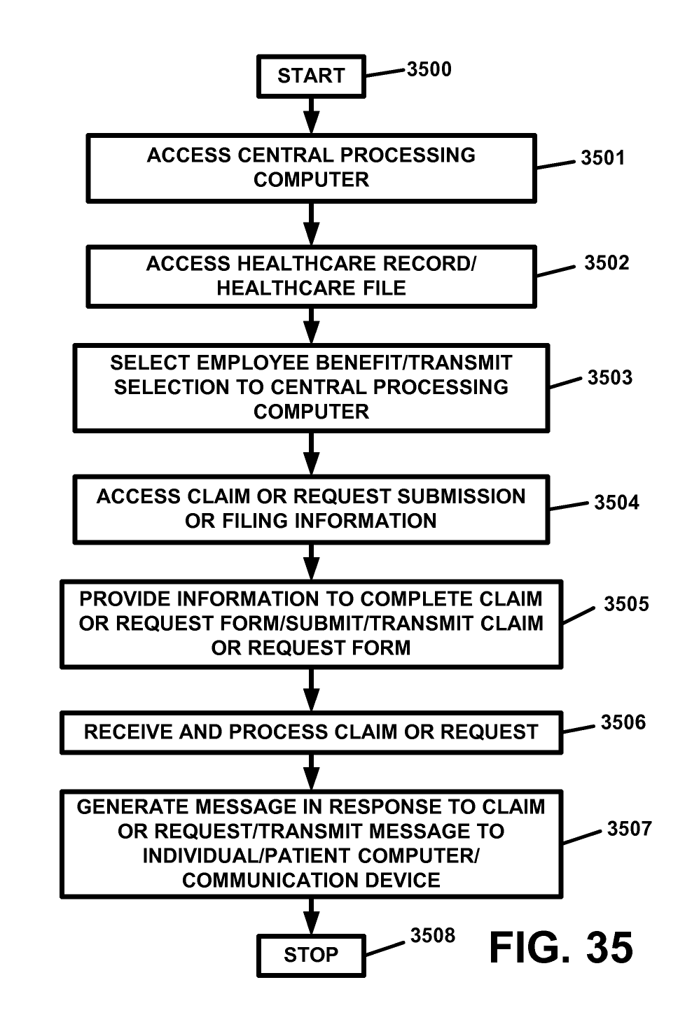

In another preferred embodiment, the apparatus 100 of the present invention can be utilized by an individual, a patient, or a caregiver having a electronic healthcare record or a electronic healthcare file stored in the database 10H of the central processing computer 10, to submit or to file a claim for, or a request for, or pursuant to, an employee benefit, via the apparatus 100, via the central processing computer 10, or via, or using information, a link, or a hyperlink, contained in or stored in the individual's, the patient's, or the caregiver's, electronic healthcare record or electronic healthcare file. FIG. 35 illustrates, in flow diagram form, another preferred embodiment method for utilizing the apparatus 100 and method of the present invention in order to allow an individual, a patient, or a caregiver, to submit or to file a claim or a request for, or pursuant to, an employee benefit, via the apparatus 100, via the central processing computer 10, or via, or using information, a link, or a hyperlink, contained in, or stored in, the individual's, the patient's, or the caregiver's, electronic healthcare record or electronic healthcare file.

With reference to FIG. 35, the operation of the apparatus 100 commences at step 3500. At step 3501, the individual, the patient, or the caregiver, can access the central processing computer 10 via his or her user or patient communication device 40. At step 3502, the individual, the patient, or the caregiver, can access his or her electronic healthcare record or electronic healthcare file. At step 3503, the individual, the patient, or the caregiver, can then select the employee benefit for which, or pursuant to which, he or she desires to submit or file a claim or request. At step 3503, the individual, the patient, or the caregiver, can transmit information regarding the selection to the central processing computer 10. At step 3504, the individual, the patient, or the caregiver, can then access the claim submission or filing information, or the request submission or filing information, he or she desires regarding the employee benefit.

At step 3504, the claim submission or filing information, or the request submission or filing information, can be stored in, or can be accessed via, the electronic healthcare record or the electronic healthcare file of the individual, the patient, or the caregiver, or the respective information can be accessed via a link or a hyperlink to the claim submission or filing information, or to the request submission or filing information, or can be accessed via a link or a hyperlink to a provider communication device 20, an insurer or payer communication device 30, an intermediary communication device 50, associated with the benefit provider of the employee benefit. The respective information can also be accessed, in another preferred embodiment, via or from the healthcare records computer 60 or the insurance exchange computer 70. Any of the above-described information, link(s), or hyperlink(s), can be stored in the electronic healthcare record or electronic healthcare file of the individual, the patient, or the caregiver which can be stored in the database 10H of the central processing computer 10 and/or in the electronic healthcare record or electronic healthcare file of the individual, the patient, or the caregiver which can be stored in the database 60H of the healthcare records computer 60.

In another preferred embodiment, the benefit provider, if a provider of goods, products, or services, including, but not limited to, healthcare goods, products, or services as well as any other type or kind of goods, products, or services, can also use or have associated therewith a provider communication device 20. In another preferred embodiment, the benefit provider, if an insurer or a payer, can use or have associated therewith an insurer or payer communication device 30. In another preferred embodiment, the benefit provider, if a third party or an intermediary, can also use or have associated therewith an intermediary communication device 50.

In another preferred embodiment, as well as any and/or all of the embodiments described herein, a link(s) or a hyperlink(s) to any of the benefits providers described herein, or to any of their respective computers or communication devices 20, 30, or 50, or other computers or communication devices, can also be stored in the database 10H or in any of the other databases 20H, 30H, 40H, or 50H, or in any other database(s).

At step 3505, the individual, the patient, or the caregiver, can provide or can fill in, or complete, any necessary form(s), claims form(s), request form(s), or can provide any other needed or required data and/or information via any other information vehicle, using his or her user or patient communication device 40, and can then submit or file the respective claim or request, for, or pursuant to, the employee benefit, by transmitting the completed form(s), claims form(s), request form(s), or other needed or required information, to the central processing computer 10 or to the computer or communication device associated with the respective benefit provider. At step 3506, the central processing 10, or the computer or communication device associated with the benefit provider, can receive the claim or the request and can then process any information contained in the completed form(s), claims form(s), or request form(s), or other information and/or can process any other provided or submitted information.

At step 3506, the central processing 10, or the computer or communication device associated with the benefit provider, can process the claim or the request for, or pursuant to, the employee benefit, or any information associated with the claim or the request for, or pursuant to, the employee benefit, such as by processing any information contained in the completed form(s), claims form(s), request form(s), or by processing any other provided information, submitted by, or filed by, the individual, the patient, or the caregiver, at step 3505.

At step 3507, the central processing 10, or the computer or communication device associated with the benefit provider, can generate a message in response to the claim or the request for, or pursuant to, the employee benefit. The message generated by the central processing 10, or by the computer or communication device associated with the benefit provider, can contain information regarding a confirmation that the claim or the request, or other information, for, or pursuant to, the employee benefit has been received by the benefit provider of the employee benefit, that the claim or the request is allowed or will be allowed, that a benefit or a payment in response to the claim or the request will be provided, that a payment has been made, or will be made, to a financial account, a savings account, a checking account, a benefits spending account, a healthcare spending account, or any other employee benefit financial account, of or associated with the individual, the patient, or the caregiver, that the claim or the request is denied or disallowed or will be denied or disallowed, that a benefit or a payment in response to the claim or the request will not be provided, or that more information is needed from the individual, the patient, or the caregiver, or that a response to the claim or the request will be forthcoming.

At step 3507, the central processing 10, or the computer or communication device associated with the benefit provider, can then transmit the message to the user or patient communication device 40. At step 3507, the individual, the patient, or the caregiver, can then review the information contained in the message. Thereafter, the operation of the apparatus 100 will cease at step 3508.

In another preferred embodiment, the central processing computer 10 can record and/or store, in the individual's, the patient's, or the caregiver's, electronic healthcare record or electronic healthcare file, or in the database 10H of the central processing computer 10, any information regarding the individual's or the patient's claim or request, and/or the submission, transmission, or filing, of same, for, or pursuant to, the employee benefit, the completed form(s), claims form(s), request form(s), or any other needed or required information, or any information, which was submitted pertaining to the claim or the request, a response to the claim or the request, the message, or any information contained in the message. In another preferred embodiment, the information regarding the individual's or the patient's claim or request, and/or the submission, transmission, or filing, of same, for, or pursuant to, the employee benefit, the completed form(s), claims form(s), request form(s), or any other needed or required information, or any information, which was submitted pertaining to the claim or the request, a response to the claim or the request, the message, or any information contained in the message, can be transmitted to a provider communication device 20 of or associated with any provider of the individual, patient, or caregiver, to any insurer or payer communication device 30 of or associated with any insurer or payer of the individual, patient, or caregiver, to an intermediary communication device 50 of or associated with any intermediary or third party who may be authorized to receive same, to the healthcare records computer 60 for storage in the individual's, the patient's, or the caregiver's, electronic healthcare record or electronic healthcare file, or in the database 60H of same, and/or to the insurance exchange computer 70.

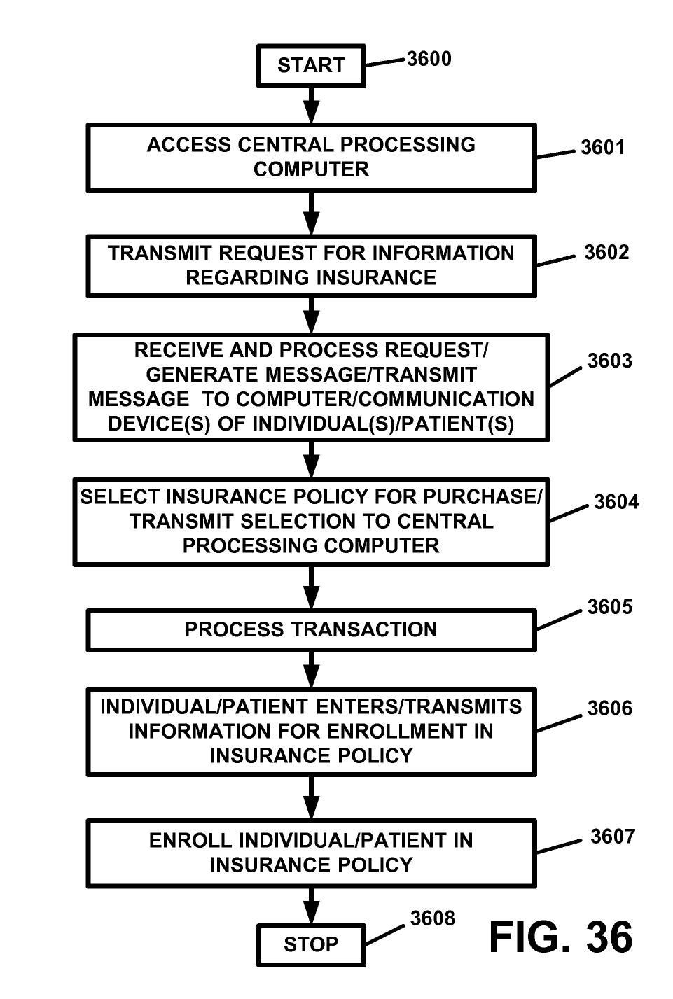

In another preferred embodiment, the present invention can be utilized as, and/or as a platform for, an insurance exchange in order to provide a venue by which to allow insurers or payers to sell healthcare insurance, disability insurance, life insurance, automobile insurance, homeowner's insurance, property or casualty insurance, or any other insurance policy, payer policy, payer program, or payer plan. FIG. 36 illustrates, in flow diagram form, another preferred embodiment method for utilizing the apparatus 100 and method of the present invention in order to allow insurers or payers to sell healthcare insurance, disability insurance, life insurance, automobile insurance, homeowner's insurance, property or casualty insurance, or any other insurance policy, payer policy, payer program, or payer plan, via the apparatus 100, the central processing computer 10, the insurance exchange computer 70, or any computer or communication device used by an insurer, a payer, a provider, or any other intermediary. In the preferred embodiment of FIG. 36, the apparatus 100 of the present invention can also be utilized by any provider of any type or kind of good, product, or service, to sell its respective goods, products, or services, via the apparatus 100. It is important to note that, while the embodiment of FIG. 36 is described and illustrated as being utilized in order to sell insurance, it can also be utilized in a same, a similar, or an analogous, manner in order to sell any type or kind of good, product, or service, which can be healthcare or healthcare-related goods, products, or services, or non-healthcare or non-healthcare-related goods, products, or services, or any other goods, products, or services, which can be the subject of commerce.

With reference to FIG. 36, the operation of the apparatus 100 commences at step 3600. At step 3601, the individual, the patient, or the caregiver, can access the central processing computer 10 via his or her user or patient communication device 40. At step 3602, the individual, the patient, or the caregiver, can enter and transmit, to the central processing computer 10, a request to receive information regarding the insurance policy, plan, product, service, or program, which he or she desires to purchase. For example, an individual desiring to purchase healthcare insurance can request to receive information regarding the various healthcare insurance policies or other payer policies, programs, or plans, which are offered by the various insurers or payers, or employee benefits providers, who or which use the apparatus 100 of the present invention to sell their respective healthcare insurance policies or other payer policies, programs, or plans, or which healthcare insurance policies or other payer policies, programs, or plans, are made available for purchase via the apparatus 100 of the present invention.

In this regard, in a preferred embodiment, any number of insurers or payers, or benefits providers, can offer their healthcare insurance policies, plans, products, services, or programs, for sale via the apparatus 100 of the present invention in order to create a healthcare insurance exchange or an insurance exchange for selling insurance policies, plans, products, services, or programs of any kind or type. In another preferred embodiment, the individual, patient, or caregiver, can link to, hyperlink to, or access, the insurance exchange computer 70 either via the central processing computer 10 and/or the individual's, patient's, or caregiver's, electronic healthcare record which is stored in the database 10H of the central processing computer 10. In a preferred embodiment, the individual's, patient's, or caregiver's, electronic healthcare record an also contain a link(s) or a hyperlink(s) to the insurance exchange computer 70.

It is important to note that, although the apparatus 100 of the present invention of the embodiment of FIG. 36 is described and illustrated as being used as an insurance exchange for selling healthcare insurance, the apparatus 100 can also be utilized in a same, a similar, or an analogous, manner in order to create an exchange for selling disability insurance, life insurance, automobile insurance, homeowner's insurance, property or casualty insurance, or any other insurance policy, payer policy, payer program, or payer plan, or any type or kind of goods, products, or services, which can be healthcare or healthcare-related goods, products, or services, or non-healthcare or non-healthcare-related goods, products, or services, or any other goods, products, or services, which can be the subject of commerce.

In another preferred embodiment, at step 3602, the individual, the patient, or the caregiver, can also include, in his or her request, any specific needs or requirements he or she has for the healthcare insurance policy, plan, product, service, or program, he or she is seeking to purchase. In a preferred embodiment, the request can be transmitted to and received at the central processing computer and/or at the insurance exchange computer 70.

At step 3603, the central processing computer 10, or the insurance exchange computer 70, can process the request and can generate information or generate a message containing information regarding one or more healthcare insurance policies which are available for sale. At step 3603, the message can be transmitted from the central processing computer 10, or from the insurance exchange computer 70, to the user or patient communication device 40 associated with or used by the individual, the patient, or the caregiver. At step 3604, the individual, the patient, or the caregiver, can select the healthcare insurance policy he or she desires to purchase and can transmit his or her selection to the central processing computer 10 and/or to the insurance exchange computer 70. In a preferred embodiment, the selection can also be transmitted to the insurance exchange computer 70 either via the central processing computer or directly from the user of patient communication device 40.

At step 3605, the central processing computer 10 or the insurance exchange computer 70 can either process the transaction involving the individual's, the patient's, or the caregiver's, purchase of the selected healthcare insurance policy or the central processing computer 10 or the insurance exchange computer 70 can forward the individual, the patient, or the caregiver, to the insurer or payer communication device 30 which is associated with or used by the insurer or the payer whose healthcare insurance policy, plan, product, service, or program, the individual, the patient, or the caregiver, is purchasing.

At step 3606, the individual, the patient, or the caregiver, can then enter any needed or required information for enrolling the individual, the patient, or the caregiver, and any dependents or other beneficiaries of the individual, the patient, or the caregiver, if applicable, in the healthcare insurance policy, plan, product, service, or program. At step 3606, the information for enrolling the individual, the patient, or the caregiver, and any dependents or other beneficiaries of the individual, the patient, or the caregiver, if applicable, in the healthcare insurance policy, plan, product, service, or program, can also be transmitted to and received at the central processing computer 10, to the insurance exchange computer 70 and/or, if applicable, can also be transmitted or forwarded to insurer or payer communication device 30 which is associated with the insurer or payer whose healthcare insurance policy, plan, product, service, or program, the individual, the patient, or the caregiver, is purchasing. In another preferred embodiment, the central processing computer 10 can be programmed to automatically access and/or query the database 10H or the electronic healthcare record or the electronic healthcare file of the individual, the patient, or the caregiver, and automatically collect any and/or all needed information for enrolling the individual, the patient, or the caregiver, and any dependents or other beneficiaries of the individual, the patient, or the caregiver, if applicable, in the healthcare insurance policy, plan, product, service, or program. In another preferred embodiment, the central processing computer 10 can be programmed to enroll the individual, the patient, or the caregiver, and any dependents or other beneficiaries of the individual, the patient, or the caregiver, if applicable, in the healthcare insurance policy, plan, product, service, or program, automatically.

In another preferred embodiment, the insurance exchange computer 70 and/or the insurer or payer communication device 30 can also be programmed to automatically access and/or query the database 10H or the electronic healthcare record or the electronic healthcare file of the individual, the patient, or the caregiver, and automatically collect any and/or all needed information for enrolling the individual, the patient, or the caregiver, and any dependents or other beneficiaries of the individual, the patient, or the caregiver, if applicable, in the healthcare insurance policy, plan, product, service, or program. In another preferred embodiment, the insurance exchange computer 70 and/or the insurer or payer communication device 30 can also be programmed to enroll the individual, the patient, or the caregiver, and any dependents or other beneficiaries of the individual, the patient, or the caregiver, if applicable, in the healthcare insurance policy, plan, product, service, or program, automatically.

At step 3607, the central processing computer 10, the insurance exchange computer 70, or the insurer or payer communication device 30 which is associated with the insurer or the payer, can process the information and enroll the individual, the patient, or the caregiver, and any dependents or other beneficiaries of the individual, the patient, or the caregiver, if applicable, in the healthcare insurance policy, plan, product, service, or program. In another preferred embodiment, at step 3607, the central processing computer 10, the insurance exchange computer 70, or the computer or communication device 30 which is associated with the insurer or the payer, can be programmed to automatically enroll the individual, the patient, or the caregiver, and any dependents or other beneficiaries of the individual, the patient, or the caregiver, if applicable, in the healthcare insurance policy, plan, product, service, or program.

At step 3607, the central processing computer 10, the insurance exchange computer 70, or the computer or communication device 30 which is associated with the insurer or the payer, can also process any payment, by or on behalf of the individual, the patient, or the caregiver, for the healthcare insurance policy, plan, product, service, or program. In a situation where the individual, the patient, or the caregiver, is paying for the healthcare insurance policy, plan, product, service, or program, the individual, the patient, or the caregiver, can make payment in any appropriate manner, such as, for example, by a credit card payment, by a debit card payment, by an electronic bill payment process or operation, by an electronic funds transfer, by payment from an benefits account, from an employee benefits account, from a cafeteria plan and/or account, or from a healthcare spending account, or by or in any other appropriate manner. In a situation where the healthcare insurance policy, plan, product, service, or program, is to be paid for by a third party, such as, for example, by an employer of the individual, the patient, or the caregiver, as part of an employee benefits package, or by any person, entity, or any third party, the individual, the patient, or the caregiver can provide any needed information identifying the respective employer, or the respective person, entity, to third party, and the payment for the healthcare insurance policy, plan, product, service, or program can be effected from a financial account associated with that employer, or from a financial account associated with that person, entity, or third party, using information stored regarding that employer, or that person, entity, or third party, or any financial account associated with same.

The central processing computer 10 can also, at step 3607, then record and/or store, in the individual's, the patient's, or the caregiver's, electronic healthcare record or electronic healthcare file, or in the database 10H of the central processing computer 10 any information regarding the healthcare insurance policy, plan, product, service, or program, purchased by of for the individual, the patient, or the caregiver. The information regarding the healthcare insurance policy, plan, product, service, or program, stored in the individual's, the patient's, or the caregiver's, electronic healthcare record or electronic healthcare file, can also contain a link(s) or hyperlink(s) to the insurer or payer communication device 30 and/or to the insurance exchange computer 70. At step 3607, each of the central processing computer 10, the insurer or payer communication device 30, and/or the insurance exchange computer 70, can also record and/or store any information regarding the healthcare insurance policy, plan, product, service, or program, purchased by of for the individual, the patient, or the caregiver. At step 3607, any information regarding the healthcare insurance policy, plan, product, service, or program, purchased by of for the individual, the patient, or the caregiver, can also be stored in the user or patient communication device 40 associated with or used by the individual, the patient, or the caregiver, and/or in the database 40H of same. Thereafter, the operation of the apparatus 100 will cease at step 3608.

In another preferred embodiment, the apparatus 100 of the embodiment of FIG. 36 can also be utilized in a same, a similar, or an analogous, manner in order to allow an individual, a patient, or a caregiver, to purchase and/or enroll in a supplemental healthcare insurance policy, plan, product, service, or program, or to purchase an upgrade to or for a current healthcare insurance policy, plan, product, service, or program. In another preferred embodiment, the apparatus 100 of the embodiment of FIG. 36 can also be utilized in a same, a similar, or an analogous, manner in order to allow an individual, a patient, or a caregiver, to purchase and/or enroll in a supplemental healthcare insurance policy, plan, product, service, or program, or to purchase an upgrade to or for a current disability insurance policy, plan, product, service, or program, a life insurance policy, plan, product, service, or program, an automobile insurance policy, plan, product, service, or program, a homeowner's insurance policy, plan, product, service, or program, a property or casualty insurance policy, plan, product, service, or program, or any other insurance policy, plan, product, service, or program, payer policy, plan, product, service, or program, any payer program, or any payer plan. Any and/or all information regarding any such insurance purchases and/or enrollments made or effectuated can be stored in the individual's, the patient's, or the caregiver's, electronic healthcare record and can be stored in the database 10H of the central processing computer 10, in the database 40H of the user or patient communication device 40 associated with or used by the respective individual, patient, or caregiver, in the database 30H of the insurer or payer communication device 30 associated with or used by the respective insurer or payer selling the respective policy, plan, product, service, or program, or in the database 70H of the insurance exchange computer 70.

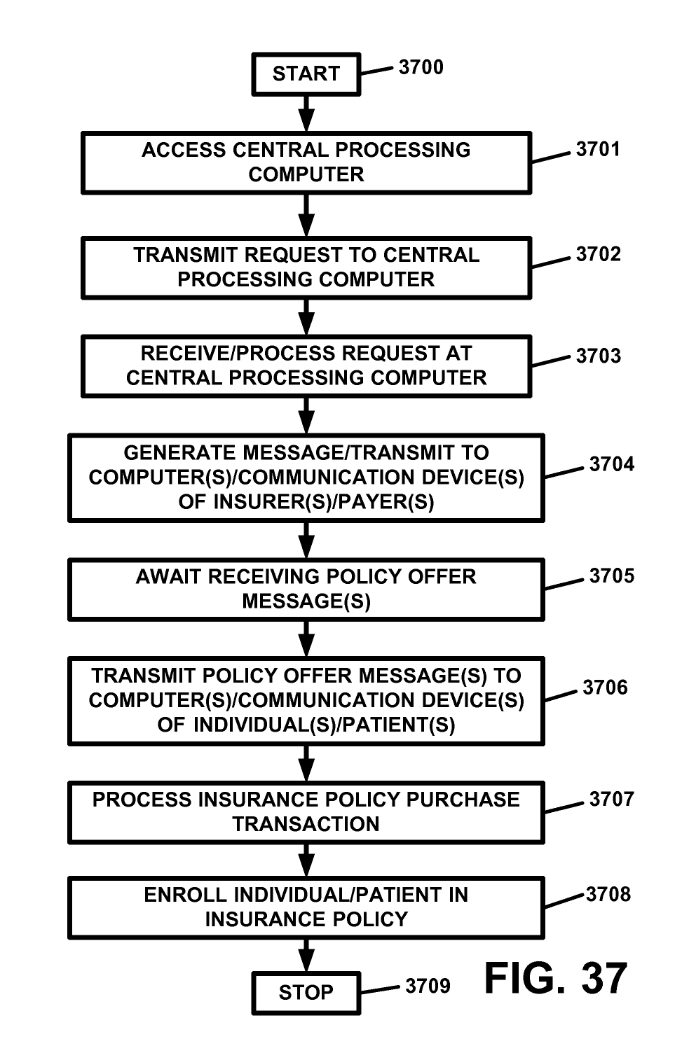

In another preferred embodiment, the apparatus 100 of the present invention can be utilized in order to allow an individual or a patient, or a caregiver for the individual or the patient, to post with the apparatus 100 a request for an insurance policy, his or her requirement(s) for an insurance policy, or his or her need for an insurance policy. The insurance policy can be a policy for healthcare insurance, disability insurance, life insurance, automobile insurance, homeowner's insurance, property or casualty insurance, or any other insurance policy, payer policy, payer program, or payer plan. FIG. 37 illustrates, in flow diagram form, another preferred embodiment method for utilizing the apparatus 100 and method of the present invention in order to allow an individual or a patient, or a caregiver, to post a request for an insurance policy, his or her requirement for an insurance policy, or his or her need for an insurance policy.

In a preferred embodiment, the apparatus 100 can provide information regarding the individual's or the patient's posting of the request for an insurance policy, information contained in the request, or the requirement for an insurance policy, or the need for an insurance policy, to any number of insurers or payers, or to any number of brokers of insurance. Thereafter, any insurer or payer, or any broker, can offer the individual, the patient, or the caregiver, an insurance policy fitting or matching the individual's, the patient's, or the caregiver's, request, request criteria, requirements, or needs, via the apparatus 100. If the individual, the patient, or the caregiver, decides to purchase the offered insurance policy, he or she can do so via the apparatus 100 and can be enrolled in the insurance policy via the apparatus 100.

In the description of the preferred embodiment of FIG. 37, the operation of the apparatus 100 is described as being utilized in connection with selling healthcare insurance. It is, however, important to note that the embodiment of FIG. 37 can also be utilized in a same, a similar, or an analogous, manner in connection with selling disability insurance, life insurance, automobile insurance, homeowner's insurance, property or casualty insurance, or any other insurance policy, payer policy, payer program, or payer plan. In a preferred embodiment, any number of insurers or payers can offer their respective healthcare insurance policies, plans, or programs, or other insurance policies, plans, or programs, for sale via the apparatus 100 and method of the present invention. In another preferred embodiment of FIG. 37, the apparatus 100 can also be utilized in a same, a similar, or an analogous, manner in order to sell any type or kind of goods, products, or services, which can be healthcare-related goods, products, or services, or non-healthcare-related goods, products, or services, wellness or wellness goods, products, or services, fitness or fitness-related goods, products, or services, or any other goods, products, or services, which can be the subject of commerce.

With reference to FIG. 37, the operation of the apparatus 100 commences at step 3700. At step 3701, the individual, the patient, or the caregiver, can access the central processing computer 10 via his or her user or patient communication device 40. At step 3702, the individual, the patient, or the caregiver, can enter and transmit, to the central processing computer 10, a request for a healthcare insurance policy, information regarding his or her requirement for a healthcare insurance policy, or information regarding his or her need for a healthcare insurance policy. At step 3703, the central processing computer 10 can receive and/or process the information regarding the individual's, the patient's, or the caregiver's, request for a healthcare insurance policy, the information regarding his or her requirement for a healthcare insurance policy, or the information regarding his or her need for a healthcare insurance policy. At step 3704, the central processing computer 10 can generate a message containing information regarding the individual's, the patient's, or the caregiver's, request for a healthcare insurance policy, information regarding his or her requirement for a healthcare insurance policy, or information regarding his or her need for a healthcare insurance policy. At step 3704, the central processing computer 10 can transmit the message to the insurer or payer communication device 30, or to any other computer or communication device, associated with or used by each of any number of insurers or payers who or which have indicated an interest in receiving same and in selling healthcare insurance pursuant to this preferred embodiment via the apparatus 100.

At step 3705, the operation of the apparatus 100, or the central processing computer 10, will await the receiving of offers, each in an policy offer message, of and/or from healthcare insurance policies from each of any of the insurers or the payers who or which have a healthcare insurance policy to offer the individual, the patient, or the caregiver. At step 3706, any policy offer message, containing an offer to sell a healthcare insurance policy, and details regarding same, along with a link or hyperlink to the apparatus 100, to the central processing computer 10, or to the computer or communication device 30 associated with the insurer or the payer offering the respective healthcare insurance policy, can be transmitted to the user's or patient's computer or communication device 40 associated with the individual, the patient, or the caregiver. The policy offer message(s) can also, at step 3706, be transmitted to and stored at each of the central processing computer 10 in the database 10H of same, the healthcare records computer 60 in the database 60H of same, the insurance exchange computer 70 in the database 70H of same, the social networking computer 80 in the database 80H, and/or in the media computer 90 in the database 90H of same. In another preferred embodiment, the policy offer message can be provided, upon request, upon access, or as an advertisement, to any users, individuals, patients, caregivers, providers, insurers or payers, or intermediaries, or any other users, members or subscribers of, and/or who access, the central processing computer 10, the healthcare records computer 60, the insurance exchange computer 70, the social networking computer 80, and/or in the media computer 90.

At step 3707, the individual, the patient, or the caregiver, can review any of the offers contained in any of the policy offer messages, or any number of the offers and, if the individual, the patient, or the caregiver, desires to purchase a healthcare insurance policy, the individual, the patient, or the caregiver can utilize the user or patient communication device 40, or any other computer or communication device, in order to access or link to the respective central processing computer 10, or to the respective computer or communication device 30 associated with the insurer or the payer offering the healthcare insurance policy, and can purchase the healthcare insurance policy.

At step 3708, the central processing computer 10, or the computer or communication device 30 associated with the insurer or the payer, whichever the case may be, can then process the transaction involving the individual's or the patient's, or the caregiver's, purchase of the healthcare insurance policy. At step 3708, the individual, the patient, or the caregiver, can enter any needed or required information for enrolling the individual or patient, and any dependents or other beneficiaries of the individual, the patient, or the caregiver, if applicable, in the healthcare insurance policy. At step 3708, any information for enrolling the individual, the patient, or the caregiver, and any dependents or other beneficiaries of the individual, the patient, or the caregiver, if applicable, in the healthcare insurance policy can also be transmitted to and received at the respective central processing computer 10 or the computer or communication device 30 associated with the insurer or the payer.

At step 3708, the central processing computer 10, or the computer or insurer or payer communication device 30 which is associated with the insurer or the payer, can process the information and enroll the individual, the patient, or the caregiver, and any dependents or other beneficiaries of the individual, the patient, or the caregiver, if applicable, in the healthcare insurance policy. In another preferred embodiment, at step 3708, the central processing computer 10, or the computer or communication device 30 associated with the insurer or the payer, can also be programmed to automatically enroll the individual, the patient, or the caregiver, and any dependents or other beneficiaries of the individual, the patient, or the caregiver, if applicable, in the healthcare insurance policy.

In another preferred embodiment, the central processing computer 10, or the computer or insurer or payer communication device 30 associated with the insurer or the payer, can also be programmed to automatically query the database 10H or the electronic healthcare record or the electronic healthcare file of the individual, patient, or caregiver, and collect, obtain, and/or utilize, any or all needed information for enrolling the individual, the patient, or the caregiver, and any dependents or other beneficiaries of the individual, the patient, or the caregiver, if applicable, in the healthcare insurance policy. In a preferred embodiment, the electronic healthcare record can contain any and all data and/or information for automatically enrolling the individual, the patient, or the caregiver, and any dependents or other beneficiaries of the individual, the patient, or the caregiver, if applicable, in the healthcare insurance policy. In a preferred embodiment, enrollment in the healthcare insurance policy can be performed automatically with and by the central processing computer 10 by the central processing computer 10 automatically obtaining any data and/or information needed for the reenrollment from the individual's, the patient's, or the caregiver's electronic healthcare record, automatically completing and generating an y needed enrollment forms, and transmitting or submitting any data and/or information or enrollment forms to the insurer or payer communication device 30. In another preferred embodiment, enrollment in the healthcare insurance policy can be performed automatically with and by the insurer or payer communication device 30 by the insurer or payer communication device 30 automatically obtaining any data and/or information needed for the reenrollment from the individual's, the patient's, or the caregiver's electronic healthcare record from the central processing computer 10, and by automatically completing and generating any needed enrollment forms and storing same in the insurer or payer communication device 30 or in the database 30H of same.

In a preferred embodiment, data and/or information, which can be date-stamped and/or time-stamped, regarding any enrollment, including any enrollment forms and/or any other data and/or information used in generating the enrollment forms or processing the enrollment, which can also can be stored, at step 3708, in each of the individual's, the patient's, or the caregiver's, electronic healthcare record in the database 10H of the central processing computer 10, in the individual's, the patient's, or the caregiver's, electronic healthcare record in the database 60H of the healthcare records computer 10, in the individual's, the patient's, or the caregiver's, electronic healthcare record in the database 70H of the insurance exchange computer, and/or in the in the individual's, the patient's, or the caregiver's, electronic healthcare record in the database 30H of the insurer or payer communication device 30.

At step 3708, the central processing computer 10, or the computer or insurer or payer communication device 30 which is associated with the insurer or payer, can also process any payment by or on behalf of the individual, the patient, or the caregiver. In an situation where the individual, the patient, or the caregiver, is paying for the healthcare insurance policy, the individual, the patient, or the caregiver, can make payment in any appropriate manner, such as, for example, by a credit card payment, by a debit card payment, by an electronic bill payment process or operation, by an electronic funds transfer, by or from a healthcare spending account, an employee benefits account, an employee benefits spending account, an employee benefits cafeteria account, or by or in any other appropriate manner.

In a situation where the healthcare insurance policy is to be paid for by a third party, such as, for example, by an employer of the individual, the patient, or the caregiver, as part of an employee benefits package, or by any person, entity, or third party, the individual, the patient, or the caregiver, can provide any needed information identifying the employer, or the person, entity, or third party, and/or the account of the account information, and payment can be effected from a financial account associated with that employer, or from a financial account associated with that person, entity, or third party, using information stored regarding that employer, or that person, entity, or third party, the account, or any respective financial account associated with same.

The central processing computer 10 can then record and/or store, in the individual's, the patient's, or the caregiver's electronic healthcare record or electronic healthcare file, or in the database 10H, any information regarding the healthcare insurance or the healthcare insurance policy purchased by or for the individual, the patient, or the caregiver, the enrollment in same, and/or the payment or any payments regarding same. Thereafter, the operation of the apparatus 100 will cease at step 3709.

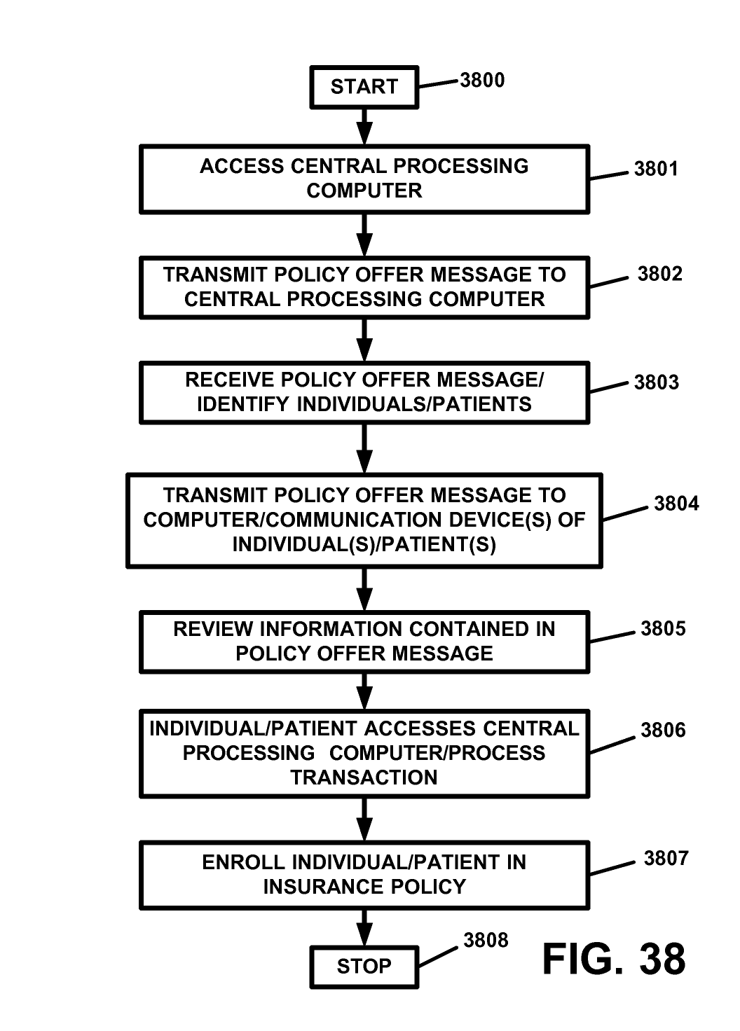

In another preferred embodiment, the present invention can be utilized in order to allow an insurer, a payer, a healthcare provider, or a provider of any goods, products, or services, to offer, and/or to transmit messages offering, their respective insurance policies, payment policies, payment plans, payment programs, benefits, benefits packages, or any other goods, products, or services, to any number of the herein-described individuals, patients, or caregivers for any individuals or patients, who utilize the apparatus 100 of the present invention. Any of the insurance policies offered via this embodiment can be a policy for healthcare insurance, disability insurance, life insurance, automobile insurance, homeowner's insurance, property or casualty insurance, or any other insurance policy, payer policy, payer program, or payer plan. FIG. 38 illustrates, in flow diagram form, another preferred embodiment method for utilizing the apparatus 100 and method of the present invention in order to allow an insurer, a payer, a healthcare provider, or a provider of any goods, products, or services, to offer, and/or to transmit messages offering, their respective insurance policies, payment policies, payment plans, payment programs, benefits, benefits packages, or any other goods, products, or services, to any number of the herein-described individuals, patients, or caregivers, who utilize the apparatus 100 of the present invention. Thereafter, an individual, patient, or caregiver, can purchase a respective insurance policy, payment policy, payment plan, payment program, benefits, benefits package, or any other good, product, or service, offered by the respective insurer, a payer, a healthcare provider, or provider.

In the description of the preferred embodiment of FIG. 38, the operation of the apparatus 100 is described as being utilized in connection with selling a healthcare insurance policy. It is, however, important to note that the embodiment of FIG. 38 can also be utilized in a same, a similar, or an analogous, manner in connection with selling disability insurance, life insurance, automobile insurance, homeowner's insurance, property or casualty insurance, or any other insurance policy, payer policy, payer program, or payer plan, or in connection with selling any good, product, or service. In another preferred embodiment, any number of insurers or payers, or any number, types, or kinds, of providers, can offer their respective healthcare insurance policies, plans, or programs, disability insurance policies, plans, or programs, life insurance policies, plans, or programs, automobile insurance policies, plans, or programs, homeowner's insurance policies, plans, or programs, property or casualty insurance policies, plans, or programs, or any other insurance, policies, plans, or programs, payer policies, payer programs, payer plans, or any goods, products, or services, for sale via the apparatus 100 of the present invention. In another preferred embodiment of FIG. 38, the apparatus 100 can also be utilized in a same, a similar, or an analogous, manner in order to sell any type or kind of good, product, or service, which can be healthcare-related goods, products, or services, or non-healthcare-related goods, products, or services, wellness or wellness-related goods, products, or services, fitness or fitness-related goods, products, or services or any other goods, products, or services, which can be the subject of commerce.

In another preferred embodiment, any information regarding, a link(s) to, or a hyperlink(s) to, to any of these providers, information regarding any good(s), product(s), or service(s) previously purchased from or currently offered by same, and/or information regarding transactions between an individual, patient, or caregiver, and the provider(s) can also be stored in the individual's or patient's electronic healthcare record(s) stored in the database 10H of the central processing computer 10 and/or in the database 60H of the healthcare records computer 60.

With reference to FIG. 38, the operation of the apparatus 100 commences at step 3800. At step 3801, the insurer or payer offering a healthcare insurance policy can access the central processing computer 10 via its insurer or payer computer or communication device 30. At step 3802, the insurer or payer can enter and transmit, to the central processing computer 10, a policy offer message containing its offering of a healthcare insurance policy along with details regarding the healthcare insurance policy being offered. The policy offer message can also contain contact information regarding, or a link or a hyperlink to a computer or communication device 30 associated with the insurer or payer. In another preferred embodiment, the policy offer message can also be transmitted to and stored at the healthcare records computer 60, the insurance exchange computer 70, the social networking computer 80, and/or the media computer 90 so that the policy offer message can be disseminated to or can be made available to any and/or all users, members, subscribers, of or to the respective healthcare records computer 60, the insurance exchange computer 70, the social networking computer 80, and/or the media computer 90.

At step 3803, the central processing computer 10 can receive the policy offer message, and can identify the individuals or patients, or their caregivers, who may have, or who may not have, indicated an interest in receiving same, and/or to whom the policy offer message can be transmitted. At step 3804, the central processing computer 10 can transmit the policy offer message to any number of, or to all of, the identified individuals or patients, or their caregivers, by transmitting the policy offer message to the respective user or patient communication device 40 associated with the respective individual, patient, or caregiver. In another preferred embodiment, any policy offer message can also be stored in the individual's or patient's electronic healthcare record(s) stored in the database 10H of the central processing computer 10 and/or in the database 60H of the healthcare records computer 60.

At step 3805, the individual, the patient, or the caregiver, can review the offer contained in the policy offer message. If the individual, the patient, or the caregiver, desires to purchase the healthcare insurance policy offered in the policy offer message, he or she, at step 3806, can access the central processing computer 10, or the insurer's or payer's communication device 30, via his or her user or patient communication device 40. In the case of accessing the insurer's or payer's communication device 30, the individual, the patient, or the caregiver, can access same by using a link or a hyperlink provided in the policy offer message. At step 3806, the central processing computer 10, or the computer or communication device 30 associated with the insurer or payer, whichever the case may be, can then process information or transaction information regarding or involving the individual's, the patient's, or the caregiver's, purchase of the healthcare insurance policy.

At step 3806, the individual, the patient, or the caregiver, can enter any needed or required information for enrolling the individual, the patient, or the caregiver, and any dependents or other beneficiaries of the individual, the patient, or the caregiver, if applicable, in the healthcare insurance policy. At step 3806, any information for enrolling the individual or patient, or the caregiver, and any dependents or other beneficiaries of the individual, the patient, or the caregiver, if applicable, in the healthcare insurance policy can also be transmitted to and received at the respective central processing computer 10 or at the computer or communication device 30 associated with the insurer or payer. In another preferred embodiment, the central processing computer 10, or the computer or communication device 30 associated with the insurer or payer, can be programmed to automatically query the database 10H or the electronic healthcare record or the electronic healthcare file of the individual, the patient, or the caregiver, and collect any or all needed data and/or information for enrolling the individual, the patient, or the caregiver, and any dependents or other beneficiaries of the individual, the patient, or the caregiver, if applicable, in the healthcare insurance policy.

At step 3807, the central processing computer 10, or the computer or communication device 30 which is associated with the insurer or payer, whichever the case may be, can process the information and enroll the individual, the patient, or the caregiver, and any dependents or other beneficiaries of the individual, the patient, or the caregiver, if applicable, in the healthcare insurance policy. In another preferred embodiment, at step 3807, the central processing computer 10, or the computer or communication device 30 associated with the insurer or payer, can also be programmed to automatically enroll the individual, the patient, or the caregiver, and any dependents or other beneficiaries of the individual, the patient, or the caregiver, if applicable, in the healthcare insurance policy.

At step 3807, the central processing computer 10, or the computer or communication device 30 which is associated with the insurer or payer, can also process any payment by or on behalf of the individual, the patient, or the caregiver. In an situation where the individual, the patient, or the caregiver, is paying for the healthcare insurance policy, the individual, the patient, or the caregiver, can make a payment in any appropriate manner, such as, for example, by a credit card payment, by a debit card payment, by an electronic bill payment process or operation, by an electronic funds transfer, or by or in any other appropriate manner. In a situation where the healthcare insurance policy is to be paid for by a third party, such as, for example, by an employer of the individual, the patient, or the caregiver, as part of an employee benefits package, or by any other person, entity, or third party, the individual, the patient, or the caregiver, can provide any needed information identifying the employer, or the person, entity, or third party, and any payment can be effected from a financial account associated with that employer, or from a financial account associated with that person, entity, or third party, using information stored regarding that employer, or that person, entity, or third party, or any respective financial account associated with same.

The central processing computer 10 can then record and/or store, in the individual's or the patient's electronic healthcare record or electronic healthcare file, or in the database 10H, or in the database 60H, any information regarding the healthcare insurance or the healthcare insurance policy purchased by or for the individual, the patient, or the caregiver. Thereafter, the operation of the apparatus 100 will cease at step 3808.

In another preferred embodiment, the any number of policy offer messages can be transmitted from any number of insurer or payer communication devices 30 to, and stored in, the central processing computer 10, and/or in the healthcare records computer(s) 60, and/or can be stored in the individual's or patient's electronic healthcare record stored in the database 10H or stored in the database 60H. In another preferred embodiment, any individual, patient, or caregiver, can access the central processing computer 10 and/or access the individual's or patient's electronic healthcare record, and review any and/or all of the policy offer messages and/or purchase and/or enroll in any of the healthcare insurance policies offered therein or thereby. In this regard, the central processing computer 10 or the individual's or patient's electronic healthcare record can serve as and/or facilitate the providing of an insurance exchange for healthcare insurance and/or healthcare insurance policies, products, subscriptions, or services. In another preferred embodiment, any individual, patient, or caregiver, can access the healthcare records computer 60 and/or access the individual's or patient's electronic healthcare record store therein, and review any and/or all of the policy offer messages and/or purchase and/or enroll in any of the healthcare insurance policies offered therein or thereby. In this regard, the healthcare records computer 60 or the individual's or patient's electronic healthcare record stored therein can also serve as, and/or facilitate the providing of, an insurance exchange for healthcare insurance and/or healthcare insurance policies, products, subscriptions, or services.

In another preferred embodiment, any of the users, individuals, patients, caregivers, providers, insurers or payer, or intermediaries, or any members or subscribers, can also obtain information regarding, or ascertain, healthcare insurance policy offers, by accessing, and/or obtaining said information from, any of the herein-described healthcare records computers 60, the insurance exchange computers 70, the social networking computers 80, and/or the media computers 90.

The apparatus 100, in the embodiment of FIG. 38, can also be utilized in a same, a similar, or an analogous, manner in order to allow an insurer, payer, or any provider of any goods, products, services, or subscriptions, to sell, or to offer to sell, disability insurance, life insurance, automobile insurance, homeowner's insurance, property or casualty insurance, or any other insurance policy, payer policy, payer program, or payer plan, or can be utilized in connection with selling any good, product, or service, or any subscription, which can be the subject of commerce.

In another preferred embodiment, the apparatus 100 of the present invention can also be utilized in order to provide for, or facilitate, the selling or the purchasing of any type or kind of healthcare insurance policy, disability insurance policy, life insurance policy, automobile insurance policy, homeowner's insurance policy, property or casualty insurance policy, or any other insurance or insurance policies described or noted herein, payer policy, payer program, or payer plan, and can provide for allowing any individual, patient, caregiver, employer, third party, or intermediary, to pay for same, with any and/or all information regarding the respective healthcare insurance policy, disability insurance policy, life insurance policy, automobile insurance policy, homeowner's insurance policy, property or casualty insurance policy, or any other insurance or insurance policies, or any other insurance policy, payer policy, payer program, or payer plan, being stored in the database 10H, in the central processing computer 10, in the individual's or patient's electronic healthcare record, in the healthcare records computer 60, its database 60H, or in the individual's or patient's electronic healthcare record stored therein, or in any other computer or communication device described herein.

In another preferred embodiment, the apparatus 100 of the present invention can provide for the portability of benefits, such as the portability of healthcare insurance, disability insurance, life insurance, or their respective policies, plans, or programs, or any other related or unrelated insurance policy, payer policy, payer program, or payer plan, from one job to another job, from one employment relationship to another employment relationship, from a period of employment to or during a period of unemployment, from or during a period of unemployment to a period of employment, from a period of employment to or during a period of self-employment, or from a period of employment to, through, or during, a period of retirement, or from or between, or during, any employment or unemployment period or status of an individual, a patient, or a caregiver.

The apparatus 100 of the present invention, by storing information regarding the respective healthcare insurance policy, disability insurance policy, life insurance policy, or any other related or unrelated insurance policy, payer policy, payer program, or payer plan, and by allowing for the payment for same via the apparatus 100, such as by or from accounts associated with, individuals, patients, caregivers, employers, third parties, or intermediaries, or any other person or entity, facilitates the portability of these respective healthcare insurance policies, disability insurance policies, life insurance policies, or any other related or unrelated insurance policies, plans, or programs, or any payer policies, payer programs, or payer plans. By storing this information in an electronic healthcare record or an electronic healthcare file of an individual or a patient, or a caregiver of the individual or patient, and/or by making it possible for individuals, patients, caregivers, employers, third parties, or intermediaries, or any other person or entity, to pay for same, the apparatus 100 and method of the present invention facilitates the portability of these healthcare insurance policies, disability insurance policies, life insurance policies, or any other related or unrelated insurance policies, payer policies, payer programs, or payer plans, from one job to another job, from one employment relationship to another employment relationship, from a period of employment to or during a period of unemployment, from or during a period of unemployment to a period of employment, from a period of employment to or during a period of self-employment, or from a period of employment to, through, or during, a period of retirement, or from or between, or during, any employment or unemployment period or status of an individual, a patient, or a caregiver of the individual or patient.

In another preferred embodiment, any and/or all of the herein-described embodiments of the apparatus 100 and method of the present invention can also be utilized in a same, a similar, or an analogous, manner in order to provide healthcare information, healthcare-related information, wellness information, wellness-related information, and/or any of the herein-described information or functionality, for or regarding animals of any type or kind, pets, dogs, cats, domestic animals, zoo animals, theme park animals, circus animals, animals used in entertainment shows or water shows, or any other animals for which an owner, keeper, or caretaker, desires to store or maintain an electronic healthcare record, an electronic healthcare file, or a healthcare history, or for which an owner, keeper, or caretaker, desires to utilize any of the functionality described herein as being provided by the apparatus 100 and method of the present invention. In this regard, the apparatus 100 of the present invention, any of its component computers or communication devices 10, 20, 30, 40, 50, 60, 70, 80, and/or 90 described herein, any of the healthcare devices, monitoring device, or healthcare equipment described herein as being utilized in connection with the apparatus 100 and methods of the present invention, any and/or all of the embodiments described herein or method of utilizing the apparatus 100 of the present invention, can also be utilized in processing and/or providing veterinary healthcare information or veterinary healthcare-related information for any kinds or types of the herein-described or other animals or pets.

In another preferred embodiment, any of the herein-described electronic healthcare records or electronic healthcare files for any of the herein-described individuals, patients, or caregivers, can also include or contain any data and/or information and/or a link(s) or hyperlink(s) to any electronic healthcare record or electronic healthcare file of or for any animal or pet of a respective individual, patient, or caregiver, or of or for any animal or pet for which the respective individual, patient, or caregiver, is responsible for providing care, healthcare, and/or healthcare oversight. In another preferred embodiment, the electronic healthcare record or electronic healthcare file of or for any animal or pet can also include or contain any data and/or information regarding and/or a link(s) or hyperlink(s) to information and/or to the electronic healthcare record or electronic healthcare file of the individual, patient, or caregiver, to whom the animal or pet belongs or who is responsible for providing care, healthcare, and/or healthcare oversight for the animal or pet.

In another preferred embodiment, as well as any and/or all of the embodiments described herein, the apparatus 100, the central processing computer 10, or any provider computer or communication device 20 associated with any laboratory testing provider, can also generate a message containing laboratory testing results and transmit same to a user or patient computer or communication device 40 associated with or used by an individual, patient, or a caregiver, and/or to a provider computer or communication device 20 associated with or used by the healthcare provider of the individual or patient who ordered the test, or can be transmitted to a provider computer or communication device 20 of or associated with any other healthcare provider of the individual or patient. The message can also be sent to the central processing computer 10 and can be stored in the electronic healthcare record or electronic healthcare file of the individual, the patient, or the caregiver.

Any and/or all of the signals, messages, reports, alerts, alert messages, notification messages, or any other communications or communication transmissions, described herein as being transmitted from one device, computer, or communication device, to another, can be, or can be included in, or be attached to, an e-mail message, an instant messaging message, an electronic transmission, or electronic data transmission or any other data or information transmission, or any data or information exchange, or an electronic data interchange, and can be transmitted via any appropriate or necessary computer(s) or device(s).

In another preferred embodiment, the apparatus 100 and method of the present invention can also process any of the data or information described herein as being recorded or stored, processed by, or generated by, the apparatus 100 and method of the present invention, so as to obtain information for or regarding the meaningful use of electronic healthcare records, electronic medical records, electronic dental records, or electronic behavioral healthcare records.

In another preferred embodiment, as well as in any of the embodiments described herein, intelligent agents, software agents, mobile agents, and/or related technologies, can be utilized in conjunction with the present invention. The respective intelligent agent(s), software agent(s), mobile agent(s), (hereinafter referred to collectively as “intelligent agent” or “intelligent agents”) can be programmed and/or designed to act on behalf of the respective users, individuals, patients, caregivers, providers, insurers or payers, and/or intermediaries, so as to act on behalf of the respective party as well as to perform any of processing functions and/or other functions described herein.

In another preferred embodiment, the intelligent agent can act on behalf of the respective person or party in various related interactions and/or other activities which are described as being performed herein and/or which may be incidental and/or related thereto. Therefore, the present invention also provides an agent-based apparatus and method for providing healthcare information and/or healthcare-related information.

The apparatus of the present invention, in any and/or all of the embodiments described herein, can also be programmed to be self-activating and/or activated automatically.

The apparatus of the present invention can also be programmed in order to automatically generate and/or transmit any of the e-mails, electronic message transmissions, electronic notification transmissions, and/or any of the communications or communication transmission, which are described herein, between any of the users, individuals, patients, caregivers, providers, insurers or payers, or intermediaries, or other parties or entities who or which utilize the apparatus 100 and method of the present invention.

The present invention, in any and/or all of the herein-described embodiments, can utilize electronic commerce technologies and security methods, techniques and technologies which are know by those skilled in the pertinent art as of the date of filing of this application.

The communications networks and/or systems on, or over, which the apparatus 100 of the present invention may be utilized, can include any one or combination of telecommunication networks or systems, satellite communication networks or systems, radio communication networks or systems, digital communication networks or systems, digital satellite communication networks or systems, personal communications services networks or systems, cable television networks or systems, broadband communication networks or systems, low earth orbiting satellite (LEOs) networks or systems, wireless communication networks or systems, wireless Internet networks or systems, wireless World Wide Web networks or systems, as well as in, or on any internets and/or intranets, the Internet, the World Wide Web, and any other suitable communication network or system.

The data and/or information, described as being stored in the database 10H and/or in any of the other databases described herein, can be continuously updated so as to store the latest values for the data and/or information and can be stored and be made available for future processing routines.

Any and/or all of the data and/or information described herein, which is stored in the database 10H, or in the collection of databases, can be linked via relational database techniques and/or via any appropriate database management techniques. The data and/or information, in the preferred embodiments, can be updated via inputs from any of the computers and/or communication devices 10, 20, 30, 40, 50, 60, 70, 80, and/or 90, and/or any external computers or communication devices, described herein, in real-time, and/or via dynamically linked database management techniques. The above-described updates can also be provided from other information sources via the communication network.

The data and/or information which is stored in the database 10H, or in any other the other databases described herein, and/or which may be otherwise utilized with, and/or in conjunction with, the apparatus 100 and method of the present invention, can be linked via any suitable data linking techniques such as, for example, dynamically linked lists (DLLs), linked lists, and object links embedded (OLE's). Any suitable database management technique(s) may also be utilized in conjunction with the present invention.

The present invention provides an apparatus and a method for providing comprehensive information in the healthcare fields and/or healthcare-related fields. The present invention also provides valuable services to the various parties who seek, provide, pay for, administer, and/or monitor healthcare services, goods and/or products as well as a healthcare-related services, goods, and/or products.

The present invention can also provide comprehensive and accurate information to any of the users, individuals, patients, caregivers, providers, insurers or payers, and/or intermediaries, or other parties described herein so as to facilitate an improved healthcare system which can provide up-to-date individual, patient, caregiver, provider, insurer or payer, and/or intermediary, information. The apparatus 100 of the present invention, by facilitating the creation and maintenance of a comprehensive database of information, which can be accessed on a global basis, at any time of day or night, and from any location, can provide users, individuals, patients, caregivers, providers, insurers or payers, and/or intermediaries, with information which can improve healthcare treatments, reduce the likelihood of errors in diagnoses and/or prescribed treatments, reduce healthcare costs, reduce the likelihood of incorrect and/or fraudulent care, and can provide for a healthcare system which is characterized by an improved quality of care, care management, and cost efficiency.

Any of the messages or information described herein, which, can be transmitted to or provided to any of the users, individuals, patients, caregivers, providers, insurers or payers, insurance companies, healthcare insurance companies, healthcare maintenance organizations, or any other healthcare-related entities, employer employers, or third party intermediaries, who or which use the apparatus 100 and method of the present invention, can contain or include advertisements or marketing materials or information regarding any good, product, or service, which may be of interest to a respective user, individual, patient, caregiver, provider, insurer or payer, insurance company, healthcare insurance company, healthcare maintenance organization, or any other healthcare-related entity, employer, or third party intermediary. In this manner, the apparatus 100 and method of the present invention can be used to market any goods, products, or services, including any healthcare goods, products, or services, healthcare provider goods, products, services, medications, therapies, healthcare, life, or disability, insurance products or services, or any other goods, products, or services, which can be marketed to, or which may be of interest to, any respective user, individual, patient, caregiver, provider, insurer or payer, insurance company, healthcare insurance company, healthcare maintenance organization, or any other healthcare-related entity, employer, or third party intermediary, who or which utilize the apparatus 100 and method of the present invention.

In this manner, the apparatus 100 and method of the present invention can also be used to advertise or market any goods, products, or services, including any healthcare goods, products, or services, healthcare provider goods, products, services, medications, therapies, healthcare, life, or disability, insurance products or services, or any other goods, products, or services, which can be marketed to, or which may be of interest to, any respective user, individual, patient, caregiver, provider, insurer or payer, insurance company, healthcare insurance company, healthcare maintenance organization, or any other healthcare-related entity, employer, or third party intermediary. In this manner, the apparatus 100 can also be utilized to generate advertising revenues.

In another preferred embodiment, the apparatus 100 and method of the present invention, and in particular, the central processing computer 10, can process transactions regarding or involving the purchase and/or sale of goods, products, services, healthcare insurance policies, life insurance policies, disability insurance policies, group healthcare insurance policies, group life insurance policies, group disability insurance policies, healthcare, life, or disability, insurance products and/or services, healthcare goods, products, or services, provider offered goods, products, or services, health and/or wellness goods, products, or services, exercise goods, products, or services, drugs, medications, or any other good(s), product(s), or service(s), which may be of interest to any of the of the herein-described users, individuals, patients, caregivers, providers, insurers or payers, insurance companies, healthcare insurance companies, healthcare maintenance organizations, or any other healthcare-related entities, employer employers, third parties, or third party intermediaries, who or which utilize the apparatus 100 and method of the present invention. In this regard, the apparatus 100 of the present invention can also be utilized as a venue, site, or portal, for conducting electronic commerce, or web-based or Internet-based commerce, or cable television-based, or telecommunication networked-based commerce, with or in any of the various goods, products, or services, which can or may be offered for sale via the apparatus 100 of the present invention.

In any and or all of the embodiments described herein, any of the diagnostic reports, treatment reports, treatment plans, evaluations reports, provider reports, insurer reports or payer reports, messages, alert messages, notification messages, etc., described herein as being generated by the apparatus 100 of the present invention and/or the central processing computer 10, can contain and/or include a link(s) or a hyperlink(s) to, or a link(s) or a hyperlink(s) to data and/or information stored in, the individual's, the patient's, or the caregiver's, electronic healthcare record or electronic healthcare file.

In any and or all of the embodiments described herein, any of the diagnostic reports, treatment reports, treatment plans, evaluations reports, provider reports, insurer reports or payer reports, messages, alert messages, notification messages, etc., described herein as being generated by the apparatus 100 of the present invention and/or the central processing computer 10, can contain and/or include information regarding any notes, comments, or messages, entered into the electronic healthcare record by the individual, the patient, or a caregiver, or can contain a link(s) or a hyperlink(s) to any notes, comments, or messages entered into the electronic healthcare record by the individual, the patient, or a caregiver.

In any and/or all of the embodiments described herein, any and/or all of the any electronic healthcare records, electronic medical records, electronic dental records, electronic pharmacy records, electronic behavioral health records, utilized in connection with the apparatus 100 can contain a link(s) or a hyperlink(s) to any of the herein-described healthcare records computers 60, insurance exchange computers 70, social networking computers 80, and/or the media computers 90. In any and/or all of the embodiments described herein, any user, individual, patient, or caregiver, can use his or her user or patient communication device 40 to access any healthcare records computer 60 via his or her electronic healthcare record(s), electronic medical record(s), electronic dental record(s), electronic pharmacy record(s), or electronic behavioral health record(s) for any reason and/or purpose.

In any and/or all of the embodiments described herein, any user, individual, patient, or caregiver, can use his or her user or patient communication device 40 to access any insurance exchange computers 70 via his or her electronic healthcare record(s), electronic medical record(s), electronic dental record(s), electronic pharmacy record(s), or electronic behavioral health record(s) in order to purchase an insurance policy, program, or service for any healthcare insurance, life insurance, disability insurance, automobile insurance, property insurance, liability insurance, or any other kind or type of insurance, to submit insurance claims or payment requests pursuant to any healthcare insurance, life insurance, disability insurance, automobile insurance, property insurance, liability insurance, or any other kind or type of insurance, or to check the status of any insurance claims or payment requests.

In any and/or all of the embodiments described herein, any user, individual, patient, or caregiver, can use his or her user or patient communication device 40 to access any social networking computers 80 via his or her electronic healthcare record(s), electronic medical record(s), electronic dental record(s), electronic pharmacy record(s), or electronic behavioral health record(s) in order to engage or participate in any social networking activity, support groups, on-line chats or discussions, seminars, or any other activity which one can engage in on, in, or via a social network.

In any and/or all of the embodiments described herein, any user, individual, patient, or caregiver, can use his or her user or patient communication device 40 to access any media computers 90 via his or her electronic healthcare record(s), electronic medical record(s), electronic dental record(s), electronic pharmacy record(s), or electronic behavioral health record(s) in order to search for and/or obtain any information provided by the respective media computer 90. The apparatus 100 and method of the present invention can also be used in any applications wherein the healthcare of groups of individuals is monitored and/or managed by a person or entity having such a responsibility, role, or interest.

In another preferred embodiment, the apparatus 100 and method of the present invention can be utilized, in any and/or of the embodiments described herein and/or in any combinations of same, in or as a sports medicine application(s) or a sports healthcare application(s) in order to provide a sports medicine electronic healthcare record, electronic healthcare history, and/or electronic healthcare file, for athletes or sport participants or their respective organizations, teams, clubs, or other entities, which can provide or be capable of providing any and/or all of the features or functionality described herein.

In this embodiment, the apparatus 100 and method of the present invention can be utilized in order to provide a comprehensive and/or centralized sports medicine electronic healthcare record, electronic healthcare history, and/or electronic healthcare file, system for athletes or participants of any sport or sports or any activity or activities, athletes or sports participants of any age, professional athletes, minor league athletes, Olympic athletes, competitive athletes, government team athletes, world class competition athletes, amateur athletes, college athletes, high school age athletes, children athletes, secondary school athletes, recreational organization athletes or members, child recreational organization athletes or members, adult recreational organization athletes or members, little league athletes or members, boys club athletes or members, girls club athletes or members, hobbyist athletes, or any other individuals, male or female, who participate in athletic endeavors, sporting events, exercise activities, martial arts, mixed martial arts, boxing, wrestling, physical activities, or any team sport or activity or individual sport or activity.

The apparatus 100 and method of the present invention can also be utilized by any organization, governmental entity, business, team, league, club, network, or any other entity, which oversees, manages, uses, employs, provides oversight over, owns or otherwise has playing or managing rights over, provides control over, or provides or is responsible for the healthcare of, any of the herein-described or other athletes or sports participants. In this regard, the apparatus 100 and method of the present invention can, for example, be utilized by a profession sports team or club, a minor league professional sports team or club, a college athletic department, a high school athletic department, a grade school or secondary or other school or organization athletic department, a recreational organization athletic organization or club, a government sponsored or monitored athletic entity, any private or public sponsored, sanctioned, or monitored, athletic or sports league, club, group, network, or other athletic, entity, and/or any other entity which can or may benefit from using the apparatus 100 and method of the present invention, in order to maintain electronic healthcare records, electronic healthcare histories, or electronic healthcare files, of, for, or regarding its respective athletes or sports participants.

In another preferred embodiment, as well as in any and/or all of the embodiments described herein, the apparatus 100 and method of the present invention can process sports medicine-related data and/of information for and/or involving electronic healthcare records, electronic healthcare histories, or electronic healthcare files, of and for athletes or sports participants of any age and in or for any sport or athletic activity. In another preferred embodiment, as well as in any and/or all of the embodiments described herein, the apparatus 100 and method of the present invention can process sports medicine-related data and/of information for and/or involving any athletes or sport participants as well as for their respective organizations, teams, clubs, leagues, or other entities.

In another preferred embodiment, as well as in any and/or all of the embodiments described herein, the apparatus 100 and method of the present invention can process sports medicine-related data and/of information for creating and for maintaining a comprehensive and/or centralized sports medicine electronic healthcare record, electronic healthcare history, and/or electronic healthcare file, system for athletes or participants of any sport or sports or any activity or activities, athletes or sports participants of any age, professional athletes, minor league athletes, Olympic athletes, competitive athletes, government team athletes, world class competition athletes, amateur athletes, college athletes, high school age athletes, children athletes, secondary school athletes, recreational organization athletes or members, child recreational organization athletes or members, adult recreational organization athletes or members, little league athletes or members, boys club athletes or members, girls club athletes or members, hobbyist athletes, or any other individuals, male or female, who participate in athletic endeavors, sporting events, exercise activities or programs, the martial arts, mixed martial arts, boxing and other fighting or combat sports, any and/or all team sports, including but not limited to baseball, football, basketball, hockey, soccer, lacrosse, track and field, gymnastics, car racing, skiing and winter sports, swimming and aquatic sports, weightlifting, dancing, and/or any other sports or sporting activities, and/or other physical activities, or any team sporting activities or individual sporting activities.

In another preferred embodiment, as well as in any and/or all of the embodiments described herein, the apparatus 100 and method of the present invention can process sports medicine-related data and/of information for and/or involving any organization, governmental entity, business, team, league, club, network, or any other entity, which oversees, manages, uses, employs, provides oversight over, owns or otherwise has playing or managing rights over, provides control over, or provides or is responsible for the healthcare of, any of the herein-described or other athletes or sports participants.

In another preferred embodiment, as well as in any and/or all of the embodiments described herein, the apparatus 100 and method of the present invention can process sports medicine-related data and/of information for and/or regarding sports-related injuries or athletic related injuries, or conditions, or other healthcare information relating to sports-related injuries, athletic injuries, sport-related conditions, and/or athletics-related conditions.

In another preferred embodiment, as well as in any and/or all of the embodiments described herein, the apparatus 100 and method of the present invention can process sports medicine-related data and/of information for diagnosing, treating, creating treatment plans for, creating rehabilitation plans or programs for, or creating therapy plans of programs for or relating to, sports-related injuries or conditions or athletic-related injuries or conditions. In another preferred embodiment, as well as in any and/or all of the embodiments described herein, the apparatus 100 and method of the present invention can also process any information regarding diagnoses, treatments, treatment plans, procedures, corrective procedures or surgical procedures, cures, rehabilitation plans or programs, therapies, physical therapies, exercise therapies, drug or medicinal therapies, diets, nutritional therapies, alternate medicine therapies, herbal therapies, and/or any other information which can or which may be utilized or needed for monitoring and/or managing the health and well-being of athletes or sports participants.

In still another preferred embodiment, as well as in any and/or all of the embodiments described herein, the apparatus 100 and method of the present invention can process information for diagnosing, treating, creating treatment plans for, creating rehabilitation plans or programs for, or creating therapy plans of programs for or relating to, sports-related injuries or conditions or athletic-related injuries or conditions, and can be utilized for devising and planning treatments, treatment plans, procedures, operations, rehabilitation programs, plans, or regimens, physical therapy programs, plans, or regimens, occupational therapy programs, plans, or regimens, exercise programs, plans, or regimens, massage therapy programs, plans, or regimes, and/or any other programs, plans, or regimens for treating, curing, or otherwise dealing with, a sports-related injury or diagnosis.

In another preferred embodiment, as well as in any and/or all of the embodiments described herein, the apparatus 100 and method of the present invention can also process information for identifying or locating healthcare providers, doctors, specialists, dentists, dental specialists, psychiatrists, psychologists, chiropractors, podiatrists, optometrists, or any other providers, hospitals, treatments facilities, therapists, nurses, physical therapists, massage therapists, occupational therapists, trainers, and/or any other providers or care givers, and/or testing laboratories, who or which can provide services for any other athletes and/or sports participants who may or which my utilize or be serviced by the apparatus 100 and method of the present invention, or any of their respective organizations, teams, clubs, or other entities.

In any and/or all of the embodiments described herein, the apparatus 100 or the central processing computer 10 can process information regarding and/or can provide sports medicine-related diagnoses, sports medicine-related comprehensive diagnostic evaluations, sports medicine-related treatment plans, sports medicine-related evaluations of diagnoses and treatment plans, sports medicine-related appointment scheduling, and/or sports medicine-related automated notifications to any of the herein-described individuals, users, providers, payer, and/or third parties or intermediaries, or any of the herein-described organizations, governmental entities, businesses, teams, leagues, clubs, networks, or any other entities, which oversee, manage, use, employ, provide oversight over, owns or otherwise has playing or managing rights over, an athlete or sports participants upon an occurrence of any of the herein-described events, happenings, or occurrences. In any and/or all of the embodiments described herein, the apparatus 100 or the central processing computer 10 can process information regarding and/or can provide sports medicine-related insurance or payer claim generation and/or submission, and/or sports medicine-related medical and/or healthcare training simulation.

In any and/or all of the embodiments described herein, the apparatus 100 or the central processing computer 10 can generate and/or provide sports medicine-related diagnostic reports, sports medicine-related treatment reports, or sports medicine-related treatment plans, for or regarding any kind or type of sports injury or condition or any kind or type of athletic injury or condition,

In any and/or all of the embodiments described herein, any of the herein-described diagnostic reports can contain diagnostic information of, regarding, or relating to, a sports injury or condition or a sports-related injury or condition. The diagnostic report can also contain information regarding a healthcare provider who or which has been identified or located for treating the injury or condition. In any and/or all of the embodiments described herein, any of the herein-described treatment plans or treatment reports can contain information regarding various treatments, treatment plans, operations, rehabilitation programs, plans, or regimens, physical therapy programs, plans, or regimens, occupational therapy programs, plans, or regimens, exercise programs, plans or regimens, diet or nutritional programs, plans, or regimens, massage therapy programs, plans, or regimes, and/or any other programs, plans, or regimens for treating, curing, or otherwise dealing with, or other procedures, plans, or programs, or for treating the injury and/or can also contain information regarding a healthcare provider(s) or facility or facilities who or which can perform or assist in performing, or effectuate or assist in effectuating, any treatments, procedures, or other activities under a treatment plan or program.

The apparatus 100 and method of the present invention can also be utilized by any respective organization, governmental entity, business, team, league, club, network, or any other entities, which oversees, manages, uses, employs, provides oversight over, owns or otherwise has playing or managing rights over, an athlete or sports participant in order to maintain accurate, up-to-date, and/or comprehensive electronic healthcare records, electronic healthcare histories, or electronic healthcare files for its respective athletes and sports participants, to be notified upon healthcare-related events, happenings, or occurrences, involving or regarding its respective athletes or sports participants, to identify and located healthcare providers, healthcare facilities, or other third parties who or which might be able to treat, help, assist, or care for, its respective athletes or sports participants, devise, oversee, or monitor, health and/or well-being programs or plans for its respective athletes or sports participants, devise, oversee, or monitor, treatment plans or programs, rehabilitation plans or programs, or physical therapy plans or programs, for its respective athletes or sports participants, or to devise, oversee, or monitor, diet or nutritional plans or programs, alternate medicine plans or programs, or any other plans or programs for promoting the health and well-being of its respective athletes or sports participants.

In any and/or all of the embodiments described herein, the apparatus 100 and method of the present invention can also be utilized in a same, similar, or analogous manner, in order to process and/or to provide veterinary healthcare information and/or veterinary healthcare-related information for and regarding any kind or type of animal or animals or any type or kind of pet or pets. In this regard, it is to be understood that the apparatus 100 of the present invention, in each and every one of the embodiments described herein, can be utilized by any user, individual, caregiver, provider, insurer or payer, or intermediary, in order to process healthcare or healthcare-related information for any animals and/or pets. In this regard, the term “caregiver” can be use to refer to a caregiver, owner, or other individual, person, or entity, who or which owns, cares for, manages, monitors, or who is responsible for caring for, for monitoring the health, healthcare, and/or well-being of, and/or who may be otherwise responsible for, any type or kind of animal or pet.

In any and/or all of the embodiments described herein, the apparatus 100 and method of the present invention can also be utilized as a clearinghouse for facilitating the offering, selling, buying, trading, and/or other commerce and/or transactions, involving healthcare and/or healthcare-related services, products and/or goods.

In any and/or all of the embodiments described herein, any act or action described as being taken or performed by an individual or patient described herein can also be taken or performed by the individual's or the patient's caregiver. In this regard, the mere fact that an act or an action is described as being taken or performed by an individual or a patient does not preclude the act or action being taken or performed by a caregiver of the individual or patient. To the contrary, it is to be understood that any act or action taken or performed by an individual or patient can also be taken or performed by a caregiver of the individual or patient.

In any and/or all of the embodiments described herein, any of the individual's, patient's, or caregiver's, electronic healthcare records described herein can contain or include data and/or information regarding, and/or a link(s) or a hyperlink(s) to, the central processing computer(s), any number of provider communication devices 20 associated with or used by any of the providers or the individual, patient, or caregiver or any other provider(s), any number of insurer or payer communication devices 30 associated with or used by any insurer or payer or any insurers or payers of or for the individual, patient, or caregiver, or any other insurer(s) or payer(s), any number of user or patient communication devices 40 associated with or used by the individual, patient, or caregiver, any number of intermediary communication devices 50 associated with or used by any intermediary(s) or third party(s), any number of healthcare records computer 60, any number of insurance exchange computers 70, any number of social networking computers 80, and/or any number of media computers 90.

In any and/or or all of the embodiments described herein, any of the reports, messages, alerts, alert messages, diagnostic reports, treatment reports, treatment plans, payer reports, provider reports, evaluation reports, notification messages, claim forms, request for payment forms, and/or any and/or all of the various reports, messages, alert messages, notification messages, plans, communications, or any other data and/or information, described as being generated by, transmitted from, or received by, the apparatus 100 or by any of the herein-described and respective computers or communications devices 10, 20, 30, 40, 50, 60, 70, 80, and/or 90, can contain or include information regarding, information obtained from, information contained in, and/or a link(s) or a hyperlink(s) to, an individual's, patient's, or caregiver's, electronic healthcare record or electronic healthcare file and/or any data and/or information contained in or include in an individual's, patient's, or caregiver's, electronic healthcare record or electronic healthcare file.

In any and/or or all of the embodiments described herein, any individual's, patient's, or caregiver's, electronic healthcare record or electronic healthcare file, and/or any data and/or information contained in or included in an individual's, patient's, or caregiver's, electronic healthcare record or electronic healthcare file, can contain or include, can contain or include information regarding, can contain or include information obtained from, can contain or include information contained in, and/or can contain or include a link(s) or a hyperlink(s) to, any of the reports, messages, alerts, alert messages, diagnostic reports, treatment reports, treatment plans, payer reports, provider reports, evaluation reports, notification messages, claim forms, request for payment forms, and/or any and/or all of the various reports, messages, alert messages, notification messages, plans, communications, or any other data and/or information, described herein as being generated by, transmitted from, or received by, the apparatus 100 or by any of the herein-described and respective computers or communications devices 10, 20, 30, 40, 50, 60, 70, 80, and/or 90.

In any and/or or all of the embodiments described herein, any of the reports, messages, alerts, alert messages, diagnostic reports, treatment reports, treatment plans, payer reports, provider reports, evaluation reports, notification messages, claim forms, request for payment forms, and/or any and/or all of the various reports, messages, alert messages, notification messages, plans, communications, or any other data and/or information, described as being generated by, transmitted from, or received by, the apparatus 100 or by any of the herein-described and respective computers or communications devices 10, 20, 30, 40, 50, 60, 70, 80, and/or 90, can also contain or include information regarding and/or a link(s) or a hyperlink(s) to wellness information, wellness-related information, fitness information, fitness-related information, and/or an advertisement(s) or marketing information or materials for or regarding any goods(s), products(s), or services(s), or any of the providers, healthcare providers, providers of any goods(s), products(s), or services(s), insurers or payer, insurance providers or companies, intermediaries or third parties, healthcare records providers, healthcare records websites, companies, or entities, insurance exchanges, insurance exchange websites or companies, social networking websites or companies, and/or media websites, companies or media providers or sources.

In any and/or or all of the embodiments described herein, any of the reports, messages, alerts, alert messages, diagnostic reports, treatment reports, treatment plans, wellness reports, exercise reports, fitness reports, nutritional reports, diet reports, rehabilitation reports, therapy reports, and/or any other reports, payer reports, provider reports, evaluation reports, notification messages, claim forms, request for payment forms, and/or any and/or all of the various reports, messages, alert messages, notification messages, plans, communications, or any other data and/or information, described as being generated by, transmitted from, or received by, the apparatus 100 or by any of the herein-described and respective computers or communications devices 10, 20, 30, 40, 50, 60, 70, 80, and/or 90, can also contain or include information regarding and/or a link(s) or a hyperlink(s) to information, text information, audio, audio information or audio clips, video, video information, video clips, audio and video information, audio and video clips, news stories, news programs, television programs, and/or information in any other form or type regarding fitness, fitness exercises, exercises, fitness routines, fitness regimens, wellness, wellness exercises, wellness routines, wellness regimens, diets, diet exercises, diet or dieting routines, diet or dieting regimens, training, training principals, training exercises, training routines, training regimens, aerobics training, aerobics exercises, aerobics routines or regimens, nutrition, health and well being, meditation, exercise program or routines of any kind or type, including, but not limited to weight training, cardio training, yoga, Tai Chi, Pilates, martial arts training, boot camp training, various exercise routines or workouts, and/or any other information relating to fitness, wellness, dieting, nutrition, training, exercise, or any related or other information.

In any and/or or all of the embodiments described herein, any of the reports, messages, alerts, alert messages, diagnostic reports, treatment reports, treatment plans, wellness reports, exercise reports, fitness reports, nutritional reports, diet reports, rehabilitation reports, therapy reports, and/or any other reports, payer reports, provider reports, evaluation reports, notification messages, claim forms, request for payment forms, and/or any and/or all of the various reports, messages, alert messages, notification messages, plans, communications, or any other data and/or information, described as being generated by, transmitted from, or received by, the apparatus 100 or by any of the herein-described and respective computers or communications devices 10, 20, 30, 40, 50, 60, 70, 80, and/or 90, can also contain or include information regarding and/or a link(s) or a hyperlink(s) to a respective individual's, patient', or caregiver's, electronic healthcare record or electronic healthcare file, as well as to any other report, message, alert, alert message, diagnostic report, treatment report, treatment plan, wellness report, exercise report, fitness report, nutritional report, diet report, rehabilitation report, therapy report, and/or any other report, payer report, provider report, evaluation report, notification message, claim form, request for payment form, and/or any and/or all of the various reports, messages, alert messages, notification messages, plans, communications, or any other data and/or information, described herein.

In any and/or all of the embodiments described herein, any respective electronic healthcare record or electronic healthcare file of any individual. patient, or caregiver, can also contain or include information regarding, and/or a link(s) or hyperlink(s) to, any of the herein-described reports, messages, alerts, alert messages, diagnostic reports, treatment reports, treatment plans, wellness reports, exercise reports, fitness reports, nutritional reports, diet reports, rehabilitation reports, therapy reports, and/or any other reports, payer reports, provider reports, evaluation reports, notification messages, claim forms, request for payment forms, and/or any and/or all of the various reports, messages, alert messages, notification messages, plans, communications, or any other data and/or information, and/or a link(s) or a hyperlink(s) to information, text information, audio, audio information or audio clips, video, video information, video clips, audio and video information, audio and video clips, news stories, news programs, television programs, and/or information in any other form or type regarding fitness, fitness exercises, exercises, fitness routines, fitness regimens, wellness, wellness exercises, wellness routines, wellness regimens, diets, diet exercises, diet or dieting routines, diet or dieting regimens, training, training principals, training exercises, training routines, training regimens, aerobics training, aerobics exercises, aerobics routines or regimens, nutrition, health and well being, meditation, exercise program or routines of any kind or type, including, but not limited to weight training, cardio training, yoga, Tai Chi, Pilates, martial arts training, boot camp training, various exercise routines or workouts, and/or any other information relating to fitness, wellness, dieting, nutrition, training, exercise, and/or any other information and/or any other related information.

In any and/or all of the embodiments described herein, any of the data and/or information described herein as being stored in any of the individual's, patient's, or caregiver's, electronic healthcare records, in any of the provider communication devices 20 associated with or used by any of the providers or the individual, patient, or caregiver, or any other provider(s), in any of the insurer or payer communication devices 30 associated with or used by any insurer or payer or any insurers or payers of or for the individual, patient, or caregiver, or any other insurer(s) or payer(s), in any of the user or patient communication devices 40 associated with or used by the individual, patient, or caregiver, in any of the intermediary communication devices 50 associated with or used by any intermediary(s) or third party(s), in any of the healthcare records computer 60, in any of the insurance exchange computers 70, in any of the social networking computers 80, and/or in any of the media computers 90, can be stored to the cloud or “The Cloud” using cloud computing techniques, cloud architecture techniques, and/or cloud storage techniques. In this regard, in another preferred embodiment, the apparatus 100 and methods of the present invention can also provide for cloud-based healthcare or healthcare-related data and/or information processing and/or storage, cloud-based electronic healthcare records, cloud-based electronic healthcare records storage and/or retrieval, a cloud-based electronic healthcare records system or platform, and/or cloud based processing and/or storage of any and/or all of the data and/or information described herein as being processed by the apparatus 100 and methods of the present invention.

In any and/or all of the embodiments described herein, any and/or all of the reports, various reports, diagnostic reports, treatment reports, treatment plans, evaluation reports, provider reports, insurer reports or payer reports, messages, various messages, alert messages, alerts, notifications, notification messages, communications, transmissions, and/or any other data and/or information, described herein as being generated by, received by, processed by, entered into, and/or in any other manner used by or in connection or in conjunction with, the apparatus 100, the central processing computer 10, and/or any of the other computers or communication devices 20, 30, 40, 50, 60, 70, 80, and 90 described herein, and/or any notes, comments, or messages, entered by any of the herein-described individuals, patients, caregivers, providers, insurers or payers, insurance companies, intermediaries, third parties, or any other individuals, users, persons, and/or entities, who or which use the apparatus 100, can be stored in the central processing computer 10 and/or in the database 10H of same, and can also be stored in any of the herein-described computers or communication devices 20, 30, 40, 50, 60, 70, 80, and/or 90 and/or in the respective databases 20H, 30H, 40H, 50H, 60H, 70H, 80H, and/or 90H of same.

In any and/or all of the embodiments described herein, any and/or all of the herein-described electronic healthcare records or electronic healthcare files, as well as any of the herein-described reports, various reports, diagnostic reports, treatment reports, treatment plans, evaluation reports, provider reports, insurer reports or payer reports, messages, various messages, alert messages, alerts, notifications, notification messages, communications, transmissions, and/or any other data and/or information, which can be provided by the apparatus 100 of the present invention to any of the herein-described individuals, patients, caregivers, providers, insurers or payers, insurance companies, intermediaries, third parties, or any other individuals, users, persons, and/or entities, who or which use the apparatus 100, via a respective computer or communication device 20, 30, 40, or 50, can contain data or information regarding, and/or can contain a link(s) or hyperlink(s), to any number of central processing computers 10, to any number of provider communication devices 20, to any number of insurer or payer communication devices 30, to any number of user or patient communication devices 40, to any number of intermediary communication devices 50, to any number of healthcare records computers 60, to any number of insurance exchange computers 70, to any number of social networking computers 80, and/or to any number of media computers 90, and/or to any number of, or other, electronic healthcare records or any number of, or other, electronic healthcare files, and/or to any, or any number of, any of the herein-described reports, various reports, diagnostic reports, treatment reports, treatment plans, evaluation reports, provider reports, insurer reports or payer reports, messages, various messages, alert messages, alerts, notifications, notification messages, communications, and/or transmissions.

In another preferred embodiment, in any instance where a link or hyperlink is used to provide access to data, information, a computer or communication device, an electronic healthcare record, or any report, message, or any other information described herein as being provided the apparatus 100, a corresponding link or hyperlink can be utilized which can allow for, or facilitate, a bi-directional access or two-way access between such respectively linked data, information, a computer or communication device, an electronic healthcare record, or any report, message, or any other information. In this regard, and as and for an illustrative example, if an electronic healthcare record has a link or hyperlink which can be used to link that electronic healthcare record to a provider communication device 20 or to a diagnostic report, that respective provider communication device 20 or diagnostic report can also be provided with a link or hyperlink back to that electronic healthcare record.

In another preferred embodiment, any and/or all of the herein-described electronic healthcare records or electronic healthcare files, as well as any of the herein-described reports, various reports, diagnostic reports, treatment reports, treatment plans, wellness reports, exercise reports, fitness reports, nutritional reports, diet reports, rehabilitation reports, therapy reports, and/or any other reports, evaluation reports, provider reports, insurer reports or payer reports, messages, various messages, alert messages, alerts, notifications, notification messages, communications, and/or transmissions, and/or any other data and/or information, can also be generated and/or provided in an electronic version and/or in a web page format, a web page layout, or a web page version, and can be provided with links or hyperlinks to any and/or all relevant data and/or information.

In another preferred embodiment, any of the herein-described electronic healthcare records or electronic healthcare files can also include, for a respective individual or patient, any data and/or information, or a link(s) or hyperlink(s) to any of the herein-described healthcare information, healthcare-related information, healthcare history information, medication information, provider information for each provider of the individual or patient, insurer or payer information for each insurer or payer of the individual or patient, appointment information, appointment reminder information, any notes, comments, or messages entered by the individual, the patient, or the caregiver of the individual or patient, insurance policy information, and/or any of the herein-described reports, various reports, diagnostic reports, treatment reports, treatment plans, wellness reports, exercise reports, fitness reports, nutritional reports, diet reports, rehabilitation reports, therapy reports, and/or any other reports, evaluation reports, provider reports, insurer reports or payer reports, messages, various messages, alert messages, alerts, notifications, notification messages, communications, transmissions, and/or any other data and/or information, which can be generated by or provided by the apparatus 100 of the present invention.

In another preferred embodiment, any of the herein-described individuals, patients, caregivers, providers, insurers or payers, intermediaries or third parties, or any other users, individuals, or persons, can communicate with, conference with, confer with, and/or share or view data and/or information with, any other individuals, patients, caregivers, providers, insurers or payers, intermediaries or third parties, or any other users, individuals, or persons, by audio communication, audio conferencing, video communication, video conferencing, or by using any suitable or appropriate web conferencing and/or online meeting products or services and/or any other similar web conferencing and/or information sharing products and/or services which are available as of the filing date of this application. In another preferred embodiment, any of the herein-described individuals, patients, caregivers, providers, insurers or payers, intermediaries or third parties, or any other users, individuals, or persons, can communicate with, conference with, confer with, and/or share or view data and/or information with, any other individuals, patients, caregivers, providers, insurers or payers, intermediaries or third parties, or any other users, individuals, or persons, by using by using any suitable or appropriate web conferencing and/or online meeting products or services and/or any other similar web conferencing and/or information sharing products and/or services which are available as of the filing date of this application.

In another preferred embodiment, each of the apparatus 100, the central processing computer(s) 10, the provider communication devices 20, the insurer or payer communication devices 30, the user or patient communication devices 40, the intermediary communication devices 50, the healthcare records computers 60, the insurance exchange computers 70, the social networking computers 80, and/or the media computers 90, can be equipped with voice recognition software and/or equipment in order to facilitate voice entry of data and/or information into the respective computer or communication device 10, 20, 30, 40, 50, 60, 70, 80, and/or 90.

In another preferred embodiment, each of the apparatus 100, the central processing computer(s) 10, the provider communication devices 20, the insurer or payer communication devices 30, the user or patient communication devices 40, the intermediary communication devices 50, the healthcare records computers 60, the insurance exchange computers 70, the social networking computers 80, and/or the media computers 90, can be equipped with voice synthesis software an/or equipment in order to facilitate the voice synthesized output of data and/or information from the respective computer or communication device 10, 20, 30, 40, 50, 60, 70, 80, and/or 90.

In another preferred embodiment, including any and/or all of the embodiments described herein, any gym, exercise facility, fitness center, exercise center, martial arts school, gymnastics school, school elementary school, junior high school, middle school, high school, university, sports club, sports team, athletic club, or athletic team, health center, diet enter, nutrition center, weight loss center, or any other facility or entity can be a provider or an intermediary and can have associated therewith a respective provider communication device 20 or intermediary communication device 50 which can receive, enter, store, and/or transmit, data and/or information regarding an individual's or patient's exercise activity or activities, fitness activity or activities, sports or athletic activity or activities, dieting activities, nutritional activities, weight loss activities, and/or any other data and/or information regarding the individual or patient. In another preferred embodiment, any data and/or information regarding an individual's or patient's exercise activity or activities, fitness activity or activities, sports or athletic activity or activities, dieting activities, nutritional activities, weight loss activities, and/or any other data and/or information regarding the individual or patient can be transmitted to the central processing computer 10 and can be stored in the electronic healthcare record or the electronic healthcare file of the individual, patient, or caregiver.

In another preferred embodiment, the data and/or information regarding an individual's or patient's exercise activity or activities, fitness activity or activities, sports or athletic activity or activities, dieting activities, nutritional activities, weight loss activities, and/or any other data and/or information regarding the individual or patient can also be transmitted to, and/or stored at or in, the provider communication device 20 associated with any provider(s) of the individual or patient, to any insurer or payer communication device 30 associated with any insurer or payer of the individual or patient, to any communication device 40 associated with the individual, patient, or caregiver of the individual or patient, to any intermediary communication device 50 associated with any authorized intermediary or third party, to any healthcare records computer 60, to any insurance exchange computer 70, and/or to any social networking computer 80. In another preferred embodiment, the data and/or information regarding an individual's or patient's exercise activity or activities, fitness activity or activities, sports or athletic activity or activities, dieting activities, nutritional activities, weight loss activities, and/or any other data and/or information regarding the individual or patient can also contain or include a link(s) or hyperlink(s) to the respective gym, exercise facility, fitness center, exercise center, martial arts school, gymnastics school, school elementary school, junior high school, middle school, high school, university, sports club, sports team, athletic club, or athletic team, health center, diet enter, nutrition center, weight loss center, or any other facility or entity, from which the data and/or information was obtained or recorded and/to to any data, information, and/or records, regarding the individual or patient which are stored in the provider communication device 20 or the intermediary communication device 50 associated with the to the respective gym, exercise facility, fitness center, exercise center, martial arts school, gymnastics school, school elementary school, junior high school, middle school, high school, university, sports club, sports team, athletic club, or athletic team, health center, diet enter, nutrition center, weight loss center, or any other facility or entity.

In this regard, any data and/or information regarding any exercise activity or activities, fitness activity or activities, sports or athletic activity or activities, dieting activities, nutritional activities, weight loss activities, and/or any other data and/or information regarding the individual or patient can be obtained by any of the herein-described individuals, patients, or caregivers, or by their respective providers, insurers or payers, or authorized intermediaries or third parties. In this regard, a caregiver, a provider, an insurer or payer, or an authorized intermediary or third party can ascertain, verify, monitor, or otherwise check or review, the respective exercise activity or activities, fitness activity or activities, sports or athletic activity or activities, dieting activities, nutritional activities, weight loss activities, and/or any other data and/or information regarding the individual or patient.

In another preferred embodiment, the electronic healthcare record or the electronic healthcare file of an individual, patient, or caregiver, can contain a link or hyperlink to the individual's, the patient's, or the caregiver's, account with a respective telematics, on-line services provider, or other services provider, for a vehicle owned or used by the individual, patient, or caregiver, and vice versa. In this regard, if an individual, patient, or caregiver, in a vehicle capable of detecting the occurrence of an accident involving, or capable of providing a communication link with the sick or ill individual, patient, or caregiver, can provide, to an emergency responder or a communication device associated with or used by an emergency responder, data and/or information regarding, and/or a link(s) or hyperlink(s) to the individual's, patient's, or caregiver's, electronic healthcare record or electronic healthcare file, when the emergency responder responds to an emergency involving the individual, patient, or caregiver.

In another preferred embodiment, as well any and/or all of the embodiments described herein, the central processing computer 10 can be programmed to store information regarding any and/or all activities regarding and/or involving an individual's, a patient's, or a caregiver's, electronic healthcare record, including, but not limited, any information regarding any accessing of same, any activities performed regarding same, including, but not limited to, any data and/or information entered into, changed, altered, modified, or updated, in same, and/or dates and/or times of the activity as well as who performed the activity, any information regarding and any of the herein-described reports, messages, alerts, alert messages, notifications, notification messages, insurance claims, requests for payments, generated or submitted involving the individual, patient, or caregiver, or his or her electronic healthcare record or electronic healthcare file, and/or any other activity described herein as being performed in connection with or using the apparatus 100 of the present invention. The central processing computer 10 can generate an activity report or activity reports at any time, at any time interval, upon an occurrence or happening or any activity, or at any other time, and can transmit the activity report to a computer or communication device 40, 20, 30, or 50 associated with the individual, patient, or caregiver, a provider(s) of the individual, patient, or caregiver, an insurer or payer of the individual, patient, or caregiver, or any other intermediary or third party. Any of the herein-described activity reports can also be stored in the individual's, patient's, or caregiver's, electronic healthcare record or electronic healthcare file. Any of the herein-described activity reports can also contain a link or hyperlink to the individual's, patient's, or caregiver's, electronic healthcare record or electronic healthcare file.

While the present invention has been described and illustrated in various preferred and alternate embodiments, such descriptions are merely illustrative of the present invention and are not to be construed to be limitations thereof. In this regard, the present invention encompasses all modifications, variations and/or alternate embodiments, with the scope of the present invention being limited only by the claims which follow.

What is claimed is:

1. A computer-implemented method, comprising:
receiving, with a first receiver, and storing in an electronic healthcare record of an individual or a patient, a note, a comment, or a message, wherein the note, the comment, or the message, is transmitted from a first communication device, wherein the first communication device is associated with or is used by an individual, a patient, or a caregiver of or for an individual or patient;
transmitting, with or from a transmitter or a computer, the note, the comment, or the message, to a second communication device, wherein the second communication device is associated with or is used by a provider;
receiving, with the first receiver or the computer, information regarding the individual or the patient, an examination finding, a procedure finding, a diagnosis, a treatment, a treatment plan, or information provided by the provider, wherein the information regarding the individual or the patient, an examination finding, a procedure finding, a diagnosis, a treatment, a treatment plan, or information provided by the provider, is transmitted from the second communication device or from a third communication device, wherein the third communication device is associated with or is used by the provider;
processing, with the computer, the information regarding the individual or the patient, an examination finding, a procedure finding, a diagnosis, a treatment, a treatment plan, or information provided by the provider;
generating, with the computer, a report containing information regarding the information regarding the individual or the patient, an examination finding, a procedure finding, a diagnosis, a treatment, a treatment plan, a wellness report, an exercise report, a fitness report, a nutritional report, a diet report, a rehabilitation report, a therapy report, or information provided by the provider, wherein the report contains information regarding, a link to, or a hyperlink to, the electronic healthcare record of the individual or the patient, data or information contained in the electronic healthcare record of the individual or the patient, the note, the comment, or the message; and
transmitting, with or from the transmitter, a second transmitter, or the computer, the report to the first communication device, to the second communication device, to a third communication device, or to a fourth communication device, wherein the fourth communication device is associated with or is used by the individual, the patient, the caregiver, a second provider, or an insurer or payer of the individual, the patient, or the caregiver.

2. The computer-implemented method of claim 1, further comprising:
generating, with the computer, an insurance claim, a claim form, a request for payment, or a request for payment form; and
transmitting the insurance claim, the claim form, the request for payment, or the request for payment form, to the fourth communication device or to a fifth communication device, wherein the fifth communication device is associated with or is used by an insurer or payer of the individual, the patient, or the caregiver.

3. The computer implemented method of claim 2, wherein the insurance claim, the claim form, the request for payment, or the request for payment form, contains information contained or included in, or a link or a hyperlink to information contained in or included in, the electronic healthcare record of the individual or the patient.

4. The computer-implemented method of claim 1, further comprising:
storing the report in the electronic healthcare record of the individual or the patient.

5. The computer-implemented method of claim 2, further comprising:
transmitting the insurance claim, the claim form, the request for payment, or the request for payment form, to the first communication device, to the fourth communication device, or to a fifth communication device, wherein the fifth communication device is associated with or is used by the individual, the patient, or the caregiver.

6. The computer-implemented method of claim 2, further comprising:
transmitting the insurance claim, the claim form, the request for payment, or the request for payment form, to the second communication device, to the third communication device, or to a fifth communication device, wherein the fifth communication device is associated with or is used by provider or a second provider.

7. The computer-implemented method of claim 1, further comprising:
receiving a provider-provided note, comment, or message, provided by the provider, wherein the provider-provided note, comment, or message, is transmitted from the second communication device or from the third communication device; and
storing the provider-provided note, comment, or message, in the electronic healthcare record of the individual or the patient.

8. The computer-implemented method of claim 1, further comprising:
receiving an insurer-provided or a payer-provided note, comment, or message, provided by an insurer or a payer, insurer-provided or a payer-provided note, comment, or message, is transmitted from the fourth communication device or from a fifth communication device, wherein the fifth communication device is associated with or is used by an insurer or payer of the individual, the patient, or the caregiver.
storing the insurer-provided or a payer-provided note, comment, or message, in the electronic healthcare record of the individual or the patient.

9. The computer-implemented method of claim 1, wherein the electronic healthcare record of the individual or the patient contains one or more electronic healthcare records, electronic medical records, electronic dental records, electronic pharmacy records, or electronic behavioral health records, or contains a link or hyperlink to one or more electronic healthcare records, electronic medical records, electronic dental records, electronic pharmacy records, or electronic behavioral health records, or contains a link or a hyperlink to a computer or a communication device associated with or used by a provider, an insurer or a payer, an insurance company computer, or a healthcare records computer, or contains a link or a hyperlink to an insurance exchange computer, a social networking computer, or a media computer.

10. The computer-implemented method of claim 1, wherein the first communication device is a personal computer.

11. The computer-implemented method of claim 1, wherein the first communication device is a tablet or a tablet computer.

12. The computer-implemented method of claim 1, wherein the first communication device is a cellular telephone, a smart phone, or a personal digital assistant.

13. The computer-implemented method of claim 1, further comprising:
receiving information regarding or an update regarding a personal healthcare record associated with the individual or the patient;
processing the information regarding or the update regarding the personal healthcare record associated with the individual or the patient;
generating an updated personal healthcare record; and
transmitting the updated personal healthcare record to the first communication device.

14. The computer-implemented method of claim 13, further comprising:
storing the, or information contained or included in the, updated personal healthcare record in the electronic healthcare record of the individual or the patient.

15. The computer-implemented method of claim 1, wherein the report contains a link to wellness information.

16. The computer-implemented method of claim 1, further comprising:
receiving a request to create or establish the electronic healthcare record of the individual or the patient or a request to create or establish a second healthcare record of the individual or the patient; and
creating or establish the electronic healthcare record of the individual or the patient or a request to create or establish a second healthcare record of the individual or the patient.

17. The computer-implemented method of claim 1, further comprising:
processing a request by the individual or the patient, by a caregiver of the individual or patient, by a second individual or a second patient, or by a caregiver of the second individual or the second patient, to make or schedule an appointment with the provider or with the second provider; and
scheduling the appointment; and
storing information regarding the appointment; and
transmitting the information regarding the appointment to the first communication device or to a fourth communication device, wherein the fourth communication device is associated with the individual, the patient, the caregiver of the individual or the patient, the second individual, the second patient, the caregiver of the second individual or the second patient, the provider, or a second provider.

18. The computer-implemented method of claim 1, further comprising:
generating a notification message regarding an event or occurrence regarding the individual or the patient or a second individual or a second patient; and
transmitting the notification message to the second communication device, to the third communication device, to the fourth communication, or to a fifth communication device, wherein the fifth communication device is associated with or used by a provider of the second individual or the second patient.

19. The computer-implemented method of claim 1, further comprising:
determining whether the provider, a second provider, an insurer or payer, or a user, is allowed or authorized to access, obtain, modify, change, alter, or update, the electronic healthcare record of the individual or the patient or an electronic healthcare record of a second individual or a second patient; and
allowing the provider, the second provider, the insurer or payer, or the user, to access, obtain, modify, change, alter, or update, the electronic healthcare record of the individual or the patient or the electronic healthcare record of a second individual or a second patient if the provider, the second provider, the insurer or payer, or the user, is authorized or allowed.

20. The computer-implemented method of claim 19, further comprising:
processing information for undoing, negating, or voiding, an unauthorized modification, change, alteration, or update to the electronic healthcare record or to the second electronic healthcare record.
